(19) United States
(12) Patent Application Publication
(10) Pub. No.: US 2026/0112616 A1
(43) Pub. Date: Apr. 23, 2026

(54) ADVANCED ELECTROLYTE SYSTEMS WITH SPECIALIZED ADDITIVES FOR IMPROVING PERFORMANCE OF LITHIUM-SULFUR BATTERIES

(71) Applicant: Lyten, Inc., San Jose, CA (US)

(72) Inventors: Jared Long, San Jose, CA (US); Jesse Baucom, Santa Clara, CA (US); Alexander Klevay, San Jose, CA (US); Amruth Bhargav, Mountain View, CA (US); Babu Ganguli, Santa Clara, CA (US)

(21) Appl. No.: 19/372,067

(22) Filed: Oct. 28, 2025

Related U.S. Application Data
(63) Continuation-in-part of application No. 18/765,011, filed on Jul. 5, 2024.
(60) Provisional application No. 63/562,167, filed on Mar. 6, 2024.

(51) Int. Cl. H01M 4/40; H01M 4/02; H01M 10/052; H01M 10/0567; H01M 10/0568; H01M 10/0569

(52) U.S. Cl. CPC H01M 4/405; H01M 10/052; H01M 10/0567; H01M 10/0568; H01M 10/0569; H01M 2004/021; H01M 2004/027; H01M 2300/0034; H01M 2300/004

(57) ABSTRACT

The synthesis of two-dimensional (2D) porous carbon materials has attracted much attention due to their widespread applications. In this work, a high-performance Fe/N doped hierarchical porous carbon nanosheets is developed through thermal activation step based on organic groups triggered polymer particles exfoliation. Polymer nanoparticles are exfoliated by the reaction between the phenolic hydroxyl groups and the amino groups. The gas produced from dicyandiamide then blows polymer fragments into ultrathin flexible carbon nanosheets under pyrolysis process, along with nitrogen doping. The Fe—N—C catalyst exhibits half-wave potential (E_{1/2}) at 0.852 V (vs. RHE) in 0.1 M KOH and at 0.686 V (vs. RHE) in 0.5 M H₂SO₄ for oxygen reduction reaction. Additionally, the polymer electrolyte membrane fuel cells that employ the catalyst at the cathode exhibits durability close to 100 h, without showing significant degradation after 96 h continuous operation. In addition, this method can be generalized to synthesize carbon nanosheets by using various polymer precursors. This work provides a new and general strategy for preparing porous carbon or metal/carbon nanosheets, which paves the way for the mass production of effective 2D carbon materials in many important applications.

### RELATED APPLICATIONS

The present application is a continuation-in-part of, and claims priority to. U.S. patent application Ser. No. 18/765,011, filed Jul. 5, 2024, and entitled “ELECTROLYTE SYSTEMS INCLUDING ELECTRON WITHDRAWING COMPOUNDS WITH AN ALPHA-BETA MOTIF FOR IMPROVING PERFORMANCE OF LITHIUM-BASED SECONDARY BATTERIES”, which, in turn, is related, and claims priority to, U.S. Provisional Patent Application No. 63/562,167, filed Mar. 6, 2024 and entitled “ELECTROLYTE ADDITIVE FOR IMPROVING PERFORMANCE AND CYCLE LIFE OF LITHIUM-BASED SECONDARY BATTERIES”, the contents of all of which are herein incorporated by reference in their entirety.

### FIELD OF THE INVENTION

The present invention relates to battery technology, and more particularly to advanced electrolyte compositions for lithium-sulfur batteries including specialized additives such as highly solvating compounds, fluoroether additives, and guanidine-containing compounds.

### BACKGROUND

The field of lithium-sulfur battery technology faces a significant challenge in achieving high energy density while maintaining practical electrolyte performance and operational stability. Despite offering theoretical energy densities of up to 2600 Wh/kg, which substantially exceeds conventional lithium-ion systems, lithium-sulfur batteries struggle to realize this potential due to complex electrochemical processes and stringent electrolyte requirements. This issue has become increasingly important due to growing demand for lightweight, high-capacity energy storage solutions across applications including electric vehicles, aerospace systems, drone platforms, portable electronics, and grid-scale energy storage where weight and volume constraints are paramount.

Existing systems attempting to address lithium-sulfur battery limitations encounter several fundamental obstacles. These include the polysulfide shuttle effect where soluble lithium polysulfide intermediates migrate between electrodes causing capacity loss and reduced coulombic efficiency, electrolyte degradation and dryout during cycling, and lithium dendrite formation at anode surfaces leading to safety concerns and performance deterioration. Current electrolyte formulations typically require high electrolyte-to-sulfur ratios often exceeding 5:1, which significantly increases overall battery weight and reduces practical energy density. Additionally, existing electrolyte compositions struggle to simultaneously provide adequate polysulfide solvation, maintain electrochemical stability, ensure sufficient ionic conductivity, and balance polysulfide dissolution kinetics with electrode passivation effects within a single system.

For instance, in aerospace and drone applications where weight reduction is paramount, current lithium-sulfur batteries fail to deliver the energy density advantages that make them theoretically attractive due to excessive electrolyte loading requirements. Another example is in electric vehicle applications, where existing electrolyte formulations are unable to provide both the high energy density and extended cycle life required for commercial viability, often forcing manufacturers to choose between performance characteristics rather than achieving both simultaneously. Traditional electrolyte additives frequently provide limited improvement in one performance metric while compromising others, such as enhancing cycle life at the expense of rate capability, or improving solid electrolyte interphase formation while increasing system resistance and reducing overall battery performance.

As such, there is thus a long-felt and ongoing need for improved electrolyte compositions to address the above, and/or other issues associated with the prior art.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an electrochemical lithium-sulfur cell is provided. The electrochemical lithium-sulfur cell includes a cathode comprising sulfur with a mass loading of less than 5 mg/cm², an anode comprising lithium with a thickness of less than 100 microns, and an electrolyte solution comprising a solvent package having at least two solvents. Dimethoxyethane (DME) comprises at least 60% by volume of the solvent package, and lithium salts are present at a total concentration below 1.2 M, wherein at least one lithium salt is lithium nitrate (LiNO₃) and at least one additional lithium salt is selected from the group consisting of lithium bis(trifluoromethanesulfonyl)imide (LiTFSI), lithium bis(fluorosulfonyl)imide (LiFSI), lithium perchlorate (LiClO₄), and lithium trifluoromethanesulfonate (LiOTf). The electrolyte-to-sulfur mass ratio is less than or equal to 3.5:1.

According to other aspects, the DME may comprise at least 70% by volume of the solvent package, the solvent package may comprise at least three solvents, and the anode may be freestanding without a copper foil current collector. The anode may comprise a lithium alloy, such as a lithium-magnesium alloy. The molar ratio of DME to LiTFSI may be about 10.1:1, providing excess non-coordinated ether groups for polysulfide solvation, and the molar ratio of DME to total lithium salts may be about 5.52:1. The lithium-sulfur cell may be configured to operate at a pressure of about 40 PSI, below 50 PSI, and/or between 50-100 PSI and cycle between 1.8 V and 2.5 V.

In various embodiments, the solvent package may comprise DME, dioxolane (DOL), and bis(2,2,2-trifluoroethyl) ether (BTFE) in a volume ratio ranging from about 60-80:10-20:10-20. The lithium salts may comprise LiTFSI at a concentration ranging from about 0.3 M to about 0.9 M and LiNO₃ at a concentration ranging from about 0.25 M to about 0.75 M. In some cases, the lithium salts may comprise LiTFSI at a concentration ranging from about 0.4 M to about 0.9 M, LiNO₃ at a concentration ranging from about 0.25 M to about 0.75 M, and DCDA at a concentration ranging from about 0.075 M to about 0.225 M.

According to another aspect of the present disclosure, a lithium-sulfur electrochemical cell is provided that includes a lithium anode, a sulfur cathode, and an electrolyte comprising a fluoroether compound having specialized molecular structures. The fluoroether compound may have the structure CF₃CH₂O—R, where R is selected from the group consisting of alkyl groups, fluoroalkyl groups, CH₂CF₃, CH₂CF₂CF₂H, CH₂CH₂OCH₂CF₃, and combinations thereof. The fluoroether compound may be CF₃CH₂OCH₂CF₃ (BTFE), or may have the structure CF₃CHFCF₂O—R that forms a solid electrolyte interphase on the lithium anode. The fluoroether compound may have the structure CF₂HCF₂CH₂O—R and provide improved rate performance due to low electrolyte viscosity. The fluoroether compound may contain two oxygen molecules in the ether structure and have the formula CF₃CH₂OCH₂CH₂OCH₂CF₃.

According to a related aspect, a method for improving electrochemical performance of a lithium-sulfur battery comprises providing a lithium-sulfur electrochemical cell having a lithium anode and a sulfur cathode, introducing an electrolyte comprising a fluoroether compound selected from the group consisting of CF₃CHFCF₂O—R compounds, CF₂HCF₂CH₂O—R compounds, and fluoroethers containing two oxygen molecules in the ether structure, and operating the electrochemical cell to form a solid electrolyte interphase (SEI) on the lithium anode that provides improved coulombic efficiency.

According to another aspect of the present disclosure, an electrolyte composition is provided that comprises at least one solvent, at least one lithium salt, at least one electron withdrawing compound comprising a fluorinated ether, and at least one performance enhancing additive. The fluorinated ether may have the structure CF₃CHFCF₂O—R, where R is selected from the group consisting of alkyl groups, fluoroalkyl groups, and combinations thereof. The fluorinated ether and the performance enhancing additive may work synergistically to improve coulombic efficiency, and the combination may form an enhanced solid electrolyte interphase (SEI) layer. The fluorinated ether may comprise CF₃CH₂O—R groups and the performance enhancing additive may comprise a viscosity modifier. The fluorinated ether and the performance enhancing additive may be present in a ratio that optimizes both coulombic efficiency and cycle life, wherein the fluorinated ether provides SEI formation properties and the performance enhancing additive provides polysulfide dissolution control.

According to another aspect of the present disclosure, an electrolyte system is provided that includes at least one solvent, at least one electron withdrawing compound, at least one performance-enhancing additive comprising a guanidine-containing compound, at least one nitrogen-containing additive, and at least one lithium ion-transporting compound.

The guanidine-containing compound is selected from the group consisting of guanidine nitrate, guanidine thiocyanate, guanine, guanidine bromide, guanidine hydrochloride, 1,3-diphenylguanidine, biguanide, metformin hydrochloride, and combinations thereof. The nitrogen-containing additive is selected from the group consisting of dicyandiamide (DCDA), guanidine nitrate, acetonitrile, azobisisobutyronitrile (AIBN), cyanamide, lithium dicyanamide, succinonitrile, sildenafil citrate, taurine, (S)-2-amino-5-ureidopentanoic acid, 2-(1-methylguanidino) acetic acid, 1,3,7-trimethyl-2,3,6,7-tetrahydro-1H-purine-2,6-dione, 2-phenylethylamine, and combinations thereof.

The guanidine-containing compound may have an NH₂—CNH—NH—R structural motif and may be present in a concentration ranging from 0.05M to 0.15M, or approximately 0.10M. The electrolyte system may comprise both the guanidine-containing compound and dicyandiamide (DCDA), wherein the combination exhibits enhanced coulombic efficiency compared to either component alone. The guanidine-containing compound may comprise a halogen selected from the group consisting of bromine and iodine, or may comprise a cyclic ring structure containing nitrogen, such as a purine ring system.

The at least one solvent may comprise dimethoxyethane (DME) or may be selected from the group consisting of dimethoxyethane, diethylene glycol dimethyl ether, tetraethylene glycol dimethyl ether, and combinations thereof. The at least one lithium ion-transporting compound may comprise lithium bis(trifluoromethanesulfonyl)imide (LiTFSI) or may be selected from the group consisting of lithium bis(trifluoromethanesulfonyl)imide (LiTFSI), lithium bis(fluorosulfonyl)imide (LiFSI), lithium perchlorate (LiClO₄), and lithium trifluoromethanesulfonate (LiOTf)lithium tetrafluoroborate, and combinations thereof. The at least one electron withdrawing compound may comprise lithium nitrate. The nitrogen-containing additive may be present in a concentration ranging from 0.01M to 0.2M. The guanidine-containing compound may be guanidine nitrate or guanidine thiocyanate and the nitrogen-containing additive may be dicyandiamide. The guanidine-containing compound may exhibit synergistic electrochemical performance when present with the nitrogen-containing additive, with both additives present in optimized concentration ratios within the range of 0.05M to 0.15M for the guanidine-containing compound. The guanidine-containing compound may be selected based on protection of the NH₂—CNH—NH—R structural motif, and the combination may provide enhanced electrochemical stability compared to either component alone.

In some aspects, the techniques described herein relate to an electrolyte composition, including: at least one solvent; at least one lithium salt; at least one electron withdrawing compound including a fluorinated ether; and at least one performance enhancing additive.

In some aspects, the techniques described herein relate to an electrolyte composition, wherein the fluorinated ether has the structure CF₃CHFCF₂O—R, where R is selected from the group consisting of alkyl groups, fluoroalkyl groups, and combinations thereof.

In some aspects, the techniques described herein relate to an electrolyte composition, wherein the fluorinated ether and the performance enhancing additive work synergistically to improve coulombic efficiency.

In some aspects, the techniques described herein relate to an electrolyte composition, wherein the combination of the fluorinated ether and the performance enhancing additive forms an enhanced solid electrolyte interphase (SEI) layer.

In some aspects, the techniques described herein relate to an electrolyte composition, wherein the enhanced solid electrolyte interphase layer provides improved electrochemical stability and reduced lithium dendrite formation.

In some aspects, the techniques described herein relate to an electrolyte composition, wherein the fluorinated ether includes CF₃CH₂O—R groups and the performance enhancing additive includes a viscosity modifier.

In some aspects, the techniques described herein relate to an electrolyte composition, wherein the viscosity modifier is selected from the group consisting of lithium nitrate, lithium bis(trifluoromethanesulfonyl)imide, and combinations thereof.

In some aspects, the techniques described herein relate to an electrolyte composition, wherein the fluorinated ether and the performance enhancing additive are present in a weight ratio ranging from about 1:1 to about 10:1, wherein the combination increases coulombic efficiency and cycle life compared to electrolyte compositions containing either component alone.

In some aspects, the techniques described herein relate to an electrolyte composition, wherein the ratio of fluorinated ether to performance enhancing additive ranges from 1:1 to 5:1 by weight.

In some aspects, the techniques described herein relate to an electrolyte composition, wherein the fluorinated ether provides SEI formation properties and the performance enhancing additive provides polysulfide dissolution control.

In some aspects, the techniques described herein relate to an electrolyte composition, wherein the polysulfide dissolution control reduces polysulfide shuttle effects during battery cycling operations.

In some aspects, the techniques described herein relate to an electrolyte composition, wherein the combination of the fluorinated ether and the performance enhancing additive reduces electrolyte viscosity while maintaining high coulombic efficiency.

In some aspects, the techniques described herein relate to an electrolyte composition, wherein the electrolyte viscosity is reduced by at least 20% compared to conventional ether-based electrolytes.

In some aspects, the techniques described herein relate to an electrolyte composition, wherein the fluorinated ether includes multiple CF₃CH₂O groups and the performance enhancing additive includes a conductivity enhancer.

In some aspects, the techniques described herein relate to an electrolyte composition, wherein the conductivity enhancer increases ionic conductivity by at least 15% compared to baseline electrolyte formulations.

In some aspects, the techniques described herein relate to an electrolyte composition, wherein: the at least one solvent includes dimethoxyethane and dioxolane; the at least one lithium salt includes lithium bis(trifluoromethanesulfonyl)imide; and the performance enhancing additive includes lithium nitrate.

In some aspects, the techniques described herein relate to an electrolyte composition, wherein the dimethoxyethane and dioxolane are present in a ratio ranging from at least one of: 1:1 to 3:1 by volume; or 1:1 to 5:1 by volume.

In some aspects, the techniques described herein relate to an electrolyte composition, wherein: the fluorinated ether is selected from the group consisting of BTFE, THE, HFMOP, TFEO, F5DEE, and F6DEE; and the performance enhancing additive includes at least one lithium salt additive.

In some aspects, the techniques described herein relate to an electrolyte composition, wherein the fluorinated ether is BTFE having the structure CF₃CH₂OCH₂CF₃.

In some aspects, the techniques described herein relate to an electrolyte composition, wherein: the fluorinated ether contains two oxygen molecules in the ether structure; the performance enhancing additive includes a combination of lithium nitrate and a viscosity modifier; and the electrolyte composition exhibits improved rate performance and cycle life compared to conventional lithium-sulfur battery electrolytes.

In some aspects, the techniques described herein relate to an electrolyte system, including: at least one solvent; at least one electron withdrawing compound; at least one performance-enhancing additive including a guanidine-containing compound, wherein the guanidine-containing compound is selected from the group consisting of: guanidine nitrate, guanidine thiocyanate, guanine, guanidine bromide, and combinations thereof, at least one nitrogen-containing additive selected from the group consisting of: dicyandiamide (DCDA), guanidine nitrate, acetonitrile, azobisisobutyronitrile (AIBN), cyanamide, lithium dicyanamide, succinonitrile, guanidine iodide, sildenafil citrate, taurine, (S)-2-amino-5-ureidopentanoic acid, 2-(1-methylguanidino) acetic acid, 1,3,7-trimethyl-2,3,6,7-tetrahydro-1H-purine-2,6-dione, 2-phenylethylamine, guanidine hydrochloride, 1,3-diphenylguanidine, biguanide, metformin hydrochloride, and combinations thereof, and at least one lithium ion-transporting compound.

In some aspects, the techniques described herein relate to an electrolyte system, wherein the guanidine-containing compound has an NH₂—CNH—NH—R structural motif.

In some aspects, the techniques described herein relate to an electrolyte system, wherein the guanidine-containing compound is present in a concentration ranging from 0.05M to 0.15M.

In some aspects, the techniques described herein relate to an electrolyte system, wherein the guanidine-containing compound is present in a concentration of approximately 0.10M.

In some aspects, the techniques described herein relate to an electrolyte system, wherein the electrolyte system includes both the guanidine-containing compound and dicyandiamide (DCDA).

In some aspects, the techniques described herein relate to an electrolyte system, wherein the combination of DCDA and the guanidine-containing compound exhibits enhanced coulombic efficiency compared to either DCDA alone or the guanidine-containing compound alone.

In some aspects, the techniques described herein relate to an electrolyte system, wherein the guanidine-containing compound includes a halogen.

In some aspects, the techniques described herein relate to an electrolyte system, wherein the halogen is selected from the group consisting of bromine and iodine.

In some aspects, the techniques described herein relate to an electrolyte system, wherein the guanidine-containing compound includes a cyclic ring structure containing nitrogen.

In some aspects, the techniques described herein relate to an electrolyte system, wherein the cyclic ring structure is a purine ring system.

In some aspects, the techniques described herein relate to an electrolyte system, wherein the at least one solvent includes dimethoxyethane (DME).

In some aspects, the techniques described herein relate to an electrolyte system, wherein the at least one solvent is selected from the group consisting of dimethoxyethane, diethylene glycol dimethyl ether, tetraethylene glycol dimethyl ether, and combinations thereof.

In some aspects, the techniques described herein relate to an electrolyte system, wherein the at least one lithium ion-transporting compound includes lithium bis(trifluoromethanesulfonyl)imide (LiTFSI).

In some aspects, the techniques described herein relate to an electrolyte system, wherein the at least one lithium ion-transporting compound is selected from the group consisting of lithium bis(trifluoromethanesulfonyl)imide (LiTFSI), lithium bis(fluorosulfonyl)imide (LiFSI), lithium perchlorate (LiClO₄), and lithium trifluoromethanesulfonate (LiOTf), lithium tetrafluoroborate, and combinations thereof.

In some aspects, the techniques described herein relate to an electrolyte system, wherein the at least one electron withdrawing compound includes lithium nitrate.

In some aspects, the techniques described herein relate to an electrolyte system, wherein the nitrogen-containing additive is present in a concentration ranging from 0.01M to 0.2M.

In some aspects, the techniques described herein relate to an electrolyte system, wherein the guanidine-containing compound is guanidine nitrate and the nitrogen-containing additive is dicyandiamide.

In some aspects, the techniques described herein relate to an electrolyte system, wherein the guanidine-containing compound is guanidine thiocyanate and the nitrogen-containing additive is dicyandiamide.

In some aspects, the techniques described herein relate to an electrolyte system, wherein the guanidine-containing compound exhibits synergistic electrochemical performance when present with the nitrogen-containing additive, and wherein the guanidine-containing compound and nitrogen-containing additive are present in optimized concentration ratios within the range of 0.05M to 0.15M for the guanidine-containing compound.

In some aspects, the techniques described herein relate to an electrolyte system, wherein the guanidine-containing compound is selected based on protection of the NH₂—CNH—NH—R structural motif, the electrolyte system includes both guanidine-containing compound and dicyandiamide in combination, and wherein the combination provides enhanced electrochemical stability compared to either component alone.

### BRIEF DESCRIPTION OF THE DRAWINGS

FIGS. 1A-1B are simplified schematics of the chemical structure of the inventive motif characteristic of compounds included in the inventive electrolyte systems described herein, according to various embodiments.

FIGS. 2A-1 through 2B-3 are simplified schematics of the chemical structures of several exemplary species of alpha-hydrogenated, selectively beta-functionalized compounds, according to different approaches.

FIG. 3 illustrates a simplified schematic of a reaction pathway for chalcogenide materials to form free radicals that facilitate conversion of lithium polysulfides, in accordance with one embodiment.

FIGS. 4A-4E are simplified graphs showing performance characteristics of an electrolyte system 401 including an inventive electrolyte system as disclosed herein and in accordance with one embodiment with reference to a control electrolyte system 404 implementing an electrolyte system otherwise identical to the inventive electrolyte system, but omitting any chalcogenide.

FIG. 4A is a plot showing discharge capacity versus cycle number for the inventive electrolyte system 401 and the control electrolyte system 404, according to one embodiment.

FIG. 4B is a plot showing columbic efficiency versus cycle number for the inventive electrolyte system 401 and the control electrolyte system 404, according to the same embodiment.

FIG. 4C is a plot showing rating capacity for the inventive electrolyte system 401 and the control electrolyte system 404, according to the same embodiment.

FIG. 4D is a plot showing discharge capacity versus charge rate for the inventive electrolyte system 401 and the control electrolyte system 404, according to the same embodiment.

FIG. 4E is a plot showing potential versus capacity for the inventive electrolyte system 401 and the control electrolyte system 404, according to the same embodiment.

FIG. 5A is a plot showing cycle life versus fluoroether concentration for inventive electrolyte systems 401, 411, and 421 and corresponding control electrolyte systems 402, 412, and 422, according to several exemplary embodiments.

FIG. 5B is a plot showing cycle life versus fluoroether concentration for inventive electrolyte systems 401, 411, and 421 and corresponding control electrolyte systems 402, 412, and 422, according to several exemplary embodiments.

FIGS. 6A-6D are simplified schematics of the chemical structures of performance-enhancing additives, in accordance with several embodiments.

FIG. 7A is a plot comparing capacity retention over cycle life of a lithium-sulfur electrochemical cell having a baseline electrolyte composition (control) versus a lithium-sulfur electrochemical cell having a baseline electrolyte composition but also including DCDA additive (+DCDA), in accordance with one embodiment.

FIG. 7B is a plot comparing Coulombic efficiency of a lithium-sulfur electrochemical cell having a baseline electrolyte composition (control) versus a lithium-sulfur electrochemical cell having a baseline electrolyte composition but also including DCDA additive (+DCDA), in accordance with one embodiment.

FIG. 7C is a plot showing Fourier-Transform Infrared (FTIR) spectra of the solid-electrolyte interphase (SEI) of two lithium-sulfur electrochemical cells having a baseline electrolyte composition (control) in comparison to the SEI of two lithium-sulfur electrochemical cells having a baseline electrolyte composition but also including DCDA additive (+DCDA), in accordance with one embodiment.

FIG. 8A shows a simplified schematic cross-sectional view of an electrochemical cell characterized by a pouch cell arrangement, according to one embodiment of the presently disclosed inventive concepts.

FIG. 8B is a simplified schematic external view of the electrochemical cell shown in FIG. 8A, according to one embodiment of the presently disclosed inventive concepts.

FIG. 8C depicts a simplified schematic of the pouch cell arrangement shown in FIG. 8B, wrapped into a jelly-roll configuration, according to one approach of the presently disclosed inventive concepts.

FIG. 9A is a simplified schematic of an electrochemical cell characterized by a coin cell arrangement, according to one implementation of the presently disclosed inventive concepts.

FIG. 9B depicts various components of the coin cell arrangement shown in FIG. 9A, according to a simplified schematic exploded view.

FIG. 10A is a simplified schematic of an electrochemical cell characterized by a cylindrical cell arrangement, according to one aspect of the presently disclosed inventive concepts.

FIG. 10B is a simplified schematic cut-out view of exemplary components of the cylindrical cell arrangement shown in FIG. 10A, according to one implementation of the presently disclosed inventive concepts.

FIG. 11 is a simplified schematic of an electrochemical cell characterized by a cylindrical cell arrangement, according to one aspect of the presently disclosed inventive concepts.

FIG. 12 is a chart showing various forms of carbonaceous material, and methods of producing the same from elemental carbon (e.g., charcoal), which may be included in various components of electrochemical cells such as shown in the foregoing FIGs.

FIG. 13 illustrates a battery system including a battery cell with cathode and anode components, according to aspects of the present disclosure.

FIG. 14 illustrates an electrolyte system showing components for forming a solvent package, according to aspects of the present disclosure.

FIG. 15 depicts a specific capacity graph showing DME to lithium salt ratio relationships, according to aspects of the present disclosure.

FIG. 16 depicts an energy density graph with electrolyte composition zones and operating points, according to aspects of the present disclosure.

FIG. 17 depicts an electrolyte composition with an exemplary composition table, according to aspects of the present disclosure.

FIG. 18 depicts discharge capacity versus cycle number curves for different electrolyte compositions, according to aspects of the present disclosure.

FIG. 19 illustrates a cycle number graph 1900, in accordance with one embodiment.

FIG. 20 depicts a fluoroether property table showing physical and electrochemical characteristics of various fluoroether compounds, according to aspects of the present disclosure.

FIG. 21-1 through 21-14 illustrate various chemical structures of fluoroether compounds, according to an embodiment.

FIG. 22 depicts a general chemical structure formula for a fluoroether compound, according to aspects of the present disclosure.

FIG. 23A depicts discharge capacity versus cycle number for two electrolyte compositions in lithium-sulfur electrochemical cells, according to an embodiment.

FIG. 23B depicts coulombic efficiency versus cycle number for the two electrolyte compositions of FIG. 23A, according to an embodiment.

FIG. 24A depicts discharge capacity versus cycle number for two electrolyte compositions in lithium-sulfur electrochemical cells, according to an embodiment.

FIG. 24B depicts coulombic efficiency versus cycle number for the two electrolyte compositions of FIG. 24A, according to an embodiment.

FIG. 25A depicts discharge capacity versus cycle number for two electrolyte compositions in lithium-sulfur electrochemical cells, according to an embodiment.

FIG. 25B depicts coulombic efficiency versus cycle number for the two electrolyte compositions of FIG. 25A, according to an embodiment.

FIGS. 26-1 through 26-5 depict chemical structures that may relate to increasing coulombic efficiency, according to an embodiment.

FIG. 27 depicts a chemical structure diagram of a guanidine-containing compound, according to aspects of the present disclosure.

FIG. 28A depicts a graph showing discharge capacity versus cycle number for two electrolyte compositions, according to an embodiment.

FIG. 28B depicts a graph showing coulombic efficiency versus cycle number for the two electrolyte compositions of FIG. 28A, according to an embodiment.

FIG. 29A depicts a graph showing discharge capacity versus cycle number for two electrolyte compositions, according to aspects of the present disclosure.

FIG. 29B depicts a graph showing coulombic efficiency versus cycle number for the two electrolyte compositions of FIG. 29A, according to aspects of the present disclosure.

FIG. 30A depicts a graph showing discharge capacity versus cycle number for two electrolyte compositions, according to aspects of the present disclosure.

FIG. 30B depicts a graph showing coulombic efficiency versus cycle number for the two electrolyte compositions of FIG. 30A, according to aspects of the present disclosure.

FIG. 31A depicts a graph showing discharge capacity versus cycle number for two electrolyte compositions, according to an embodiment.

FIG. 31B depicts a graph showing coulombic efficiency versus cycle number for the two electrolyte compositions of FIG. 31A, according to an embodiment.

### DETAILED DESCRIPTION

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

To address the problems highlighted hereinabove regarding safety and efficiency of electrolyte systems for lithium-based batteries with suitable performance, one principal aspect of the presently disclosed inventive concepts includes an electrolyte system including compounds that contain a motif referred-to herein as an “alpha-hydrogenated, selectively beta-functionalized” (or, equivalently, an “alpha-hydrogenated, selectively beta functionalized”) structure. Preferably, the solvent system is capable of satisfying the multitude of stringent requirements for lithium-based batteries noted above.

The inventors propose the exemplary class of alpha-hydrogenated, selectively beta-functionalized compounds advantageously exhibit similar or superior performance because the beta position is not sterically hindered from participating in desired chemical reactions (e.g., facilitating lithium polysulfide conversion via redox reactions, preferential formation of short-chain lithium polysulfide species, robust formation of a SEI, high solvation capability with respect to lithium salts, etc.), while simultaneously preserving the electron density of the electron withdrawing group adjacent to the alpha carbon of the motif. As described in greater detail hereinbelow, without such selective beta modification, solvent compounds otherwise exhibiting a similar (e.g., alpha-hydrogenated but not beta modified) motif undesirably tend to break down into gases in a cascade of reductive decomposition reactions and ultimately evaporate away from the solvent system.

Similarly, the inventive concepts presented herein relate to the use of such electrolyte systems with a lithium-based anode material in an electrochemical cell. As utilized herein, the term “lithium-based” shall be understood as referring to pure lithium metal, as well as lithium alloys or composites (such as Li—Mg, Li—S, Li—C, Li—Al, Li—Fe, and any other suitable equivalent(s) thereof that would be appreciated by skilled artisans upon reading the present descriptions) or combination(s) thereof.

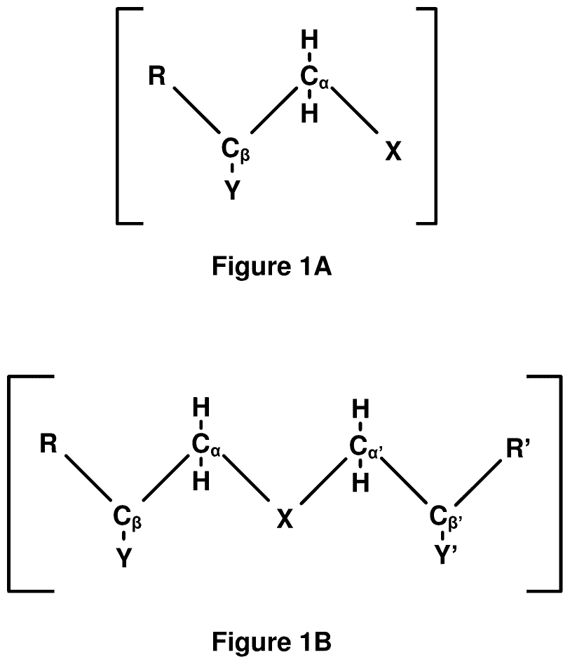

FIGS. 1A-1B are simplified schematics of chemical structures of the motif characteristic of compounds included in the inventive electrolyte systems described herein, according to various embodiments. As an option, the motifs shown in FIGS. 1A-1B may be implemented in the context of any one or more of the embodiments set forth in any previous and/or subsequent FIG. (s) and/or description thereof. Of course, however, the motifs may be implemented in the context of any desired environment. For instance, solvent systems including amides such as dimethylacetamide (DMA), dimethylformamide (DMF), or any other suitable equivalent(s) thereof that would be appreciated by those having ordinary skill in the art upon reading the present disclosure. Further, the aforementioned definitions may equally apply to the description below.

As shown in FIG. 1A, the motif generally includes an alpha carbon C that is hydrogenated (i.e., has at least one hydrogen bonded thereto, preferably is saturated with hydrogen, and more preferably is not directly bonded to another electron withdrawing group other than X), and directly bonded to a beta carbon Cp and an electron withdrawing group X. According to various embodiments, the electron withdrawing group is characterized by an electronegativity greater than carbon, and preferably by an electronegativity characterized by an electronegativity greater than the alpha carbon to which X is bonded. Preferably, X is not a halogen. Accordingly, in preferred implementations X may be selected from a group consisting of nitrogen, oxygen, and sulfur.

With continuing reference to FIG. 1A, In embodiments where C_{α} is not saturated with hydrogen, C_{α} may be doubly bonded to X, such as for a terminal aldehyde in which C_{α} is bonded to a single hydrogen and doubly bonded to X, and X is oxygen.

In addition to being bonded to the alpha carbon C_{α} the beta carbon C_{β} is bonded to a modifying group Y and an aliphatic or aromatic side chain R. Whether R is aliphatic or aromatic, shorter chains, e.g. C1-C20, are preferred to minimize the overall mass of the molecule. Moreover, the backbone of R may, in various implementations, include elements other than carbon, including but not limited to phosphorus, sulfur, oxygen, nitrogen, etc., as would be understood by a person having ordinary skill in the art upon reading the present disclosures. In some approaches, R may be functionalized, such as with halogen(s), amine(s), amide(s), oxide(s), thiol(s), etc., as would be understood by a person having ordinary skill in the art upon reading the present disclosures.

Optionally, depending on the identity of Y and R, and bonding between the beta carbon C_{β}, Y, and R, the beta carbon Cp may optionally be bonded to a hydrogen (not shown), or doubly bonded to either Y or R.

In accordance with the embodiment depicted in FIG. 1A, the electron withdrawing group X is a terminal functional group of the molecule containing the alpha-hydrogenated, selectively beta-functionalized motif.

Of course, in alternative embodiments, such as shown in FIG. 1B, the electron withdrawing group X may be part of the backbone of the molecule, such as for a secondary or tertiary amine (where X is nitrogen), an ether (where X is oxygen), or an organosulfur (where X is sulfur), etc., as will be appreciated by those having ordinary skill in the art upon reading the present descriptions.

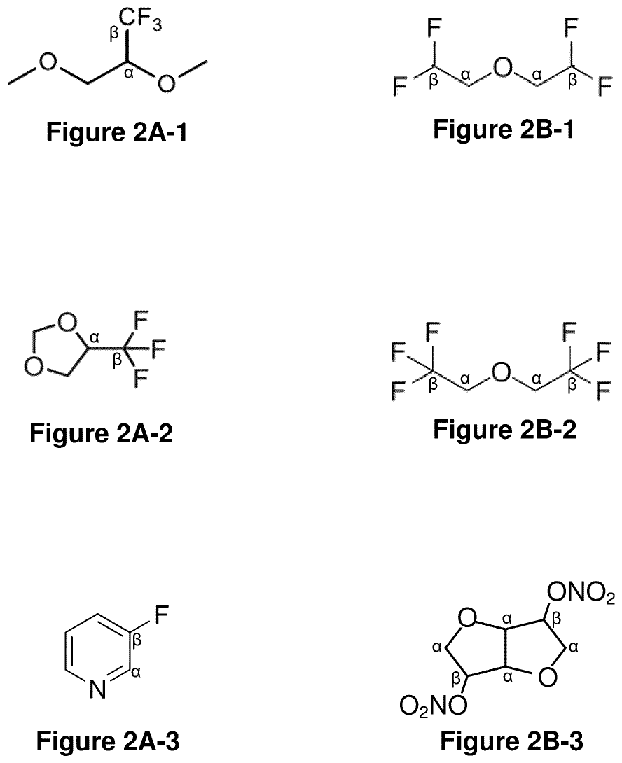

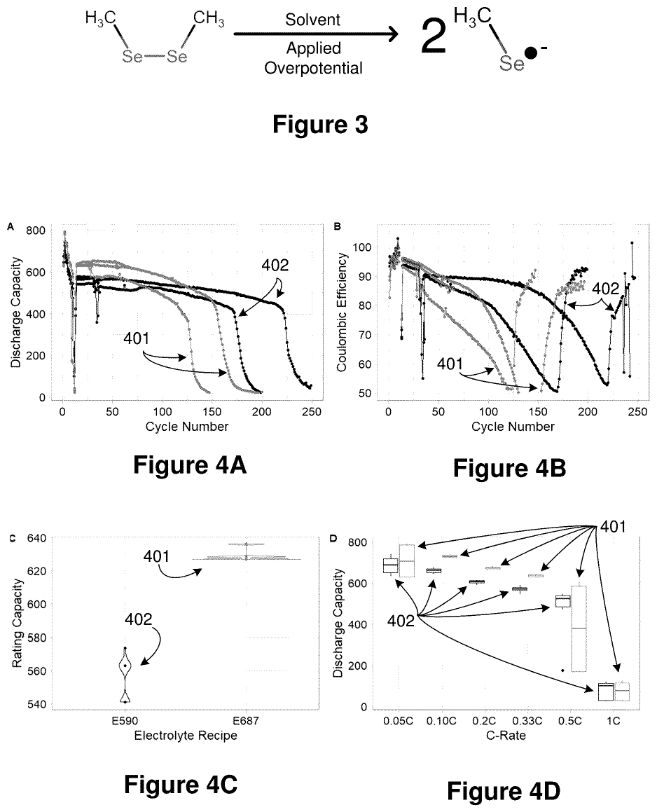

With continuing reference to FIG. 1B, and except as noted immediately hereinabove, the same considerations with respect to bonding and identity of C_{α}, C_{β}, Y, and R as described with respect to FIG. 1A apply to the motif as shown in FIG. 1B. In addition, similar considerations apply with respect to C_{α′}, C_{β′}, Y′, and R′, with the exception that in certain arrangements R and R′ may be part of the same aromatic structure connecting the molecule into a ring (or multi-ring) structure. For instance, and as described in greater detail below with respect to FIG. 2B-3, R and R′ may form a connected double-ring structure. Of course, it shall be understood that C_{α}, C_{β}, Y, R, C_{α′}, C_{β′}, Y′, and R′ may each independently be defined according to any suitable combination of characteristics (identity, bonding, etc.) described hereinabove, according to various embodiments.

FIGS. 2A-1 through 2A-3 are simplified schematics of the chemical structures of several exemplary species of alpha-hydrogenated, selectively beta-functionalized compounds, where the beta modifications are fluorine (i.e., Y═F), while FIG. 2B-3 depicts an exemplary alpha-hydrogenated, selectively beta-functionalized compound where the beta modification is not fluorine (i.e., Y═ONO₂), according to different approaches. As an option, the exemplary compounds may be implemented in the context of any one or more of the embodiments set forth in any previous and/or subsequent FIG. (s) and/or description thereof. Of course, however, the compounds may be implemented in the context of any desired environment. Further, the aforementioned definitions may equally apply to the description below.

As shown in FIGS. 2A-1, 2A-2, and 2A-3, the exemplary electron-withdrawing compounds (1,1,1-trifluoro-2,3-dimethyoxypropane (TFDMP), 4-(trifluoromethyl)-1,3-dioxolane (TFDOL), and (3-fluoropyridine) (3F-P), respectively) fit the motif shown in FIG. 1A. In FIG. 2A-3, R forms an aromatic ring that connects back to C_{α}. For the structures shown in FIGS. 2A-1 and 2A-2, X is oxygen, meanwhile for the structure shown in FIG. 2A-3, X is nitrogen.

The exemplary electron withdrawing compounds shown in FIGS. 2B-1, 2B-2, and 2B-3 (monofluoride bis(2-fluoroethyl) ether (BFE), bis(2,2,2-trifluoroethyl) ether (BTFE), and isosorbide dinitrate (ISDN), respectively); fit the motif as shown in FIG. 1B. For the electron withdrawing compounds shown in FIGS. 2B-1, 2B-2, and 2B-3, X is oxygen. For the electron withdrawing compounds shown in FIGS. 2B-1 and 2B-2, Y is fluorine. For the electron withdrawing compound shown in FIG. 2B-3 only, Y is ONO₂.

Of course, the exemplary structures shown in FIGS. 2A-1 through 2B-3 are to be understood as illustrative of the scope of electron withdrawing compounds according to various embodiments of the inventive concepts presented herein. Other compounds including the motifs shown in FIGS. 1A and/or 1B may also be suitable electron withdrawing compounds, according to different implementations, such as detailed below with reference to Table 2. In particular, exemplary suitable electron withdrawing compounds such as 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, or other suitable equivalents and combinations thereof as would be appreciated by those having ordinary skill in the art upon reading the present disclosures may be employed as electron-withdrawing compounds without departing from the scope of the inventive concepts set forth herein. Moreover, combinations of electron withdrawing groups may be employed without departing from the scope of the presently described inventive concepts.

Further still, those having ordinary skill in the art will appreciate that compounds such as shown in FIG. 2B-3, which excludes any fluorine or other halogen, are particularly preferred species of electron withdrawing compounds as they do not raise the environmental concerns associated with heavily halogenated, particularly heavily fluorinated, compounds. Indeed, according to certain approaches, the exemplary electron withdrawing groups discussed hereinabove, analogs thereof, and/or derivatives thereof, may be modified to substitute halide functional groups with —ONO₂ functional groups to form nitrate esters, and mitigate or eliminate environmental concerns associated with PFAS and other so-called “forever chemicals”.

Similarly, in particularly preferred embodiments the inventive electrolyte solvent systems may include lithiated salts that do not include any halogen component, such as LiClO₄, or other suitable equivalents (and combinations) thereof that would be appreciated by a person having ordinary skill in the art upon reading the present disclosure.

Still yet even further, the R and/or R′ groups of preferred electron withdrawing compounds in the context of the inventive concepts are characterized by minimal length, again to minimize the mass contribution of the electron withdrawing compound to the electrolyte system overall, and electrochemical cells including such electrolyte systems.

FIG. 3 illustrates a simplified schematic of a reaction pathway for chalcogenide materials to form free radicals that facilitate conversion of lithium polysulfides, in accordance with one embodiment.

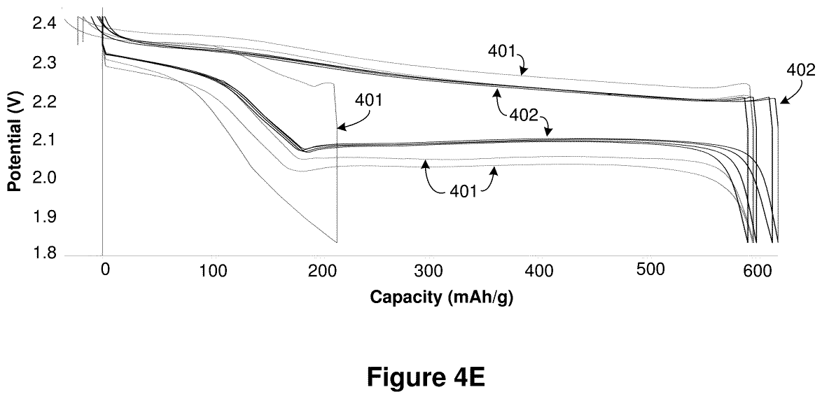

FIGS. 4A-4E are simplified graphs showing performance characteristics of an electrolyte system 401 including an inventive electrolyte system as disclosed herein and in accordance with one embodiment with reference to a control electrolyte system 402 implementing an electrolyte system otherwise identical to the inventive electrolyte system, but omitting any chalcogenide.

FIG. 4A is a plot showing discharge capacity versus cycle number for the inventive electrolyte system 401 and the control electrolyte system 402, according to one embodiment.

FIG. 4B is a plot showing columbic efficiency versus cycle number for the inventive electrolyte system 401 and the control electrolyte system 402, according to the same embodiment.

FIG. 4C is a plot showing rating capacity for the inventive electrolyte system 401 and the control electrolyte system 402, according to the same embodiment.

FIG. 4D is a plot showing discharge capacity versus charge/discharge rate for the inventive electrolyte system 401 and the control electrolyte system 402, according to the same embodiment.

FIG. 4E is a plot showing potential versus capacity for the inventive electrolyte system 401 and the control electrolyte system 402, according to the same embodiment.

The inventive electrolyte system 401 and control electrolyte system 402 each respectively include two solvents, an electron withdrawing compound, and two lithium ion-transporting compounds, in the same amount. The inventive electrolyte system 401 further includes about 1 wt % of a chalcogenide DMDSe.

As can be seen from FIGS. 4A-4E, the inventive electrolyte system 401 exhibits a more pronounced feature corresponding to presence/creation of Li₂S₍ₛ₎ relative to the control electrochemical cell 402. Moreover, capacity of the inventive electrochemical cell 401 is reversibly increased at every rate. Without wishing to be bound to any particular theory, the inventors propose the improved performance of the inventive electrochemical cell may, at least in part, be attributed to increased capacity through the second discharge plateau, owing to improved liquid-solid reaction kinetics of polysulfide conversion (Equation 1(c), above).

Similar experiments including a second inventive electrolyte system 403 which employs an identical formulation as inventive electrolyte system 401, but including DPDSe rather than DMDSe as the chalcogenide component, exhibited improved performance with respect to the control electrolyte system 402, but lesser performance on all metrics relative to inventive electrolyte system 401. Again without wishing to be bound to any particular theory, the inventors propose that DPDSe assists kinetics of liquid-liquid conversion reactions (Equations 1(a)-1(b)), which are not the rate limiting step until removal of the greater barrier presented by liquid-solid conversion (Equation 1(c)), and alleviated by inclusion of DMDSe.

In further experiments the inventors varied the amount of DMDSe in the inventive electrolyte system 401, testing embodiments including 0.5 wt % DMDSe, 1.0 wt % DMDSe, and 2.0 wt % DMDSe, but otherwise being identical to the formulation described hereinabove for inventive electrolyte system 401.

Despite expectations for further increased performance with increasing DMDSe concentration beyond 1 wt %, the opposite relationship was observed, with notable losses in discharge capacity, coulombic efficiency, and rating capacity in amounts greater than 1 wt %. Despite expecting increased improvement of lithium polysulfide conversion reaction kinetics with higher amount of available free radicals (i.e., higher concentration of DMDSe), the inventors postulate that increased DMDSe achieves optimal improvement of liquid-to-solid (and, to a lesser degree, solid-solid) reaction kinetics to the point of no longer being the rate limiting step in the overall pathway when included in an amount of about 1 wt %. Above this concentration, lithium polysulfide shuttling thus may increase without any corresponding benefit to discharge capacity. Put another way, including DMDSe as the chalcogenide improves kinetics of the lower plateau (liquid-to-solid reactions), while including DPDSe improves kinetics of the upper plateau (solid-liquid reaction). When the electrolyte system includes certain electron-withdrawing compounds (such as BTFE) which independently assist with reactions going into liquid state, addition of a chalcogenide that facilitates liquid-to-solid reactions provides a synergistic improvement to overall lithium polysulfide conversion and thus improves sulfur utilization in the resulting electrochemical cell.

The above is merely one example of the aforementioned observations that particular electrolyte system compositions may not necessarily follow conventional trends and expectations with respect to reaction kinetics and corresponding performance characteristics.

In still further experiments, the inventors tested formulations of an inventive electrolyte system similar to inventive electrolyte system 401, but including a combination of DMDSe and DPDSe in equal amounts of 0.5 wt % each, and 1.0 wt % each, since these concentration ranges produced the best results for similar inventive electrolyte systems as shown with reference to FIGS. 4A-4E, and described hereinabove.

In general, the mixed diselenide electrolyte formulation exhibited little difference with respect to cycle life, and a slight improvement to capacity and Coulombic efficiency at 1 wt % concentration, despite expectations for lower Coulombic efficiency due to presence of greater amount of selenide (i.e., a system including 1 wt % each DMDSe and DPDSe is comparable in terms of selenide concentration to a system including 2 wt % DMDSe, which was observed to exhibit poor Coulombic efficiency relative to 1 wt % DMDSe alone, but the combined 1 wt % each of DMDSe and DPDSe did not exhibit the same loss, indeed a slight increase was observed).

In addition to testing various species of chalcogenide, the inventors investigated different electron withdrawing compounds (particularly hydrofluoroethers TTE, BTFE, or FDMB) at different concentrations, in formulations otherwise similar to inventive electrolyte system 401 shown and described hereinabove regarding FIGS. 4A-4E.

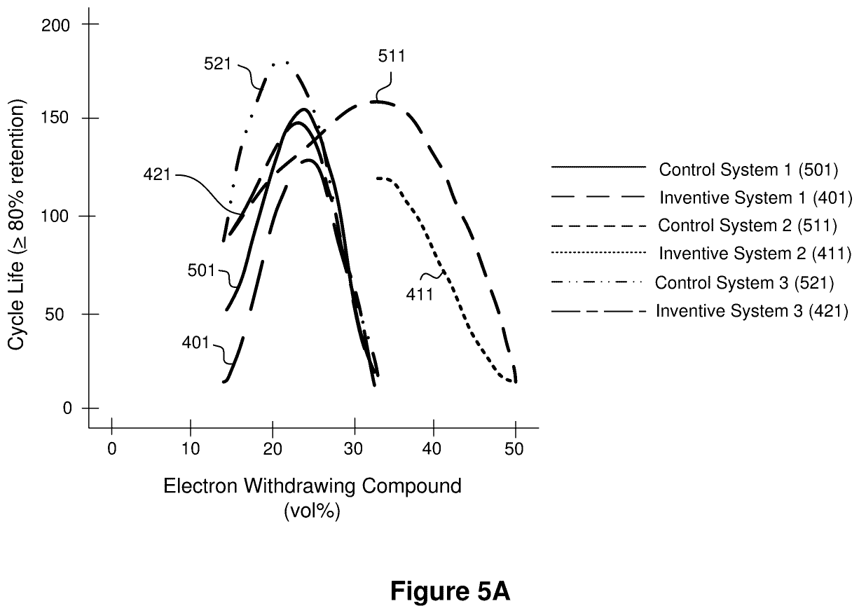

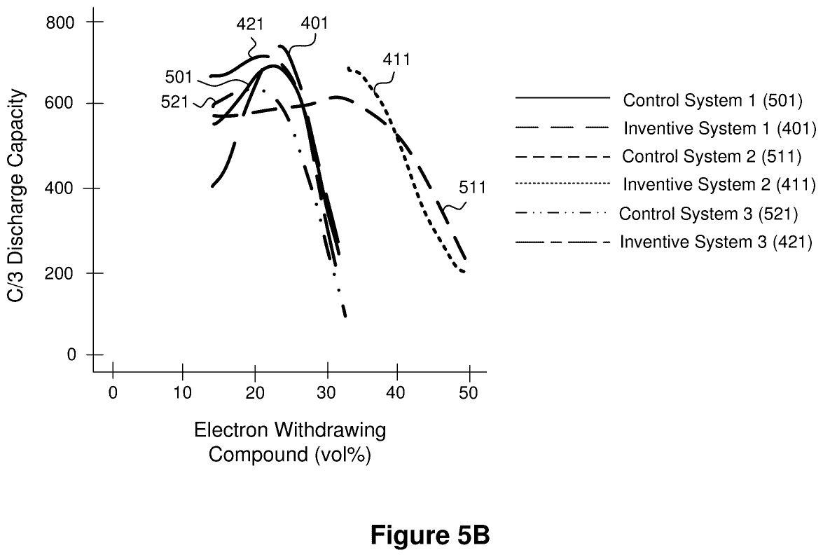

The results of these experiments are summarized in Table 1 and FIGS. 5A-5B.

TABLE 1
Lithium-based battery performance as a function
of hydrofluoroether composition

| Electron | | Control | DMDSe | Control | DMDSe |
|---|---|---|---|---|---|
| Withdrawing | Conc | C/3 | C/3 | Cycle | Cycle |
| Compound | (vol %) | Capacity | Capacity | Life | Life |
| TTE | 14% | 600 | 660 | 110 | 90 |
| TTE | 25% | 620 | 660 | 170 | 140 |
| TTE | 33% | 150 | 140 | 14 | 0 |
| BTFE | 14% | 550 | 400 | 50 | 14 |
| BTFE | 25% | 660 | 710 | 150 | 125 |
| BTFE | 33% | 200 | 200 | 14 | 0 |
| FDMB | 14% | 565 | Not tested | 90 | Not tested |
| FDMB | 25% | 590 | Not tested | 140 | Not tested |
| FDMB | 33% | 610 | 680 | 160 | 120 |
| FDMB | 50% | 200 | 200 | 14 | 0 |

Note
that the capacities shown in Table 1 are reported on an electrode basis rather than on a sulfur basis.

FIGS. 5A-5B depict exemplary curves for the inventive electrolyte systems 401, 411, and 421 and corresponding control electrolyte systems 501, 511, and 521. Per Table 1, the various electrolyte systems included two solvents, one electron withdrawing compound (respectively, BTFE for electrolyte systems 401 and 501, FDMB for electrolyte systems 411 and 511, and TTE for electrolyte systems 421 and 521), two lithium ion-transporting compounds (LITFSI and LiNO₃), and a chalcogenide component (DMDSe), in the same amounts, respectively, and within the ranges described herein.

FIG. 5A depicts performance of the cells with respect to cycle life (defined, in accordance with these experiments, by retention of at least 80% capacity following discharge) as a function of hydrofluoroether concentration, while FIG. 5B depicts performance with respect to capacity as a function of hydrofluoroether concentration.

As mentioned briefly above, testing the different hydrofluoroethers, and concentrations thereof, produced surprising results that do not follow the conventional wisdom regarding role of hydrofluoroether (and indeed, fluorine generally) in lithium-based batteries. In general, addition of fluorine in an electrolyte system of a lithium-based battery is correlated with increased life cycle of the resulting battery. This is because, conventionally, it has been understood that added fluorine corresponds to decreased solvation capability and wettability of (typically concentrated, and highly viscous) electrolyte toward electrode surfaces.

Moreover, hydrofluoroethers and similar electron withdrawing compounds are conventionally understood (and indeed designed) to be inert towards both electrodes of lithium-based batteries. Moreover still, for lithium-sulfur battery chemistries, strict limitations on the amount of salt that can be included due to limited solubility in the remaining components of the electrolyte system, and the battery as a whole.

The presently disclosed inventive concepts employ these electron withdrawing compounds in electrolytes with low salt concentration due to lower Lewis acid-base interaction with polysulfides (less solubility), and previous presumptions that these compounds, particularly hydrofluoroethers, were “known” to be inert towards the notoriously reactive, lithium-based anode material.

The presently disclosed inventive concepts employ these electron withdrawing compounds in electrolytes with low salt concentration due to lower Lewis acid-base interaction with polysulfides (less solubility), and previous presumptions that these compounds, particularly hydrofluoroethers, were “known” to be inert towards the notoriously reactive, lithium-based anode material.

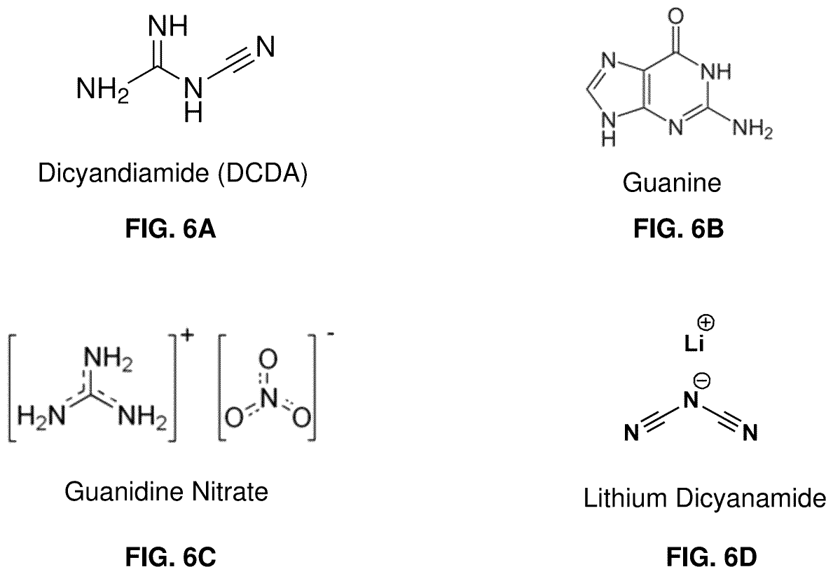

FIGS. 6A-6D are simplified schematics of the chemical structures of performance-enhancing additives, in accordance with several embodiments. FIG. 6A shows the structure of dicyandiamide, while FIG. 6B shows the structure of guanine, FIG. 6C shows the chemical structure of guanidine nitrate, and FIG. 6D depicts the chemical structure of lithium dicyanamide, according to illustrative embodiments.

Without wishing to be bound to any particular theory, the inventors propose that the inventive electrolyte systems described herein form a protective solid-electrolyte interphase (SEI) on surfaces of both the cathode and anode of the lithium-based electrochemical cells into which the electrolyte systems are introduced.

With respect to the contribution of the solvent(s) and electron withdrawing compound(s) to the SEI, refer to U.S. Provisional Patent Application No. 63/624,202 and its progeny for a detailed investigation and discussion of the mechanism and chemical structure of components of the SEI formed therewith.

With respect to the performance-enhancing additive, and again without wishing to be bound to any particular theory, the inventors propose suitable additives, such as acetonitrile, azobisisobutyronitrile (AIBN), cyanamide, lithium dicyanamide, dicyandiamide (DCDA), guanine, guanidine nitrate, guanidine thiocyante, guanidine p-tolunesulfonate, guanidine trifluoromethanolate, 2-guanidinobenzimidazole, guanidine hydrochloride, guanidine carbonate, guanidine bromide, guanidine iodide, guanidine acetate, guanidine sulfate, guanidine phosphate, succionitrile, or any combination thereof, form a protective thin film polymer on or around surface(s) of the electrodes, and this protective film both mitigates the well-known polysulfide shuttling effect and its detrimental effects as well as protects the anode in particular from delithiation (stripping) during cycling of the electrochemical cell.

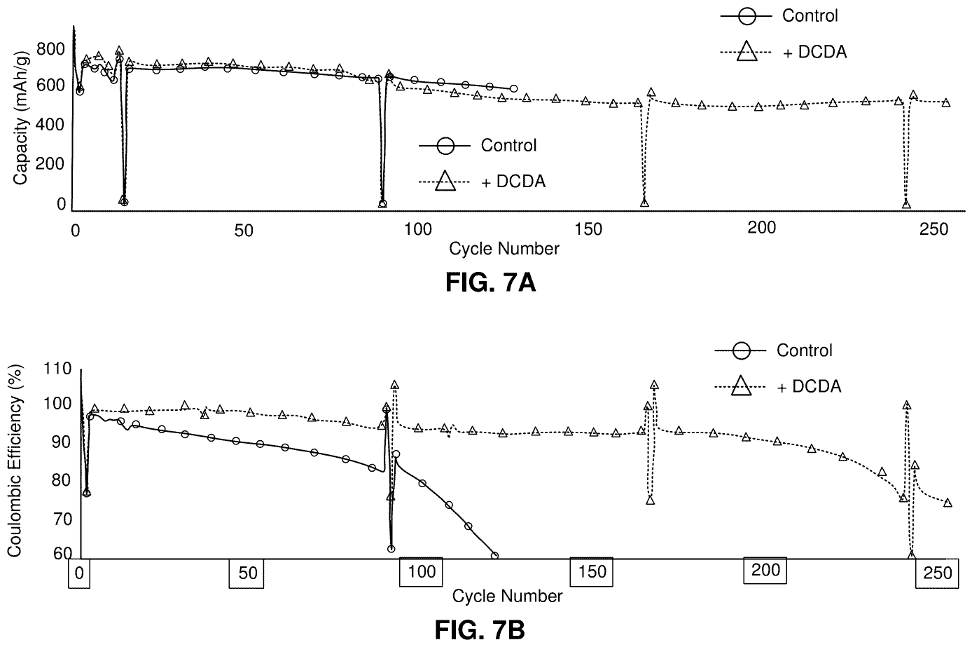

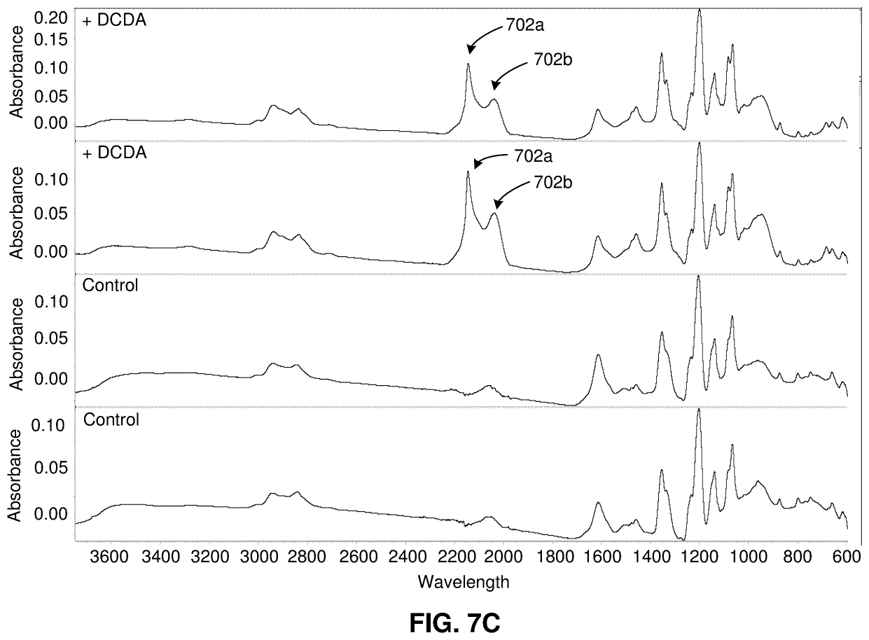

As a result, and as reflected in the data shown in FIGS. 7A-7B, both cycle life (FIGS. 7A-7B) and Coulombic efficiency (FIG. 7B) of lithium-based electrochemical cells implementing the inventive electrolyte system are dramatically improved.

For instance, referring again to FIGS. 7A-7B, it is evident that the control electrochemical cell (control, circular data points), which included an electrolyte system without any performance-enhancing additive, experienced dramatic reduction in Coulombic efficiency at around 90 cycles, and failed after about 100 cycles.

By comparison, lithium-based electrochemical cells including the inventive electrolyte system exhibit substantially improved retention of Coulombic efficiency, remaining above 80% for over 225 cycles. Indeed, select embodiments of lithium-based electrochemical cells implementing the inventive electrolyte system presently disclosed remained active (above 80% CE) for over 300 cycles.

Notably, and as shown in FIG. 7A in particular, these benefits were not associated with loss of specific capacity, which remained similar to the control, and stable over the longer cycle life of the inventive electrochemical cells.

Moreover, the electrochemical cell embodiments used to produce the comparative data shown in FIGS. 7A-7B were charged and discharged at a rate of C/3, but additional embodiments showed similar performance characteristics when charged at rates up to about 1C, indicating the inventive electrolyte system described herein also may facilitate higher charge/discharge rates than typically achievable (e.g., about C/3) using similar electrochemical cells without the inventive electrolyte system described herein.

FIG. 7C is a plot showing Fourier-Transform Infrared (FTIR) spectra of the solid-electrolyte interphase (SEI) of two lithium-sulfur electrochemical cells having a baseline electrolyte composition (control) in comparison to the SEI of two inventive lithium-sulfur electrochemical cells having a baseline electrolyte composition but also including DCDA additive (+DCDA), in accordance with one embodiment.

As is apparent from the spectra, the inventive electrochemical cell SEIs exhibit two distinct peaks 702a, 702b in the vicinity of wavelength 2000-2200. Without wishing to be bound to any particular theory, the inventors postulate these peaks correspond to presence of lithium cyanate and lithium thiocyanate in or on the SEI. These compounds are proposed to form from decomposition of DCDA at the electron supplying anode in the presence of oxidative species such as polysulfides and nitrate in a synergistic manner.

Moreover, in view of the double-ended nature of the cyanate and thiocyanate anions, which each have both an ‘anion’ end with a Lewis basic negative charge and the other end has a Lewis basic nitrogen with a lone pair, the inventors propose these species are enhancing Li⁺ transport, and/or increasing Li⁺ concentration in the SEI, which advantageously enhances robustness against degradation of the interphase, and correspondingly extending cycle life of the electrochemical cell. Put another way, the cyanate and thiocyanate facilitate Li⁺ ion transport without (or at least with significantly less) degradation of the SEI, allowing Li⁺ present in the cell to be dedicated to normal cycling rather than rebuilding the SEI. This mechanism is particularly effective in later cycles, thus significantly extending the life of the electrochemical cell.

While FIGS. 6-7C and corresponding descriptions presented hereinabove feature an inventive electrolyte system including one or more compounds selected from acetonitrile, azobisisobutyronitrile (AIBN), cyanamide, lithium dicyanamide, dicyandiamide (DCDA), guanine, guanidine nitrate, guanidine thiocyante, guanidine p-tolunesulfonate, guanidine trifluoromethanolate, 2-guanidinobenzimidazole, guanidine hydrochloride, guanidine carbonate, guanidine bromide, guanidine iodide, guanidine acetate, guanidine sulfate, guanidine phosphate, succionitrile, or any combination thereof as the performance-enhancing additive, those having ordinary skill in the art will appreciate, upon reading the present descriptions, that other suitable equivalent(s) thereof may be implemented as performance-enhancing additive(s), in any suitable permutation, combination or amount, without departing from the scope of the inventive concepts disclosed herein.

For instance, derivatives of performance enhancing additive(s) that may form in the presence of other components of electrolyte systems described herein, isomers of performance enhancing additive(s), compounds with similar chemical motifs and/or structures, larger molecules including performance enhancing additive(s) or substantially similar structures as a portion of the larger molecular structure, etc. may be implemented as performance-enhancing additives while remaining within the scope of the inventive concepts presented herein.

Additionally or alternatively, compounds capable of forming a thin film protective polymer layer with a composition similar to the thin film formed by performance enhancing additive(s) or derivatives thereof (singly, or in combination with other components of the electrolyte system, in various approaches) may be utilized as performance-enhancing additives in the context of the presently disclosed inventive concepts.

Tables 2 and 3 below summarize various suitable compositions of the solvent system and additional components of the inventive electrolyte systems described hereinabove, respectively and according to several exemplary embodiments. It shall be understood that the exemplary embodiments set forth in the tables are provided by way of illustration rather than limitation, and other compositions falling within the scope of the disclosure provided herein may be employed without departing from the scope of the inventive concepts presented herein.

Moreover, for brevity and organizational simplicity, the tables describe different components and suitable amounts individually, and in select combinations, but it shall be understood that any combination of different species may be employed in suitable amounts as informed by the broad ranges presented above may be employed without departing from the scope of the presently described inventive concepts.

For instance, any number of different species of solvent(s) electron withdrawing compound(s) lithium ion-transporting compound(s), and/or performance-enhancing additive(s), may be included in an electrolyte system composition with the only limitation being that the total amount of solvent(s), electron withdrawing compound(s), lithium ion-transporting compound(s), and performance-enhancing additive(s), respectively, fall within the broad ranges set forth hereinabove for the respective component.

TABLE 2
Exemplary Solvent System Components

| | Vol % | | Vol % | Electron | |
|---|---|---|---|---|---|
| Solvent | Solvent | Solvent | Solvent | Withdrawing | Vol % |
| 1 | 1 | 2 | 2 | Compound (EWC) | EWC |
| dimethoxy- | 25.00 | none | 0 | bis(2-fluoroethyl) | 75.00 |
| ethane | | | | ether (BFE) | |
| (DME) | | | | | |
| DME | 25.00 | none | 0 | 3-fluoropyridine | 75.00 |
| | | | | (3FP) | |
| DME | 25.00 | none | 0 | bis(2,2,2, | 75.00 |
| | | | | trifluoroethyl) ether | |
| | | | | (BTFE) | |
| DME | 25.00 | none | 0 | fluorinated 1,4- | 75.00 |
| | | | | dimethoxylbutane | |
| | | | | (FDMB) | |
| DME | 25.00 | none | 0 | isosorbide dinitrate | 75.00 |
| | | | | (ISDN) | |
| DME | 25.00 | none | 0 | 1,1,2,2- | 75.00 |
| | | | | tetrafluoroethyl | |
| | | | | 2,2,3,3- | |
| | | | | tetrafluororopyl | |
| | | | | ether (TTE) | |
| DME | 33.00 | none | 0 | BFE | 67.00 |
| DME | 33.00 | none | 0 | 3FP | 67.00 |
| DME | 33.00 | none | 0 | BFTE | 67.00 |
| DME | 33.00 | none | 0 | FDMB | 67.00 |
| DME | 33.00 | none | 0 | ISDN | 67.00 |
| DME | 33.00 | none | 0 | TTE | 67.00 |
| DME | 50.00 | none | 0 | BFE | 50.00 |
| DME | 50.00 | none | 0 | 3FP | 50.00 |
| DME | 50.00 | none | 0 | BFTE | 50.00 |
| DME | 50.00 | none | 0 | FDMB | 50.00 |
| DME | 50.00 | none | 0 | ISDN | 50.00 |
| DME | 50.00 | none | 0 | TTE | 50.00 |
| DME | 75.00 | none | 0 | BFE | 25.00 |
| DME | 75.00 | none | 0 | 3FP | 25.00 |
| DME | 75.00 | none | 0 | BFTE | 25.00 |
| DME | 75.00 | none | 0 | FDMB | 25.00 |
| DME | 75.00 | none | 0 | ISDN | 25.00 |
| DME | 75.00 | none | 0 | TTE | 25.00 |
| DME | 10.00 | diox- | 15.00 | BFE | 75.00 |
| | | olane | | | |
| | | (DOL) | | | |
| DME | 10.00 | DOL | 25.00 | BFE | 65.00 |
| DME | 10.00 | DOL | 33.00 | BFE | 57.00 |
| DME | 10.00 | DOL | 50.00 | BFE | 40.00 |
| DME | 10.00 | DOL | 65.00 | BFE | 25.00 |
| DME | 10.00 | DOL | 15.00 | 3FP | 75.00 |
| DME | 10.00 | DOL | 25.00 | 3FP | 65.00 |
| DME | 10.00 | DOL | 33.00 | 3FP | 57.00 |
| DME | 10.00 | DOL | 50.00 | 3FP | 40.00 |
| DME | 10.00 | DOL | 65.00 | 3FP | 25.00 |
| DME | 10.00 | DOL | 15.00 | BFTE | 75.00 |
| DME | 10.00 | DOL | 25.00 | BFTE | 65.00 |
| DME | 10.00 | DOL | 33.00 | BFTE | 57.00 |
| DME | 10.00 | DOL | 50.00 | BFTE | 40.00 |
| DME | 10.00 | DOL | 65.00 | BFTE | 25.00 |
| DME | 10.00 | DOL | 15.00 | FDMB | 75.00 |
| DME | 10.00 | DOL | 25.00 | FDMB | 65.00 |
| DME | 10.00 | DOL | 33.00 | FDMB | 57.00 |
| DME | 10.00 | DOL | 50.00 | FDMB | 40.00 |
| DME | 10.00 | DOL | 65.00 | FDMB | 25.00 |
| DME | 10.00 | DOL | 15.00 | ISDN | 75.00 |
| DME | 10.00 | DOL | 25.00 | ISDN | 65.00 |
| DME | 10.00 | DOL | 33.00 | ISDN | 57.00 |
| DME | 10.00 | DOL | 50.00 | ISDN | 40.00 |
| DME | 10.00 | DOL | 65.00 | ISDN | 25.00 |
| DME | 10.00 | DOL | 15.00 | TTE | 75.00 |
| DME | 10.00 | DOL | 25.00 | TTE | 65.00 |
| DME | 10.00 | DOL | 33.00 | TTE | 57.00 |
| DME | 10.00 | DOL | 50.00 | TTE | 40.00 |
| DME | 10.00 | DOL | 65.00 | TTE | 25.00 |
| DME | 10.00 | toluene | 15.00 | BFE | 75.00 |
| | | (TOL) | | | |
| DME | 10.00 | TOL | 25.00 | BFE | 65.00 |
| DME | 10.00 | TOL | 33.00 | BFE | 57.00 |
| DME | 10.00 | TOL | 50.00 | BFE | 40.00 |
| DME | 10.00 | TOL | 65.00 | BFE | 25.00 |
| DME | 10.00 | TOL | 15.00 | 3FP | 75.00 |
| DME | 10.00 | TOL | 25.00 | 3FP | 65.00 |
| DME | 10.00 | TOL | 33.00 | 3FP | 57.00 |
| DME | 10.00 | TOL | 50.00 | 3FP | 40.00 |
| DME | 10.00 | TOL | 65.00 | 3FP | 25.00 |
| DME | 10.00 | TOL | 15.00 | BFTE | 75.00 |
| DME | 10.00 | TOL | 25.00 | BFTE | 65.00 |
| DME | 10.00 | TOL | 33.00 | BFTE | 57.00 |
| DME | 10.00 | TOL | 50.00 | BFTE | 40.00 |
| DME | 10.00 | TOL | 65.00 | BFTE | 25.00 |
| DME | 10.00 | TOL | 15.00 | FDMB | 75.00 |
| DME | 10.00 | TOL | 25.00 | FDMB | 65.00 |
| DME | 10.00 | TOL | 33.00 | FDMB | 57.00 |
| DME | 10.00 | TOL | 50.00 | FDMB | 40.00 |
| DME | 10.00 | TOL | 65.00 | FDMB | 25.00 |
| DME | 10.00 | TOL | 15.00 | ISDN | 75.00 |
| DME | 10.00 | TOL | 25.00 | ISDN | 65.00 |
| DME | 10.00 | TOL | 33.00 | ISDN | 57.00 |
| DME | 10.00 | TOL | 50.00 | ISDN | 40.00 |
| DME | 10.00 | TOL | 65.00 | ISDN | 25.00 |
| DME | 10.00 | TOL | 15.00 | TTE | 75.00 |
| DME | 10.00 | TOL | 25.00 | TTE | 65.00 |
| DME | 10.00 | TOL | 33.00 | TTE | 57.00 |
| DME | 10.00 | TOL | 50.00 | TTE | 40.00 |
| DME | 10.00 | TOL | 65.00 | TTE | 25.00 |
| DME | 10.00 | sul- | 15.00 | BFE | 75.00 |
| | | folane | | | |
| | | (SUL) | | | |
| DME | 10.00 | SUL | 25.00 | BFE | 65.00 |
| DME | 10.00 | SUL | 33.00 | BFE | 57.00 |
| DME | 10.00 | SUL | 50.00 | BFE | 40.00 |
| DME | 10.00 | SUL | 65.00 | BFE | 25.00 |
| DME | 10.00 | SUL | 15.00 | 3FP | 75.00 |
| DME | 10.00 | SUL | 25.00 | 3FP | 65.00 |
| DME | 10.00 | SUL | 33.00 | 3FP | 57.00 |
| DME | 10.00 | SUL | 50.00 | 3FP | 40.00 |
| DME | 10.00 | SUL | 65.00 | 3FP | 25.00 |
| DME | 10.00 | SUL | 15.00 | BFTE | 75.00 |
| DME | 10.00 | SUL | 25.00 | BFTE | 65.00 |
| DME | 10.00 | SUL | 33.00 | BFTE | 57.00 |
| DME | 10.00 | SUL | 50.00 | BFTE | 40.00 |
| DME | 10.00 | SUL | 65.00 | BFTE | 25.00 |
| DME | 10.00 | SUL | 15.00 | FDMB | 75.00 |
| DME | 10.00 | SUL | 25.00 | FDMB | 65.00 |
| DME | 10.00 | SUL | 33.00 | FDMB | 57.00 |
| DME | 10.00 | SUL | 50.00 | FDMB | 40.00 |
| DME | 10.00 | SUL | 65.00 | FDMB | 25.00 |
| DME | 10.00 | SUL | 15.00 | ISDN | 75.00 |
| DME | 10.00 | SUL | 25.00 | ISDN | 65.00 |
| DME | 10.00 | SUL | 33.00 | ISDN | 57.00 |
| DME | 10.00 | SUL | 50.00 | ISDN | 40.00 |
| DME | 10.00 | SUL | 65.00 | ISDN | 25.00 |
| DME | 10.00 | SUL | 15.00 | TTE | 75.00 |
| DME | 10.00 | SUL | 25.00 | TTE | 65.00 |
| DME | 10.00 | SUL | 33.00 | TTE | 57.00 |
| DME | 10.00 | SUL | 50.00 | TTE | 40.00 |
| DME | 10.00 | SUL | 65.00 | TTE | 25.00 |
| DME | 25.00 | DOL | 15.00 | BFE | 60.00 |
| DME | 25.00 | DOL | 25.00 | BFE | 50.00 |
| DME | 25.00 | DOL | 33.00 | BFE | 42.00 |
| DME | 25.00 | DOL | 50.00 | BFE | 25.00 |
| DME | 25.00 | DOL | 15.00 | 3FP | 60.00 |
| DME | 25.00 | DOL | 25.00 | 3FP | 50.00 |
| DME | 25.00 | DOL | 33.00 | 3FP | 42.00 |
| DME | 25.00 | DOL | 50.00 | 3FP | 25.00 |
| DME | 25.00 | DOL | 15.00 | BFTE | 60.00 |
| DME | 25.00 | DOL | 25.00 | BFTE | 50.00 |
| DME | 25.00 | DOL | 33.00 | BFTE | 42.00 |
| DME | 25.00 | DOL | 50.00 | BFTE | 25.00 |
| DME | 25.00 | DOL | 15.00 | FDMB | 60.00 |
| DME | 25.00 | DOL | 25.00 | FDMB | 50.00 |
| DME | 25.00 | DOL | 33.00 | FDMB | 42.00 |
| DME | 25.00 | DOL | 50.00 | FDMB | 25.00 |
| DME | 25.00 | DOL | 15.00 | ISDN | 60.00 |
| DME | 25.00 | DOL | 25.00 | ISDN | 50.00 |
| DME | 25.00 | DOL | 33.00 | ISDN | 42.00 |
| DME | 25.00 | DOL | 50.00 | ISDN | 25.00 |
| DME | 25.00 | DOL | 15.00 | TTE | 60.00 |
| DME | 25.00 | DOL | 25.00 | TTE | 50.00 |
| DME | 25.00 | DOL | 33.00 | TTE | 42.00 |
| DME | 25.00 | DOL | 50.00 | TTE | 25.00 |
| DME | 25.00 | TOL | 15.00 | BFE | 60.00 |
| DME | 25.00 | TOL | 25.00 | BFE | 50.00 |
| DME | 25.00 | TOL | 33.00 | BFE | 42.00 |
| DME | 25.00 | TOL | 50.00 | BFE | 25.00 |
| DME | 25.00 | TOL | 15.00 | 3FP | 60.00 |
| DME | 25.00 | TOL | 25.00 | 3FP | 50.00 |
| DME | 25.00 | TOL | 33.00 | 3FP | 42.00 |
| DME | 25.00 | TOL | 50.00 | 3FP | 25.00 |
| DME | 25.00 | TOL | 15.00 | BFTE | 60.00 |
| DME | 25.00 | TOL | 25.00 | BFTE | 50.00 |
| DME | 25.00 | TOL | 33.00 | BFTE | 42.00 |
| DME | 25.00 | TOL | 50.00 | BFTE | 25.00 |
| DME | 25.00 | TOL | 15.00 | FDMB | 60.00 |
| DME | 25.00 | TOL | 25.00 | FDMB | 50.00 |
| DME | 25.00 | TOL | 33.00 | FDMB | 42.00 |
| DME | 25.00 | TOL | 50.00 | FDMB | 25.00 |
| DME | 25.00 | TOL | 15.00 | ISDN | 60.00 |
| DME | 25.00 | TOL | 25.00 | ISDN | 50.00 |
| DME | 25.00 | TOL | 33.00 | ISDN | 42.00 |
| DME | 25.00 | TOL | 50.00 | ISDN | 25.00 |
| DME | 25.00 | TOL | 15.00 | TTE | 60.00 |
| DME | 25.00 | TOL | 25.00 | TTE | 50.00 |
| DME | 25.00 | TOL | 33.00 | TTE | 42.00 |
| DME | 25.00 | TOL | 50.00 | TTE | 25.00 |
| DME | 25.00 | SUL | 15.00 | BFE | 60.00 |
| DME | 25.00 | SUL | 25.00 | BFE | 50.00 |
| DME | 25.00 | SUL | 33.00 | BFE | 42.00 |
| DME | 25.00 | SUL | 50.00 | BFE | 25.00 |
| DME | 25.00 | SUL | 15.00 | 3FP | 60.00 |
| DME | 25.00 | SUL | 25.00 | 3FP | 50.00 |
| DME | 25.00 | SUL | 33.00 | 3FP | 42.00 |
| DME | 25.00 | SUL | 50.00 | 3FP | 25.00 |
| DME | 25.00 | SUL | 15.00 | BFTE | 60.00 |
| DME | 25.00 | SUL | 25.00 | BFTE | 50.00 |
| DME | 25.00 | SUL | 33.00 | BFTE | 42.00 |
| DME | 25.00 | SUL | 50.00 | BFTE | 25.00 |
| DME | 25.00 | SUL | 15.00 | FDMB | 60.00 |
| DME | 25.00 | SUL | 25.00 | FDMB | 50.00 |
| DME | 25.00 | SUL | 33.00 | FDMB | 42.00 |
| DME | 25.00 | SUL | 50.00 | FDMB | 25.00 |
| DME | 25.00 | SUL | 15.00 | ISDN | 60.00 |
| DME | 25.00 | SUL | 25.00 | ISDN | 50.00 |
| DME | 25.00 | SUL | 33.00 | ISDN | 42.00 |
| DME | 25.00 | SUL | 50.00 | ISDN | 25.00 |
| DME | 25.00 | SUL | 15.00 | TTE | 60.00 |
| DME | 25.00 | SUL | 25.00 | TTE | 50.00 |
| DME | 25.00 | SUL | 33.00 | TTE | 42.00 |
| DME | 25.00 | SUL | 50.00 | TTE | 25.00 |
| DME | 33.00 | DOL | 15.00 | BFE | 52.00 |
| DME | 33.00 | DOL | 25.00 | BFE | 42.00 |
| DME | 33.00 | DOL | 33.00 | BFE | 34.00 |
| DME | 33.00 | DOL | 50.00 | BFE | 17.00 |
| DME | 33.00 | DOL | 15.00 | 3FP | 52.00 |
| DME | 33.00 | DOL | 25.00 | 3FP | 42.00 |
| DME | 33.00 | DOL | 33.00 | 3FP | 34.00 |
| DME | 33.00 | DOL | 50.00 | 3FP | 17.00 |
| DME | 33.00 | DOL | 15.00 | BFTE | 52.00 |
| DME | 33.00 | DOL | 25.00 | BFTE | 42.00 |
| DME | 33.00 | DOL | 33.00 | BFTE | 34.00 |
| DME | 33.00 | DOL | 50.00 | BFTE | 17.00 |
| DME | 33.00 | DOL | 15.00 | FDMB | 52.00 |
| DME | 33.00 | DOL | 25.00 | FDMB | 42.00 |
| DME | 33.00 | DOL | 33.00 | FDMB | 34.00 |
| DME | 33.00 | DOL | 50.00 | FDMB | 17.00 |
| DME | 33.00 | DOL | 15.00 | ISDN | 52.00 |
| DME | 33.00 | DOL | 25.00 | ISDN | 42.00 |
| DME | 33.00 | DOL | 33.00 | ISDN | 34.00 |
| DME | 33.00 | DOL | 50.00 | ISDN | 17.00 |
| DME | 33.00 | DOL | 15.00 | TTE | 52.00 |
| DME | 33.00 | DOL | 25.00 | TTE | 42.00 |
| DME | 33.00 | DOL | 33.00 | TTE | 34.00 |
| DME | 33.00 | DOL | 50.00 | TTE | 17.00 |
| DME | 33.00 | TOL | 15.00 | BFE | 52.00 |
| DME | 33.00 | TOL | 25.00 | BFE | 42.00 |
| DME | 33.00 | TOL | 33.00 | BFE | 34.00 |
| DME | 33.00 | TOL | 50.00 | BFE | 17.00 |
| DME | 33.00 | TOL | 15.00 | 3FP | 52.00 |
| DME | 33.00 | TOL | 25.00 | 3FP | 42.00 |
| DME | 33.00 | TOL | 33.00 | 3FP | 34.00 |
| DME | 33.00 | TOL | 50.00 | 3FP | 17.00 |
| DME | 33.00 | TOL | 15.00 | BFTE | 52.00 |
| DME | 33.00 | TOL | 25.00 | BFTE | 42.00 |
| DME | 33.00 | TOL | 33.00 | BFTE | 34.00 |
| DME | 33.00 | TOL | 50.00 | BFTE | 17.00 |
| DME | 33.00 | TOL | 15.00 | FDMB | 52.00 |
| DME | 33.00 | TOL | 25.00 | FDMB | 42.00 |
| DME | 33.00 | TOL | 33.00 | FDMB | 34.00 |
| DME | 33.00 | TOL | 50.00 | FDMB | 17.00 |
| DME | 33.00 | TOL | 15.00 | ISDN | 52.00 |
| DME | 33.00 | TOL | 25.00 | ISDN | 42.00 |
| DME | 33.00 | TOL | 33.00 | ISDN | 34.00 |
| DME | 33.00 | TOL | 50.00 | ISDN | 17.00 |
| DME | 33.00 | TOL | 15.00 | TTE | 52.00 |
| DME | 33.00 | TOL | 25.00 | TTE | 42.00 |
| DME | 33.00 | TOL | 33.00 | TTE | 34.00 |
| DME | 33.00 | TOL | 50.00 | TTE | 17.00 |
| DME | 33.00 | SUL | 15.00 | BFE | 52.00 |
| DME | 33.00 | SUL | 25.00 | BFE | 42.00 |
| DME | 33.00 | SUL | 33.00 | BFE | 34.00 |
| DME | 33.00 | SUL | 50.00 | BFE | 17.00 |
| DME | 33.00 | SUL | 15.00 | 3FP | 52.00 |
| DME | 33.00 | SUL | 25.00 | 3FP | 42.00 |
| DME | 33.00 | SUL | 33.00 | 3FP | 34.00 |
| DME | 33.00 | SUL | 50.00 | 3FP | 17.00 |
| DME | 33.00 | SUL | 15.00 | BFTE | 52.00 |
| DME | 33.00 | SUL | 25.00 | BFTE | 42.00 |
| DME | 33.00 | SUL | 33.00 | BFTE | 34.00 |
| DME | 33.00 | SUL | 50.00 | BFTE | 17.00 |
| DME | 33.00 | SUL | 15.00 | FDMB | 52.00 |
| DME | 33.00 | SUL | 25.00 | FDMB | 42.00 |
| DME | 33.00 | SUL | 33.00 | FDMB | 34.00 |
| DME | 33.00 | SUL | 50.00 | FDMB | 17.00 |
| DME | 33.00 | SUL | 15.00 | ISDN | 52.00 |
| DME | 33.00 | SUL | 25.00 | ISDN | 42.00 |
| DME | 33.00 | SUL | 33.00 | ISDN | 34.00 |
| DME | 33.00 | SUL | 50.00 | ISDN | 17.00 |
| DME | 33.00 | SUL | 15.00 | TTE | 52.00 |
| DME | 33.00 | SUL | 25.00 | TTE | 42.00 |
| DME | 33.00 | SUL | 33.00 | TTE | 34.00 |
| DME | 33.00 | SUL | 50.00 | TTE | 17.00 |
| DME | 50.00 | DOL | 10.00 | BFE | 40.00 |
| DME | 50.00 | DOL | 25.00 | BFE | 25.00 |
| DME | 50.00 | DOL | 33.00 | BFE | 17.00 |
| DME | 50.00 | DOL | 15.00 | 3FP | 35.00 |
| DME | 50.00 | DOL | 25.00 | 3FP | 25.00 |
| DME | 50.00 | DOL | 33.00 | 3FP | 17.00 |
| DME | 50.00 | DOL | 15.00 | BFTE | 35.00 |
| DME | 50.00 | DOL | 25.00 | BFTE | 25.00 |
| DME | 50.00 | DOL | 33.00 | BFTE | 17.00 |
| DME | 50.00 | DOL | 15.00 | FDMB | 35.00 |
| DME | 50.00 | DOL | 25.00 | FDMB | 25.00 |
| DME | 50.00 | DOL | 33.00 | FDMB | 17.00 |
| DME | 50.00 | DOL | 15.00 | ISDN | 35.00 |
| DME | 50.00 | DOL | 25.00 | ISDN | 25.00 |
| DME | 50.00 | DOL | 33.00 | ISDN | 17.00 |
| DME | 50.00 | DOL | 15.00 | TTE | 35.00 |
| DME | 50.00 | DOL | 25.00 | TTE | 25.00 |
| DME | 50.00 | DOL | 33.00 | TTE | 17.00 |
| DME | 50.00 | TOL | 15.00 | BFE | 35.00 |
| DME | 50.00 | TOL | 25.00 | BFE | 25.00 |
| DME | 50.00 | TOL | 33.00 | BFE | 17.00 |
| DME | 50.00 | TOL | 15.00 | 3FP | 35.00 |
| DME | 50.00 | TOL | 25.00 | 3FP | 25.00 |
| DME | 50.00 | TOL | 33.00 | 3FP | 17.00 |
| DME | 50.00 | TOL | 15.00 | BFTE | 35.00 |
| DME | 50.00 | TOL | 25.00 | BFTE | 25.00 |
| DME | 50.00 | TOL | 33.00 | BFTE | 17.00 |
| DME | 50.00 | TOL | 15.00 | FDMB | 35.00 |
| DME | 50.00 | TOL | 25.00 | FDMB | 25.00 |
| DME | 50.00 | TOL | 33.00 | FDMB | 17.00 |
| DME | 50.00 | TOL | 15.00 | ISDN | 35.00 |
| DME | 50.00 | TOL | 25.00 | ISDN | 25.00 |
| DME | 50.00 | TOL | 33.00 | ISDN | 17.00 |
| DME | 50.00 | TOL | 15.00 | TTE | 35.00 |
| DME | 50.00 | TOL | 25.00 | TTE | 25.00 |
| DME | 50.00 | TOL | 33.00 | TTE | 17.00 |
| DME | 50.00 | SUL | 15.00 | BFE | 35.00 |
| DME | 50.00 | SUL | 25.00 | BFE | 25.00 |
| DME | 50.00 | SUL | 33.00 | BFE | 17.00 |
| DME | 50.00 | SUL | 15.00 | 3FP | 35.00 |
| DME | 50.00 | SUL | 25.00 | 3FP | 25.00 |
| DME | 50.00 | SUL | 33.00 | 3FP | 17.00 |
| DME | 50.00 | SUL | 15.00 | BFTE | 35.00 |
| DME | 50.00 | SUL | 25.00 | BFTE | 25.00 |
| DME | 50.00 | SUL | 33.00 | BFTE | 17.00 |
| DME | 50.00 | SUL | 15.00 | FDMB | 35.00 |
| DME | 50.00 | SUL | 25.00 | FDMB | 25.00 |
| DME | 50.00 | SUL | 33.00 | FDMB | 17.00 |
| DME | 50.00 | SUL | 15.00 | ISDN | 35.00 |
| DME | 50.00 | SUL | 25.00 | ISDN | 25.00 |
| DME | 50.00 | SUL | 33.00 | ISDN | 17.00 |
| DME | 50.00 | SUL | 15.00 | TTE | 35.00 |
| DME | 50.00 | SUL | 25.00 | TTE | 25.00 |
| DME | 50.00 | SUL | 33.00 | TTE | 17.00 |
| DOL | 25.00 | none | 0 | BFE | 75.00 |
| DOL | 25.00 | none | 0 | 3FP | 75.00 |
| DOL | 25.00 | none | 0 | BFTE | 75.00 |
| DOL | 25.00 | none | 0 | FDMB | 75.00 |
| DOL | 25.00 | none | 0 | ISDN | 75.00 |
| DOL | 25.00 | none | 0 | TTE | 75.00 |
| DOL | 33.00 | none | 0 | BFE | 67.00 |
| DOL | 33.00 | none | 0 | 3FP | 67.00 |
| DOL | 33.00 | none | 0 | BFTE | 67.00 |
| DOL | 33.00 | none | 0 | FDMB | 67.00 |
| DOL | 33.00 | none | 0 | ISDN | 67.00 |
| DOL | 33.00 | none | 0 | TTE | 67.00 |
| DOL | 50.00 | none | 0 | BFE | 50.00 |
| DOL | 50.00 | none | 0 | 3FP | 50.00 |
| DOL | 50.00 | none | 0 | BFTE | 50.00 |
| DOL | 50.00 | none | 0 | FDMB | 50.00 |
| DOL | 50.00 | none | 0 | ISDN | 50.00 |
| DOL | 50.00 | none | 0 | TTE | 50.00 |
| DOL | 75.00 | none | 0 | BFE | 25.00 |
| DOL | 75.00 | none | 0 | 3FP | 25.00 |
| DOL | 75.00 | none | 0 | BFTE | 25.00 |
| DOL | 75.00 | none | 0 | FDMB | 25.00 |
| DOL | 75.00 | none | 0 | ISDN | 25.00 |
| DOL | 75.00 | none | 0 | TTE | 25.00 |
| DOL | 10.00 | DME | 15.00 | BFE | 75.00 |
| DOL | 10.00 | DME | 25.00 | BFE | 65.00 |
| DOL | 10.00 | DME | 33.00 | BFE | 57.00 |
| DOL | 10.00 | DME | 50.00 | BFE | 40.00 |
| DOL | 10.00 | DME | 65.00 | BFE | 25.00 |
| DOL | 10.00 | DME | 15.00 | 3FP | 75.00 |
| DOL | 10.00 | DME | 25.00 | 3FP | 65.00 |
| DOL | 10.00 | DME | 33.00 | 3FP | 57.00 |
| DOL | 10.00 | DME | 50.00 | 3FP | 40.00 |
| DOL | 10.00 | DME | 65.00 | 3FP | 25.00 |
| DOL | 10.00 | DME | 15.00 | BFTE | 75.00 |
| DOL | 10.00 | DME | 25.00 | BFTE | 65.00 |
| DOL | 10.00 | DME | 33.00 | BFTE | 57.00 |
| DOL | 10.00 | DME | 50.00 | BFTE | 40.00 |
| DOL | 10.00 | DME | 65.00 | BFTE | 25.00 |
| DOL | 10.00 | DME | 15.00 | FDMB | 75.00 |
| DOL | 10.00 | DME | 25.00 | FDMB | 65.00 |
| DOL | 10.00 | DME | 33.00 | FDMB | 57.00 |
| DOL | 10.00 | DME | 50.00 | FDMB | 40.00 |
| DOL | 10.00 | DME | 65.00 | FDMB | 25.00 |
| DOL | 10.00 | DME | 15.00 | ISDN | 75.00 |
| DOL | 10.00 | DME | 25.00 | ISDN | 65.00 |
| DOL | 10.00 | DME | 33.00 | ISDN | 57.00 |
| DOL | 10.00 | DME | 50.00 | ISDN | 40.00 |
| DOL | 10.00 | DME | 65.00 | ISDN | 25.00 |
| DOL | 10.00 | DME | 15.00 | TTE | 75.00 |
| DOL | 10.00 | DME | 25.00 | TTE | 65.00 |
| DOL | 10.00 | DME | 33.00 | TTE | 57.00 |
| DOL | 10.00 | DME | 50.00 | TTE | 40.00 |
| DOL | 10.00 | DME | 65.00 | TTE | 25.00 |
| DOL | 10.00 | TOL | 15.00 | BFE | 75.00 |
| DOL | 10.00 | TOL | 25.00 | BFE | 65.00 |
| DOL | 10.00 | TOL | 33.00 | BFE | 57.00 |
| DOL | 10.00 | TOL | 50.00 | BFE | 40.00 |
| DOL | 10.00 | TOL | 65.00 | BFE | 25.00 |
| DOL | 10.00 | TOL | 15.00 | 3FP | 75.00 |
| DOL | 10.00 | TOL | 25.00 | 3FP | 65.00 |
| DOL | 10.00 | TOL | 33.00 | 3FP | 57.00 |
| DOL | 10.00 | TOL | 50.00 | 3FP | 40.00 |
| DOL | 10.00 | TOL | 65.00 | 3FP | 25.00 |
| DOL | 10.00 | TOL | 15.00 | BFTE | 75.00 |
| DOL | 10.00 | TOL | 25.00 | BFTE | 65.00 |
| DOL | 10.00 | TOL | 33.00 | BFTE | 57.00 |
| DOL | 10.00 | TOL | 50.00 | BFTE | 40.00 |
| DOL | 10.00 | TOL | 65.00 | BFTE | 25.00 |
| DOL | 10.00 | TOL | 15.00 | FDMB | 75.00 |
| DOL | 10.00 | TOL | 25.00 | FDMB | 65.00 |
| DOL | 10.00 | TOL | 33.00 | FDMB | 57.00 |
| DOL | 10.00 | TOL | 50.00 | FDMB | 40.00 |
| DOL | 10.00 | TOL | 65.00 | FDMB | 25.00 |
| DOL | 10.00 | TOL | 15.00 | ISDN | 75.00 |
| DOL | 10.00 | TOL | 25.00 | ISDN | 65.00 |
| DOL | 10.00 | TOL | 33.00 | ISDN | 57.00 |
| DOL | 10.00 | TOL | 50.00 | ISDN | 40.00 |
| DOL | 10.00 | TOL | 65.00 | ISDN | 25.00 |
| DOL | 10.00 | TOL | 15.00 | TTE | 75.00 |
| DOL | 10.00 | TOL | 25.00 | TTE | 65.00 |
| DOL | 10.00 | TOL | 33.00 | TTE | 57.00 |
| DOL | 10.00 | TOL | 50.00 | TTE | 40.00 |
| DOL | 10.00 | TOL | 65.00 | TTE | 25.00 |
| DOL | 10.00 | SUL | 15.00 | BFE | 75.00 |
| DOL | 10.00 | SUL | 25.00 | BFE | 65.00 |
| DOL | 10.00 | SUL | 33.00 | BFE | 57.00 |
| DOL | 10.00 | SUL | 50.00 | BFE | 40.00 |
| DOL | 10.00 | SUL | 65.00 | BFE | 25.00 |
| DOL | 10.00 | SUL | 15.00 | 3FP | 75.00 |
| DOL | 10.00 | SUL | 25.00 | 3FP | 65.00 |
| DOL | 10.00 | SUL | 33.00 | 3FP | 57.00 |
| DOL | 10.00 | SUL | 50.00 | 3FP | 40.00 |
| DOL | 10.00 | SUL | 65.00 | 3FP | 25.00 |
| DOL | 10.00 | SUL | 15.00 | BFTE | 75.00 |
| DOL | 10.00 | SUL | 25.00 | BFTE | 65.00 |
| DOL | 10.00 | SUL | 33.00 | BFTE | 57.00 |
| DOL | 10.00 | SUL | 50.00 | BFTE | 40.00 |
| DOL | 10.00 | SUL | 65.00 | BFTE | 25.00 |
| DOL | 10.00 | SUL | 15.00 | FDMB | 75.00 |
| DOL | 10.00 | SUL | 25.00 | FDMB | 65.00 |
| DOL | 10.00 | SUL | 33.00 | FDMB | 57.00 |
| DOL | 10.00 | SUL | 50.00 | FDMB | 40.00 |
| DOL | 10.00 | SUL | 65.00 | FDMB | 25.00 |
| DOL | 10.00 | SUL | 15.00 | ISDN | 75.00 |
| DOL | 10.00 | SUL | 25.00 | ISDN | 65.00 |
| DOL | 10.00 | SUL | 33.00 | ISDN | 57.00 |
| DOL | 10.00 | SUL | 50.00 | ISDN | 40.00 |
| DOL | 10.00 | SUL | 65.00 | ISDN | 25.00 |
| DOL | 10.00 | SUL | 15.00 | TTE | 75.00 |
| DOL | 10.00 | SUL | 25.00 | TTE | 65.00 |
| DOL | 10.00 | SUL | 33.00 | TTE | 57.00 |
| DOL | 10.00 | SUL | 50.00 | TTE | 40.00 |
| DOL | 10.00 | SUL | 65.00 | TTE | 25.00 |
| DOL | 25.00 | DME | 15.00 | BFE | 60.00 |
| DOL | 25.00 | DME | 25.00 | BFE | 50.00 |
| DOL | 25.00 | DME | 33.00 | BFE | 42.00 |
| DOL | 25.00 | DME | 50.00 | BFE | 25.00 |
| DOL | 25.00 | DME | 15.00 | 3FP | 60.00 |
| DOL | 25.00 | DME | 25.00 | 3FP | 50.00 |
| DOL | 25.00 | DME | 33.00 | 3FP | 42.00 |
| DOL | 25.00 | DME | 50.00 | 3FP | 25.00 |
| DOL | 25.00 | DME | 15.00 | BFTE | 60.00 |
| DOL | 25.00 | DME | 25.00 | BFTE | 50.00 |
| DOL | 25.00 | DME | 33.00 | BFTE | 42.00 |
| DOL | 25.00 | DME | 50.00 | BFTE | 25.00 |
| DOL | 25.00 | DME | 15.00 | FDMB | 60.00 |
| DOL | 25.00 | DME | 25.00 | FDMB | 50.00 |
| DOL | 25.00 | DME | 33.00 | FDMB | 42.00 |
| DOL | 25.00 | DME | 50.00 | FDMB | 25.00 |
| DOL | 25.00 | DME | 15.00 | ISDN | 60.00 |
| DOL | 25.00 | DME | 25.00 | ISDN | 50.00 |
| DOL | 25.00 | DME | 33.00 | ISDN | 42.00 |
| DOL | 25.00 | DME | 50.00 | ISDN | 25.00 |
| DOL | 25.00 | DME | 15.00 | TTE | 60.00 |
| DOL | 25.00 | DME | 25.00 | TTE | 50.00 |
| DOL | 25.00 | DME | 33.00 | TTE | 42.00 |
| DOL | 25.00 | DME | 50.00 | TTE | 25.00 |
| DOL | 25.00 | TOL | 15.00 | BFE | 60.00 |
| DOL | 25.00 | TOL | 25.00 | BFE | 50.00 |
| DOL | 25.00 | TOL | 33.00 | BFE | 42.00 |
| DOL | 25.00 | TOL | 50.00 | BFE | 25.00 |
| DOL | 25.00 | TOL | 15.00 | 3FP | 60.00 |
| DOL | 25.00 | TOL | 25.00 | 3FP | 50.00 |
| DOL | 25.00 | TOL | 33.00 | 3FP | 42.00 |
| DOL | 25.00 | TOL | 50.00 | 3FP | 25.00 |
| DOL | 25.00 | TOL | 15.00 | BFTE | 60.00 |
| DOL | 25.00 | TOL | 25.00 | BFTE | 50.00 |
| DOL | 25.00 | TOL | 33.00 | BFTE | 42.00 |
| DOL | 25.00 | TOL | 50.00 | BFTE | 25.00 |
| DOL | 25.00 | TOL | 15.00 | FDMB | 60.00 |
| DOL | 25.00 | TOL | 25.00 | FDMB | 50.00 |
| DOL | 25.00 | TOL | 33.00 | FDMB | 42.00 |
| DOL | 25.00 | TOL | 50.00 | FDMB | 25.00 |
| DOL | 25.00 | TOL | 15.00 | ISDN | 60.00 |
| DOL | 25.00 | TOL | 25.00 | ISDN | 50.00 |
| DOL | 25.00 | TOL | 33.00 | ISDN | 42.00 |
| DOL | 25.00 | TOL | 50.00 | ISDN | 25.00 |
| DOL | 25.00 | TOL | 15.00 | TTE | 60.00 |
| DOL | 25.00 | TOL | 25.00 | TTE | 50.00 |
| DOL | 25.00 | TOL | 33.00 | TTE | 42.00 |
| DOL | 25.00 | TOL | 50.00 | TTE | 25.00 |
| DOL | 25.00 | SUL | 15.00 | BFE | 60.00 |
| DOL | 25.00 | SUL | 25.00 | BFE | 50.00 |
| DOL | 25.00 | SUL | 33.00 | BFE | 42.00 |
| DOL | 25.00 | SUL | 50.00 | BFE | 25.00 |
| DOL | 25.00 | SUL | 15.00 | 3FP | 60.00 |
| DOL | 25.00 | SUL | 25.00 | 3FP | 50.00 |
| DOL | 25.00 | SUL | 33.00 | 3FP | 42.00 |
| DOL | 25.00 | SUL | 50.00 | 3FP | 25.00 |
| DOL | 25.00 | SUL | 15.00 | BFTE | 60.00 |
| DOL | 25.00 | SUL | 25.00 | BFTE | 50.00 |
| DOL | 25.00 | SUL | 33.00 | BFTE | 42.00 |
| DOL | 25.00 | SUL | 50.00 | BFTE | 25.00 |
| DOL | 25.00 | SUL | 15.00 | FDMB | 60.00 |
| DOL | 25.00 | SUL | 25.00 | FDMB | 50.00 |
| DOL | 25.00 | SUL | 33.00 | FDMB | 42.00 |
| DOL | 25.00 | SUL | 50.00 | FDMB | 25.00 |
| DOL | 25.00 | SUL | 15.00 | ISDN | 60.00 |
| DOL | 25.00 | SUL | 25.00 | ISDN | 50.00 |
| DOL | 25.00 | SUL | 33.00 | ISDN | 42.00 |
| DOL | 25.00 | SUL | 50.00 | ISDN | 25.00 |
| DOL | 25.00 | SUL | 15.00 | TTE | 60.00 |
| DOL | 25.00 | SUL | 25.00 | TTE | 50.00 |
| DOL | 25.00 | SUL | 33.00 | TTE | 42.00 |
| DOL | 25.00 | SUL | 50.00 | TTE | 25.00 |
| DOL | 33.00 | DME | 15.00 | BFE | 52.00 |
| DOL | 33.00 | DME | 25.00 | BFE | 42.00 |
| DOL | 33.00 | DME | 33.00 | BFE | 34.00 |
| DOL | 33.00 | DME | 50.00 | BFE | 17.00 |
| DOL | 33.00 | DME | 15.00 | 3FP | 52.00 |
| DOL | 33.00 | DME | 25.00 | 3FP | 42.00 |
| DOL | 33.00 | DME | 33.00 | 3FP | 34.00 |
| DOL | 33.00 | DME | 50.00 | 3FP | 17.00 |
| DOL | 33.00 | DME | 15.00 | BFTE | 52.00 |
| DOL | 33.00 | DME | 25.00 | BFTE | 42.00 |
| DOL | 33.00 | DME | 33.00 | BFTE | 34.00 |
| DOL | 33.00 | DME | 50.00 | BFTE | 17.00 |
| DOL | 33.00 | DME | 15.00 | FDMB | 52.00 |
| DOL | 33.00 | DME | 25.00 | FDMB | 42.00 |
| DOL | 33.00 | DME | 33.00 | FDMB | 34.00 |
| DOL | 33.00 | DME | 50.00 | FDMB | 17.00 |
| DOL | 33.00 | DME | 15.00 | ISDN | 52.00 |
| DOL | 33.00 | DME | 25.00 | ISDN | 42.00 |
| DOL | 33.00 | DME | 33.00 | ISDN | 34.00 |
| DOL | 33.00 | DME | 50.00 | ISDN | 17.00 |
| DOL | 33.00 | DME | 15.00 | TTE | 52.00 |
| DOL | 33.00 | DME | 25.00 | TTE | 42.00 |
| DOL | 33.00 | DME | 33.00 | TTE | 34.00 |
| DOL | 33.00 | DME | 50.00 | TTE | 17.00 |
| DOL | 33.00 | TOL | 15.00 | BFE | 52.00 |
| DOL | 33.00 | TOL | 25.00 | BFE | 42.00 |
| DOL | 33.00 | TOL | 33.00 | BFE | 34.00 |
| DOL | 33.00 | TOL | 50.00 | BFE | 17.00 |
| DOL | 33.00 | TOL | 15.00 | 3FP | 52.00 |
| DOL | 33.00 | TOL | 25.00 | 3FP | 42.00 |
| DOL | 33.00 | TOL | 33.00 | 3FP | 34.00 |
| DOL | 33.00 | TOL | 50.00 | 3FP | 17.00 |
| DOL | 33.00 | TOL | 15.00 | BFTE | 52.00 |
| DOL | 33.00 | TOL | 25.00 | BFTE | 42.00 |
| DOL | 33.00 | TOL | 33.00 | BFTE | 34.00 |
| DOL | 33.00 | TOL | 50.00 | BFTE | 17.00 |
| DOL | 33.00 | TOL | 15.00 | FDMB | 52.00 |
| DOL | 33.00 | TOL | 25.00 | FDMB | 42.00 |
| DOL | 33.00 | TOL | 33.00 | FDMB | 34.00 |
| DOL | 33.00 | TOL | 50.00 | FDMB | 17.00 |
| DOL | 33.00 | TOL | 15.00 | ISDN | 52.00 |
| DOL | 33.00 | TOL | 25.00 | ISDN | 42.00 |
| DOL | 33.00 | TOL | 33.00 | ISDN | 34.00 |
| DOL | 33.00 | TOL | 50.00 | ISDN | 17.00 |
| DOL | 33.00 | TOL | 15.00 | TTE | 52.00 |
| DOL | 33.00 | TOL | 25.00 | TTE | 42.00 |
| DOL | 33.00 | TOL | 33.00 | TTE | 34.00 |
| DOL | 33.00 | TOL | 50.00 | TTE | 17.00 |
| DOL | 33.00 | SUL | 15.00 | BFE | 52.00 |
| DOL | 33.00 | SUL | 25.00 | BFE | 42.00 |
| DOL | 33.00 | SUL | 33.00 | BFE | 34.00 |
| DOL | 33.00 | SUL | 50.00 | BFE | 17.00 |
| DOL | 33.00 | SUL | 15.00 | 3FP | 52.00 |
| DOL | 33.00 | SUL | 25.00 | 3FP | 42.00 |
| DOL | 33.00 | SUL | 33.00 | 3FP | 34.00 |
| DOL | 33.00 | SUL | 50.00 | 3FP | 17.00 |
| DOL | 33.00 | SUL | 15.00 | BFTE | 52.00 |
| DOL | 33.00 | SUL | 25.00 | BFTE | 42.00 |
| DOL | 33.00 | SUL | 33.00 | BFTE | 34.00 |
| DOL | 33.00 | SUL | 50.00 | BFTE | 17.00 |
| DOL | 33.00 | SUL | 15.00 | FDMB | 52.00 |
| DOL | 33.00 | SUL | 25.00 | FDMB | 42.00 |
| DOL | 33.00 | SUL | 33.00 | FDMB | 34.00 |
| DOL | 33.00 | SUL | 50.00 | FDMB | 17.00 |
| DOL | 33.00 | SUL | 15.00 | ISDN | 52.00 |
| DOL | 33.00 | SUL | 25.00 | ISDN | 42.00 |
| DOL | 33.00 | SUL | 33.00 | ISDN | 34.00 |
| DOL | 33.00 | SUL | 50.00 | ISDN | 17.00 |
| DOL | 33.00 | SUL | 15.00 | TTE | 52.00 |
| DOL | 33.00 | SUL | 25.00 | TTE | 42.00 |
| DOL | 33.00 | SUL | 33.00 | TTE | 34.00 |
| DOL | 33.00 | SUL | 50.00 | TTE | 17.00 |
| DOL | 50.00 | DME | 10.00 | BFE | 40.00 |
| DOL | 50.00 | DME | 25.00 | BFE | 25.00 |
| DOL | 50.00 | DME | 33.00 | BFE | 17.00 |
| DOL | 50.00 | DME | 15.00 | 3FP | 35.00 |
| DOL | 50.00 | DME | 25.00 | 3FP | 25.00 |
| DOL | 50.00 | DME | 33.00 | 3FP | 17.00 |
| DOL | 50.00 | DME | 15.00 | BFTE | 35.00 |
| DOL | 50.00 | DME | 25.00 | BFTE | 25.00 |
| DOL | 50.00 | DME | 33.00 | BFTE | 17.00 |
| DOL | 50.00 | DME | 15.00 | FDMB | 35.00 |
| DOL | 50.00 | DME | 25.00 | FDMB | 25.00 |
| DOL | 50.00 | DME | 33.00 | FDMB | 17.00 |
| DOL | 50.00 | DME | 15.00 | ISDN | 35.00 |
| DOL | 50.00 | DME | 25.00 | ISDN | 25.00 |
| DOL | 50.00 | DME | 33.00 | ISDN | 17.00 |
| DOL | 50.00 | DME | 15.00 | TTE | 35.00 |
| DOL | 50.00 | DME | 25.00 | TTE | 25.00 |
| DOL | 50.00 | DME | 33.00 | TTE | 17.00 |
| DOL | 50.00 | TOL | 15.00 | BFE | 35.00 |
| DOL | 50.00 | TOL | 25.00 | BFE | 25.00 |
| DOL | 50.00 | TOL | 33.00 | BFE | 17.00 |
| DOL | 50.00 | TOL | 15.00 | 3FP | 35.00 |
| DOL | 50.00 | TOL | 25.00 | 3FP | 25.00 |
| DOL | 50.00 | TOL | 33.00 | 3FP | 17.00 |
| DOL | 50.00 | TOL | 15.00 | BFTE | 35.00 |
| DOL | 50.00 | TOL | 25.00 | BFTE | 25.00 |
| DOL | 50.00 | TOL | 33.00 | BFTE | 17.00 |
| DOL | 50.00 | TOL | 15.00 | FDMB | 35.00 |
| DOL | 50.00 | TOL | 25.00 | FDMB | 25.00 |
| DOL | 50.00 | TOL | 33.00 | FDMB | 17.00 |
| DOL | 50.00 | TOL | 15.00 | ISDN | 35.00 |
| DOL | 50.00 | TOL | 25.00 | ISDN | 25.00 |
| DOL | 50.00 | TOL | 33.00 | ISDN | 17.00 |
| DOL | 50.00 | TOL | 15.00 | TTE | 35.00 |
| DOL | 50.00 | TOL | 25.00 | TTE | 25.00 |
| DOL | 50.00 | TOL | 33.00 | TTE | 17.00 |
| DOL | 50.00 | SUL | 15.00 | BFE | 35.00 |
| DOL | 50.00 | SUL | 25.00 | BFE | 25.00 |
| DOL | 50.00 | SUL | 33.00 | BFE | 17.00 |
| DOL | 50.00 | SUL | 15.00 | 3FP | 35.00 |
| DOL | 50.00 | SUL | 25.00 | 3FP | 25.00 |
| DOL | 50.00 | SUL | 33.00 | 3FP | 17.00 |
| DOL | 50.00 | SUL | 15.00 | BFTE | 35.00 |
| DOL | 50.00 | SUL | 25.00 | BFTE | 25.00 |
| DOL | 50.00 | SUL | 33.00 | BFTE | 17.00 |
| DOL | 50.00 | SUL | 15.00 | FDMB | 35.00 |
| DOL | 50.00 | SUL | 25.00 | FDMB | 25.00 |
| DOL | 50.00 | SUL | 33.00 | FDMB | 17.00 |
| DOL | 50.00 | SUL | 15.00 | ISDN | 35.00 |
| DOL | 50.00 | SUL | 25.00 | ISDN | 25.00 |
| DOL | 50.00 | SUL | 33.00 | ISDN | 17.00 |
| DOL | 50.00 | SUL | 15.00 | TTE | 35.00 |
| DOL | 50.00 | SUL | 25.00 | TTE | 25.00 |
| DOL | 50.00 | SUL | 33.00 | TTE | 17.00 |
| SUL | 10.00 | DOL | 15.00 | BFE | 75.00 |
| SUL | 10.00 | DOL | 25.00 | BFE | 65.00 |
| SUL | 10.00 | DOL | 33.00 | BFE | 57.00 |
| SUL | 10.00 | DOL | 50.00 | BFE | 40.00 |
| SUL | 10.00 | DOL | 65.00 | BFE | 25.00 |
| SUL | 10.00 | DOL | 15.00 | 3FP | 75.00 |
| SUL | 10.00 | DOL | 25.00 | 3FP | 65.00 |
| SUL | 10.00 | DOL | 33.00 | 3FP | 57.00 |
| SUL | 10.00 | DOL | 50.00 | 3FP | 40.00 |
| SUL | 10.00 | DOL | 65.00 | 3FP | 25.00 |
| SUL | 10.00 | DOL | 15.00 | BFTE | 75.00 |
| SUL | 10.00 | DOL | 25.00 | BFTE | 65.00 |
| SUL | 10.00 | DOL | 33.00 | BFTE | 57.00 |
| SUL | 10.00 | DOL | 50.00 | BFTE | 40.00 |
| SUL | 10.00 | DOL | 65.00 | BFTE | 25.00 |
| SUL | 10.00 | DOL | 15.00 | FDMB | 75.00 |
| SUL | 10.00 | DOL | 25.00 | FDMB | 65.00 |
| SUL | 10.00 | DOL | 33.00 | FDMB | 57.00 |
| SUL | 10.00 | DOL | 50.00 | FDMB | 40.00 |
| SUL | 10.00 | DOL | 65.00 | FDMB | 25.00 |
| SUL | 10.00 | DOL | 15.00 | ISDN | 75.00 |
| SUL | 10.00 | DOL | 25.00 | ISDN | 65.00 |
| SUL | 10.00 | DOL | 33.00 | ISDN | 57.00 |
| SUL | 10.00 | DOL | 50.00 | ISDN | 40.00 |
| SUL | 10.00 | DOL | 65.00 | ISDN | 25.00 |
| SUL | 10.00 | DOL | 15.00 | TTE | 75.00 |
| SUL | 10.00 | DOL | 25.00 | TTE | 65.00 |
| SUL | 10.00 | DOL | 33.00 | TTE | 57.00 |
| SUL | 10.00 | DOL | 50.00 | TTE | 40.00 |
| SUL | 10.00 | DOL | 65.00 | TTE | 25.00 |
| SUL | 10.00 | TOL | 15.00 | BFE | 75.00 |
| SUL | 10.00 | TOL | 25.00 | BFE | 65.00 |
| SUL | 10.00 | TOL | 33.00 | BFE | 57.00 |
| SUL | 10.00 | TOL | 50.00 | BFE | 40.00 |
| SUL | 10.00 | TOL | 65.00 | BFE | 25.00 |
| SUL | 10.00 | TOL | 15.00 | 3FP | 75.00 |
| SUL | 10.00 | TOL | 25.00 | 3FP | 65.00 |
| SUL | 10.00 | TOL | 33.00 | 3FP | 57.00 |
| SUL | 10.00 | TOL | 50.00 | 3FP | 40.00 |
| SUL | 10.00 | TOL | 65.00 | 3FP | 25.00 |
| SUL | 10.00 | TOL | 15.00 | BFTE | 75.00 |
| SUL | 10.00 | TOL | 25.00 | BFTE | 65.00 |
| SUL | 10.00 | TOL | 33.00 | BFTE | 57.00 |
| SUL | 10.00 | TOL | 50.00 | BFTE | 40.00 |
| SUL | 10.00 | TOL | 65.00 | BFTE | 25.00 |
| SUL | 10.00 | TOL | 15.00 | FDMB | 75.00 |
| SUL | 10.00 | TOL | 25.00 | FDMB | 65.00 |
| SUL | 10.00 | TOL | 33.00 | FDMB | 57.00 |
| SUL | 10.00 | TOL | 50.00 | FDMB | 40.00 |
| SUL | 10.00 | TOL | 65.00 | FDMB | 25.00 |
| SUL | 10.00 | TOL | 15.00 | ISDN | 75.00 |
| SUL | 10.00 | TOL | 25.00 | ISDN | 65.00 |
| SUL | 10.00 | TOL | 33.00 | ISDN | 57.00 |
| SUL | 10.00 | TOL | 50.00 | ISDN | 40.00 |
| SUL | 10.00 | TOL | 65.00 | ISDN | 25.00 |
| SUL | 10.00 | TOL | 15.00 | TTE | 75.00 |
| SUL | 10.00 | TOL | 25.00 | TTE | 65.00 |
| SUL | 10.00 | TOL | 33.00 | TTE | 57.00 |
| SUL | 10.00 | TOL | 50.00 | TTE | 40.00 |
| SUL | 10.00 | TOL | 65.00 | TTE | 25.00 |
| SUL | 25.00 | DME | 15.00 | BFE | 60.00 |
| SUL | 25.00 | DME | 25.00 | BFE | 50.00 |
| SUL | 25.00 | DME | 33.00 | BFE | 42.00 |
| SUL | 25.00 | DME | 50.00 | BFE | 25.00 |
| SUL | 25.00 | DME | 15.00 | 3FP | 60.00 |
| SUL | 25.00 | DME | 25.00 | 3FP | 50.00 |
| SUL | 25.00 | DME | 33.00 | 3FP | 42.00 |
| SUL | 25.00 | DME | 50.00 | 3FP | 25.00 |
| SUL | 25.00 | DME | 15.00 | BFTE | 60.00 |
| SUL | 25.00 | DME | 25.00 | BFTE | 50.00 |
| SUL | 25.00 | DME | 33.00 | BFTE | 42.00 |
| SUL | 25.00 | DME | 50.00 | BFTE | 25.00 |
| SUL | 25.00 | DME | 15.00 | FDMB | 60.00 |
| SUL | 25.00 | DME | 25.00 | FDMB | 50.00 |
| SUL | 25.00 | DME | 33.00 | FDMB | 42.00 |
| SUL | 25.00 | DME | 50.00 | FDMB | 25.00 |
| SUL | 25.00 | DME | 15.00 | ISDN | 60.00 |
| SUL | 25.00 | DME | 25.00 | ISDN | 50.00 |
| SUL | 25.00 | DME | 33.00 | ISDN | 42.00 |
| SUL | 25.00 | DME | 50.00 | ISDN | 25.00 |
| SUL | 25.00 | DME | 15.00 | TTE | 60.00 |
| SUL | 25.00 | DME | 25.00 | TTE | 50.00 |
| SUL | 25.00 | DME | 33.00 | TTE | 42.00 |
| SUL | 25.00 | DME | 50.00 | TTE | 25.00 |
| SUL | 25.00 | DOL | 15.00 | BFE | 60.00 |
| SUL | 25.00 | DOL | 25.00 | BFE | 50.00 |
| SUL | 25.00 | DOL | 33.00 | BFE | 42.00 |
| SUL | 25.00 | DOL | 50.00 | BFE | 25.00 |
| SUL | 25.00 | DOL | 15.00 | 3FP | 60.00 |
| SUL | 25.00 | DOL | 25.00 | 3FP | 50.00 |
| SUL | 25.00 | DOL | 33.00 | 3FP | 42.00 |
| SUL | 25.00 | DOL | 50.00 | 3FP | 25.00 |
| SUL | 25.00 | DOL | 15.00 | BFTE | 60.00 |
| SUL | 25.00 | DOL | 25.00 | BFTE | 50.00 |
| SUL | 25.00 | DOL | 33.00 | BFTE | 42.00 |
| SUL | 25.00 | DOL | 50.00 | BFTE | 25.00 |
| SUL | 25.00 | DOL | 15.00 | FDMB | 60.00 |
| SUL | 25.00 | DOL | 25.00 | FDMB | 50.00 |
| SUL | 25.00 | DOL | 33.00 | FDMB | 42.00 |
| SUL | 25.00 | DOL | 50.00 | FDMB | 25.00 |
| SUL | 25.00 | DOL | 15.00 | ISDN | 60.00 |
| SUL | 25.00 | DOL | 25.00 | ISDN | 50.00 |
| SUL | 25.00 | DOL | 33.00 | ISDN | 42.00 |
| SUL | 25.00 | DOL | 50.00 | ISDN | 25.00 |
| SUL | 25.00 | DOL | 15.00 | TTE | 60.00 |
| SUL | 25.00 | DOL | 25.00 | TTE | 50.00 |
| SUL | 25.00 | DOL | 33.00 | TTE | 42.00 |
| SUL | 25.00 | DOL | 50.00 | TTE | 25.00 |
| SUL | 25.00 | TOL | 15.00 | BFE | 60.00 |
| SUL | 25.00 | TOL | 25.00 | BFE | 50.00 |
| SUL | 25.00 | TOL | 33.00 | BFE | 42.00 |
| SUL | 25.00 | TOL | 50.00 | BFE | 25.00 |
| SUL | 25.00 | TOL | 15.00 | 3FP | 60.00 |
| SUL | 25.00 | TOL | 25.00 | 3FP | 50.00 |
| SUL | 25.00 | TOL | 33.00 | 3FP | 42.00 |
| SUL | 25.00 | TOL | 50.00 | 3FP | 25.00 |
| SUL | 25.00 | TOL | 15.00 | BFTE | 60.00 |
| SUL | 25.00 | TOL | 25.00 | BFTE | 50.00 |
| SUL | 25.00 | TOL | 33.00 | BFTE | 42.00 |
| SUL | 25.00 | TOL | 50.00 | BFTE | 25.00 |
| SUL | 25.00 | TOL | 15.00 | FDMB | 60.00 |
| SUL | 25.00 | TOL | 25.00 | FDMB | 50.00 |
| SUL | 25.00 | TOL | 33.00 | FDMB | 42.00 |
| SUL | 25.00 | TOL | 50.00 | FDMB | 25.00 |
| SUL | 25.00 | TOL | 15.00 | ISDN | 60.00 |
| SUL | 25.00 | TOL | 25.00 | ISDN | 50.00 |
| SUL | 25.00 | TOL | 33.00 | ISDN | 42.00 |
| SUL | 25.00 | TOL | 50.00 | ISDN | 25.00 |
| SUL | 25.00 | TOL | 15.00 | TTE | 60.00 |
| SUL | 25.00 | TOL | 25.00 | TTE | 50.00 |
| SUL | 25.00 | TOL | 33.00 | TTE | 42.00 |
| SUL | 25.00 | TOL | 50.00 | TTE | 25.00 |
| SUL | 33.00 | DME | 15.00 | BFE | 52.00 |
| SUL | 33.00 | DME | 25.00 | BFE | 42.00 |
| SUL | 33.00 | DME | 33.00 | BFE | 34.00 |
| SUL | 33.00 | DME | 50.00 | BFE | 17.00 |
| SUL | 33.00 | DME | 15.00 | 3FP | 52.00 |
| SUL | 33.00 | DME | 25.00 | 3FP | 42.00 |
| SUL | 33.00 | DME | 33.00 | 3FP | 34.00 |
| SUL | 33.00 | DME | 50.00 | 3FP | 17.00 |
| SUL | 33.00 | DME | 15.00 | BFTE | 52.00 |
| SUL | 33.00 | DME | 25.00 | BFTE | 42.00 |
| SUL | 33.00 | DME | 33.00 | BFTE | 34.00 |
| SUL | 33.00 | DME | 50.00 | BFTE | 17.00 |
| SUL | 33.00 | DME | 15.00 | FDMB | 52.00 |
| SUL | 33.00 | DME | 25.00 | FDMB | 42.00 |
| SUL | 33.00 | DME | 33.00 | FDMB | 34.00 |
| SUL | 33.00 | DME | 50.00 | FDMB | 17.00 |
| SUL | 33.00 | DME | 15.00 | ISDN | 52.00 |
| SUL | 33.00 | DME | 25.00 | ISDN | 42.00 |
| SUL | 33.00 | DME | 33.00 | ISDN | 34.00 |
| SUL | 33.00 | DME | 50.00 | ISDN | 17.00 |
| SUL | 33.00 | DME | 15.00 | TTE | 52.00 |
| SUL | 33.00 | DME | 25.00 | TTE | 42.00 |
| SUL | 33.00 | DME | 33.00 | TTE | 34.00 |
| SUL | 33.00 | DME | 50.00 | TTE | 17.00 |
| SUL | 33.00 | DOL | 15.00 | BFE | 52.00 |
| SUL | 33.00 | DOL | 25.00 | BFE | 42.00 |
| SUL | 33.00 | DOL | 33.00 | BFE | 34.00 |
| SUL | 33.00 | DOL | 50.00 | BFE | 17.00 |
| SUL | 33.00 | DOL | 15.00 | 3FP | 52.00 |
| SUL | 33.00 | DOL | 25.00 | 3FP | 42.00 |
| SUL | 33.00 | DOL | 33.00 | 3FP | 34.00 |
| SUL | 33.00 | DOL | 50.00 | 3FP | 17.00 |
| SUL | 33.00 | DOL | 15.00 | BFTE | 52.00 |
| SUL | 33.00 | DOL | 25.00 | BFTE | 42.00 |
| SUL | 33.00 | DOL | 33.00 | BFTE | 34.00 |
| SUL | 33.00 | DOL | 50.00 | BFTE | 17.00 |
| SUL | 33.00 | DOL | 15.00 | FDMB | 52.00 |
| SUL | 33.00 | DOL | 25.00 | FDMB | 42.00 |
| SUL | 33.00 | DOL | 33.00 | FDMB | 34.00 |
| SUL | 33.00 | DOL | 50.00 | FDMB | 17.00 |
| SUL | 33.00 | DOL | 15.00 | ISDN | 52.00 |
| SUL | 33.00 | DOL | 25.00 | ISDN | 42.00 |
| SUL | 33.00 | DOL | 33.00 | ISDN | 34.00 |
| SUL | 33.00 | DOL | 50.00 | ISDN | 17.00 |
| SUL | 33.00 | DOL | 15.00 | TTE | 52.00 |
| SUL | 33.00 | DOL | 25.00 | TTE | 42.00 |
| SUL | 33.00 | DOL | 33.00 | TTE | 34.00 |
| SUL | 33.00 | DOL | 50.00 | TTE | 17.00 |
| SUL | 33.00 | TOL | 15.00 | BFE | 52.00 |
| SUL | 33.00 | TOL | 25.00 | BFE | 42.00 |
| SUL | 33.00 | TOL | 33.00 | BFE | 34.00 |
| SUL | 33.00 | TOL | 50.00 | BFE | 17.00 |
| SUL | 33.00 | TOL | 15.00 | 3FP | 52.00 |
| SUL | 33.00 | TOL | 25.00 | 3FP | 42.00 |
| SUL | 33.00 | TOL | 33.00 | 3FP | 34.00 |
| SUL | 33.00 | TOL | 50.00 | 3FP | 17.00 |
| SUL | 33.00 | TOL | 15.00 | BFTE | 52.00 |
| SUL | 33.00 | TOL | 25.00 | BFTE | 42.00 |
| SUL | 33.00 | TOL | 33.00 | BFTE | 34.00 |
| SUL | 33.00 | TOL | 50.00 | BFTE | 17.00 |
| SUL | 33.00 | TOL | 15.00 | FDMB | 52.00 |
| SUL | 33.00 | TOL | 25.00 | FDMB | 42.00 |
| SUL | 33.00 | TOL | 33.00 | FDMB | 34.00 |
| SUL | 33.00 | TOL | 50.00 | FDMB | 17.00 |
| SUL | 33.00 | TOL | 15.00 | ISDN | 52.00 |
| SUL | 33.00 | TOL | 25.00 | ISDN | 42.00 |
| SUL | 33.00 | TOL | 33.00 | ISDN | 34.00 |
| SUL | 33.00 | TOL | 50.00 | ISDN | 17.00 |
| SUL | 33.00 | TOL | 15.00 | TTE | 52.00 |
| SUL | 33.00 | TOL | 25.00 | TTE | 42.00 |
| SUL | 33.00 | TOL | 33.00 | TTE | 34.00 |
| SUL | 33.00 | TOL | 50.00 | TTE | 17.00 |
| SUL | 50.00 | DME | 10.00 | BFE | 40.00 |
| SUL | 50.00 | DME | 25.00 | BFE | 25.00 |
| SUL | 50.00 | DME | 33.00 | BFE | 17.00 |
| SUL | 50.00 | DME | 15.00 | 3FP | 35.00 |
| SUL | 50.00 | DME | 25.00 | 3FP | 25.00 |
| SUL | 50.00 | DME | 33.00 | 3FP | 17.00 |
| SUL | 50.00 | DME | 15.00 | BFTE | 35.00 |
| SUL | 50.00 | DME | 25.00 | BFTE | 25.00 |
| SUL | 50.00 | DME | 33.00 | BFTE | 17.00 |
| SUL | 50.00 | DME | 15.00 | FDMB | 35.00 |
| SUL | 50.00 | DME | 25.00 | FDMB | 25.00 |
| SUL | 50.00 | DME | 33.00 | FDMB | 17.00 |
| SUL | 50.00 | DME | 15.00 | ISDN | 35.00 |
| SUL | 50.00 | DME | 25.00 | ISDN | 25.00 |
| SUL | 50.00 | DME | 33.00 | ISDN | 17.00 |
| SUL | 50.00 | DME | 15.00 | TTE | 35.00 |
| SUL | 50.00 | DME | 25.00 | TTE | 25.00 |
| SUL | 50.00 | DME | 33.00 | TTE | 17.00 |
| SUL | 50.00 | DOL | 15.00 | BFE | 35.00 |
| SUL | 50.00 | DOL | 25.00 | BFE | 25.00 |
| SUL | 50.00 | DOL | 33.00 | BFE | 17.00 |
| SUL | 50.00 | DOL | 15.00 | 3FP | 35.00 |
| SUL | 50.00 | DOL | 25.00 | 3FP | 25.00 |
| SUL | 50.00 | DOL | 33.00 | 3FP | 17.00 |
| SUL | 50.00 | DOL | 15.00 | BFTE | 35.00 |
| SUL | 50.00 | DOL | 25.00 | BFTE | 25.00 |
| SUL | 50.00 | DOL | 33.00 | BFTE | 17.00 |
| SUL | 50.00 | DOL | 15.00 | FDMB | 35.00 |
| SUL | 50.00 | DOL | 25.00 | FDMB | 25.00 |
| SUL | 50.00 | DOL | 33.00 | FDMB | 17.00 |
| SUL | 50.00 | DOL | 15.00 | ISDN | 35.00 |
| SUL | 50.00 | DOL | 25.00 | ISDN | 25.00 |
| SUL | 50.00 | DOL | 33.00 | ISDN | 17.00 |
| SUL | 50.00 | DOL | 15.00 | TTE | 35.00 |
| SUL | 50.00 | DOL | 25.00 | TTE | 25.00 |
| SUL | 50.00 | DOL | 33.00 | TTE | 17.00 |
| SUL | 50.00 | TOL | 15.00 | BFE | 35.00 |
| SUL | 50.00 | TOL | 25.00 | BFE | 25.00 |
| SUL | 50.00 | TOL | 33.00 | BFE | 17.00 |
| SUL | 50.00 | TOL | 15.00 | 3FP | 35.00 |
| SUL | 50.00 | TOL | 25.00 | 3FP | 25.00 |
| SUL | 50.00 | TOL | 33.00 | 3FP | 17.00 |
| SUL | 50.00 | TOL | 15.00 | BFTE | 35.00 |
| SUL | 50.00 | TOL | 25.00 | BFTE | 25.00 |
| SUL | 50.00 | TOL | 33.00 | BFTE | 17.00 |
| SUL | 50.00 | TOL | 15.00 | FDMB | 35.00 |
| SUL | 50.00 | TOL | 25.00 | FDMB | 25.00 |
| SUL | 50.00 | TOL | 33.00 | FDMB | 17.00 |
| SUL | 50.00 | TOL | 15.00 | ISDN | 35.00 |
| SUL | 50.00 | TOL | 25.00 | ISDN | 25.00 |
| SUL | 50.00 | TOL | 33.00 | ISDN | 17.00 |
| SUL | 50.00 | TOL | 15.00 | TTE | 35.00 |
| SUL | 50.00 | TOL | 25.00 | TTE | 25.00 |
| SUL | 50.00 | TOL | 33.00 | TTE | 17.00 |
| TOL | 25.00 | none | 0 | BFE | 75.00 |
| TOL | 25.00 | none | 0 | 3FP | 75.00 |
| TOL | 25.00 | none | 0 | BFTE | 75.00 |
| TOL | 25.00 | none | 0 | FDMB | 75.00 |
| TOL | 25.00 | none | 0 | ISDN | 75.00 |
| TOL | 25.00 | none | 0 | TTE | 75.00 |
| TOL | 33.00 | none | 0 | BFE | 67.00 |
| TOL | 33.00 | none | 0 | 3FP | 67.00 |
| TOL | 33.00 | none | 0 | BFTE | 67.00 |
| TOL | 33.00 | none | 0 | FDMB | 67.00 |
| TOL | 33.00 | none | 0 | ISDN | 67.00 |
| TOL | 33.00 | none | 0 | TTE | 67.00 |
| TOL | 50.00 | none | 0 | BFE | 50.00 |
| TOL | 50.00 | none | 0 | 3FP | 50.00 |
| TOL | 50.00 | none | 0 | BFTE | 50.00 |
| TOL | 50.00 | none | 0 | FDMB | 50.00 |
| TOL | 50.00 | none | 0 | ISDN | 50.00 |
| TOL | 50.00 | none | 0 | TTE | 50.00 |
| TOL | 75.00 | none | 0 | BFE | 25.00 |
| TOL | 75.00 | none | 0 | 3FP | 25.00 |
| TOL | 75.00 | none | 0 | BFTE | 25.00 |
| TOL | 75.00 | none | 0 | FDMB | 25.00 |
| TOL | 75.00 | none | 0 | ISDN | 25.00 |
| TOL | 75.00 | none | 0 | TTE | 25.00 |
| TOL | 10.00 | DME | 15.00 | BFE | 75.00 |
| TOL | 10.00 | DME | 25.00 | BFE | 65.00 |
| TOL | 10.00 | DME | 33.00 | BFE | 57.00 |
| TOL | 10.00 | DME | 50.00 | BFE | 40.00 |
| TOL | 10.00 | DME | 65.00 | BFE | 25.00 |
| TOL | 10.00 | DME | 15.00 | 3FP | 75.00 |
| TOL | 10.00 | DME | 25.00 | 3FP | 65.00 |
| TOL | 10.00 | DME | 33.00 | 3FP | 57.00 |
| TOL | 10.00 | DME | 50.00 | 3FP | 40.00 |
| TOL | 10.00 | DME | 65.00 | 3FP | 25.00 |
| TOL | 10.00 | DME | 15.00 | BFTE | 75.00 |
| TOL | 10.00 | DME | 25.00 | BFTE | 65.00 |
| TOL | 10.00 | DME | 33.00 | BFTE | 57.00 |
| TOL | 10.00 | DME | 50.00 | BFTE | 40.00 |
| TOL | 10.00 | DME | 65.00 | BFTE | 25.00 |
| TOL | 10.00 | DME | 15.00 | FDMB | 75.00 |
| TOL | 10.00 | DME | 25.00 | FDMB | 65.00 |
| TOL | 10.00 | DME | 33.00 | FDMB | 57.00 |
| TOL | 10.00 | DME | 50.00 | FDMB | 40.00 |
| TOL | 10.00 | DME | 65.00 | FDMB | 25.00 |
| TOL | 10.00 | DME | 15.00 | ISDN | 75.00 |
| TOL | 10.00 | DME | 25.00 | ISDN | 65.00 |
| TOL | 10.00 | DME | 33.00 | ISDN | 57.00 |
| TOL | 10.00 | DME | 50.00 | ISDN | 40.00 |
| TOL | 10.00 | DME | 65.00 | ISDN | 25.00 |
| TOL | 10.00 | DME | 15.00 | TTE | 75.00 |
| TOL | 10.00 | DME | 25.00 | TTE | 65.00 |
| TOL | 10.00 | DME | 33.00 | TTE | 57.00 |
| TOL | 10.00 | DME | 50.00 | TTE | 40.00 |
| TOL | 10.00 | DME | 65.00 | TTE | 25.00 |
| TOL | 10.00 | DOL | 15.00 | BFE | 75.00 |
| TOL | 10.00 | DOL | 25.00 | BFE | 65.00 |
| TOL | 10.00 | DOL | 33.00 | BFE | 57.00 |
| TOL | 10.00 | DOL | 50.00 | BFE | 40.00 |
| TOL | 10.00 | DOL | 65.00 | BFE | 25.00 |
| TOL | 10.00 | DOL | 15.00 | 3FP | 75.00 |
| TOL | 10.00 | DOL | 25.00 | 3FP | 65.00 |
| TOL | 10.00 | DOL | 33.00 | 3FP | 57.00 |
| TOL | 10.00 | DOL | 50.00 | 3FP | 40.00 |
| TOL | 10.00 | DOL | 65.00 | 3FP | 25.00 |
| TOL | 10.00 | DOL | 15.00 | BFTE | 75.00 |
| TOL | 10.00 | DOL | 25.00 | BFTE | 65.00 |
| TOL | 10.00 | DOL | 33.00 | BFTE | 57.00 |
| TOL | 10.00 | DOL | 50.00 | BFTE | 40.00 |
| TOL | 10.00 | DOL | 65.00 | BFTE | 25.00 |
| TOL | 10.00 | DOL | 15.00 | FDMB | 75.00 |
| TOL | 10.00 | DOL | 25.00 | FDMB | 65.00 |
| TOL | 10.00 | DOL | 33.00 | FDMB | 57.00 |
| TOL | 10.00 | DOL | 50.00 | FDMB | 40.00 |
| TOL | 10.00 | DOL | 65.00 | FDMB | 25.00 |
| TOL | 10.00 | DOL | 15.00 | ISDN | 75.00 |
| TOL | 10.00 | DOL | 25.00 | ISDN | 65.00 |
| TOL | 10.00 | DOL | 33.00 | ISDN | 57.00 |
| TOL | 10.00 | DOL | 50.00 | ISDN | 40.00 |
| TOL | 10.00 | DOL | 65.00 | ISDN | 25.00 |
| TOL | 10.00 | DOL | 15.00 | TTE | 75.00 |
| TOL | 10.00 | DOL | 25.00 | TTE | 65.00 |
| TOL | 10.00 | DOL | 33.00 | TTE | 57.00 |
| TOL | 10.00 | DOL | 50.00 | TTE | 40.00 |
| TOL | 10.00 | DOL | 65.00 | TTE | 25.00 |
| TOL | 10.00 | SUL | 15.00 | BFE | 75.00 |
| TOL | 10.00 | SUL | 25.00 | BFE | 65.00 |
| TOL | 10.00 | SUL | 33.00 | BFE | 57.00 |
| TOL | 10.00 | SUL | 50.00 | BFE | 40.00 |
| TOL | 10.00 | SUL | 65.00 | BFE | 25.00 |
| TOL | 10.00 | SUL | 15.00 | 3FP | 75.00 |
| TOL | 10.00 | SUL | 25.00 | 3FP | 65.00 |
| TOL | 10.00 | SUL | 33.00 | 3FP | 57.00 |
| TOL | 10.00 | SUL | 50.00 | 3FP | 40.00 |
| TOL | 10.00 | SUL | 65.00 | 3FP | 25.00 |
| TOL | 10.00 | SUL | 15.00 | BFTE | 75.00 |
| TOL | 10.00 | SUL | 25.00 | BFTE | 65.00 |
| TOL | 10.00 | SUL | 33.00 | BFTE | 57.00 |
| TOL | 10.00 | SUL | 50.00 | BFTE | 40.00 |
| TOL | 10.00 | SUL | 65.00 | BFTE | 25.00 |
| TOL | 10.00 | SUL | 15.00 | FDMB | 75.00 |
| TOL | 10.00 | SUL | 25.00 | FDMB | 65.00 |
| TOL | 10.00 | SUL | 33.00 | FDMB | 57.00 |
| TOL | 10.00 | SUL | 50.00 | FDMB | 40.00 |
| TOL | 10.00 | SUL | 65.00 | FDMB | 25.00 |
| TOL | 10.00 | SUL | 15.00 | ISDN | 75.00 |
| TOL | 10.00 | SUL | 25.00 | ISDN | 65.00 |
| TOL | 10.00 | SUL | 33.00 | ISDN | 57.00 |
| TOL | 10.00 | SUL | 50.00 | ISDN | 40.00 |
| TOL | 10.00 | SUL | 65.00 | ISDN | 25.00 |
| TOL | 10.00 | SUL | 15.00 | TTE | 75.00 |
| TOL | 10.00 | SUL | 25.00 | TTE | 65.00 |
| TOL | 10.00 | SUL | 33.00 | TTE | 57.00 |
| TOL | 10.00 | SUL | 50.00 | TTE | 40.00 |
| TOL | 10.00 | SUL | 65.00 | TTE | 25.00 |
| TOL | 25.00 | DME | 15.00 | BFE | 60.00 |
| TOL | 25.00 | DME | 25.00 | BFE | 50.00 |
| TOL | 25.00 | DME | 33.00 | BFE | 42.00 |
| TOL | 25.00 | DME | 50.00 | BFE | 25.00 |
| TOL | 25.00 | DME | 15.00 | 3FP | 60.00 |
| TOL | 25.00 | DME | 25.00 | 3FP | 50.00 |
| TOL | 25.00 | DME | 33.00 | 3FP | 42.00 |
| TOL | 25.00 | DME | 50.00 | 3FP | 25.00 |
| TOL | 25.00 | DME | 15.00 | BFTE | 60.00 |
| TOL | 25.00 | DME | 25.00 | BFTE | 50.00 |
| TOL | 25.00 | DME | 33.00 | BFTE | 42.00 |
| TOL | 25.00 | DME | 50.00 | BFTE | 25.00 |
| TOL | 25.00 | DME | 15.00 | FDMB | 60.00 |
| TOL | 25.00 | DME | 25.00 | FDMB | 50.00 |
| TOL | 25.00 | DME | 33.00 | FDMB | 42.00 |
| TOL | 25.00 | DME | 50.00 | FDMB | 25.00 |
| TOL | 25.00 | DME | 15.00 | ISDN | 60.00 |
| TOL | 25.00 | DME | 25.00 | ISDN | 50.00 |
| TOL | 25.00 | DME | 33.00 | ISDN | 42.00 |
| TOL | 25.00 | DME | 50.00 | ISDN | 25.00 |
| TOL | 25.00 | DME | 15.00 | TTE | 60.00 |
| TOL | 25.00 | DME | 25.00 | TTE | 50.00 |
| TOL | 25.00 | DME | 33.00 | TTE | 42.00 |
| TOL | 25.00 | DME | 50.00 | TTE | 25.00 |
| TOL | 25.00 | DOL | 15.00 | BFE | 60.00 |
| TOL | 25.00 | DOL | 25.00 | BFE | 50.00 |
| TOL | 25.00 | DOL | 33.00 | BFE | 42.00 |
| TOL | 25.00 | DOL | 50.00 | BFE | 25.00 |
| TOL | 25.00 | DOL | 15.00 | 3FP | 60.00 |
| TOL | 25.00 | DOL | 25.00 | 3FP | 50.00 |
| TOL | 25.00 | DOL | 33.00 | 3FP | 42.00 |
| TOL | 25.00 | DOL | 50.00 | 3FP | 25.00 |
| TOL | 25.00 | DOL | 15.00 | BFTE | 60.00 |
| TOL | 25.00 | DOL | 25.00 | BFTE | 50.00 |
| TOL | 25.00 | DOL | 33.00 | BFTE | 42.00 |
| TOL | 25.00 | DOL | 50.00 | BFTE | 25.00 |
| TOL | 25.00 | DOL | 15.00 | FDMB | 60.00 |
| TOL | 25.00 | DOL | 25.00 | FDMB | 50.00 |
| TOL | 25.00 | DOL | 33.00 | FDMB | 42.00 |
| TOL | 25.00 | DOL | 50.00 | FDMB | 25.00 |
| TOL | 25.00 | DOL | 15.00 | ISDN | 60.00 |
| TOL | 25.00 | DOL | 25.00 | ISDN | 50.00 |
| TOL | 25.00 | DOL | 33.00 | ISDN | 42.00 |
| TOL | 25.00 | DOL | 50.00 | ISDN | 25.00 |
| TOL | 25.00 | DOL | 15.00 | TTE | 60.00 |
| TOL | 25.00 | DOL | 25.00 | TTE | 50.00 |
| TOL | 25.00 | DOL | 33.00 | TTE | 42.00 |
| TOL | 25.00 | DOL | 50.00 | TTE | 25.00 |
| TOL | 25.00 | SUL | 15.00 | BFE | 60.00 |
| TOL | 25.00 | SUL | 25.00 | BFE | 50.00 |
| TOL | 25.00 | SUL | 33.00 | BFE | 42.00 |
| TOL | 25.00 | SUL | 50.00 | BFE | 25.00 |
| TOL | 25.00 | SUL | 15.00 | 3FP | 60.00 |
| TOL | 25.00 | SUL | 25.00 | 3FP | 50.00 |
| TOL | 25.00 | SUL | 33.00 | 3FP | 42.00 |
| TOL | 25.00 | SUL | 50.00 | 3FP | 25.00 |
| TOL | 25.00 | SUL | 15.00 | BFTE | 60.00 |
| TOL | 25.00 | SUL | 25.00 | BFTE | 50.00 |
| TOL | 25.00 | SUL | 33.00 | BFTE | 42.00 |
| TOL | 25.00 | SUL | 50.00 | BFTE | 25.00 |
| TOL | 25.00 | SUL | 15.00 | FDMB | 60.00 |
| TOL | 25.00 | SUL | 25.00 | FDMB | 50.00 |
| TOL | 25.00 | SUL | 33.00 | FDMB | 42.00 |
| TOL | 25.00 | SUL | 50.00 | FDMB | 25.00 |
| TOL | 25.00 | SUL | 15.00 | ISDN | 60.00 |
| TOL | 25.00 | SUL | 25.00 | ISDN | 50.00 |
| TOL | 25.00 | SUL | 33.00 | ISDN | 42.00 |
| TOL | 25.00 | SUL | 50.00 | ISDN | 25.00 |
| TOL | 25.00 | SUL | 15.00 | TTE | 60.00 |
| TOL | 25.00 | SUL | 25.00 | TTE | 50.00 |
| TOL | 25.00 | SUL | 33.00 | TTE | 42.00 |
| TOL | 25.00 | SUL | 50.00 | TTE | 25.00 |
| TOL | 33.00 | DME | 15.00 | BFE | 52.00 |
| TOL | 33.00 | DME | 25.00 | BFE | 42.00 |
| TOL | 33.00 | DME | 33.00 | BFE | 34.00 |
| TOL | 33.00 | DME | 50.00 | BFE | 17.00 |
| TOL | 33.00 | DME | 15.00 | 3FP | 52.00 |
| TOL | 33.00 | DME | 25.00 | 3FP | 42.00 |
| TOL | 33.00 | DME | 33.00 | 3FP | 34.00 |
| TOL | 33.00 | DME | 50.00 | 3FP | 17.00 |
| TOL | 33.00 | DME | 15.00 | BFTE | 52.00 |
| TOL | 33.00 | DME | 25.00 | BFTE | 42.00 |
| TOL | 33.00 | DME | 33.00 | BFTE | 34.00 |
| TOL | 33.00 | DME | 50.00 | BFTE | 17.00 |
| TOL | 33.00 | DME | 15.00 | FDMB | 52.00 |
| TOL | 33.00 | DME | 25.00 | FDMB | 42.00 |
| TOL | 33.00 | DME | 33.00 | FDMB | 34.00 |
| TOL | 33.00 | DME | 50.00 | FDMB | 17.00 |
| TOL | 33.00 | DME | 15.00 | ISDN | 52.00 |
| TOL | 33.00 | DME | 25.00 | ISDN | 42.00 |
| TOL | 33.00 | DME | 33.00 | ISDN | 34.00 |
| TOL | 33.00 | DME | 50.00 | ISDN | 17.00 |
| TOL | 33.00 | DME | 15.00 | TTE | 52.00 |
| TOL | 33.00 | DME | 25.00 | TTE | 42.00 |
| TOL | 33.00 | DME | 33.00 | TTE | 34.00 |
| TOL | 33.00 | DME | 50.00 | TTE | 17.00 |
| TOL | 33.00 | DOL | 15.00 | BFE | 52.00 |
| TOL | 33.00 | DOL | 25.00 | BFE | 42.00 |
| TOL | 33.00 | DOL | 33.00 | BFE | 34.00 |
| TOL | 33.00 | DOL | 50.00 | BFE | 17.00 |
| TOL | 33.00 | DOL | 15.00 | 3FP | 52.00 |
| TOL | 33.00 | DOL | 25.00 | 3FP | 42.00 |
| TOL | 33.00 | DOL | 33.00 | 3FP | 34.00 |
| TOL | 33.00 | DOL | 50.00 | 3FP | 17.00 |
| TOL | 33.00 | DOL | 15.00 | BFTE | 52.00 |
| TOL | 33.00 | DOL | 25.00 | BFTE | 42.00 |
| TOL | 33.00 | DOL | 33.00 | BFTE | 34.00 |
| TOL | 33.00 | DOL | 50.00 | BFTE | 17.00 |
| TOL | 33.00 | DOL | 15.00 | FDMB | 52.00 |
| TOL | 33.00 | DOL | 25.00 | FDMB | 42.00 |
| TOL | 33.00 | DOL | 33.00 | FDMB | 34.00 |
| TOL | 33.00 | DOL | 50.00 | FDMB | 17.00 |
| TOL | 33.00 | DOL | 15.00 | ISDN | 52.00 |
| TOL | 33.00 | DOL | 25.00 | ISDN | 42.00 |
| TOL | 33.00 | DOL | 33.00 | ISDN | 34.00 |
| TOL | 33.00 | DOL | 50.00 | ISDN | 17.00 |
| TOL | 33.00 | DOL | 15.00 | TTE | 52.00 |
| TOL | 33.00 | DOL | 25.00 | TTE | 42.00 |
| TOL | 33.00 | DOL | 33.00 | TTE | 34.00 |
| TOL | 33.00 | DOL | 50.00 | TTE | 17.00 |
| TOL | 33.00 | SUL | 15.00 | BFE | 52.00 |
| TOL | 33.00 | SUL | 25.00 | BFE | 42.00 |
| TOL | 33.00 | SUL | 33.00 | BFE | 34.00 |
| TOL | 33.00 | SUL | 50.00 | BFE | 17.00 |
| TOL | 33.00 | SUL | 15.00 | 3FP | 52.00 |
| TOL | 33.00 | SUL | 25.00 | 3FP | 42.00 |
| TOL | 33.00 | SUL | 33.00 | 3FP | 34.00 |
| TOL | 33.00 | SUL | 50.00 | 3FP | 17.00 |
| TOL | 33.00 | SUL | 15.00 | BFTE | 52.00 |
| TOL | 33.00 | SUL | 25.00 | BFTE | 42.00 |
| TOL | 33.00 | SUL | 33.00 | BFTE | 34.00 |
| TOL | 33.00 | SUL | 50.00 | BFTE | 17.00 |
| TOL | 33.00 | SUL | 15.00 | FDMB | 52.00 |
| TOL | 33.00 | SUL | 25.00 | FDMB | 42.00 |
| TOL | 33.00 | SUL | 33.00 | FDMB | 34.00 |
| TOL | 33.00 | SUL | 50.00 | FDMB | 17.00 |
| TOL | 33.00 | SUL | 15.00 | ISDN | 52.00 |
| TOL | 33.00 | SUL | 25.00 | ISDN | 42.00 |
| TOL | 33.00 | SUL | 33.00 | ISDN | 34.00 |
| TOL | 33.00 | SUL | 50.00 | ISDN | 17.00 |
| TOL | 33.00 | SUL | 15.00 | TTE | 52.00 |
| TOL | 33.00 | SUL | 25.00 | TTE | 42.00 |
| TOL | 33.00 | SUL | 33.00 | TTE | 34.00 |
| TOL | 33.00 | SUL | 50.00 | TTE | 17.00 |
| TOL | 50.00 | DME | 10.00 | BFE | 40.00 |
| TOL | 50.00 | DME | 25.00 | BFE | 25.00 |
| TOL | 50.00 | DME | 33.00 | BFE | 17.00 |
| TOL | 50.00 | DME | 15.00 | 3FP | 35.00 |
| TOL | 50.00 | DME | 25.00 | 3FP | 25.00 |
| TOL | 50.00 | DME | 33.00 | 3FP | 17.00 |
| TOL | 50.00 | DME | 15.00 | BFTE | 35.00 |
| TOL | 50.00 | DME | 25.00 | BFTE | 25.00 |
| TOL | 50.00 | DME | 33.00 | BFTE | 17.00 |
| TOL | 50.00 | DME | 15.00 | FDMB | 35.00 |
| TOL | 50.00 | DME | 25.00 | FDMB | 25.00 |
| TOL | 50.00 | DME | 33.00 | FDMB | 17.00 |
| TOL | 50.00 | DME | 15.00 | ISDN | 35.00 |
| TOL | 50.00 | DME | 25.00 | ISDN | 25.00 |
| TOL | 50.00 | DME | 33.00 | ISDN | 17.00 |
| TOL | 50.00 | DME | 15.00 | TTE | 35.00 |
| TOL | 50.00 | DME | 25.00 | TTE | 25.00 |
| TOL | 50.00 | DME | 33.00 | TTE | 17.00 |
| TOL | 50.00 | DOL | 15.00 | BFE | 35.00 |
| TOL | 50.00 | DOL | 25.00 | BFE | 25.00 |
| TOL | 50.00 | DOL | 33.00 | BFE | 17.00 |
| TOL | 50.00 | DOL | 15.00 | 3FP | 35.00 |
| TOL | 50.00 | DOL | 25.00 | 3FP | 25.00 |
| TOL | 50.00 | DOL | 33.00 | 3FP | 17.00 |
| TOL | 50.00 | DOL | 15.00 | BFTE | 35.00 |
| TOL | 50.00 | DOL | 25.00 | BFTE | 25.00 |
| TOL | 50.00 | DOL | 33.00 | BFTE | 17.00 |
| TOL | 50.00 | DOL | 15.00 | FDMB | 35.00 |
| TOL | 50.00 | DOL | 25.00 | FDMB | 25.00 |
| TOL | 50.00 | DOL | 33.00 | FDMB | 17.00 |
| TOL | 50.00 | DOL | 15.00 | ISDN | 35.00 |
| TOL | 50.00 | DOL | 25.00 | ISDN | 25.00 |
| TOL | 50.00 | DOL | 33.00 | ISDN | 17.00 |
| TOL | 50.00 | DOL | 15.00 | TTE | 35.00 |
| TOL | 50.00 | DOL | 25.00 | TTE | 25.00 |
| TOL | 50.00 | DOL | 33.00 | TTE | 17.00 |
| TOL | 50.00 | SUL | 15.00 | BFE | 35.00 |
| TOL | 50.00 | SUL | 25.00 | BFE | 25.00 |
| TOL | 50.00 | SUL | 33.00 | BFE | 17.00 |
| TOL | 50.00 | SUL | 15.00 | 3FP | 35.00 |
| TOL | 50.00 | SUL | 25.00 | 3FP | 25.00 |
| TOL | 50.00 | SUL | 33.00 | 3FP | 17.00 |
| TOL | 50.00 | SUL | 15.00 | BFTE | 35.00 |
| TOL | 50.00 | SUL | 25.00 | BFTE | 25.00 |
| TOL | 50.00 | SUL | 33.00 | BFTE | 17.00 |
| TOL | 50.00 | SUL | 15.00 | FDMB | 35.00 |
| TOL | 50.00 | SUL | 25.00 | FDMB | 25.00 |
| TOL | 50.00 | SUL | 33.00 | FDMB | 17.00 |
| TOL | 50.00 | SUL | 15.00 | ISDN | 35.00 |
| TOL | 50.00 | SUL | 25.00 | ISDN | 25.00 |
| TOL | 50.00 | SUL | 33.00 | ISDN | 17.00 |
| TOL | 50.00 | SUL | 15.00 | TTE | 35.00 |
| TOL | 50.00 | SUL | 25.00 | TTE | 25.00 |
| TOL | 50.00 | SUL | 33.00 | TTE | 17.00 |

TABLE 3
Exemplary Additional Components

| Li-Ion | Conc. | Li-Ion | Conc. | | Conc. |
|---|---|---|---|---|---|
| Transport | (mol/ | Transport | (mol/ | | (mol/ |
| Compound 1 | L) | Compound 2 | L) | Enhancer | L) |
| lithium | 0.10 | none | 0.00 | guanidine | 0.10 |
| bis(trifluoro- | | | | nitrate | |
| methane | | | | | |
| sulfonyl)imide | | | | | |
| (LiTFSI) | | | | | |
| LiTFSI | 0.25 | none | 0.00 | guanidine | 0.10 |
| | | | | nitrate | |
| LiTFSI | 0.40 | none | 0.00 | guanidine | 0.10 |
| | | | | nitrate | |
| LiTFSI | 0.50 | none | 0.00 | guanidine | 0.10 |
| | | | | nitrate | |
| LiTFSI | 0.66 | none | 0.00 | guanidine | 0.10 |
| | | | | nitrate | |
| LiTFSI | 0.75 | none | 0.00 | guanidine | 0.10 |
| | | | | nitrate | |
| LiTFSI | 1.00 | none | 0.00 | guanidine | 0.10 |
| | | | | nitrate | |
| LiTFSI | 0.10 | none | 0.00 | guanidine | 0.15 |
| | | | | nitrate | |
| LiTFSI | 0.25 | none | 0.00 | guanidine | 0.15 |
| | | | | nitrate | |
| LiTFSI | 0.40 | none | 0.00 | guanidine | 0.15 |
| | | | | nitrate | |
| LiTFSI | 0.50 | none | 0.00 | guanidine | 0.15 |
| | | | | nitrate | |
| LiTFSI | 0.66 | none | 0.00 | guanidine | 0.15 |
| | | | | nitrate | |
| LiTFSI | 0.75 | none | 0.00 | guanidine | 0.15 |
| | | | | nitrate | |
| LiTFSI | 1.00 | none | 0.00 | guanidine | 0.15 |
| | | | | nitrate | |
| LiTFSI | 0.10 | lithium | 0.10 | dicyanide | 0.10 |
| | | nitrate | | diamide | |
| | | (LiNO₃) | | (DCDA) | |
| LiTFSI | 0.10 | LiNO₃ | 0.25 | DCDA | 0.10 |
| LiTFSI | 0.10 | LiNO₃ | 0.33 | DCDA | 0.10 |
| LiTFSI | 0.10 | LiNO₃ | 0.50 | DCDA | 0.10 |
| LiTFSI | 0.10 | LiNO₃ | 0.66 | DCDA | 0.10 |
| LiTFSI | 0.10 | LiNO₃ | 0.75 | DCDA | 0.10 |
| LiTFSI | 0.10 | LiNO₃ | 1.00 | DCDA | 0.10 |
| LiTFSI | 0.10 | LiNO₃ | 0.10 | DCDA | 0.15 |
| LiTFSI | 0.10 | LiNO₃ | 0.25 | DCDA | 0.15 |
| LiTFSI | 0.10 | LiNO₃ | 0.33 | DCDA | 0.15 |
| LiTFSI | 0.10 | LiNO₃ | 0.50 | DCDA | 0.15 |
| LiTFSI | 0.10 | LiNO₃ | 0.66 | DCDA | 0.15 |
| LiTFSI | 0.10 | LiNO₃ | 0.75 | DCDA | 0.15 |
| LiTFSI | 0.10 | LiNO₃ | 1.00 | DCDA | 0.15 |
| LiTFSI | 0.25 | LiNO₃ | 0.10 | DCDA | 0.10 |
| LiTFSI | 0.25 | LiNO₃ | 0.25 | DCDA | 0.10 |
| LiTFSI | 0.25 | LiNO₃ | 0.33 | DCDA | 0.10 |
| LiTFSI | 0.25 | LiNO₃ | 0.50 | DCDA | 0.10 |
| LiTFSI | 0.25 | LiNO₃ | 0.66 | DCDA | 0.10 |
| LiTFSI | 0.25 | LiNO₃ | 0.75 | DCDA | 0.10 |
| LiTFSI | 0.25 | LiNO₃ | 1.00 | DCDA | 0.10 |
| LiTFSI | 0.25 | LiNO₃ | 0.10 | DCDA | 0.15 |
| LiTFSI | 0.25 | LiNO₃ | 0.25 | DCDA | 0.15 |
| LiTFSI | 0.25 | LiNO₃ | 0.33 | DCDA | 0.15 |
| LiTFSI | 0.25 | LiNO₃ | 0.50 | DCDA | 0.15 |
| LiTFSI | 0.25 | LiNO₃ | 0.66 | DCDA | 0.15 |
| LiTFSI | 0.25 | LiNO₃ | 0.75 | DCDA | 0.15 |
| LiTFSI | 0.25 | LiNO₃ | 1.00 | DCDA | 0.15 |
| LiTFSI | 0.40 | LiNO₃ | 0.10 | DCDA | 0.10 |
| LiTFSI | 0.40 | LiNO₃ | 0.25 | DCDA | 0.10 |
| LiTFSI | 0.40 | LiNO₃ | 0.33 | DCDA | 0.10 |
| LiTFSI | 0.40 | LiNO₃ | 0.50 | DCDA | 0.10 |
| LiTFSI | 0.40 | LiNO₃ | 0.66 | DCDA | 0.10 |
| LiTFSI | 0.40 | LiNO₃ | 0.75 | DCDA | 0.10 |
| LiTFSI | 0.40 | LiNO₃ | 1.00 | DCDA | 0.10 |
| LiTFSI | 0.40 | LiNO₃ | 0.10 | DCDA | 0.15 |
| LiTFSI | 0.40 | LiNO₃ | 0.25 | DCDA | 0.15 |
| LiTFSI | 0.40 | LiNO₃ | 0.33 | DCDA | 0.15 |
| LiTFSI | 0.40 | LiNO₃ | 0.50 | DCDA | 0.15 |
| LiTFSI | 0.40 | LiNO₃ | 0.66 | DCDA | 0.15 |
| LiTFSI | 0.40 | LiNO₃ | 0.75 | DCDA | 0.15 |
| LiTFSI | 0.40 | LiNO₃ | 1.00 | DCDA | 0.15 |
| LiTFSI | 0.50 | LiNO₃ | 0.10 | DCDA | 0.10 |
| LiTFSI | 0.50 | LiNO₃ | 0.25 | DCDA | 0.10 |
| LiTFSI | 0.50 | LiNO₃ | 0.33 | DCDA | 0.10 |
| LiTFSI | 0.50 | LiNO₃ | 0.50 | DCDA | 0.10 |
| LiTFSI | 0.50 | LiNO₃ | 0.66 | DCDA | 0.10 |
| LiTFSI | 0.50 | LiNO₃ | 0.75 | DCDA | 0.10 |
| LiTFSI | 0.50 | LiNO₃ | 1.00 | DCDA | 0.10 |
| LiTFSI | 0.50 | LiNO₃ | 0.10 | DCDA | 0.15 |
| LiTFSI | 0.50 | LiNO₃ | 0.25 | DCDA | 0.15 |
| LiTFSI | 0.50 | LiNO₃ | 0.33 | DCDA | 0.15 |
| LiTFSI | 0.50 | LiNO₃ | 0.50 | DCDA | 0.15 |
| LiTFSI | 0.50 | LiNO₃ | 0.66 | DCDA | 0.15 |
| LiTFSI | 0.50 | LiNO₃ | 0.75 | DCDA | 0.15 |
| LiTFSI | 0.50 | LiNO₃ | 1.00 | DCDA | 0.15 |
| LiTFSI | 0.66 | LiNO₃ | 0.10 | DCDA | 0.10 |
| LiTFSI | 0.66 | LiNO₃ | 0.25 | DCDA | 0.10 |
| LiTFSI | 0.66 | LiNO₃ | 0.33 | DCDA | 0.10 |
| LiTFSI | 0.66 | LiNO₃ | 0.50 | DCDA | 0.10 |
| LiTFSI | 0.66 | LiNO₃ | 0.66 | DCDA | 0.10 |
| LiTFSI | 0.66 | LiNO₃ | 0.75 | DCDA | 0.10 |
| LiTFSI | 0.66 | LiNO₃ | 1.00 | DCDA | 0.10 |
| LiTFSI | 0.66 | LiNO₃ | 0.10 | DCDA | 0.15 |
| LiTFSI | 0.66 | LiNO₃ | 0.25 | DCDA | 0.15 |
| LiTFSI | 0.66 | LiNO₃ | 0.33 | DCDA | 0.15 |
| LiTFSI | 0.66 | LiNO₃ | 0.50 | DCDA | 0.15 |
| LiTFSI | 0.66 | LiNO₃ | 0.66 | DCDA | 0.15 |
| LiTFSI | 0.66 | LiNO₃ | 0.75 | DCDA | 0.15 |
| LiTFSI | 0.66 | LiNO₃ | 1.00 | DCDA | 0.15 |
| LiTFSI | 0.75 | LiNO₃ | 0.10 | DCDA | 0.10 |
| LiTFSI | 0.75 | LiNO₃ | 0.25 | DCDA | 0.10 |
| LiTFSI | 0.75 | LiNO₃ | 0.33 | DCDA | 0.10 |
| LiTFSI | 0.75 | LiNO₃ | 0.50 | DCDA | 0.10 |
| LiTFSI | 0.75 | LiNO₃ | 0.66 | DCDA | 0.10 |
| LiTFSI | 0.75 | LiNO₃ | 0.75 | DCDA | 0.10 |
| LiTFSI | 0.75 | LiNO₃ | 1.00 | DCDA | 0.10 |
| LiTFSI | 0.75 | LiNO₃ | 0.10 | DCDA | 0.15 |
| LiTFSI | 0.75 | LiNO₃ | 0.25 | DCDA | 0.15 |
| LiTFSI | 0.75 | LiNO₃ | 0.33 | DCDA | 0.15 |
| LiTFSI | 0.75 | LiNO₃ | 0.50 | DCDA | 0.15 |
| LiTFSI | 0.75 | LiNO₃ | 0.66 | DCDA | 0.15 |
| LiTFSI | 0.75 | LiNO₃ | 0.75 | DCDA | 0.15 |
| LiTFSI | 0.75 | LiNO₃ | 1.00 | DCDA | 0.15 |
| LiTFSI | 1.00 | LiNO₃ | 0.10 | DCDA | 0.10 |
| LiTFSI | 1.00 | LiNO₃ | 0.25 | DCDA | 0.10 |
| LiTFSI | 1.00 | LiNO₃ | 0.33 | DCDA | 0.10 |
| LiTFSI | 1.00 | LiNO₃ | 0.50 | DCDA | 0.10 |
| LiTFSI | 1.00 | LiNO₃ | 0.66 | DCDA | 0.10 |
| LiTFSI | 1.00 | LiNO₃ | 0.75 | DCDA | 0.10 |
| LiTFSI | 1.00 | LiNO₃ | 1.00 | DCDA | 0.10 |
| LiTFSI | 1.00 | LiNO₃ | 0.10 | DCDA | 0.15 |
| LiTFSI | 1.00 | LiNO₃ | 0.25 | DCDA | 0.15 |
| LiTFSI | 1.00 | LiNO₃ | 0.33 | DCDA | 0.15 |
| LiTFSI | 1.00 | LiNO₃ | 0.50 | DCDA | 0.15 |
| LiTFSI | 1.00 | LiNO₃ | 0.66 | DCDA | 0.15 |
| LiTFSI | 1.00 | LiNO₃ | 0.75 | DCDA | 0.15 |
| LiTFSI | 1.00 | LiNO₃ | 1.00 | DCDA | 0.15 |
| LiTFSI | 0.10 | lithium | 0.10 | guanine | 0.10 |
| | | Perchlorate | | | |
| | | (LiClO₄) | | | |
| LiTFSI | 0.10 | LiClO₄ | 0.25 | guanine | 0.10 |
| LiTFSI | 0.10 | LiClO₄ | 0.33 | guanine | 0.10 |
| LiTFSI | 0.10 | LiClO₄ | 0.50 | guanine | 0.10 |
| LiTFSI | 0.10 | LiClO₄ | 0.66 | guanine | 0.10 |
| LiTFSI | 0.10 | LiClO₄ | 0.75 | guanine | 0.10 |
| LiTFSI | 0.10 | LiClO₄ | 1.00 | guanine | 0.10 |
| LiTFSI | 0.10 | LiClO₄ | 0.10 | guanine | 0.15 |
| LiTFSI | 0.10 | LiClO₄ | 0.25 | guanine | 0.15 |
| LiTFSI | 0.10 | LiClO₄ | 0.33 | guanine | 0.15 |
| LiTFSI | 0.10 | LiClO₄ | 0.50 | guanine | 0.15 |
| LiTFSI | 0.10 | LiClO₄ | 0.66 | guanine | 0.15 |
| LiTFSI | 0.10 | LiClO₄ | 0.75 | guanine | 0.15 |
| LiTFSI | 0.10 | LiClO₄ | 1.00 | guanine | 0.15 |
| LiTFSI | 0.25 | LiClO₄ | 0.10 | guanine | 0.10 |
| LiTFSI | 0.25 | LiClO₄ | 0.25 | guanine | 0.10 |
| LiTFSI | 0.25 | LiClO₄ | 0.33 | guanine | 0.10 |
| LiTFSI | 0.25 | LiClO₄ | 0.50 | guanine | 0.10 |
| LiTFSI | 0.25 | LiClO₄ | 0.66 | guanine | 0.10 |
| LiTFSI | 0.25 | LiClO₄ | 0.75 | guanine | 0.10 |
| LiTFSI | 0.25 | LiClO₄ | 1.00 | guanine | 0.10 |
| LiTFSI | 0.25 | LiClO₄ | 0.10 | guanine | 0.15 |
| LiTFSI | 0.25 | LiClO₄ | 0.25 | guanine | 0.15 |
| LiTFSI | 0.25 | LiClO₄ | 0.33 | guanine | 0.15 |
| LiTFSI | 0.25 | LiClO₄ | 0.50 | guanine | 0.15 |
| LiTFSI | 0.25 | LiClO₄ | 0.66 | guanine | 0.15 |
| LiTFSI | 0.25 | LiClO₄ | 0.75 | guanine | 0.15 |
| LiTFSI | 0.25 | LiClO₄ | 1.00 | guanine | 0.15 |
| LiTFSI | 0.40 | LiClO₄ | 0.10 | guanine | 0.10 |
| LiTFSI | 0.40 | LiClO₄ | 0.25 | guanine | 0.10 |
| LiTFSI | 0.40 | LiClO₄ | 0.33 | guanine | 0.10 |
| LiTFSI | 0.40 | LiClO₄ | 0.50 | guanine | 0.10 |
| LiTFSI | 0.40 | LiClO₄ | 0.66 | guanine | 0.10 |
| LiTFSI | 0.40 | LiClO₄ | 0.75 | guanine | 0.10 |
| LiTFSI | 0.40 | LiClO₄ | 1.00 | guanine | 0.10 |
| LiTFSI | 0.40 | LiClO₄ | 0.10 | guanine | 0.15 |
| LiTFSI | 0.40 | LiClO₄ | 0.25 | guanine | 0.15 |
| LiTFSI | 0.40 | LiClO₄ | 0.33 | guanine | 0.15 |
| LiTFSI | 0.40 | LiClO₄ | 0.50 | guanine | 0.15 |
| LiTFSI | 0.40 | LiClO₄ | 0.66 | guanine | 0.15 |
| LiTFSI | 0.40 | LiClO₄ | 0.75 | guanine | 0.15 |
| LiTFSI | 0.40 | LiClO₄ | 1.00 | guanine | 0.15 |
| LiTFSI | 0.50 | LiClO₄ | 0.10 | guanine | 0.10 |
| LiTFSI | 0.50 | LiClO₄ | 0.25 | guanine | 0.10 |
| LiTFSI | 0.50 | LiClO₄ | 0.33 | guanine | 0.10 |
| LiTFSI | 0.50 | LiClO₄ | 0.50 | guanine | 0.10 |
| LiTFSI | 0.50 | LiClO₄ | 0.66 | guanine | 0.10 |
| LiTFSI | 0.50 | LiClO₄ | 0.75 | guanine | 0.10 |
| LiTFSI | 0.50 | LiClO₄ | 1.00 | guanine | 0.10 |
| LiTFSI | 0.50 | LiClO₄ | 0.10 | guanine | 0.15 |
| LiTFSI | 0.50 | LiClO₄ | 0.25 | guanine | 0.15 |
| LiTFSI | 0.50 | LiClO₄ | 0.33 | guanine | 0.15 |
| LiTFSI | 0.50 | LiClO₄ | 0.50 | guanine | 0.15 |
| LiTFSI | 0.50 | LiClO₄ | 0.66 | guanine | 0.15 |
| LiTFSI | 0.50 | LiClO₄ | 0.75 | guanine | 0.15 |
| LiTFSI | 0.50 | LiClO₄ | 1.00 | guanine | 0.15 |
| LiTFSI | 0.66 | LiClO₄ | 0.10 | guanine | 0.10 |
| LiTFSI | 0.66 | LiClO₄ | 0.25 | guanine | 0.10 |
| LiTFSI | 0.66 | LiClO₄ | 0.33 | guanine | 0.10 |
| LiTFSI | 0.66 | LiClO₄ | 0.50 | guanine | 0.10 |
| LiTFSI | 0.66 | LiClO₄ | 0.66 | guanine | 0.10 |
| LiTFSI | 0.66 | LiClO₄ | 0.75 | guanine | 0.10 |
| LiTFSI | 0.66 | LiClO₄ | 1.00 | guanine | 0.10 |
| LiTFSI | 0.66 | LiClO₄ | 0.10 | guanine | 0.15 |
| LiTFSI | 0.66 | LiClO₄ | 0.25 | guanine | 0.15 |
| LiTFSI | 0.66 | LiClO₄ | 0.33 | guanine | 0.15 |
| LiTFSI | 0.66 | LiClO₄ | 0.50 | guanine | 0.15 |
| LiTFSI | 0.66 | LiClO₄ | 0.66 | guanine | 0.15 |
| LiTFSI | 0.66 | LiClO₄ | 0.75 | guanine | 0.15 |
| LiTFSI | 0.66 | LiClO₄ | 1.00 | guanine | 0.15 |
| LiTFSI | 0.75 | LiClO₄ | 0.10 | guanine | 0.10 |
| LiTFSI | 0.75 | LiClO₄ | 0.25 | guanine | 0.10 |
| LiTFSI | 0.75 | LiClO₄ | 0.33 | guanine | 0.10 |
| LiTFSI | 0.75 | LiClO₄ | 0.50 | guanine | 0.10 |
| LiTFSI | 0.75 | LiClO₄ | 0.66 | guanine | 0.10 |
| LiTFSI | 0.75 | LiClO₄ | 0.75 | guanine | 0.10 |
| LiTFSI | 0.75 | LiClO₄ | 1.00 | guanine | 0.10 |
| LiTFSI | 0.75 | LiClO₄ | 0.10 | guanine | 0.15 |
| LiTFSI | 0.75 | LiClO₄ | 0.25 | guanine | 0.15 |
| LiTFSI | 0.75 | LiClO₄ | 0.33 | guanine | 0.15 |
| LiTFSI | 0.75 | LiClO₄ | 0.50 | guanine | 0.15 |
| LiTFSI | 0.75 | LiClO₄ | 0.66 | guanine | 0.15 |
| LiTFSI | 0.75 | LiClO₄ | 0.75 | guanine | 0.15 |
| LiTFSI | 0.75 | LiClO₄ | 1.00 | guanine | 0.15 |
| LiTFSI | 1.00 | LiClO₄ | 0.10 | guanine | 0.10 |
| LiTFSI | 1.00 | LiClO₄ | 0.25 | guanine | 0.10 |
| LiTFSI | 1.00 | LiClO₄ | 0.33 | guanine | 0.10 |
| LiTFSI | 1.00 | LiClO₄ | 0.50 | guanine | 0.10 |
| LiTFSI | 1.00 | LiClO₄ | 0.66 | guanine | 0.10 |
| LiTFSI | 1.00 | LiClO₄ | 0.75 | guanine | 0.10 |
| LiTFSI | 1.00 | LiClO₄ | 1.00 | guanine | 0.10 |
| LiTFSI | 1.00 | LiClO₄ | 0.10 | guanine | 0.15 |
| LiTFSI | 1.00 | LiClO₄ | 0.25 | guanine | 0.15 |
| LiTFSI | 1.00 | LiClO₄ | 0.33 | guanine | 0.15 |
| LiTFSI | 1.00 | LiClO₄ | 0.50 | guanine | 0.15 |
| LiTFSI | 1.00 | LiClO₄ | 0.66 | guanine | 0.15 |
| LiTFSI | 1.00 | LiClO₄ | 0.75 | guanine | 0.15 |
| LiTFSI | 1.00 | LiClO₄ | 1.00 | guanine | 0.15 |
| LiTFSI | 0.10 | Lithium | 0.10 | guanidine | 0.10 |
| | | trifluoroacetate | | nitrate | |
| | | (LiTFAc) | | | |
| LiTFSI | 0.10 | LiTFAc | 0.25 | guanidine | 0.10 |
| | | | | nitrate | |
| LiTFSI | 0.10 | LiTFAc | 0.33 | guanidine | 0.10 |
| | | | | nitrate | |
| LiTFSI | 0.10 | LiTFAc | 0.50 | guanidine | 0.10 |
| | | | | nitrate | |
| LiTFSI | 0.10 | LiTFAc | 0.66 | guanidine | 0.10 |
| | | | | nitrate | |
| LiTFSI | 0.10 | LiTFAc | 0.75 | guanidine | 0.10 |
| | | | | nitrate | |
| LiTFSI | 0.10 | LiTFAc | 1.00 | guanidine | 0.10 |
| | | | | nitrate | |
| LiTFSI | 0.10 | LiTFAc | 0.10 | guanidine | 0.15 |
| | | | | nitrate | |
| LiTFSI | 0.10 | LiTFAc | 0.25 | guanidine | 0.15 |
| | | | | nitrate | |
| LiTFSI | 0.10 | LiTFAc | 0.33 | guanidine | 0.15 |
| | | | | nitrate | |
| LiTFSI | 0.10 | LiTFAc | 0.50 | guanidine | 0.15 |
| | | | | nitrate | |
| LiTFSI | 0.10 | LiTFAc | 0.66 | guanidine | 0.15 |
| | | | | nitrate | |
| LiTFSI | 0.10 | LiTFAc | 0.75 | guanidine | 0.15 |
| | | | | nitrate | |
| LiTFSI | 0.10 | LiTFAc | 1.00 | guanidine | 0.15 |
| | | | | nitrate | |
| LiTFSI | 0.25 | LiTFAc | 0.10 | guanidine | 0.10 |
| | | | | nitrate | |
| LiTFSI | 0.25 | LiTFAc | 0.25 | guanidine | 0.10 |
| | | | | nitrate | |
| LiTFSI | 0.25 | LiTFAc | 0.33 | guanidine | 0.10 |
| | | | | nitrate | |
| LiTFSI | 0.25 | LiTFAc | 0.50 | guanidine | 0.10 |
| | | | | nitrate | |
| LiTFSI | 0.25 | LiTFAc | 0.66 | guanidine | 0.10 |
| | | | | nitrate | |
| LiTFSI | 0.25 | LiTFAc | 0.75 | guanidine | 0.10 |
| | | | | nitrate | |
| LiTFSI | 0.25 | LiTFAc | 1.00 | guanidine | 0.10 |
| | | | | nitrate | |
| LiTFSI | 0.25 | LiTFAc | 0.10 | guanidine | 0.15 |
| | | | | nitrate | |
| LiTFSI | 0.25 | LiTFAc | 0.25 | guanidine | 0.15 |
| | | | | nitrate | |
| LiTFSI | 0.25 | LiTFAc | 0.33 | guanidine | 0.15 |
| | | | | nitrate | |
| LiTFSI | 0.25 | LiTFAc | 0.50 | guanidine | 0.15 |
| | | | | nitrate | |
| LiTFSI | 0.25 | LiTFAc | 0.66 | guanidine | 0.15 |
| | | | | nitrate | |
| LiTFSI | 0.25 | LiTFAc | 0.75 | guanidine | 0.15 |
| | | | | nitrate | |
| LiTFSI | 0.25 | LiTFAc | 1.00 | guanidine | 0.15 |
| | | | | nitrate | |
| LiTFSI | 0.40 | LiTFAc | 0.10 | guanidine | 0.10 |
| | | | | nitrate | |
| LiTFSI | 0.40 | LiTFAc | 0.25 | guanidine | 0.10 |
| | | | | nitrate | |
| LiTFSI | 0.40 | LiTFAc | 0.33 | guanidine | 0.10 |
| | | | | nitrate | |
| LiTFSI | 0.40 | LiTFAc | 0.50 | guanidine | 0.10 |
| | | | | nitrate | |
| LiTFSI | 0.40 | LiTFAc | 0.66 | guanidine | 0.10 |
| | | | | nitrate | |
| LiTFSI | 0.40 | LiTFAc | 0.75 | guanidine | 0.10 |
| | | | | nitrate | |
| LiTFSI | 0.40 | LiTFAc | 1.00 | guanidine | 0.10 |
| | | | | nitrate | |
| LiTFSI | 0.40 | LiTFAc | 0.10 | guanidine | 0.15 |
| | | | | nitrate | |
| LiTFSI | 0.40 | LiTFAc | 0.25 | guanidine | 0.15 |
| | | | | nitrate | |
| LiTFSI | 0.40 | LiTFAc | 0.33 | guanidine | 0.15 |
| | | | | nitrate | |
| LiTFSI | 0.40 | LiTFAc | 0.50 | guanidine | 0.15 |
| | | | | nitrate | |
| LiTFSI | 0.40 | LiTFAc | 0.66 | guanidine | 0.15 |
| | | | | nitrate | |
| LiTFSI | 0.40 | LiTFAc | 0.75 | guanidine | 0.15 |
| | | | | nitrate | |
| LiTFSI | 0.40 | LiTFAc | 1.00 | guanidine | 0.15 |
| | | | | nitrate | |
| LiTFSI | 0.50 | LiTFAc | 0.10 | guanidine | 0.10 |
| | | | | nitrate | |
| LiTFSI | 0.50 | LiTFAc | 0.25 | guanidine | 0.10 |
| | | | | nitrate | |
| LiTFSI | 0.50 | LiTFAc | 0.33 | guanidine | 0.10 |
| | | | | nitrate | |
| LiTFSI | 0.50 | LiTFAc | 0.50 | guanidine | 0.10 |
| | | | | nitrate | |
| LiTFSI | 0.50 | LiTFAc | 0.66 | guanidine | 0.10 |
| | | | | nitrate | |
| LiTFSI | 0.50 | LiTFAc | 0.75 | guanidine | 0.10 |
| | | | | nitrate | |
| LiTFSI | 0.50 | LiTFAc | 1.00 | guanidine | 0.10 |
| | | | | nitrate | |
| LiTFSI | 0.50 | LiTFAc | 0.10 | guanidine | 0.15 |
| | | | | nitrate | |
| LiTFSI | 0.50 | LiTFAc | 0.25 | guanidine | 0.15 |
| | | | | nitrate | |
| LiTFSI | 0.50 | LiTFAc | 0.33 | guanidine | 0.15 |
| | | | | nitrate | |
| LiTFSI | 0.50 | LiTFAc | 0.50 | guanidine | 0.15 |
| | | | | nitrate | |
| LiTFSI | 0.50 | LiTFAc | 0.66 | guanidine | 0.15 |
| | | | | nitrate | |
| LiTFSI | 0.50 | LiTFAc | 0.75 | guanidine | 0.15 |
| | | | | nitrate | |
| LiTFSI | 0.50 | LiTFAc | 1.00 | guanidine | 0.15 |
| | | | | nitrate | |
| LiTFSI | 0.66 | LiTFAc | 0.10 | guanidine | 0.10 |
| | | | | nitrate | |
| LiTFSI | 0.66 | LiTFAc | 0.25 | guanidine | 0.10 |
| | | | | nitrate | |
| LiTFSI | 0.66 | LiTFAc | 0.33 | guanidine | 0.10 |
| | | | | nitrate | |
| LiTFSI | 0.66 | LiTFAc | 0.50 | guanidine | 0.10 |
| | | | | nitrate | |
| LiTFSI | 0.66 | LiTFAc | 0.66 | guanidine | 0.10 |
| | | | | nitrate | |
| LiTFSI | 0.66 | LiTFAc | 0.75 | guanidine | 0.10 |
| | | | | nitrate | |
| LiTFSI | 0.66 | LiTFAc | 1.00 | guanidine | 0.10 |
| | | | | nitrate | |
| LiTFSI | 0.66 | LiTFAc | 0.10 | guanidine | 0.15 |
| | | | | nitrate | |
| LiTFSI | 0.66 | LiTFAc | 0.25 | guanidine | 0.15 |
| | | | | nitrate | |
| LiTFSI | 0.66 | LiTFAc | 0.33 | guanidine | 0.15 |
| | | | | nitrate | |
| LiTFSI | 0.66 | LiTFAc | 0.50 | guanidine | 0.15 |
| | | | | nitrate | |
| LiTFSI | 0.66 | LiTFAc | 0.66 | guanidine | 0.15 |
| | | | | nitrate | |
| LiTFSI | 0.66 | LiTFAc | 0.75 | guanidine | 0.15 |
| | | | | nitrate | |
| LiTFSI | 0.66 | LiTFAc | 1.00 | guanidine | 0.15 |
| | | | | nitrate | |
| LiTFSI | 0.75 | LiTFAc | 0.10 | guanidine | 0.10 |
| | | | | nitrate | |
| LiTFSI | 0.75 | LiTFAc | 0.25 | guanidine | 0.10 |
| | | | | nitrate | |
| LiTFSI | 0.75 | LiTFAc | 0.33 | guanidine | 0.10 |
| | | | | nitrate | |
| LiTFSI | 0.75 | LiTFAc | 0.50 | guanidine | 0.10 |
| | | | | nitrate | |
| LiTFSI | 0.75 | LiTFAc | 0.66 | guanidine | 0.10 |
| | | | | nitrate | |
| LiTFSI | 0.75 | LiTFAc | 0.75 | guanidine | 0.10 |
| | | | | nitrate | |
| LiTFSI | 0.75 | LiTFAc | 1.00 | guanidine | 0.10 |
| | | | | nitrate | |
| LiTFSI | 0.75 | LiTFAc | 0.10 | guanidine | 0.15 |
| | | | | nitrate | |
| LiTFSI | 0.75 | LiTFAc | 0.25 | guanidine | 0.15 |
| | | | | nitrate | |
| LiTFSI | 0.75 | LiTFAc | 0.33 | guanidine | 0.15 |
| | | | | nitrate | |
| LiTFSI | 0.75 | LiTFAc | 0.50 | guanidine | 0.15 |
| | | | | nitrate | |
| LiTFSI | 0.75 | LiTFAc | 0.66 | guanidine | 0.15 |
| | | | | nitrate | |
| LiTFSI | 0.75 | LiTFAc | 0.75 | guanidine | 0.15 |
| | | | | nitrate | |
| LiTFSI | 0.75 | LiTFAc | 1.00 | guanidine | 0.15 |
| | | | | nitrate | |
| LiTFSI | 1.00 | LiTFAc | 0.10 | guanidine | 0.10 |
| | | | | nitrate | |
| LiTFSI | 1.00 | LiTFAc | 0.25 | guanidine | 0.10 |
| | | | | nitrate | |
| LiTFSI | 1.00 | LiTFAc | 0.33 | guanidine | 0.10 |
| | | | | nitrate | |
| LiTFSI | 1.00 | LiTFAc | 0.50 | guanidine | 0.10 |
| | | | | nitrate | |
| LiTFSI | 1.00 | LiTFAc | 0.66 | guanidine | 0.10 |
| | | | | nitrate | |
| LiTFSI | 1.00 | LiTFAc | 0.75 | guanidine | 0.10 |
| | | | | nitrate | |
| LiTFSI | 1.00 | LiTFAc | 1.00 | guanidine | 0.10 |
| | | | | nitrate | |
| LiTFSI | 1.00 | LiTFAc | 0.10 | guanidine | 0.15 |
| | | | | nitrate | |
| LiTFSI | 1.00 | LiTFAc | 0.25 | guanidine | 0.15 |
| | | | | nitrate | |
| LiTFSI | 1.00 | LiTFAc | 0.33 | guanidine | 0.15 |
| | | | | nitrate | |
| LiTFSI | 1.00 | LiTFAc | 0.50 | guanidine | 0.15 |
| | | | | nitrate | |
| LiTFSI | 1.00 | LiTFAc | 0.66 | guanidine | 0.15 |
| | | | | nitrate | |
| LiTFSI | 1.00 | LiTFAc | 0.75 | guanidine | 0.15 |
| | | | | nitrate | |
| LiTFSI | 1.00 | LiTFAc | 1.00 | guanidine | 0.15 |
| | | | | nitrate | |
| lithium | 0.10 | none | 0.00 | cyanamide | 0.10 |
| bis(fluoro- | | | | | |
| sulfonyl)imide | | | | | |
| (LiFSI) | | | | | |
| LiFSI | 0.25 | none | 0.00 | cyanamide | 0.10 |
| LiFSI | 0.40 | none | 0.00 | cyanamide | 0.10 |
| LiFSI | 0.50 | none | 0.00 | cyanamide | 0.10 |
| LiFSI | 0.66 | none | 0.00 | cyanamide | 0.10 |
| LiFSI | 0.75 | none | 0.00 | cyanamide | 0.10 |
| LiFSI | 1.00 | none | 0.00 | cyanamide | 0.10 |
| LiFSI | 0.10 | none | 0.00 | cyanamide | 0.15 |
| LiFSI | 0.25 | none | 0.00 | cyanamide | 0.15 |
| LiFSI | 0.40 | none | 0.00 | cyanamide | 0.15 |
| LiFSI | 0.50 | none | 0.00 | cyanamide | 0.15 |
| LiFSI | 0.66 | none | 0.00 | cyanamide | 0.15 |
| LiFSI | 0.75 | none | 0.00 | cyanamide | 0.15 |
| LiFSI | 1.00 | none | 0.00 | cyanamide | 0.15 |
| LiFSI | 0.10 | lithium nitrate | 0.10 | cyanamide | 0.10 |
| | | (LiNO₃) | | | |
| LiFSI | 0.10 | LiNO₃ | 0.25 | cyanamide | 0.10 |
| LiFSI | 0.10 | LiNO₃ | 0.33 | cyanamide | 0.10 |
| LiFSI | 0.10 | LiNO₃ | 0.50 | cyanamide | 0.10 |
| LiFSI | 0.10 | LiNO₃ | 0.66 | cyanamide | 0.10 |
| LiFSI | 0.10 | LiNO₃ | 0.75 | cyanamide | 0.10 |
| LiFSI | 0.10 | LiNO₃ | 1.00 | cyanamide | 0.10 |
| LiFSI | 0.10 | LiNO₃ | 0.10 | cyanamide | 0.15 |
| LiFSI | 0.10 | LiNO₃ | 0.25 | cyanamide | 0.15 |
| LiFSI | 0.10 | LiNO₃ | 0.33 | cyanamide | 0.15 |
| LiFSI | 0.10 | LiNO₃ | 0.50 | cyanamide | 0.15 |
| LiFSI | 0.10 | LiNO₃ | 0.66 | cyanamide | 0.15 |
| LiFSI | 0.10 | LiNO₃ | 0.75 | cyanamide | 0.15 |
| LiFSI | 0.10 | LiNO₃ | 1.00 | cyanamide | 0.15 |
| LiFSI | 0.25 | LiNO₃ | 0.10 | cyanamide | 0.10 |
| LiFSI | 0.25 | LiNO₃ | 0.25 | cyanamide | 0.10 |
| LiFSI | 0.25 | LiNO₃ | 0.33 | cyanamide | 0.10 |
| LiFSI | 0.25 | LiNO₃ | 0.50 | cyanamide | 0.10 |
| LiFSI | 0.25 | LiNO₃ | 0.66 | cyanamide | 0.10 |
| LiFSI | 0.25 | LiNO₃ | 0.75 | cyanamide | 0.10 |
| LiFSI | 0.25 | LiNO₃ | 1.00 | cyanamide | 0.10 |
| LiFSI | 0.25 | LiNO₃ | 0.10 | cyanamide | 0.15 |
| LiFSI | 0.25 | LiNO₃ | 0.25 | cyanamide | 0.15 |
| LiFSI | 0.25 | LiNO₃ | 0.33 | cyanamide | 0.15 |
| LiFSI | 0.25 | LiNO₃ | 0.50 | cyanamide | 0.15 |
| LiFSI | 0.25 | LiNO₃ | 0.66 | cyanamide | 0.15 |
| LiFSI | 0.25 | LiNO₃ | 0.75 | cyanamide | 0.15 |
| LiFSI | 0.25 | LiNO₃ | 1.00 | cyanamide | 0.15 |
| LiFSI | 0.40 | LiNO₃ | 0.10 | cyanamide | 0.10 |
| LiFSI | 0.40 | LiNO₃ | 0.25 | cyanamide | 0.10 |
| LiFSI | 0.40 | LiNO₃ | 0.33 | cyanamide | 0.10 |
| LiFSI | 0.40 | LiNO₃ | 0.50 | cyanamide | 0.10 |
| LiFSI | 0.40 | LiNO₃ | 0.66 | cyanamide | 0.10 |
| LiFSI | 0.40 | LiNO₃ | 0.75 | cyanamide | 0.10 |
| LiFSI | 0.40 | LiNO₃ | 1.00 | cyanamide | 0.10 |
| LiFSI | 0.40 | LiNO₃ | 0.10 | cyanamide | 0.15 |
| LiFSI | 0.40 | LiNO₃ | 0.25 | cyanamide | 0.15 |
| LiFSI | 0.40 | LiNO₃ | 0.33 | cyanamide | 0.15 |
| LiFSI | 0.40 | LiNO₃ | 0.50 | cyanamide | 0.15 |
| LiFSI | 0.40 | LiNO₃ | 0.66 | cyanamide | 0.15 |
| LiFSI | 0.40 | LiNO₃ | 0.75 | cyanamide | 0.15 |
| LiFSI | 0.40 | LiNO₃ | 1.00 | cyanamide | 0.15 |
| LiFSI | 0.50 | LiNO₃ | 0.10 | cyanamide | 0.10 |
| LiFSI | 0.50 | LiNO₃ | 0.25 | cyanamide | 0.10 |
| LiFSI | 0.50 | LiNO₃ | 0.33 | cyanamide | 0.10 |
| LiFSI | 0.50 | LiNO₃ | 0.50 | cyanamide | 0.10 |
| LiFSI | 0.50 | LiNO₃ | 0.66 | cyanamide | 0.10 |
| LiFSI | 0.50 | LiNO₃ | 0.75 | cyanamide | 0.10 |
| LiFSI | 0.50 | LiNO₃ | 1.00 | cyanamide | 0.10 |
| LiFSI | 0.50 | LiNO₃ | 0.10 | cyanamide | 0.15 |
| LiFSI | 0.50 | LiNO₃ | 0.25 | cyanamide | 0.15 |
| LiFSI | 0.50 | LiNO₃ | 0.33 | cyanamide | 0.15 |
| LiFSI | 0.50 | LiNO₃ | 0.50 | cyanamide | 0.15 |
| LiFSI | 0.50 | LiNO₃ | 0.66 | cyanamide | 0.15 |
| LiFSI | 0.50 | LiNO₃ | 0.75 | cyanamide | 0.15 |
| LiFSI | 0.50 | LiNO₃ | 1.00 | cyanamide | 0.15 |
| LiFSI | 0.66 | LiNO₃ | 0.10 | cyanamide | 0.10 |
| LiFSI | 0.66 | LiNO₃ | 0.25 | cyanamide | 0.10 |
| LiFSI | 0.66 | LiNO₃ | 0.33 | cyanamide | 0.10 |
| LiFSI | 0.66 | LiNO₃ | 0.50 | cyanamide | 0.10 |
| LiFSI | 0.66 | LiNO₃ | 0.66 | cyanamide | 0.10 |
| LiFSI | 0.66 | LiNO₃ | 0.75 | cyanamide | 0.10 |
| LiFSI | 0.66 | LiNO₃ | 1.00 | cyanamide | 0.10 |
| LiFSI | 0.66 | LiNO₃ | 0.10 | cyanamide | 0.15 |
| LiFSI | 0.66 | LiNO₃ | 0.25 | cyanamide | 0.15 |
| LiFSI | 0.66 | LiNO₃ | 0.33 | cyanamide | 0.15 |
| LiFSI | 0.66 | LiNO₃ | 0.50 | cyanamide | 0.15 |
| LiFSI | 0.66 | LiNO₃ | 0.66 | cyanamide | 0.15 |
| LiFSI | 0.66 | LiNO₃ | 0.75 | cyanamide | 0.15 |
| LiFSI | 0.66 | LiNO₃ | 1.00 | cyanamide | 0.15 |
| LiFSI | 0.75 | LiNO₃ | 0.10 | cyanamide | 0.10 |
| LiFSI | 0.75 | LiNO₃ | 0.25 | cyanamide | 0.10 |
| LiFSI | 0.75 | LiNO₃ | 0.33 | cyanamide | 0.10 |
| LiFSI | 0.75 | LiNO₃ | 0.50 | cyanamide | 0.10 |
| LiFSI | 0.75 | LiNO₃ | 0.66 | cyanamide | 0.10 |
| LiFSI | 0.75 | LiNO₃ | 0.75 | cyanamide | 0.10 |
| LiFSI | 0.75 | LiNO₃ | 1.00 | cyanamide | 0.10 |
| LiFSI | 0.75 | LiNO₃ | 0.10 | cyanamide | 0.15 |
| LiFSI | 0.75 | LiNO₃ | 0.25 | cyanamide | 0.15 |
| LiFSI | 0.75 | LiNO₃ | 0.33 | cyanamide | 0.15 |
| LiFSI | 0.75 | LiNO₃ | 0.50 | cyanamide | 0.15 |
| LiFSI | 0.75 | LiNO₃ | 0.66 | cyanamide | 0.15 |
| LiFSI | 0.75 | LiNO₃ | 0.75 | cyanamide | 0.15 |
| LiFSI | 0.75 | LiNO₃ | 1.00 | cyanamide | 0.15 |
| LiFSI | 1.00 | LiNO₃ | 0.10 | cyanamide | 0.10 |
| LiFSI | 1.00 | LiNO₃ | 0.25 | cyanamide | 0.10 |
| LiFSI | 1.00 | LiNO₃ | 0.33 | cyanamide | 0.10 |
| LiFSI | 1.00 | LiNO₃ | 0.50 | cyanamide | 0.10 |
| LiFSI | 1.00 | LiNO₃ | 0.66 | cyanamide | 0.10 |
| LiFSI | 1.00 | LiNO₃ | 0.75 | cyanamide | 0.10 |
| LiFSI | 1.00 | LiNO₃ | 1.00 | cyanamide | 0.10 |
| LiFSI | 1.00 | LiNO₃ | 0.10 | cyanamide | 0.15 |
| LiFSI | 1.00 | LiNO₃ | 0.25 | cyanamide | 0.15 |
| LiFSI | 1.00 | LiNO₃ | 0.33 | cyanamide | 0.15 |
| LiFSI | 1.00 | LiNO₃ | 0.50 | cyanamide | 0.15 |
| LiFSI | 1.00 | LiNO₃ | 0.66 | cyanamide | 0.15 |
| LiFSI | 1.00 | LiNO₃ | 0.75 | cyanamide | 0.15 |
| LiFSI | 1.00 | LiNO₃ | 1.00 | cyanamide | 0.15 |
| LiFSI | 0.10 | LiClO₄ | 0.10 | cyanamide | 0.10 |
| LiFSI | 0.10 | LiClO₄ | 0.25 | cyanamide | 0.10 |
| LiFSI | 0.10 | LiClO₄ | 0.33 | cyanamide | 0.10 |
| LiFSI | 0.10 | LiClO₄ | 0.50 | cyanamide | 0.10 |
| LiFSI | 0.10 | LiClO₄ | 0.66 | cyanamide | 0.10 |
| LiFSI | 0.10 | LiClO₄ | 0.75 | cyanamide | 0.10 |
| LiFSI | 0.10 | LiClO₄ | 1.00 | cyanamide | 0.10 |
| LiFSI | 0.10 | LiClO₄ | 0.10 | cyanamide | 0.15 |
| LiFSI | 0.10 | LiClO₄ | 0.25 | cyanamide | 0.15 |
| LiFSI | 0.10 | LiClO₄ | 0.33 | cyanamide | 0.15 |
| LiFSI | 0.10 | LiClO₄ | 0.50 | cyanamide | 0.15 |
| LiFSI | 0.10 | LiClO₄ | 0.66 | cyanamide | 0.15 |
| LiFSI | 0.10 | LiClO₄ | 0.75 | cyanamide | 0.15 |
| LiFSI | 0.10 | LiClO₄ | 1.00 | cyanamide | 0.15 |
| LiFSI | 0.25 | LiClO₄ | 0.10 | cyanamide | 0.10 |
| LiFSI | 0.25 | LiClO₄ | 0.25 | cyanamide | 0.10 |
| LiFSI | 0.25 | LiClO₄ | 0.33 | cyanamide | 0.10 |
| LiFSI | 0.25 | LiClO₄ | 0.50 | cyanamide | 0.10 |
| LiFSI | 0.25 | LiClO₄ | 0.66 | cyanamide | 0.10 |
| LiFSI | 0.25 | LiClO₄ | 0.75 | cyanamide | 0.10 |
| LiFSI | 0.25 | LiClO₄ | 1.00 | cyanamide | 0.10 |
| LiFSI | 0.25 | LiClO₄ | 0.10 | cyanamide | 0.15 |
| LiFSI | 0.25 | LiClO₄ | 0.25 | cyanamide | 0.15 |
| LiFSI | 0.25 | LiClO₄ | 0.33 | cyanamide | 0.15 |
| LiFSI | 0.25 | LiClO₄ | 0.50 | cyanamide | 0.15 |
| LiFSI | 0.25 | LiClO₄ | 0.66 | cyanamide | 0.15 |
| LiFSI | 0.25 | LiClO₄ | 0.75 | cyanamide | 0.15 |
| LiFSI | 0.25 | LiClO₄ | 1.00 | cyanamide | 0.15 |
| LiFSI | 0.40 | LiClO₄ | 0.10 | cyanamide | 0.10 |
| LiFSI | 0.40 | LiClO₄ | 0.25 | cyanamide | 0.10 |
| LiFSI | 0.40 | LiClO₄ | 0.33 | cyanamide | 0.10 |
| LiFSI | 0.40 | LiClO₄ | 0.50 | cyanamide | 0.10 |
| LiFSI | 0.40 | LiClO₄ | 0.66 | cyanamide | 0.10 |
| LiFSI | 0.40 | LiClO₄ | 0.75 | cyanamide | 0.10 |
| LiFSI | 0.40 | LiClO₄ | 1.00 | cyanamide | 0.10 |
| LiFSI | 0.40 | LiClO₄ | 0.10 | cyanamide | 0.15 |
| LiFSI | 0.40 | LiClO₄ | 0.25 | cyanamide | 0.15 |
| LiFSI | 0.40 | LiClO₄ | 0.33 | cyanamide | 0.15 |
| LiFSI | 0.40 | LiClO₄ | 0.50 | cyanamide | 0.15 |
| LiFSI | 0.40 | LiClO₄ | 0.66 | cyanamide | 0.15 |
| LiFSI | 0.40 | LiClO₄ | 0.75 | cyanamide | 0.15 |
| LiFSI | 0.40 | LiClO₄ | 1.00 | cyanamide | 0.15 |
| LiFSI | 0.50 | LiClO₄ | 0.10 | cyanamide | 0.10 |
| LiFSI | 0.50 | LiClO₄ | 0.25 | cyanamide | 0.10 |
| LiFSI | 0.50 | LiClO₄ | 0.33 | cyanamide | 0.10 |
| LiFSI | 0.50 | LiClO₄ | 0.50 | cyanamide | 0.10 |
| LiFSI | 0.50 | LiClO₄ | 0.66 | cyanamide | 0.10 |
| LiFSI | 0.50 | LiClO₄ | 0.75 | cyanamide | 0.10 |
| LiFSI | 0.50 | LiClO₄ | 1.00 | cyanamide | 0.10 |
| LiFSI | 0.50 | LiClO₄ | 0.10 | cyanamide | 0.15 |
| LiFSI | 0.50 | LiClO₄ | 0.25 | cyanamide | 0.15 |
| LiFSI | 0.50 | LiClO₄ | 0.33 | cyanamide | 0.15 |
| LiFSI | 0.50 | LiClO₄ | 0.50 | cyanamide | 0.15 |
| LiFSI | 0.50 | LiClO₄ | 0.66 | cyanamide | 0.15 |
| LiFSI | 0.50 | LiClO₄ | 0.75 | cyanamide | 0.15 |
| LiFSI | 0.50 | LiClO₄ | 1.00 | cyanamide | 0.15 |
| LiFSI | 0.66 | LiClO₄ | 0.10 | cyanamide | 0.10 |
| LiFSI | 0.66 | LiClO₄ | 0.25 | cyanamide | 0.10 |
| LiFSI | 0.66 | LiClO₄ | 0.33 | cyanamide | 0.10 |
| LiFSI | 0.66 | LiClO₄ | 0.50 | cyanamide | 0.10 |
| LiFSI | 0.66 | LiClO₄ | 0.66 | cyanamide | 0.10 |
| LiFSI | 0.66 | LiClO₄ | 0.75 | cyanamide | 0.10 |
| LiFSI | 0.66 | LiClO₄ | 1.00 | cyanamide | 0.10 |
| LiFSI | 0.66 | LiClO₄ | 0.10 | cyanamide | 0.15 |
| LiFSI | 0.66 | LiClO₄ | 0.25 | cyanamide | 0.15 |
| LiFSI | 0.66 | LiClO₄ | 0.33 | cyanamide | 0.15 |
| LiFSI | 0.66 | LiClO₄ | 0.50 | cyanamide | 0.15 |
| LiFSI | 0.66 | LiClO₄ | 0.66 | cyanamide | 0.15 |
| LiFSI | 0.66 | LiClO₄ | 0.75 | cyanamide | 0.15 |
| LiFSI | 0.66 | LiClO₄ | 1.00 | cyanamide | 0.15 |
| LiFSI | 0.75 | LiClO₄ | 0.10 | cyanamide | 0.10 |
| LiFSI | 0.75 | LiClO₄ | 0.25 | cyanamide | 0.10 |
| LiFSI | 0.75 | LiClO₄ | 0.33 | cyanamide | 0.10 |
| LiFSI | 0.75 | LiClO₄ | 0.50 | cyanamide | 0.10 |
| LiFSI | 0.75 | LiClO₄ | 0.66 | cyanamide | 0.10 |
| LiFSI | 0.75 | LiClO₄ | 0.75 | cyanamide | 0.10 |
| LiFSI | 0.75 | LiClO₄ | 1.00 | cyanamide | 0.10 |
| LiFSI | 0.75 | LiClO₄ | 0.10 | cyanamide | 0.15 |
| LiFSI | 0.75 | LiClO₄ | 0.25 | cyanamide | 0.15 |
| LiFSI | 0.75 | LiClO₄ | 0.33 | cyanamide | 0.15 |
| LiFSI | 0.75 | LiClO₄ | 0.50 | cyanamide | 0.15 |
| LiFSI | 0.75 | LiClO₄ | 0.66 | cyanamide | 0.15 |
| LiFSI | 0.75 | LiClO₄ | 0.75 | cyanamide | 0.15 |
| LiFSI | 0.75 | LiClO₄ | 1.00 | cyanamide | 0.15 |
| LiFSI | 1.00 | LiClO₄ | 0.10 | cyanamide | 0.10 |
| LiFSI | 1.00 | LiClO₄ | 0.25 | cyanamide | 0.10 |
| LiFSI | 1.00 | LiClO₄ | 0.33 | cyanamide | 0.10 |
| LiFSI | 1.00 | LiClO₄ | 0.50 | cyanamide | 0.10 |
| LiFSI | 1.00 | LiClO₄ | 0.66 | cyanamide | 0.10 |
| LiFSI | 1.00 | LiClO₄ | 0.75 | cyanamide | 0.10 |
| LiFSI | 1.00 | LiClO₄ | 1.00 | cyanamide | 0.10 |
| LiFSI | 1.00 | LiClO₄ | 0.10 | cyanamide | 0.15 |
| LiFSI | 1.00 | LiClO₄ | 0.25 | cyanamide | 0.15 |
| LiFSI | 1.00 | LiClO₄ | 0.33 | cyanamide | 0.15 |
| LiFSI | 1.00 | LiClO₄ | 0.50 | cyanamide | 0.15 |
| LiFSI | 1.00 | LiClO₄ | 0.66 | cyanamide | 0.15 |
| LiFSI | 1.00 | LiClO₄ | 0.75 | cyanamide | 0.15 |
| LiFSI | 1.00 | LiClO₄ | 1.00 | cyanamide | 0.15 |
| LiFSI | 0.10 | Lithium | 0.10 | lithium | 0.10 |
| | | trifluoroacetate | | dicyanamide | |
| | | (LiTFAc) | | | |
| LiFSI | 0.10 | LiTFAc | 0.25 | lithium | 0.10 |
| | | | | dicyanamide | |
| LiFSI | 0.10 | LiTFAc | 0.33 | lithium | 0.10 |
| | | | | dicyanamide | |
| LiFSI | 0.10 | LiTFAc | 0.50 | lithium | 0.10 |
| | | | | dicyanamide | |
| LiFSI | 0.10 | LiTFAc | 0.66 | lithium | 0.10 |
| | | | | dicyanamide | |
| LiFSI | 0.10 | LiTFAc | 0.75 | lithium | 0.10 |
| | | | | dicyanamide | |
| LiFSI | 0.10 | LiTFAc | 1.00 | lithium | 0.10 |
| | | | | dicyanamide | |
| LiFSI | 0.10 | LiTFAc | 0.10 | lithium | 0.15 |
| | | | | dicyanamide | |
| LiFSI | 0.10 | LiTFAc | 0.25 | lithium | 0.15 |
| | | | | dicyanamide | |
| LiFSI | 0.10 | LiTFAc | 0.33 | lithium | 0.15 |
| | | | | dicyanamide | |
| LiFSI | 0.10 | LiTFAc | 0.50 | lithium | 0.15 |
| | | | | dicyanamide | |
| LiFSI | 0.10 | LiTFAc | 0.66 | lithium | 0.15 |
| | | | | dicyanamide | |
| LiFSI | 0.10 | LiTFAc | 0.75 | lithium | 0.15 |
| | | | | dicyanamide | |
| LiFSI | 0.10 | LiTFAc | 1.00 | lithium | 0.15 |
| | | | | dicyanamide | |
| LiFSI | 0.25 | LiTFAc | 0.10 | lithium | 0.10 |
| | | | | dicyanamide | |
| LiFSI | 0.25 | LiTFAc | 0.25 | lithium | 0.10 |
| | | | | dicyanamide | |
| LiFSI | 0.25 | LiTFAc | 0.33 | lithium | 0.10 |
| | | | | dicyanamide | |
| LiFSI | 0.25 | LiTFAc | 0.50 | lithium | 0.10 |
| | | | | dicyanamide | |
| LiFSI | 0.25 | LiTFAc | 0.66 | lithium | 0.10 |
| | | | | dicyanamide | |
| LiFSI | 0.25 | LiTFAc | 0.75 | lithium | 0.10 |
| | | | | dicyanamide | |
| LiFSI | 0.25 | LiTFAc | 1.00 | lithium | 0.10 |
| | | | | dicyanamide | |
| LiFSI | 0.25 | LiTFAc | 0.10 | lithium | 0.15 |
| | | | | dicyanamide | |
| LiFSI | 0.25 | LiTFAc | 0.25 | lithium | 0.15 |
| | | | | dicyanamide | |
| LiFSI | 0.25 | LiTFAc | 0.33 | lithium | 0.15 |
| | | | | dicyanamide | |
| LiFSI | 0.25 | LiTFAc | 0.50 | lithium | 0.15 |
| | | | | dicyanamide | |
| LiFSI | 0.25 | LiTFAc | 0.66 | lithium | 0.15 |
| | | | | dicyanamide | |
| LiFSI | 0.25 | LiTFAc | 0.75 | lithium | 0.15 |
| | | | | dicyanamide | |
| LiFSI | 0.25 | LiTFAc | 1.00 | lithium | 0.15 |
| | | | | dicyanamide | |
| LiFSI | 0.40 | LiTFAc | 0.10 | lithium | 0.10 |
| | | | | dicyanamide | |
| LiFSI | 0.40 | LiTFAc | 0.25 | lithium | 0.10 |
| | | | | dicyanamide | |
| LiFSI | 0.40 | LiTFAc | 0.33 | lithium | 0.10 |
| | | | | dicyanamide | |
| LiFSI | 0.40 | LiTFAc | 0.50 | lithium | 0.10 |
| | | | | dicyanamide | |
| LiFSI | 0.40 | LiTFAc | 0.66 | lithium | 0.10 |
| | | | | dicyanamide | |
| LiFSI | 0.40 | LiTFAc | 0.75 | lithium | 0.10 |
| | | | | dicyanamide | |
| LiFSI | 0.40 | LiTFAc | 1.00 | lithium | 0.10 |
| | | | | dicyanamide | |
| LiFSI | 0.40 | LiTFAc | 0.10 | lithium | 0.15 |
| | | | | dicyanamide | |
| LiFSI | 0.40 | LiTFAc | 0.25 | lithium | 0.15 |
| | | | | dicyanamide | |
| LiFSI | 0.40 | LiTFAc | 0.33 | lithium | 0.15 |
| | | | | dicyanamide | |
| LiFSI | 0.40 | LiTFAc | 0.50 | lithium | 0.15 |
| | | | | dicyanamide | |
| LiFSI | 0.40 | LiTFAc | 0.66 | lithium | 0.15 |
| | | | | dicyanamide | |
| LiFSI | 0.40 | LiTFAc | 0.75 | lithium | 0.15 |
| | | | | dicyanamide | |
| LiFSI | 0.40 | LiTFAc | 1.00 | lithium | 0.15 |
| | | | | dicyanamide | |
| LiFSI | 0.50 | LiTFAc | 0.10 | lithium | 0.10 |
| | | | | dicyanamide | |
| LiFSI | 0.50 | LiTFAc | 0.25 | lithium | 0.10 |
| | | | | dicyanamide | |
| LiFSI | 0.50 | LiTFAc | 0.33 | lithium | 0.10 |
| | | | | dicyanamide | |
| LiFSI | 0.50 | LiTFAc | 0.50 | lithium | 0.10 |
| | | | | dicyanamide | |
| LiFSI | 0.50 | LiTFAc | 0.66 | lithium | 0.10 |
| | | | | dicyanamide | |
| LiFSI | 0.50 | LiTFAc | 0.75 | lithium | 0.10 |
| | | | | dicyanamide | |
| LiFSI | 0.50 | LiTFAc | 1.00 | lithium | 0.10 |
| | | | | dicyanamide | |
| LiFSI | 0.50 | LiTFAc | 0.10 | lithium | 0.15 |
| | | | | dicyanamide | |
| LiFSI | 0.50 | LiTFAc | 0.25 | lithium | 0.15 |
| | | | | dicyanamide | |
| LiFSI | 0.50 | LiTFAc | 0.33 | lithium | 0.15 |
| | | | | dicyanamide | |
| LiFSI | 0.50 | LiTFAc | 0.50 | lithium | 0.15 |
| | | | | dicyanamide | |
| LiFSI | 0.50 | LiTFAc | 0.66 | lithium | 0.15 |
| | | | | dicyanamide | |
| LiFSI | 0.50 | LiTFAc | 0.75 | lithium | 0.15 |
| | | | | dicyanamide | |
| LiFSI | 0.50 | LiTFAc | 1.00 | lithium | 0.15 |
| | | | | dicyanamide | |
| LiFSI | 0.66 | LiTFAc | 0.10 | lithium | 0.10 |
| | | | | dicyanamide | |
| LiFSI | 0.66 | LiTFAc | 0.25 | lithium | 0.10 |
| | | | | dicyanamide | |
| LiFSI | 0.66 | LiTFAc | 0.33 | lithium | 0.10 |
| | | | | dicyanamide | |
| LiFSI | 0.66 | LiTFAc | 0.50 | lithium | 0.10 |
| | | | | dicyanamide | |
| LiFSI | 0.66 | LiTFAc | 0.66 | lithium | 0.10 |
| | | | | dicyanamide | |
| LiFSI | 0.66 | LiTFAc | 0.75 | lithium | 0.10 |
| | | | | dicyanamide | |
| LiFSI | 0.66 | LiTFAc | 1.00 | lithium | 0.10 |
| | | | | dicyanamide | |
| LiFSI | 0.66 | LiTFAc | 0.10 | lithium | 0.15 |
| | | | | dicyanamide | |
| LiFSI | 0.66 | LiTFAc | 0.25 | lithium | 0.15 |
| | | | | dicyanamide | |
| LiFSI | 0.66 | LiTFAc | 0.33 | lithium | 0.15 |
| | | | | dicyanamide | |
| LiFSI | 0.66 | LiTFAc | 0.50 | lithium | 0.15 |
| | | | | dicyanamide | |
| LiFSI | 0.66 | LiTFAc | 0.66 | lithium | 0.15 |
| | | | | dicyanamide | |
| LiFSI | 0.66 | LiTFAc | 0.75 | lithium | 0.15 |
| | | | | dicyanamide | |
| LiFSI | 0.66 | LiTFAc | 1.00 | lithium | 0.15 |
| | | | | dicyanamide | |
| LiFSI | 0.75 | LiTFAc | 0.10 | lithium | 0.10 |
| | | | | dicyanamide | |
| LiFSI | 0.75 | LiTFAc | 0.25 | lithium | 0.10 |
| | | | | dicyanamide | |
| LiFSI | 0.75 | LiTFAc | 0.33 | lithium | 0.10 |
| | | | | dicyanamide | |
| LiFSI | 0.75 | LiTFAc | 0.50 | lithium | 0.10 |
| | | | | dicyanamide | |
| LiFSI | 0.75 | LiTFAc | 0.66 | lithium | 0.10 |
| | | | | dicyanamide | |
| LiFSI | 0.75 | LiTFAc | 0.75 | lithium | 0.10 |
| | | | | dicyanamide | |
| LiFSI | 0.75 | LiTFAc | 1.00 | lithium | 0.10 |
| | | | | dicyanamide | |
| LiFSI | 0.75 | LiTFAc | 0.10 | lithium | 0.15 |
| | | | | dicyanamide | |
| LiFSI | 0.75 | LiTFAc | 0.25 | lithium | 0.15 |
| | | | | dicyanamide | |
| LiFSI | 0.75 | LiTFAc | 0.33 | lithium | 0.15 |
| | | | | dicyanamide | |
| LiFSI | 0.75 | LiTFAc | 0.50 | lithium | 0.15 |
| | | | | dicyanamide | |
| LiFSI | 0.75 | LiTFAc | 0.66 | lithium | 0.15 |
| | | | | dicyanamide | |
| LiFSI | 0.75 | LiTFAc | 0.75 | lithium | 0.15 |
| | | | | dicyanamide | |
| LiFSI | 0.75 | LiTFAc | 1.00 | lithium | 0.15 |
| | | | | dicyanamide | |
| LiFSI | 1.00 | LiTFAc | 0.10 | lithium | 0.10 |
| | | | | dicyanamide | |
| LiFSI | 1.00 | LiTFAc | 0.25 | lithium | 0.10 |
| | | | | dicyanamide | |
| LiFSI | 1.00 | LiTFAc | 0.33 | lithium | 0.10 |
| | | | | dicyanamide | |
| LiFSI | 1.00 | LiTFAc | 0.50 | lithium | 0.10 |
| | | | | dicyanamide | |
| LiFSI | 1.00 | LiTFAc | 0.66 | lithium | 0.10 |
| | | | | dicyanamide | |
| LiFSI | 1.00 | LiTFAc | 0.75 | lithium | 0.10 |
| | | | | dicyanamide | |
| LiFSI | 1.00 | LiTFAc | 1.00 | lithium | 0.10 |
| | | | | dicyanamide | |
| LiFSI | 1.00 | LiTFAc | 0.10 | lithium | 0.15 |
| | | | | dicyanamide | |
| LiFSI | 1.00 | LiTFAc | 0.25 | lithium | 0.15 |
| | | | | dicyanamide | |
| LiFSI | 1.00 | LiTFAc | 0.33 | lithium | 0.15 |
| | | | | dicyanamide | |
| LiFSI | 1.00 | LiTFAc | 0.50 | lithium | 0.15 |
| | | | | dicyanamide | |
| LiFSI | 1.00 | LiTFAc | 0.66 | lithium | 0.15 |
| | | | | dicyanamide | |
| LiFSI | 1.00 | LiTFAc | 0.75 | lithium | 0.15 |
| | | | | dicyanamide | |
| LiFSI | 1.00 | LiTFAc | 1.00 | lithium | 0.15 |
| | | | | dicyanamide | |
| LiTFAc | 0.10 | none | 0.00 | lithium | 0.10 |
| | | | | dicyanamide | |
| LiTFAc | 0.25 | none | 0.00 | lithium | 0.10 |
| | | | | dicyanamide | |
| LiTFAc | 0.40 | none | 0.00 | lithium | 0.10 |
| | | | | dicyanamide | |
| LiTFAc | 0.50 | none | 0.00 | lithium | 0.10 |
| | | | | dicyanamide | |
| LiTFAc | 0.66 | none | 0.00 | lithium | 0.10 |
| | | | | dicyanamide | |
| LiTFAc | 0.75 | none | 0.00 | lithium | 0.10 |
| | | | | dicyanamide | |
| LiTFAc | 1.00 | none | 0.00 | lithium | 0.10 |
| | | | | dicyanamide | |
| LiTFAc | 0.10 | none | 0.00 | lithium | 0.15 |
| | | | | dicyanamide | |
| LiTFAc | 0.25 | none | 0.00 | lithium | 0.15 |
| | | | | dicyanamide | |
| LiTFAc | 0.40 | none | 0.00 | lithium | 0.15 |
| | | | | dicyanamide | |
| LiTFAc | 0.50 | none | 0.00 | lithium | 0.15 |
| | | | | dicyanamide | |
| LiTFAc | 0.66 | none | 0.00 | lithium | 0.15 |
| | | | | dicyanamide | |
| LiTFAc | 0.75 | none | 0.00 | lithium | 0.15 |
| | | | | dicyanamide | |
| LiTFAc | 1.00 | none | 0.00 | lithium | 0.15 |
| | | | | dicyanamide | |
| LiTFAc | 0.10 | Lithium | 0.10 | lithium | 0.10 |
| | | nitrate | | dicyanamide | |
| | | (LiNO₃) | | | |
| LiTFAc | 0.10 | LiNO₃ | 0.25 | lithium | 0.10 |
| | | | | dicyanamide | |
| LiTFAc | 0.10 | LiNO₃ | 0.33 | lithium | 0.10 |
| | | | | dicyanamide | |
| LiTFAc | 0.10 | LiNO₃ | 0.50 | lithium | 0.10 |
| | | | | dicyanamide | |
| LiTFAc | 0.10 | LiNO₃ | 0.66 | lithium | 0.10 |
| | | | | dicyanamide | |
| LiTFAc | 0.10 | LiNO₃ | 0.75 | lithium | 0.10 |
| | | | | dicyanamide | |
| LiTFAc | 0.10 | LiNO₃ | 1.00 | lithium | 0.10 |
| | | | | dicyanamide | |
| LiTFAc | 0.10 | LiNO₃ | 0.10 | lithium | 0.15 |
| | | | | dicyanamide | |
| LiTFAc | 0.10 | LiNO₃ | 0.25 | lithium | 0.15 |
| | | | | dicyanamide | |
| LiTFAc | 0.10 | LiNO₃ | 0.33 | lithium | 0.15 |
| | | | | dicyanamide | |
| LiTFAc | 0.10 | LiNO₃ | 0.50 | lithium | 0.15 |
| | | | | dicyanamide | |
| LiTFAc | 0.10 | LiNO₃ | 0.66 | lithium | 0.15 |
| | | | | dicyanamide | |
| LiTFAc | 0.10 | LiNO₃ | 0.75 | lithium | 0.15 |
| | | | | dicyanamide | |
| LiTFAc | 0.10 | LiNO₃ | 1.00 | lithium | 0.15 |
| | | | | dicyanamide | |
| LiTFAc | 0.25 | LiNO₃ | 0.10 | lithium | 0.10 |
| | | | | dicyanamide | |
| LiTFAc | 0.25 | LiNO₃ | 0.25 | lithium | 0.10 |
| | | | | dicyanamide | |
| LiTFAc | 0.25 | LiNO₃ | 0.33 | lithium | 0.10 |
| | | | | dicyanamide | |
| LiTFAc | 0.25 | LiNO₃ | 0.50 | lithium | 0.10 |
| | | | | dicyanamide | |
| LiTFAc | 0.25 | LiNO₃ | 0.66 | lithium | 0.10 |
| | | | | dicyanamide | |
| LiTFAc | 0.25 | LiNO₃ | 0.75 | lithium | 0.10 |
| | | | | dicyanamide | |
| LiTFAc | 0.25 | LiNO₃ | 1.00 | lithium | 0.10 |
| | | | | dicyanamide | |
| LiTFAc | 0.25 | LiNO₃ | 0.10 | lithium | 0.15 |
| | | | | dicyanamide | |
| LiTFAc | 0.25 | LiNO₃ | 0.25 | lithium | 0.15 |
| | | | | dicyanamide | |
| LiTFAc | 0.25 | LiNO₃ | 0.33 | lithium | 0.15 |
| | | | | dicyanamide | |
| LiTFAc | 0.25 | LiNO₃ | 0.50 | lithium | 0.15 |
| | | | | dicyanamide | |
| LiTFAc | 0.25 | LiNO₃ | 0.66 | lithium | 0.15 |
| | | | | dicyanamide | |
| LiTFAc | 0.25 | LiNO₃ | 0.75 | lithium | 0.15 |
| | | | | dicyanamide | |
| LiTFAc | 0.25 | LiNO₃ | 1.00 | lithium | 0.15 |
| | | | | dicyanamide | |
| LiTFAc | 0.40 | LiNO₃ | 0.10 | lithium | 0.10 |
| | | | | dicyanamide | |
| LiTFAc | 0.40 | LiNO₃ | 0.25 | lithium | 0.10 |
| | | | | dicyanamide | |
| LiTFAc | 0.40 | LiNO₃ | 0.33 | lithium | 0.10 |
| | | | | dicyanamide | |
| LiTFAc | 0.40 | LiNO₃ | 0.50 | lithium | 0.10 |
| | | | | dicyanamide | |
| LiTFAc | 0.40 | LiNO₃ | 0.66 | lithium | 0.10 |
| | | | | dicyanamide | |
| LiTFAc | 0.40 | LiNO₃ | 0.75 | lithium | 0.10 |
| | | | | dicyanamide | |
| LiTFAc | 0.40 | LiNO₃ | 1.00 | lithium | 0.10 |
| | | | | dicyanamide | |
| LiTFAc | 0.40 | LiNO₃ | 0.10 | lithium | 0.15 |
| | | | | dicyanamide | |
| LiTFAc | 0.40 | LiNO₃ | 0.25 | lithium | 0.15 |
| | | | | dicyanamide | |
| LiTFAc | 0.40 | LiNO₃ | 0.33 | lithium | 0.15 |
| | | | | dicyanamide | |
| LiTFAc | 0.40 | LiNO₃ | 0.50 | lithium | 0.15 |
| | | | | dicyanamide | |
| LiTFAc | 0.40 | LiNO₃ | 0.66 | lithium | 0.15 |
| | | | | dicyanamide | |
| LiTFAc | 0.40 | LiNO₃ | 0.75 | lithium | 0.15 |
| | | | | dicyanamide | |
| LiTFAc | 0.40 | LiNO₃ | 1.00 | lithium | 0.15 |
| | | | | dicyanamide | |
| LiTFAc | 0.50 | LiNO₃ | 0.10 | lithium | 0.10 |
| | | | | dicyanamide | |
| LiTFAc | 0.50 | LiNO₃ | 0.25 | lithium | 0.10 |
| | | | | dicyanamide | |
| LiTFAc | 0.50 | LiNO₃ | 0.33 | lithium | 0.10 |
| | | | | dicyanamide | |
| LiTFAc | 0.50 | LiNO₃ | 0.50 | lithium | 0.10 |
| | | | | dicyanamide | |
| LiTFAc | 0.50 | LiNO₃ | 0.66 | lithium | 0.10 |
| | | | | dicyanamide | |
| LiTFAc | 0.50 | LiNO₃ | 0.75 | lithium | 0.10 |
| | | | | dicyanamide | |
| LiTFAc | 0.50 | LiNO₃ | 1.00 | lithium | 0.10 |
| | | | | dicyanamide | |
| LiTFAc | 0.50 | LiNO₃ | 0.10 | lithium | 0.15 |
| | | | | dicyanamide | |
| LiTFAc | 0.50 | LiNO₃ | 0.25 | lithium | 0.15 |
| | | | | dicyanamide | |
| LiTFAc | 0.50 | LiNO₃ | 0.33 | lithium | 0.15 |
| | | | | dicyanamide | |
| LiTFAc | 0.50 | LiNO₃ | 0.50 | lithium | 0.15 |
| | | | | dicyanamide | |
| LiTFAc | 0.50 | LiNO₃ | 0.66 | lithium | 0.15 |
| | | | | dicyanamide | |
| LiTFAc | 0.50 | LiNO₃ | 0.75 | lithium | 0.15 |
| | | | | dicyanamide | |
| LiTFAc | 0.50 | LiNO₃ | 1.00 | lithium | 0.15 |
| | | | | dicyanamide | |
| LiTFAc | 0.66 | LiNO₃ | 0.10 | lithium | 0.10 |
| | | | | dicyanamide | |
| LiTFAc | 0.66 | LiNO₃ | 0.25 | lithium | 0.10 |
| | | | | dicyanamide | |
| LiTFAc | 0.66 | LiNO₃ | 0.33 | lithium | 0.10 |
| | | | | dicyanamide | |
| LiTFAc | 0.66 | LiNO₃ | 0.50 | lithium | 0.10 |
| | | | | dicyanamide | |
| LiTFAc | 0.66 | LiNO₃ | 0.66 | lithium | 0.10 |
| | | | | dicyanamide | |
| LiTFAc | 0.66 | LiNO₃ | 0.75 | lithium | 0.10 |
| | | | | dicyanamide | |
| LiTFAc | 0.66 | LiNO₃ | 1.00 | lithium | 0.10 |
| | | | | dicyanamide | |
| LiTFAc | 0.66 | LiNO₃ | 0.10 | lithium | 0.15 |
| | | | | dicyanamide | |
| LiTFAc | 0.66 | LiNO₃ | 0.25 | lithium | 0.15 |
| | | | | dicyanamide | |
| LiTFAc | 0.66 | LiNO₃ | 0.33 | lithium | 0.15 |
| | | | | dicyanamide | |
| LiTFAc | 0.66 | LiNO₃ | 0.50 | lithium | 0.15 |
| | | | | dicyanamide | |
| LiTFAc | 0.66 | LiNO₃ | 0.66 | lithium | 0.15 |
| | | | | dicyanamide | |
| LiTFAc | 0.66 | LiNO₃ | 0.75 | lithium | 0.15 |
| | | | | dicyanamide | |
| LiTFAc | 0.66 | LiNO₃ | 1.00 | lithium | 0.15 |
| | | | | dicyanamide | |
| LiTFAc | 0.75 | LiNO₃ | 0.10 | lithium | 0.10 |
| | | | | dicyanamide | |
| LiTFAc | 0.75 | LiNO₃ | 0.25 | lithium | 0.10 |
| | | | | dicyanamide | |
| LiTFAc | 0.75 | LiNO₃ | 0.33 | lithium | 0.10 |
| | | | | dicyanamide | |
| LiTFAc | 0.75 | LiNO₃ | 0.50 | lithium | 0.10 |
| | | | | dicyanamide | |
| LiTFAc | 0.75 | LiNO₃ | 0.66 | lithium | 0.10 |
| | | | | dicyanamide | |
| LiTFAc | 0.75 | LiNO₃ | 0.75 | lithium | 0.10 |
| | | | | dicyanamide | |
| LiTFAc | 0.75 | LiNO₃ | 1.00 | lithium | 0.10 |
| | | | | dicyanamide | |
| LiTFAc | 0.75 | LiNO₃ | 0.10 | lithium | 0.15 |
| | | | | dicyanamide | |
| LiTFAc | 0.75 | LiNO₃ | 0.25 | lithium | 0.15 |
| | | | | dicyanamide | |
| LiTFAc | 0.75 | LiNO₃ | 0.33 | lithium | 0.15 |
| | | | | dicyanamide | |
| LiTFAc | 0.75 | LiNO₃ | 0.50 | lithium | 0.15 |
| | | | | dicyanamide | |
| LiTFAc | 0.75 | LiNO₃ | 0.66 | lithium | 0.15 |
| | | | | dicyanamide | |
| LiTFAc | 0.75 | LiNO₃ | 0.75 | lithium | 0.15 |
| | | | | dicyanamide | |
| LiTFAc | 0.75 | LiNO₃ | 1.00 | lithium | 0.15 |
| | | | | dicyanamide | |
| LiTFAc | 1.00 | LiNO₃ | 0.10 | lithium | 0.10 |
| | | | | dicyanamide | |
| LiTFAc | 1.00 | LiNO₃ | 0.25 | lithium | 0.10 |
| | | | | dicyanamide | |
| LiTFAc | 1.00 | LiNO₃ | 0.33 | lithium | 0.10 |
| | | | | dicyanamide | |
| LiTFAc | 1.00 | LiNO₃ | 0.50 | lithium | 0.10 |
| | | | | dicyanamide | |
| LiTFAc | 1.00 | LiNO₃ | 0.66 | lithium | 0.10 |
| | | | | dicyanamide | |
| LiTFAc | 1.00 | LiNO₃ | 0.75 | lithium | 0.10 |
| | | | | dicyanamide | |
| LiTFAc | 1.00 | LiNO₃ | 1.00 | lithium | 0.10 |
| | | | | dicyanamide | |
| LiTFAc | 1.00 | LiNO₃ | 0.10 | lithium | 0.15 |
| | | | | dicyanamide | |
| LiTFAc | 1.00 | LiNO₃ | 0.25 | lithium | 0.15 |
| | | | | dicyanamide | |
| LiTFAc | 1.00 | LiNO₃ | 0.33 | lithium | 0.15 |
| | | | | dicyanamide | |
| LiTFAc | 1.00 | LiNO₃ | 0.50 | lithium | 0.15 |
| | | | | dicyanamide | |
| LiTFAc | 1.00 | LiNO₃ | 0.66 | lithium | 0.15 |
| | | | | dicyanamide | |
| LiTFAc | 1.00 | LiNO₃ | 0.75 | lithium | 0.15 |
| | | | | dicyanamide | |
| LiTFAc | 1.00 | LiNO₃ | 1.00 | lithium | 0.15 |
| | | | | dicyanamide | |
| LiTFAc | 0.10 | LiClO₄ | 0.10 | lithium | 0.10 |
| | | | | dicyanamide | |
| LiTFAc | 0.10 | LiClO₄ | 0.25 | lithium | 0.10 |
| | | | | dicyanamide | |
| LiTFAc | 0.10 | LiClO₄ | 0.33 | lithium | 0.10 |
| | | | | dicyanamide | |
| LiTFAc | 0.10 | LiClO₄ | 0.50 | lithium | 0.10 |
| | | | | dicyanamide | |
| LiTFAc | 0.10 | LiClO₄ | 0.66 | lithium | 0.10 |
| | | | | dicyanamide | |
| LiTFAc | 0.10 | LiClO₄ | 0.75 | lithium | 0.10 |
| | | | | dicyanamide | |
| LiTFAc | 0.10 | LiClO₄ | 1.00 | lithium | 0.10 |
| | | | | dicyanamide | |
| LiTFAc | 0.10 | LiClO₄ | 0.10 | lithium | 0.15 |
| | | | | dicyanamide | |
| LiTFAc | 0.10 | LiClO₄ | 0.25 | lithium | 0.15 |
| | | | | dicyanamide | |
| LiTFAc | 0.10 | LiClO₄ | 0.33 | lithium | 0.15 |
| | | | | dicyanamide | |
| LiTFAc | 0.10 | LiClO₄ | 0.50 | lithium | 0.15 |
| | | | | dicyanamide | |
| LiTFAc | 0.10 | LiClO₄ | 0.66 | lithium | 0.15 |
| | | | | dicyanamide | |
| LiTFAc | 0.10 | LiClO₄ | 0.75 | lithium | 0.15 |
| | | | | dicyanamide | |
| LiTFAc | 0.10 | LiClO₄ | 1.00 | lithium | 0.15 |
| | | | | dicyanamide | |
| LiTFAc | 0.25 | LiClO₄ | 0.10 | lithium | 0.10 |
| | | | | dicyanamide | |
| LiTFAc | 0.25 | LiClO₄ | 0.25 | lithium | 0.10 |
| | | | | dicyanamide | |
| LiTFAc | 0.25 | LiClO₄ | 0.33 | lithium | 0.10 |
| | | | | dicyanamide | |
| LiTFAc | 0.25 | LiClO₄ | 0.50 | lithium | 0.10 |
| | | | | dicyanamide | |
| LiTFAc | 0.25 | LiClO₄ | 0.66 | lithium | 0.10 |
| | | | | dicyanamide | |
| LiTFAc | 0.25 | LiClO₄ | 0.75 | lithium | 0.10 |
| | | | | dicyanamide | |
| LiTFAc | 0.25 | LiClO₄ | 1.00 | lithium | 0.10 |
| | | | | dicyanamide | |
| LiTFAc | 0.25 | LiClO₄ | 0.10 | lithium | 0.15 |
| | | | | dicyanamide | |
| LiTFAc | 0.25 | LiClO₄ | 0.25 | lithium | 0.15 |
| | | | | dicyanamide | |
| LiTFAc | 0.25 | LiClO₄ | 0.33 | lithium | 0.15 |
| | | | | dicyanamide | |
| LiTFAc | 0.25 | LiClO₄ | 0.50 | lithium | 0.15 |
| | | | | dicyanamide | |
| LiTFAc | 0.25 | LiClO₄ | 0.66 | lithium | 0.15 |
| | | | | dicyanamide | |
| LiTFAc | 0.25 | LiClO₄ | 0.75 | lithium | 0.15 |
| | | | | dicyanamide | |
| LiTFAc | 0.25 | LiClO₄ | 1.00 | lithium | 0.15 |
| | | | | dicyanamide | |
| LiTFAc | 0.40 | LiClO₄ | 0.10 | lithium | 0.10 |
| | | | | dicyanamide | |
| LiTFAc | 0.40 | LiClO₄ | 0.25 | lithium | 0.10 |
| | | | | dicyanamide | |
| LiTFAc | 0.40 | LiClO₄ | 0.33 | lithium | 0.10 |
| | | | | dicyanamide | |
| LiTFAc | 0.40 | LiClO₄ | 0.50 | lithium | 0.10 |
| | | | | dicyanamide | |
| LiTFAc | 0.40 | LiClO₄ | 0.66 | lithium | 0.10 |
| | | | | dicyanamide | |
| LiTFAc | 0.40 | LiClO₄ | 0.75 | lithium | 0.10 |
| | | | | dicyanamide | |
| LiTFAc | 0.40 | LiClO₄ | 1.00 | lithium | 0.10 |
| | | | | dicyanamide | |
| LiTFAc | 0.40 | LiClO₄ | 0.10 | lithium | 0.15 |
| | | | | dicyanamide | |
| LiTFAc | 0.40 | LiClO₄ | 0.25 | lithium | 0.15 |
| | | | | dicyanamide | |
| LiTFAc | 0.40 | LiClO₄ | 0.33 | lithium | 0.15 |
| | | | | dicyanamide | |
| LiTFAc | 0.40 | LiClO₄ | 0.50 | lithium | 0.15 |
| | | | | dicyanamide | |
| LiTFAc | 0.40 | LiClO₄ | 0.66 | lithium | 0.15 |
| | | | | dicyanamide | |
| LiTFAc | 0.40 | LiClO₄ | 0.75 | lithium | 0.15 |
| | | | | dicyanamide | |
| LiTFAc | 0.40 | LiClO₄ | 1.00 | lithium | 0.15 |
| | | | | dicyanamide | |
| LiTFAc | 0.50 | LiClO₄ | 0.10 | lithium | 0.10 |
| | | | | dicyanamide | |
| LiTFAc | 0.50 | LiClO₄ | 0.25 | lithium | 0.10 |
| | | | | dicyanamide | |
| LiTFAc | 0.50 | LiClO₄ | 0.33 | lithium | 0.10 |
| | | | | dicyanamide | |
| LiTFAc | 0.50 | LiClO₄ | 0.50 | lithium | 0.10 |
| | | | | dicyanamide | |
| LiTFAc | 0.50 | LiClO₄ | 0.66 | lithium | 0.10 |
| | | | | dicyanamide | |
| LiTFAc | 0.50 | LiClO₄ | 0.75 | lithium | 0.10 |
| | | | | dicyanamide | |
| LiTFAc | 0.50 | LiClO₄ | 1.00 | lithium | 0.10 |
| | | | | dicyanamide | |
| LiTFAc | 0.50 | LiClO₄ | 0.10 | lithium | 0.15 |
| | | | | dicyanamide | |
| LiTFAc | 0.50 | LiClO₄ | 0.25 | lithium | 0.15 |
| | | | | dicyanamide | |
| LiTFAc | 0.50 | LiClO₄ | 0.33 | lithium | 0.15 |
| | | | | dicyanamide | |
| LiTFAc | 0.50 | LiClO₄ | 0.50 | lithium | 0.15 |
| | | | | dicyanamide | |
| LiTFAc | 0.50 | LiClO₄ | 0.66 | lithium | 0.15 |
| | | | | dicyanamide | |
| LiTFAc | 0.50 | LiClO₄ | 0.75 | lithium | 0.15 |
| | | | | dicyanamide | |
| LiTFAc | 0.50 | LiClO₄ | 1.00 | lithium | 0.15 |
| | | | | dicyanamide | |
| LiTFAc | 0.66 | LiClO₄ | 0.10 | lithium | 0.10 |
| | | | | dicyanamide | |
| LiTFAc | 0.66 | LiClO₄ | 0.25 | lithium | 0.10 |
| | | | | dicyanamide | |
| LiTFAc | 0.66 | LiClO₄ | 0.33 | lithium | 0.10 |
| | | | | dicyanamide | |
| LiTFAc | 0.66 | LiClO₄ | 0.50 | lithium | 0.10 |
| | | | | dicyanamide | |
| LiTFAc | 0.66 | LiClO₄ | 0.66 | lithium | 0.10 |
| | | | | dicyanamide | |
| LiTFAc | 0.66 | LiClO₄ | 0.75 | lithium | 0.10 |
| | | | | dicyanamide | |
| LiTFAc | 0.66 | LiClO₄ | 1.00 | lithium | 0.10 |
| | | | | dicyanamide | |
| LiTFAc | 0.66 | LiClO₄ | 0.10 | lithium | 0.15 |
| | | | | dicyanamide | |
| LiTFAc | 0.66 | LiClO₄ | 0.25 | lithium | 0.15 |
| | | | | dicyanamide | |
| LiTFAc | 0.66 | LiClO₄ | 0.33 | lithium | 0.15 |
| | | | | dicyanamide | |
| LiTFAc | 0.66 | LiClO₄ | 0.50 | lithium | 0.15 |
| | | | | dicyanamide | |
| LiTFAc | 0.66 | LiClO₄ | 0.66 | lithium | 0.15 |
| | | | | dicyanamide | |
| LiTFAc | 0.66 | LiClO₄ | 0.75 | lithium | 0.15 |
| | | | | dicyanamide | |
| LiTFAc | 0.66 | LiClO₄ | 1.00 | lithium | 0.15 |
| | | | | dicyanamide | |
| LiTFAc | 0.75 | LiClO₄ | 0.10 | lithium | 0.10 |
| | | | | dicyanamide | |
| LiTFAc | 0.75 | LiClO₄ | 0.25 | lithium | 0.10 |
| | | | | dicyanamide | |
| LiTFAc | 0.75 | LiClO₄ | 0.33 | lithium | 0.10 |
| | | | | dicyanamide | |
| LiTFAc | 0.75 | LiClO₄ | 0.50 | lithium | 0.10 |
| | | | | dicyanamide | |
| LiTFAc | 0.75 | LiClO₄ | 0.66 | lithium | 0.10 |
| | | | | dicyanamide | |
| LiTFAc | 0.75 | LiClO₄ | 0.75 | lithium | 0.10 |
| | | | | dicyanamide | |
| LiTFAc | 0.75 | LiClO₄ | 1.00 | lithium | 0.10 |
| | | | | dicyanamide | |
| LiTFAc | 0.75 | LiClO₄ | 0.10 | lithium | 0.15 |
| | | | | dicyanamide | |
| LiTFAc | 0.75 | LiClO₄ | 0.25 | lithium | 0.15 |
| | | | | dicyanamide | |
| LiTFAc | 0.75 | LiClO₄ | 0.33 | lithium | 0.15 |
| | | | | dicyanamide | |
| LiTFAc | 0.75 | LiClO₄ | 0.50 | lithium | 0.15 |
| | | | | dicyanamide | |
| LiTFAc | 0.75 | LiClO₄ | 0.66 | lithium | 0.15 |
| | | | | dicyanamide | |
| LiTFAc | 0.75 | LiClO₄ | 0.75 | lithium | 0.15 |
| | | | | dicyanamide | |
| LiTFAc | 0.75 | LiClO₄ | 1.00 | lithium | 0.15 |
| | | | | dicyanamide | |
| LiTFAc | 1.00 | LiClO₄ | 0.10 | lithium | 0.10 |
| | | | | dicyanamide | |
| LiTFAc | 1.00 | LiClO₄ | 0.25 | lithium | 0.10 |
| | | | | dicyanamide | |
| LiTFAc | 1.00 | LiClO₄ | 0.33 | lithium | 0.10 |
| | | | | dicyanamide | |
| LiTFAc | 1.00 | LiClO₄ | 0.50 | lithium | 0.10 |
| | | | | dicyanamide | |
| LiTFAc | 1.00 | LiClO₄ | 0.66 | lithium | 0.10 |
| | | | | dicyanamide | |
| LiTFAc | 1.00 | LiClO₄ | 0.75 | lithium | 0.10 |
| | | | | dicyanamide | |
| LiTFAc | 1.00 | LiClO₄ | 1.00 | lithium | 0.10 |
| | | | | dicyanamide | |
| LiTFAc | 1.00 | LiClO₄ | 0.10 | lithium | 0.15 |
| | | | | dicyanamide | |
| LiTFAc | 1.00 | LiClO₄ | 0.25 | lithium | 0.15 |
| | | | | dicyanamide | |
| LiTFAc | 1.00 | LiClO₄ | 0.33 | lithium | 0.15 |
| | | | | dicyanamide | |
| LiTFAc | 1.00 | LiClO₄ | 0.50 | lithium | 0.15 |
| | | | | dicyanamide | |
| LiTFAc | 1.00 | LiClO₄ | 0.66 | lithium | 0.15 |
| | | | | dicyanamide | |
| LiTFAc | 1.00 | LiClO₄ | 0.75 | lithium | 0.15 |
| | | | | dicyanamide | |
| LiTFAc | 1.00 | LiClO₄ | 1.00 | lithium | 0.15 |
| | | | | dicyanamide | |
| LiTFAc | 0.10 | lithium | 0.10 | lithium | 0.10 |
| | | trifilate (LiTf) | | dicyanamide | |
| LiTFAc | 0.10 | LiTf | 0.25 | lithium | 0.10 |
| | | | | dicyanamide | |
| LiTFAc | 0.10 | LiTf | 0.33 | lithium | 0.10 |
| | | | | dicyanamide | |
| LiTFAc | 0.10 | LiTf | 0.50 | lithium | 0.10 |
| | | | | dicyanamide | |
| LiTFAc | 0.10 | LiTf | 0.66 | lithium | 0.10 |
| | | | | dicyanamide | |
| LiTFAc | 0.10 | LiTf | 0.75 | lithium | 0.10 |
| | | | | dicyanamide | |
| LiTFAc | 0.10 | LiTf | 1.00 | lithium | 0.10 |
| | | | | dicyanamide | |
| LiTFAc | 0.10 | LiTf | 0.10 | lithium | 0.15 |
| | | | | dicyanamide | |
| LiTFAc | 0.10 | LiTf | 0.25 | lithium | 0.15 |
| | | | | dicyanamide | |
| LiTFAc | 0.10 | LiTf | 0.33 | lithium | 0.15 |
| | | | | dicyanamide | |
| LiTFAc | 0.10 | LiTf | 0.50 | lithium | 0.15 |
| | | | | dicyanamide | |
| LiTFAc | 0.10 | LiTf | 0.66 | lithium | 0.15 |
| | | | | dicyanamide | |
| LiTFAc | 0.10 | LiTf | 0.75 | lithium | 0.15 |
| | | | | dicyanamide | |
| LiTFAc | 0.10 | LiTf | 1.00 | lithium | 0.15 |
| | | | | dicyanamide | |
| LiTFAc | 0.25 | LiTf | 0.10 | lithium | 0.10 |
| | | | | dicyanamide | |
| LiTFAc | 0.25 | LiTf | 0.25 | lithium | 0.10 |
| | | | | dicyanamide | |
| LiTFAc | 0.25 | LiTf | 0.33 | lithium | 0.10 |
| | | | | dicyanamide | |
| LiTFAc | 0.25 | LiTf | 0.50 | lithium | 0.10 |
| | | | | dicyanamide | |
| LiTFAc | 0.25 | LiTf | 0.66 | lithium | 0.10 |
| | | | | dicyanamide | |
| LiTFAc | 0.25 | LiTf | 0.75 | lithium | 0.10 |
| | | | | dicyanamide | |
| LiTFAc | 0.25 | LiTf | 1.00 | lithium | 0.10 |
| | | | | dicyanamide | |
| LiTFAc | 0.25 | LiTf | 0.10 | lithium | 0.15 |
| | | | | dicyanamide | |
| LiTFAc | 0.25 | LiTf | 0.25 | lithium | 0.15 |
| | | | | dicyanamide | |
| LiTFAc | 0.25 | LiTf | 0.33 | lithium | 0.15 |
| | | | | dicyanamide | |
| LiTFAc | 0.25 | LiTf | 0.50 | lithium | 0.15 |
| | | | | dicyanamide | |
| LiTFAc | 0.25 | LiTf | 0.66 | lithium | 0.15 |
| | | | | dicyanamide | |
| LiTFAc | 0.25 | LiTf | 0.75 | lithium | 0.15 |
| | | | | dicyanamide | |
| LiTFAc | 0.25 | LiTf | 1.00 | lithium | 0.15 |
| | | | | dicyanamide | |
| LiTFAc | 0.40 | LiTf | 0.10 | lithium | 0.10 |
| | | | | dicyanamide | |
| LiTFAc | 0.40 | LiTf | 0.25 | lithium | 0.10 |
| | | | | dicyanamide | |
| LiTFAc | 0.40 | LiTf | 0.33 | lithium | 0.10 |
| | | | | dicyanamide | |
| LiTFAc | 0.40 | LiTf | 0.50 | lithium | 0.10 |
| | | | | dicyanamide | |
| LiTFAc | 0.40 | LiTf | 0.66 | lithium | 0.10 |
| | | | | dicyanamide | |
| LiTFAc | 0.40 | LiTf | 0.75 | lithium | 0.10 |
| | | | | dicyanamide | |
| LiTFAc | 0.40 | LiTf | 1.00 | lithium | 0.10 |
| | | | | dicyanamide | |
| LiTFAc | 0.40 | LiTf | 0.10 | lithium | 0.15 |
| | | | | dicyanamide | |
| LiTFAc | 0.40 | LiTf | 0.25 | lithium | 0.15 |
| | | | | dicyanamide | |
| LiTFAc | 0.40 | LiTf | 0.33 | lithium | 0.15 |
| | | | | dicyanamide | |
| LiTFAc | 0.40 | LiTf | 0.50 | lithium | 0.15 |
| | | | | dicyanamide | |
| LiTFAc | 0.40 | LiTf | 0.66 | lithium | 0.15 |
| | | | | dicyanamide | |
| LiTFAc | 0.40 | LiTf | 0.75 | lithium | 0.15 |
| | | | | dicyanamide | |
| LiTFAc | 0.40 | LiTf | 1.00 | lithium | 0.15 |
| | | | | dicyanamide | |
| LiTFAc | 0.50 | LiTf | 0.10 | lithium | 0.10 |
| | | | | dicyanamide | |
| LiTFAc | 0.50 | LiTf | 0.25 | lithium | 0.10 |
| | | | | dicyanamide | |
| LiTFAc | 0.50 | LiTf | 0.33 | lithium | 0.10 |
| | | | | dicyanamide | |
| LiTFAc | 0.50 | LiTf | 0.50 | lithium | 0.10 |
| | | | | dicyanamide | |
| LiTFAc | 0.50 | LiTf | 0.66 | lithium | 0.10 |
| | | | | dicyanamide | |
| LiTFAc | 0.50 | LiTf | 0.75 | lithium | 0.10 |
| | | | | dicyanamide | |
| LiTFAc | 0.50 | LiTf | 1.00 | lithium | 0.10 |
| | | | | dicyanamide | |
| LiTFAc | 0.50 | LiTf | 0.10 | lithium | 0.15 |
| | | | | dicyanamide | |
| LiTFAc | 0.50 | LiTf | 0.25 | lithium | 0.15 |
| | | | | dicyanamide | |
| LiTFAc | 0.50 | LiTf | 0.33 | lithium | 0.15 |
| | | | | dicyanamide | |
| LiTFAc | 0.50 | LiTf | 0.50 | lithium | 0.15 |
| | | | | dicyanamide | |
| LiTFAc | 0.50 | LiTf | 0.66 | lithium | 0.15 |
| | | | | dicyanamide | |
| LiTFAc | 0.50 | LiTf | 0.75 | lithium | 0.15 |
| | | | | dicyanamide | |
| LiTFAc | 0.50 | LiTf | 1.00 | lithium | 0.15 |
| | | | | dicyanamide | |
| LiTFAc | 0.66 | LiTf | 0.10 | lithium | 0.10 |
| | | | | dicyanamide | |
| LiTFAc | 0.66 | LiTf | 0.25 | lithium | 0.10 |
| | | | | dicyanamide | |
| LiTFAc | 0.66 | LiTf | 0.33 | lithium | 0.10 |
| | | | | dicyanamide | |
| LiTFAc | 0.66 | LiTf | 0.50 | lithium | 0.10 |
| | | | | dicyanamide | |
| LiTFAc | 0.66 | LiTf | 0.66 | lithium | 0.10 |
| | | | | dicyanamide | |
| LiTFAc | 0.66 | LiTf | 0.75 | lithium | 0.10 |
| | | | | dicyanamide | |
| LiTFAc | 0.66 | LiTf | 1.00 | lithium | 0.10 |
| | | | | dicyanamide | |
| LiTFAc | 0.66 | LiTf | 0.10 | lithium | 0.15 |
| | | | | dicyanamide | |
| LiTFAc | 0.66 | LiTf | 0.25 | lithium | 0.15 |
| | | | | dicyanamide | |
| LiTFAc | 0.66 | LiTf | 0.33 | lithium | 0.15 |
| | | | | dicyanamide | |
| LiTFAc | 0.66 | LiTf | 0.50 | lithium | 0.15 |
| | | | | dicyanamide | |
| LiTFAc | 0.66 | LiTf | 0.66 | lithium | 0.15 |
| | | | | dicyanamide | |
| LiTFAc | 0.66 | LiTf | 0.75 | lithium | 0.15 |
| | | | | dicyanamide | |
| LiTFAc | 0.66 | LiTf | 1.00 | lithium | 0.15 |
| | | | | dicyanamide | |
| LiTFAc | 0.75 | LiTf | 0.10 | lithium | 0.10 |
| | | | | dicyanamide | |
| LiTFAc | 0.75 | LiTf | 0.25 | lithium | 0.10 |
| | | | | dicyanamide | |
| LiTFAc | 0.75 | LiTf | 0.33 | lithium | 0.10 |
| | | | | dicyanamide | |
| LiTFAc | 0.75 | LiTf | 0.50 | lithium | 0.10 |
| | | | | dicyanamide | |
| LiTFAc | 0.75 | LiTf | 0.66 | lithium | 0.10 |
| | | | | dicyanamide | |
| LiTFAc | 0.75 | LiTf | 0.75 | lithium | 0.10 |
| | | | | dicyanamide | |
| LiTFAc | 0.75 | LiTf | 1.00 | lithium | 0.10 |
| | | | | dicyanamide | |
| LiTFAc | 0.75 | LiTf | 0.10 | lithium | 0.15 |
| | | | | dicyanamide | |
| LiTFAc | 0.75 | LiTf | 0.25 | lithium | 0.15 |
| | | | | dicyanamide | |
| LiTFAc | 0.75 | LiTf | 0.33 | lithium | 0.15 |
| | | | | dicyanamide | |
| LiTFAc | 0.75 | LiTf | 0.50 | lithium | 0.15 |
| | | | | dicyanamide | |
| LiTFAc | 0.75 | LiTf | 0.66 | lithium | 0.15 |
| | | | | dicyanamide | |
| LiTFAc | 0.75 | LiTf | 0.75 | lithium | 0.15 |
| | | | | dicyanamide | |
| LiTFAc | 0.75 | LiTf | 1.00 | lithium | 0.15 |
| | | | | dicyanamide | |
| LiTFAc | 1.00 | LiTf | 0.10 | lithium | 0.10 |
| | | | | dicyanamide | |
| LiTFAc | 1.00 | LiTf | 0.25 | lithium | 0.10 |
| | | | | dicyanamide | |
| LiTFAc | 1.00 | LiTf | 0.33 | lithium | 0.10 |
| | | | | dicyanamide | |
| LiTFAc | 1.00 | LiTf | 0.50 | lithium | 0.10 |
| | | | | dicyanamide | |
| LiTFAc | 1.00 | LiTf | 0.66 | lithium | 0.10 |
| | | | | dicyanamide | |
| LiTFAc | 1.00 | LiTf | 0.75 | lithium | 0.10 |
| | | | | dicyanamide | |
| LiTFAc | 1.00 | LiTf | 1.00 | lithium | 0.10 |
| | | | | dicyanamide | |
| LiTFAc | 1.00 | LiTf | 0.10 | lithium | 0.15 |
| | | | | dicyanamide | |
| LiTFAc | 1.00 | LiTf | 0.25 | lithium | 0.15 |
| | | | | dicyanamide | |
| LiTFAc | 1.00 | LiTf | 0.33 | lithium | 0.15 |
| | | | | dicyanamide | |
| LiTFAc | 1.00 | LiTf | 0.50 | lithium | 0.15 |
| | | | | dicyanamide | |
| LiTFAc | 1.00 | LiTf | 0.66 | lithium | 0.15 |
| | | | | dicyanamide | |
| LiTFAc | 1.00 | LiTf | 0.75 | lithium | 0.15 |
| | | | | dicyanamide | |
| LiTFAc | 1.00 | LiTf | 1.00 | lithium | 0.15 |
| | | | | dicyanamide | |

In various approaches, the inventive structures, compositions, configurations, etc. described herein may be implemented in electrochemical cells of various types for practical utilization in a wide variety of applications. Without limitation, exemplary electrochemical cell configurations that may utilize any combination of features described herein, may be in the form of a pouch, a coin, a prismatic cell, a cylindrical configuration, or any suitable equivalent(s) thereof that would be appreciated by those having ordinary skill in the art upon reading the present disclosure.

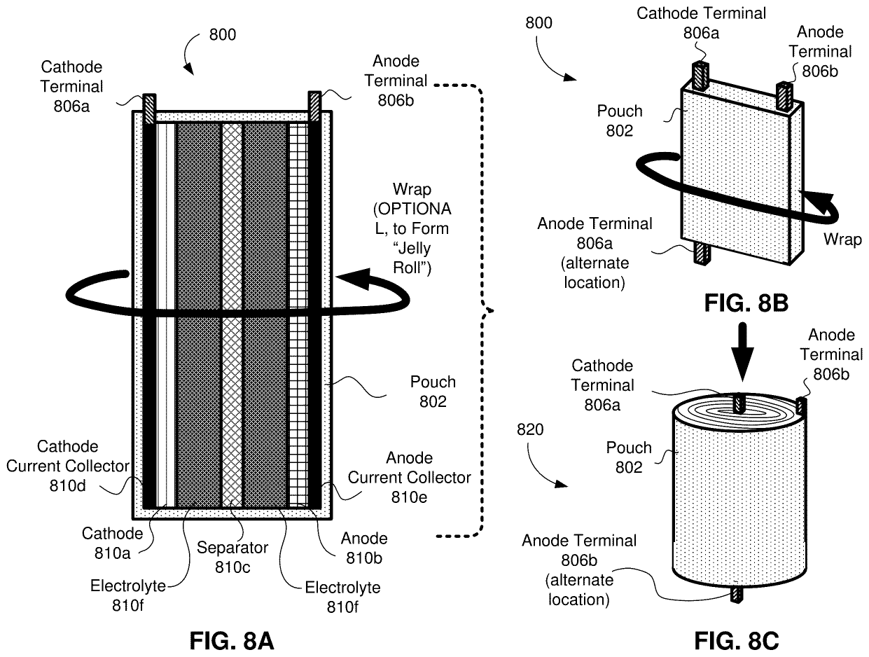

With reference to electrochemical cells having a pouch cell arrangement 800, and as shown according to exemplary embodiments in FIGS. 8A-8C, an electrochemical cell includes a cathode 810a and an anode 810b positioned on opposing sides of the pouch cell arrangement 800, and separated (physically and/or chemically) by a separator 810c. The anode 810c and cathode 810a are electronically coupled via an electrolyte 810f present in the pouch cell arrangement 800. Moreover, each electrode is electronically coupled to an external environment of the pouch cell arrangement 800 via a current collector and corresponding terminal, i.e. the cathode 810a is coupled to the external environment via cathode current collector 810d and cathode terminal 806a, while the anode 810b is coupled via anode current collector 810e and anode terminal 806b. The foregoing structures are enclosed, encased, or otherwise spatially fixed and contained via a pouch 802 surrounding the components.

The pouch 802, according to various embodiments, may take any suitable form that would be understood by those having ordinary skill in the art upon reading the present disclosure, such as a wrapping, a coating, an enclosure (soft or hard), a compressive structure (such as a metal band or mesh), etc. as would be understood by those having ordinary skill in the art upon reading the present disclosure.

Moreover, as shown in FIG. 8B, the anode terminal 806b and cathode terminal 806a extend through the pouch 802, providing electronic coupling between interior and exterior environments of the pouch cell arrangement 800. Note the anode terminal 806b may alternatively be positioned on a same side, or an opposite side, of the pouch cell arrangement 800 relative to the cathode terminal 806a. Moreover, the relative position of the anode terminal 806b and the cathode terminal 806a may be switched relative to the arrangement shown in FIGS. 8B and 8C, according to alternative implementations and without departing from the scope of the presently described inventive concepts.

As noted in FIGS. 8A and 8B, the illustrative pouch cell arrangement 800 may be wound around, e.g., its longitudinal axis, to form a spiral, folded, pleated, rolled, or otherwise at least partially overlapping configuration of the above-referenced electrochemical cell components. In preferred implementations, winding the pouch cell arrangement 800 yields a configuration known as a “jellyroll”, Shown schematically in FIG. 8C.

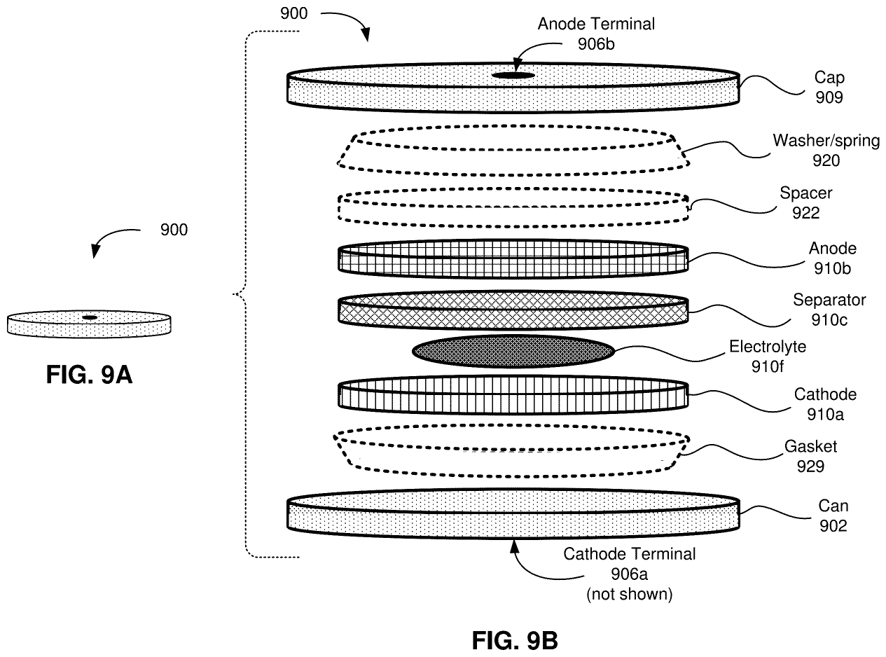

Turning now to FIGS. 9A and 9B, which depict a simplified schematic of an electrochemical cell configured according to a coin cell arrangement 900 is aptly named for its substantially flat, cylindrical shape as shown in FIG. 9A. According to various embodiments, the cylindrical cell arrangement 900 includes a can 902 and cap 904 which protect the components placed therein from mechanical damage, chemical damage (e.g. corrosion, oxidation, etc.) electrical damage, etc. and also prevent leakage of compounds within the cylindrical cell arrangement 900 into the environment.

Coupled to the cap 904 is an anode terminal 906b, and likewise coupled to the can 902 is a cathode terminal 906a (not shown in FIG. 9B). Preferably, these terminals have a composition suitable for conducting electricity generated within the coin cell arrangement 900 to an appropriately connected or coupled output, and may be inserted into a circuit to provide power thereto, as would be appreciated by those having ordinary skill in the art upon reading the present descriptions. Exemplary compositions suitable for use in cathode terminal 906a and anode terminal 906b include electrically conductive metals, such as copper, nickel, etc. as known in the art, electrically conductive carbonaceous materials, such as graphene, etc. as known in the art, or any other suitable equivalent thereof that would be appreciated by a skilled artisan upon reading the present disclosures.

Turning now to FIG. 9B, a plurality of components that may be included in a coin cell arrangement 900 are shown according to an exploded view consistent with various embodiments of the presently described inventive concepts. It shall be appreciated that components such as washer/spring 920, spacer 922, and gasket 924, represented by dotted outlines, are optional and may, but need not, be included in accordance with the inventive concepts disclosed herein. However, it shall also be appreciated that, depending on the intended application for the coin cell arrangement 900, washer/spring 920, spacer 922, and/or gasket 924 may advantageously convey mechanical strength, or convey advantageous electrical properties, on the coin cell arrangement 900. For instance, washer/spring 920 and/or gasket 924 may help secure the other depicted components in place, facilitating desired operation of the coin cell arrangement 900. Similarly, spacer 922 may cushion the anode 910b from friction or compressive force from the washer/spring 920, and/or be formed from a material that facilitates conduction of heat and/or electricity from within the coin cell arrangement 900 to the anode terminal 906b, according to the configuration shown in FIG. 9B. Of course, those having ordinary skill in the art will appreciate various advantages that may be realized via inclusion of washer/spring 920, spacer 922, and/or gasket 924, in various implementations, based on knowledge generally available at the time of the present disclosure's filing date.

With continuing reference to FIG. 9B, illustrative coin cell arrangement 900 features internal components including an anode 910b positioned toward an opposing end of the coin cell arrangement as a cathode 910a, with a separator 910c and electrolyte 910f positioned therebetween. As with all electrochemical cell arrangements shown in FIGS. 8A-11 and consistent with corresponding descriptions thereof provided herein, the anode 910b, cathode 910a, separator 910c, and electrolyte 910f may each be characterized by any composition as known in the art or as described herein that a skilled artisan would appreciate as suitable for the respective function thereof in an electrochemical cell, upon reading the present disclosure and without departing from the scope of the presently described inventive concepts. Several such exemplary compositions are provided hereinbelow, and others may be set forth elsewhere in the detailed descriptions of the inventive concepts instantly set forth. Unless expressly admitted as being known in the art, it shall be understood that any such exemplary composition described for any of the components of electrochemical cell arrangements 8A-11 is not admitted as being so well-known, but rather is considered part of the inventive concepts presented herein.

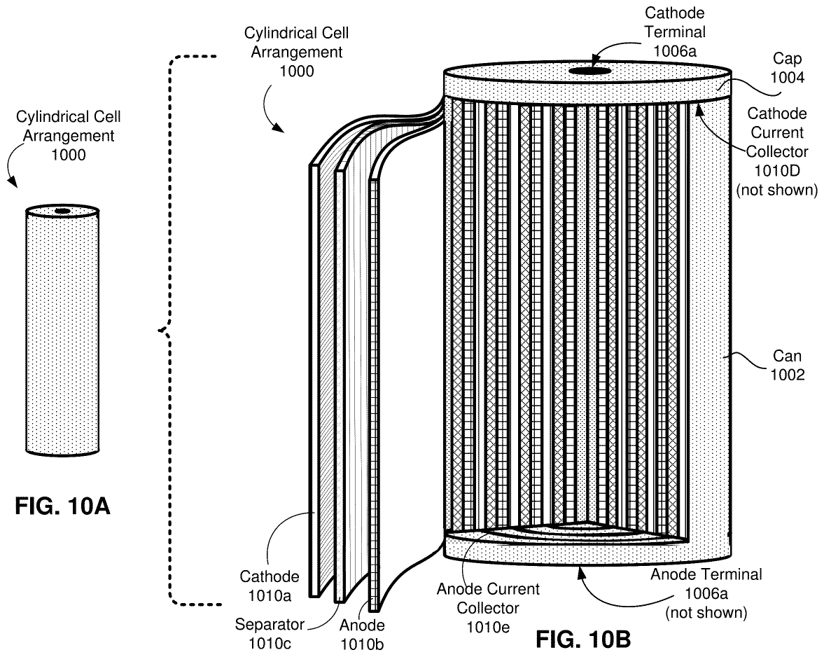

In other approaches, electrochemical cells may be characterized by a cylindrical cell arrangement 1000, e.g., as shown according to illustrative implementations in FIGS. 10A (external view) and 10B (cut-out view), includes a can 1002 and a cap 1004 that contain and protect other components internal to the cylindrical cell configuration, in similar manner as described herein regarding coin cell arrangements such as coin cell arrangement 900 shown in FIGS. 9A and 9B. Also similar to other arrangements described herein, the cap 1004 and can 1002 each respectively include a terminal configured to conduct electricity generated within the cylindrical cell arrangement 1000 to an external environment, output device electrically coupled to the cylindrical cell arrangement 1000, etc., according to various embodiments and as would be appreciated by those having ordinary skill in the art upon reading the present disclosure. As shown in FIG. 10B, cap 1004 includes a cathode terminal 1006a, while can 1002 includes an anode terminal 1006b (not shown in FIG. 10B), positioned at substantially opposite ends of the cylindrical cell arrangement 1000. Of course, the relative position of the cathode terminal 1006a and anode terminal 1006b may be swapped, according to alternative embodiments of the cylindrical cell arrangement 1000.

With continuing reference to FIG. 10B, the illustrative cylindrical cell arrangement 1000 includes similar components as described herein with reference to other electrochemical cell arrangements, but structurally arranged in a unique manner. Most notably, while the cathode(s) 1010a and anode(s) 1010b are spatially separated by separator(s) 1010c, there are a plurality of such structures arranged in substantially laminar configuration and wound around a central longitudinal axis of the cylindrical cell arrangement 1000. In this manner, the cathode(s) 1010a and anode(s) 1010b are not positioned proximate to opposing ends of the cylindrical cell arrangement 1000 as is the case for pouch cell arrangement 800 and coin cell arrangement 900, but rather present throughout a volume of the cylindrical cell arrangement 1000. Regardless, consistent with pouch cell arrangement 800, the cylindrical cell arrangement 1000 includes a cathode current collector 1010d (not shown in FIG. 10B) and an anode current collector 1010e positioned at opposing ends of the cylindrical cell arrangement 1000 and electrically coupled to a corresponding terminal (i.e., either cathode terminal 1006a or anode terminal 1006b), as would be understood by those having ordinary skill in the art upon reading the present disclosures.

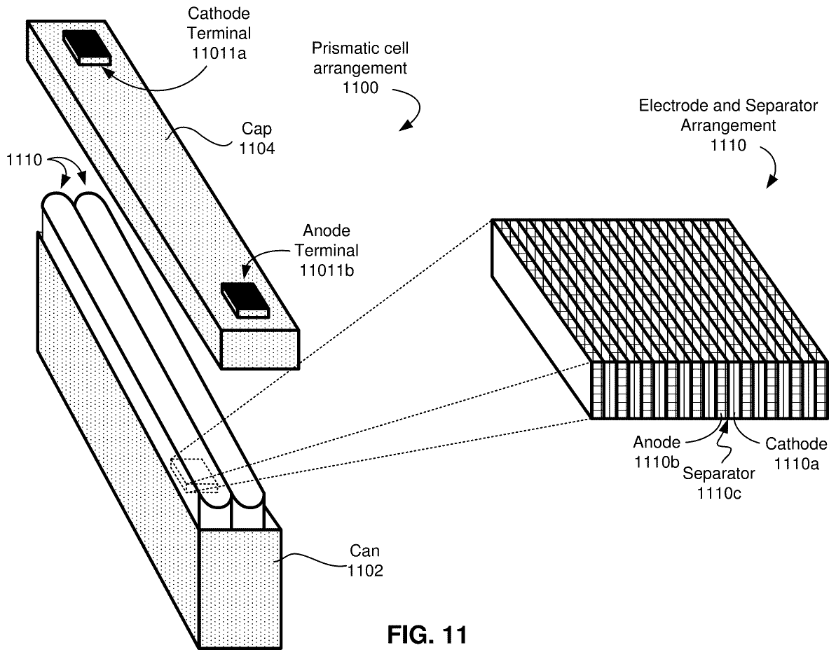

Now regarding FIG. 11, a simplified schematic of an electrochemical cell embodied in a prismatic configuration 1100 is shown, according to one aspect of the presently disclosed inventive concepts. As with other electrochemical cell arrangements described hereinabove, the prismatic cell arrangement 1100 includes a can 1102 and a cap 1104. Unique to the prismatic cell arrangement 1100, the can 1102 and cap 1104 as shown in FIG. 11 are substantially rectangular cuboidal in shape, although those having ordinary skill in the art will appreciate that a unique advantage of prismatic cell arrangements as contemplated herein is nearly unlimited flexibility with respect to the spatial configuration of the can 1102 and cap 1104. The sole limitation on such spatial configuration is the ability to fully enclose and contain the internal components, shown according to one exemplary embodiment with reference to electrode and separator arrangement 1110. This flexibility, in large part, is due to implementation of electrode and separator arrangements 1110 characterized by a laminar structure including anode(s) 1110a and cathode(s) 1110a physically and/or chemically separated by separator(s) 1110c. While the particular electrode and separator arrangement 1110 shown in FIG. 11 is a multi-layered structure (e.g., composed of a series of thin films deposited sequentially one onto the other) those having ordinary skill in the art will appreciate that according to various implementations the components of the electrode and separator arrangement 1110 (which may include components other than anode 1110b, cathode 1110a, and separator 1110c without departing from the scope of the presently disclosed inventive concepts) may be arranged in a “rolled” configuration such as shown in FIGS. 8C and 10B, or in a folded configuration, a pleated configuration, or any other configuration in which at least portion(s) of the components of the electrode and separator arrangement 1110 at least partially overlap themselves, one another, or both. Furthermore, combinations of overlapping arrangements may be implemented in electrode and separator arrangement 1110 without departing from the scope of the presently disclosed inventive concepts.

Returning to the cap 1104 of exemplary prismatic cell arrangement 1100 shown in FIG. 11, in one illustrative implementation a plurality of terminals including cathode terminal 1106a and anode terminal 1106b are disposed on an external surface of the cap 1104 and electrically coupled to the electrode and separator arrangement 1110, e.g. via one or more current collectors (not shown in FIG. 11) using any suitable means and/or mechanisms that would be understood by those having ordinary skill in the art upon reading the instant descriptions.

Several exemplary electrochemical cell arrangements have been shown and described with reference to FIGS. 8A-11, and shall be understood as illustrative rather than limiting on the scope of the inventive concepts presented herein. Moreover, certain arrangements are depicted as including or omitting certain components not expressly shown or described with reference to other arrangements (such as the washer/spring 820, spacer 822, gasket 824, electrolyte 810f, current collectors 810d and 810e, shown with reference to FIG. 8A but not expressly shown or described with reference to other arrangements set forth herein. Despite the particular components shown in FIGS. 8A-11, it shall be understood that any electrochemical cell arrangement, whether in accordance with FIGS. 8A-11 or according to a different electrochemical cell arrangement, may include any suitable combination of components described with reference to any single FIG., or components not shown in any of the FIGs, but which would be appreciated as suitable for creating a functioning electrochemical cell by a person having ordinary skill in the art upon reading the instant descriptions.

Of course, the various exemplary embodiments of electrochemical cells arranged according to different configurations shown in FIGS. 8A-11 and described hereinabove are provided for illustrative purposes, and should not be interpreted as limiting on the scope of electrochemical cells in which the inventive anode structures and compositions presently disclosed may be implemented. For instance, in various approaches different electrochemical cell configurations may be used together, in any combination, to provide power to one or more machines.

Moreover, the exemplary electrochemical cell configurations described hereinabove may be modified in any suitable manner known in the art without departing from the scope of the inventive concepts described herein. For instance, various components shown above in FIGS. 8A-11 may be modified, substituted, omitted, supplemented, etc. in any manner that a skilled artisan reading the present disclosure would appreciate as suitable for producing a working electrochemical cell, without extending beyond the scope of the presently described inventive concepts.

For instance, according to various embodiments, electrochemical cells implemented in accordance with the presently described inventive concepts may include one or more (preferably at least two) electrodes, which may individually be characterized as anode(s), or cathode(s), e.g., according to electrochemical function within the overall cell, and may be formed from any suitable material(s) known in the art and appreciated, upon reading the present disclosure, as suitable for use in combination with other structures and compositions in the exemplary electrochemical cell and in accordance with the inventive concepts provided herein.

In some approaches, either or both electrode types may be configured in the form of a three-dimensional, monolithic structure that is “free-standing”. In other words, the “free-standing” electrode is “structurally self-supporting”, such that no separate substrate, framework, scaffold, foam, matrix, current collector, supporting fluid, etc. is necessary for the monolith to support its own weight and maintain defining physical characteristics (e.g., density, volume, porosity, physical dimensions, shape, chemical composition, etc.) when deposited, positioned, or otherwise placed in a working environment such as an electrochemical cell. Of course, the inventive concepts presented herein should not be interpreted as being limited in any way to inclusion of or requirement for “free standing” electrode(s), but should be understood as allowing for such structures where advantageous to the specific application(s) or intended utility for the inventive electrochemical cell of interest.

Where a “free standing” electrode structure is implemented, corresponding electrochemical cells may, and preferably do, omit a distinct current collector (or at least a distinct anode current collector), according to select implementations. Indeed, even where no “free standing” electrode structure is present, electrochemical cells in accordance with the inventive concepts described herein may still omit a distinct current collector structure or component.

For instance, according to certain implementations, the electrode itself may serve as the current collector, or the separator(s) may serve as the current collector, in addition to fulfilling additional functions described herein with respect to the separator, such as physically, chemically, electrically, etc. segregating various components of the electrochemical cell from one another to avoid undesirable chemical reactions, physical phenomena, etc. as would be understood by a person having ordinary skill in the art upon reading the present disclosure. Again, the inventive concepts presented herein shall be understood as including, but not requiring, omission of distinct current collector components, according to various embodiments.

Accordingly, electrodes of the illustrative electrochemical cell implementations may be distinct structures, such as three dimensional monoliths, which may optionally be porous, have surface(s) thereof functionalized in order to enhance, suppress, or otherwise modify functional characteristics thereof (such as permeability, reactivity, etc. to select chemical species present within the electrochemical cell) without limitation. Electrodes may optionally or additionally include indeterminate structures, such as solutions that exhibit functional characteristics of monolithic electrode structures, but are present partially or wholly in the form of a solution. Further still, electrodes may be physically arranged in various configurations, such as thin films which may be sprayed or deposited on a suitable substrate; a one or more (flat) layers which may be sprayed or deposited on a suitable substrate or as free-standing structures; as a plurality of rows and/or channels (e.g., as may be formed in a suitable electrode material, or as may be formed as a result of stacking various layers of an electrochemical cell, rolling a multilayered electrochemical cell, etc.) as would be understood by those having ordinary skill in the art upon reading the present disclosure.

Optionally, electrodes may be coated with a protective layer designed to facilitate or mitigate predetermined chemical or physical interactions with other components of the electrochemical cell, such as reactions that consume electrode active material, form dendritic structures extending from the electrode, etc. as would be understood by those having ordinary skill in the art upon reading the present disclosure. In like manner, an electrode may include a plurality of particles (e.g. of active material) dispersed within or throughout the volume of a binder such as a polymer matrix, and the binder may be or include material(s) that facilitate or mitigate desired or undesired interactions within the electrochemical cell, respectively. In still more approaches, electrolyte(s) may be operatively, chemically, or electrically coupled to a membrane or membrane(s) configured (e.g., according to physical characteristics such as porosity, lack of porosity, spatial arrangement, surface area, etc., or chemically configured, e.g. according to chemical composition, specific functionalization (e.g., of surface(s) of the membrane), etc.) to isolate the electrolyte and/or chemical species formed or derived therefrom from other components of the electrochemical cell.

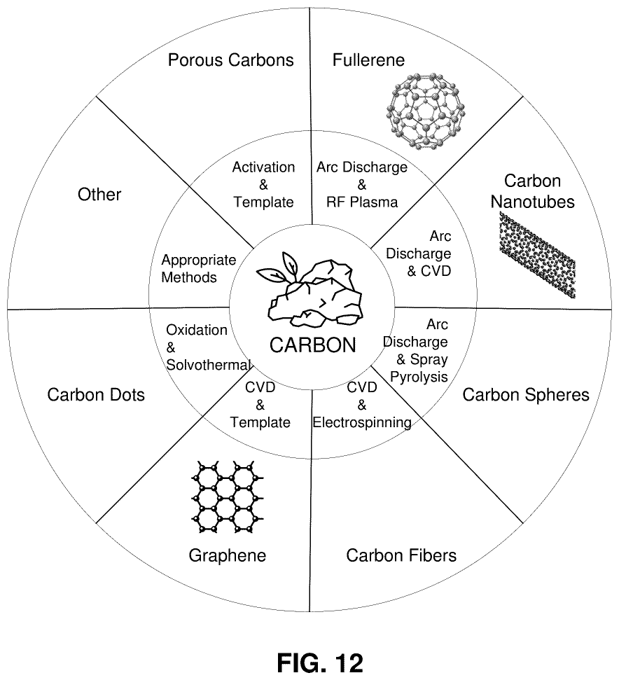

In particularly preferred approaches, electrodes may include one or more carbonaceous materials such as shown in FIG. 12 and described in greater detail hereinbelow.

It shall be appreciated that electrolytes in accordance with the presently disclosed inventive concepts may have any suitable chemical composition that would be understood by a person having ordinary skill in the art taking into consideration the particular context of the electrochemical cell, e.g., the chemical composition and structural arrangement of various other components included in the electrochemical cell.

Similarly, electrolyte(s) present in various electrochemical cells may be in liquid form, may be or include solid state electrolyte composition(s), may be or include gel-phase or gel-based electrolytes (such as gel polymer electrolytes), or any combination thereof that would be appreciated by those having ordinary skill in the art upon reading the present disclosure. Similarly, electrolytes may include semi-solid compositions such as gels, slurries, suspensions, etc. as would be appreciated by those having ordinary skill in the art upon reading the instant disclosure.

Separator(s), which may also be omitted in accordance with certain aspects of the inventive concepts described herein, may be or include any suitable composition or structure known in the art and which skilled artisans reading the present disclosure will appreciate are compatible with the inventive compositions and/or structures described herein. For instance, separator(s) may include impermeable, solid structures, semi-permeable membranes, selectively permeable compositions (i.e., compositions that are permeable to one or more predetermined chemical species, but impermeable or substantially impermeable to select, or all, other chemical species, according to various embodiments). For example, separators may be configured to physically, chemically, electrically, or otherwise functionally separate or segregate different components of the electrochemical cell from one another in order to avoid undesirable chemical reactions (such as parasitic reactions between electrolyte or derivatives thereof and electrodes, polysulfide shuttling, dendrite formation, etc. as would be understood by those having ordinary skill in the art upon reading the instant descriptions).

In addition, the exemplary electrochemical cells, in any configuration described herein or equivalents thereof that would be appreciated by those having ordinary skill in the art upon reading the instant disclosure, may include one or more mechanisms for mitigating or preventing polysulfide shuttling, dendrite formation, parasitic reactions between electrode(s) and electrolyte(s) (as well as species formed or derived from electrodes or electrolytes during operation of the electrochemical cell), or other chemical species present in the electrochemical cell environment. These mechanisms may be inherent to one or more of the exemplary structures described hereinabove (e.g., electrodes, separators, electrolytes, etc.), or may be specifically configured via specific modification, functionalization, structural arrangement, etc. of the particular components of the electrochemical cell. Any such characteristics, whether inherently present or specifically configured, are described in greater detail herein in accordance with various exemplary embodiments of the inventive concepts presently disclosed.

From the foregoing general descriptions and corresponding drawings, skilled artisans reviewing the present application will appreciate that, according to different implementations, electrochemical cells as described herein include a variety of components which each have a specific, core role in function of the electrochemical cell as a whole (e.g., electrodes facilitating electrical contact between electrolyte and an environment external to the electrochemical cell; separators serving to isolate or segregate various components, chemical species, etc. from one another within the electrochemical cell environment; and electrolyte facilitating charge transfer between electrodes of the electrochemical cell), the various components may optionally serve or convey one or more additional functions to the electrochemical cell. For instance, and as mentioned above, electrodes or separators may serve, in addition to their respective core roles, as current collectors, allowing omission of separate (often heavy, metal) structures dedicated to collecting current generated by the electrochemical cell.

In various aspects, any one or more component(s) of the electrochemical cell arrangements described herein may include one or more carbonaceous materials, including but not limited to those shown in FIG. 12. For example, certain components may include carbonaceous materials, carbonaceous materials may be included in addition to the various components shown and described with reference to FIGS. 8A-11, or both, as would be appreciated by those having ordinary skill in the art upon reading the present disclosures. In myriad embodiments, exemplary carbonaceous materials may include, without limitation, carbon black, carbon nano-onions (CNOs), necked CNOs, carbon nanospheres, graphite, pyrolytic graphite, graphene, graphene nanoparticles, graphene platelets, three-dimensional (3D) graphene, graphene oxides, fullerenes, hybrid fullerenes, single-walled nanotubes, multi-walled nanotubes, carbon dots, carbon spheres, porous carbons, carbon fibers, etc. as would be understood by skilled artisans upon reading the present descriptions. Additional details regarding the fabrication of select carbonaceous materials and characteristics thereof, particularly those shown in FIG. 12, are provided by Li, et al. “Synthesis, modification strategies and applications of coal-based materials”, Fuel Processing Tech., 230:1, 107203 (June 2022) (https://doi.org/10.1016/j.fuproc.2022.107203).

Moreover, the exemplary components of electrochemical cells described hereinabove, particularly as shown in FIGS. 8-11, may be present in a single cell “stack” (e.g., two opposing electrodes with corresponding separator, electrolyte, etc. arranged therebetween) or in a repeating (e.g., laminar) structure, according to various embodiments. A simplified repeating structure may, for example, include a first cathode (optionally coupled to a first cathode current collector) at one end of the electrochemical cell, which is immediately adjacent to a first electrolyte, which in turn is immediately adjacent to a first separator, which in turn is immediately adjacent to a second electrolyte, which in turn is immediately adjacent to a first anode (optionally coupled to a first anode current collector) positioned toward an opposing end of the electrochemical cell as the first cathode, collectively forming a single electrochemical cell layer. The repeating structure may further comprise additional electrolyte, separator, and electrode structures in a similar manner to form a multilayered, repeating pattern within the resulting electrochemical cell.

Whether including repeating structures or not, in various approaches, electrochemical cells may be manipulated, configured, arranged, etc. during fabrication of a larger structure (such as a battery). For instance, and as will be appreciated by those having ordinary skill in the art upon reviewing the inventive concepts described herein, in some approaches an electrochemical cell such as shown in FIG. 8B may be “rolled” around a central axis, forming a so-called “jelly roll” configuration, as shown in FIG. 8C according to one embodiment, which may be particularly suitable for certain arrangements or applications, such as for cylindrical or prismatic electrochemical cell embodiments, among others that skilled artisans will comprehend upon reviewing the present disclosure.

While the foregoing electrode, electrolyte, and separator components are the most common and critical aspects of the exemplary electrochemical cell as described herein, it shall be appreciated that according to various implementations electrochemical cells may, or may not, include any suitable combination or permutation of additional or alternative components, such as membranes, cans, caps, casings, wrappings, springs, wires, spacers, tabs, contacts, leads, gaskets, compressive structures or mechanisms, etc. as would be understood by a person having ordinary skill in the art upon reading the present descriptions.

Moreover, it shall be appreciated that persons having ordinary skill in the art may employ the various electrochemical cell embodiments described herein, including but not limited to coin cell arrangements, cylindrical cell arrangements, pouch cell arrangements, prismatic cell arrangements, etc. or any suitable equivalent(s) thereof that would be understood by said skilled artisan upon reading the present disclosure, in any effective permutation or combination, without departing from the scope of the inventive concepts in this disclosure. For instance, multiple of the same arrangements, combinations of different arrangements, or both, may be employed, e.g., to form a battery, or an assembly (e.g., a battery module, or a battery pack, etc. as would be understood by persons having ordinary skill in the art upon reading the present disclosure).

For example, those having ordinary skill in the art will appreciate that different arrangements described herein may have different advantages or disadvantages in the context of different applications, and may choose to employ the most advantageous arrangements of the particular application of interest. Additionally or alternatively, a skilled artisan may include different arrangements to provide robustness across different applications or working conditions to the resulting structure, providing flexibility of use, redundant failure points, or other advantage that would be understood by those having ordinary skill in the art in light of the particular application in mind.

As a concrete example, cylindrical cells are, relative to other arrangements described herein, are prone to cracking. Accordingly, a cylindrical cell arrangement such as shown in FIGS. 10A and 10B may not be applicable to or compatible with a prismatic cell configuration such as shown in FIG. 11, depending on the intended application for a given electrochemical cell, such as applications involving substantial and/or frequent application of mechanical forces (e.g. rapid acceleration/deceleration, vibration, etc. such as often experienced in vehicular applications. Similarly, pouch cell arrangements are particularly sensitive to volumetric expansion and contraction that occurs during natural operation and cycling of the electrochemical cell, and may require or benefit from additional support such as a compressive structure or internal mechanism (e.g. a polymeric support network such as described in U.S. Pat. No. 12,009,531, granted Jun. 11, 2024 and entitled “Internally enclosed support system for batteries, fabrication techniques and applications for the same”, the contents of which are herein incorporated by reference).

Moreover, while exemplary electrochemical cell arrangements expressly described herein and shown in the various FIGs include a pouch cell arrangement, a coin cell arrangement, a cylindrical cell arrangement, and a prismatic cell arrangement, other arrangements and/or components may be utilized without departing from the scope of the inventive concepts presented in this disclosure. For example, electrochemical cell arrangements may additionally or alternatively include components or be characterized by arrangements such as chassis, trays, packs, modules, assemblies, casings, etc. as would be understood by those having ordinary skill in the art upon reading the present disclosure.

Of course, the electrochemical cells described herein, according to various embodiments, may include external component(s) at least partially surrounding the electrochemical cell. For instance, exemplary external components may be selected from the group consisting of an external casing enclosing the electrochemical cell, a module operatively coupled to the electrochemical cell, an assembly operatively coupled to the electrochemical cell, a pack enclosing the electrochemical cell, a pouch enclosing the electrochemical cell, a can enclosing the electrochemical cell, a tray operatively coupled to the electrochemical cell, a pan operatively coupled to the electrochemical cell, and combinations thereof. The assembly may comprise: a parallel assembly, an in-series assembly, or a cell-to-chassis assembly. In still further embodiments, an electrochemical cell may be integrated into, or may be a part of, a structural component of the device to which the electrochemical cell is providing power, such as being integrated into a structural component of an electric vehicle.

The presently described inventive concepts include fabricating electrochemical cells of various types using additive manufacturing techniques, injection molding techniques, compression molding techniques, hybrid injection/compression molding techniques, preforming techniques, hand layup techniques, casting techniques, infusion techniques, sintering techniques, or any combination thereof that would be appreciated by a skilled artisan upon reading the present disclosure.

It should be understood that the arrangement of components illustrated in the FIGs described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described FIGs. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

For instance, in accordance with one implementation, the inventive concepts presented herein include one or more of the following compounds, features, configurations, etc., in any suitable combination or permutation that would be understood by a person having ordinary skill in the art upon reading the present disclosures: an electrolyte system comprising: at least one solvent; at least one electron withdrawing compound; at least one performance enhancing additive; and at least one lithium ion-transporting compound. The at least one solvent may include at least one ether, and preferably is selected from the group consisting of: dimethoxyethane (DME), dioxolane (DOL), dimethyl sulfoxide (DMSO), dimethyl formamide (DMF), toluene, tetramethyl urea (TMU), tetrabutylammonium hydroxide (TBA), dimethylacetamide (DMA), tetrahydrofuran (THF), diethylene glycol dimethyl ether (diglyme or DEGDME), acetonitrile (ACN), dimethyl trisulfide (DMTS), diisopropyl ether (DIPE), tetrahydrofuran (THF), 1,2-diaminopropane (DAP), triethylene glycol dimethyl ether (Triglyme/trigDME), tetraethylene glycol dimethyl ether (Tetraglyme/TEGDME), sulfolane (SUL), methyl tert-butyl ether (MTBE), 2,2,3,3-tetrafluoro-1,4-dimethoxybutane (FDMB), bis(2,2,2, trifluoroethyl) ether (BTFE), 1H,1H,5H-octafluoropentyl 1,1,2,2-tetrafluoroethyl ether (OFE), (1,1,2,2-tetrafluoroethyl 2,2,3,3-tetrafluoropropyl ether (TTE), 2,2,2-trifluoroethyl 1,1,2,2-tetrafluoroethyl ether (TFETFE), 1,1,2,2-tetrafluoroethyl isobutyl ether (TFEIE), 1,1,2,3,3,3-hexafluoropropyl 2,2,2-trifluoroethyl ether (THE), methoxyperfluorobutane (MPB), bis(2,2-difluoroethyl) ether (DFE), 2,2,2-trifluoroethyl methyl ether (TFEME), bis (2-fluoroethyl) ether (BFE), bis(2,2,2, trifluoroethyl) ether (BTFE), 3-fluoropyridine (3FP), 1,2-(1,1,2,2-tetrafluoroethoxy) ethane (TFEE), 1,2-dimethoxy-1,1,2,2-tetrafluoroethane (DMETF), 2-methyl-1(1,1,2,2-tetrafluoroethoxy) propane (TFEIBE), bis(2,2,3,3,3-pentafluoropropyl) ether (BPFPE), allyl 2,2,3,3,3-pentafluoropropyl ether (APFPE), hydrocarbons, and combinations thereof. The at least one solvent is cumulatively present in an amount ranging from greater than 0 vol % of the electrolyte system to about 75 vol % of the electrolyte system. Moreover, the at least one electron withdrawing group comprises at least one compound characterized by an alpha-hydrogenated, beta-functionalized motif, and preferably includes at least one electron withdrawing compound is selected from the group consisting of: 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), bis(2,2,2, trifluoroethyl) ether (BTFE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 3-fluoropyridine (3FP), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, isosorbide dinitrate (ISDN), bis(2-fluoroethyl) ether (BFE), and combinations thereof. The at least one electron withdrawing compound is cumulatively present in an amount preferably ranging from greater than 0 vol % of the electrolyte system to about 75 vol % of the electrolyte system. The at least one performance-enhancing additive comprises dicyandiamide (DCDA), and is present in an amount ranging from about 0.01 M to about 0.2 M. The at least one lithium ion-transporting compound comprises at least one lithium salt, and preferably is selected from the group consisting of: lithium bis(trifluoromethanesulfonyl)imide (LiTFSI), lithium nitrate (LiNO₃), lithium Perchlorate (LiClO₄), lithium difluoro(oxalato)borate (LiFOB), lithium bis (oxalato)borate (LiBOB), lithium trifilate (LiTf), lithium bis(pentafluoroethanesulfonyl)imide (LiBETi), lithium bis(fluorosulfonyl)imide (LiFSI), lithium trifluoroacetate (LiTFAc), and combinations thereof. The lithium ion-transporting compound is present in an amount ranging from about 0.1 M to about 10 M. Moreover, the electrolyte system may include at least one chalcogenide, which is preferably selected from the group consisting of: dimethyl diselenide (DMDSe), dipheyl diselenide (DPDSe), dimethyl ditelluride (DMDTe), diphenyl ditelluride (DPDTe), and combination(s) thereof, and is preferably present in an amount ranging from about 0.1 wt % to about 3.0 wt %. The inventive electrolyte system may be embodied in an electrochemical cell, which may have a configuration such as described herein, including a pouch configuration, a coin configuration, a cylindrical configuration, or a prismatic configuration. Said electrochemical cells may or may not include a distinct structure serving as a current collector.

According to another implementation, the inventive concepts presented herein include one or more of the following compounds, features, configurations, etc., in any suitable combination or permutation that would be understood by a person having ordinary skill in the art upon reading the present disclosures: an electrolyte system comprising: a solvent system; at least one electron withdrawing compound; and at least one lithium ion-transporting compound. The solvent system includes at least one solvent, which preferably is selected from the group consisting of: dimethoxyethane (DME), dioxolane (DOL), dimethyl sulfoxide (DMSO), dimethyl formamide (DMF), toluene, tetramethyl urea (TMU), tetrabutylammonium hydroxide (TBA), dimethylacetamide (DMA), tetrahydrofuran (THF), diethylene glycol dimethyl ether (diglyme or DEGDME), acetonitrile (ACN), dimethyl trisulfide (DMTS), diisopropyl ether (DIPE), tetrahydrofuran (THF), 1,2-diaminopropane (DAP), triethylene glycol dimethyl ether (Triglyme/trigDME), tetraethylene glycol dimethyl ether (Tetraglyme/TEGDME), sulfolane (SUL), methyl tert-butyl ether (MTBE), 2,2,3,3-tetrafluoro-1,4-dimethoxybutane (FDMB), bis(2,2,2, trifluoroethyl) ether (BTFE), 1H,1H,5H-octafluoropentyl 1,1,2,2-tetrafluoroethyl ether (OFE), (1,1,2,2-tetrafluoroethyl 2,2,3,3-tetrafluoropropyl ether (TTE), 2,2,2-trifluoroethyl 1,1,2,2-tetrafluoroethyl ether (TFETFE), 1,1,2,2-tetrafluoroethyl isobutyl ether (TFEIE), 1,1,2,3,3,3-hexafluoropropyl 2,2,2-trifluoroethyl ether (THE), methoxyperfluorobutane (MPB), bis(2,2-difluoroethyl) ether (DFE), 2,2,2-trifluoroethyl methyl ether (TFEME), bis (2-fluoroethyl) ether (BFE), bis(2,2,2, trifluoroethyl) ether (BTFE), 3-fluoropyridine (3FP), 1,2-(1,1,2,2-tetrafluoroethoxy) ethane (TFEE), 1,2-dimethoxy-1,1,2,2-tetrafluoroethane (DMETF), 2-methyl-1(1,1,2,2-tetrafluoroethoxy) propane (TFEIBE), bis(2,2,3,3,3-pentafluoropropyl) ether (BPFPE), allyl 2,2,3,3,3-pentafluoropropyl ether (APFPE), hydrocarbons, and combinations thereof. The solvent system comprises greater than 0 vol % of the electrolyte system to about 75 vol % of the electrolyte system. Moreover, the at least one electron withdrawing group comprises at least one compound characterized by an alpha-hydrogenated, beta-functionalized motif, and preferably includes at least one electron withdrawing compound is selected from the group consisting of: 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), bis(2,2,2, trifluoroethyl) ether (BTFE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 3-fluoropyridine (3FP), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, isosorbide dinitrate (ISDN), bis(2-fluoroethyl) ether (BFE), and combinations thereof. The at least one electron withdrawing compound is cumulatively present in an amount preferably ranging from greater than 0 vol % of the electrolyte system to about 75 vol % of the electrolyte system. The at least one electron withdrawing compound comprises at least one alpha-hydrogenated, selectively beta-modified motif, and the at least one alpha-hydrogenated, selectively beta-modified motif excludes fluorine. In other aspects, the at least one electron withdrawing compound excludes fluorine. The at least one lithium ion-transporting compound comprises at least one lithium salt, and preferably is selected from the group consisting of: lithium bis(trifluoromethanesulfonyl)imide (LiTFSI), lithium nitrate (LiNO₃), lithium Perchlorate (LiClO₄), lithium difluoro(oxalato)borate (LiFOB), lithium bis (oxalato)borate (LiBOB), lithium trifilate (LiTf), lithium bis(pentafluoroethanesulfonyl)imide (LiBETi), lithium bis(fluorosulfonyl)imide (LiFSI), lithium trifluoroacetate (LiTFAc), and combinations thereof. The at least one lithium ion-transporting compound is present in an amount ranging from about 0.1 M to about 10 M. The inventive electrolyte system may be embodied in an electrochemical cell, which may have a configuration such as described herein, including a pouch configuration, a coin configuration, a cylindrical configuration, or a prismatic configuration. Said electrochemical cells may or may not include a distinct structure serving as a current collector.

In still yet more implementations, a lithium-based anode includes one or more of the following compounds, features, configurations, etc., in any suitable combination or permutation that would be understood by a person having ordinary skill in the art upon reading the present disclosures: an interphase formed on surface(s) of the lithium-based anode, wherein the interphase is formed by interaction between an active material of the lithium-based anode and a derivative of at least one electron withdrawing compound. The at least one electron withdrawing compound preferably comprises at least one alpha-hydrogenated, selectively beta-modified motif, where the at least one alpha-hydrogenated, selectively beta-modified motif excludes fluorine and/or the at least one electron withdrawing compound excludes fluorine as a whole. Preferably, the at least one electron withdrawing compound is includes at least one electron withdrawing compound that is selected from the group consisting of: 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), bis(2,2,2, trifluoroethyl) ether (BTFE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 3-fluoropyridine (3FP), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, isosorbide dinitrate (ISDN), bis(2-fluoroethyl) ether (BFE), and combinations thereof. An active material of the lithium-based anode preferably comprises elemental lithium or a lithium alloy, where the lithium alloy comprises lithium-magnesium, lithium-sulfur, or a combination thereof. The inventive anode may be embodied in an electrochemical cell, which may have a configuration such as described herein, including a pouch configuration, a coin configuration, a cylindrical configuration, or a prismatic configuration. Said electrochemical cells may or may not include a distinct structure serving as a current collector.

In still yet more implementations, a electrolyte system includes one or more of the following compounds, features, configurations, etc., in any suitable combination or permutation that would be understood by a person having ordinary skill in the art upon reading the present disclosures: a solvent system; at least one electron withdrawing compound; at least one lithium ion-transporting compound; and at least one chalcogenide. The solvent system includes at least one solvent, which preferably is selected from the group consisting of: dimethoxyethane (DME), dioxolane (DOL), dimethyl sulfoxide (DMSO), dimethyl formamide (DMF), toluene, tetramethyl urea (TMU), tetrabutylammonium hydroxide (TBA), dimethylacetamide (DMA), tetrahydrofuran (THF), diethylene glycol dimethyl ether (diglyme or DEGDME), acetonitrile (ACN), dimethyl trisulfide (DMTS), diisopropyl ether (DIPE), tetrahydrofuran (THF), 1,2-diaminopropane (DAP), triethylene glycol dimethyl ether (Triglyme/trigDME), tetraethylene glycol dimethyl ether (Tetraglyme/TEGDME), sulfolane (SUL), methyl tert-butyl ether (MTBE), 2,2,3,3-tetrafluoro-1,4-dimethoxybutane (FDMB), bis(2,2,2, trifluoroethyl) ether (BTFE), 1H,1H,5H-octafluoropentyl 1,1,2,2-tetrafluoroethyl ether (OFE), (1,1,2,2-tetrafluoroethyl 2,2,3,3-tetrafluoropropyl ether (TTE), 2,2,2-trifluoroethyl 1,1,2,2-tetrafluoroethyl ether (TFETFE), 1,1,2,2-tetrafluoroethyl isobutyl ether (TFEIE), 1,1,2,3,3,3-hexafluoropropyl 2,2,2-trifluoroethyl ether (THE), methoxyperfluorobutane (MPB), bis(2,2-difluoroethyl) ether (DFE), 2,2,2-trifluoroethyl methyl ether (TFEME), bis (2-fluoroethyl) ether (BFE), bis(2,2,2, trifluoroethyl) ether (BTFE), 3-fluoropyridine (3FP), 1,2-(1,1,2,2-tetrafluoroethoxy) ethane (TFEE), 1,2-dimethoxy-1,1,2,2-tetrafluoroethane (DMETF), 2-methyl-1(1,1,2,2-tetrafluoroethoxy) propane (TFEIBE), bis(2,2,3,3,3-pentafluoropropyl) ether (BPFPE), allyl 2,2,3,3,3-pentafluoropropyl ether (APFPE), hydrocarbons, and combinations thereof. The solvent system comprises greater than 0 vol % of the electrolyte system to about 75 vol % of the electrolyte system. Moreover, the at least one electron withdrawing group comprises at least one compound characterized by an alpha-hydrogenated, beta-functionalized motif, and preferably includes at least one electron withdrawing compound is selected from the group consisting of: 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), bis(2,2,2, trifluoroethyl) ether (BTFE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 3-fluoropyridine (3FP), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, isosorbide dinitrate (ISDN), bis(2-fluoroethyl) ether (BFE), and combinations thereof. The at least one electron withdrawing compound is cumulatively present in an amount preferably ranging from greater than 0 vol % of the electrolyte system to about 75 vol % of the electrolyte system. The at least one electron withdrawing compound comprises at least one alpha-hydrogenated, selectively beta-modified motif, and the at least one alpha-hydrogenated, selectively beta-modified motif excludes fluorine. In other aspects, the at least one electron withdrawing compound excludes fluorine. The at least one lithium ion-transporting compound comprises at least one lithium salt, and preferably is selected from the group consisting of: lithium bis(trifluoromethanesulfonyl)imide (LiTFSI), lithium nitrate (LiNO₃), lithium Perchlorate (LiClO₄), lithium difluoro(oxalato)borate (LiFOB), lithium bis (oxalato)borate (LiBOB), lithium trifilate (LiTf), lithium bis(pentafluoroethanesulfonyl)imide (LiBETi), lithium bis(fluorosulfonyl)imide (LiFSI), lithium trifluoroacetate (LiTFAc), and combinations thereof. The lithium ion-transporting compound is present in an amount ranging from about 0.1 M to about 10 M. The at least one chalcogenide is selected from the group consisting of: dimethyl diselenide (DMDSe), dipheyl diselenide (DPDSe), dimethyl ditelluride (DMDTe), diphenyl ditelluride (DPDTe), and combination(s) thereof, and is preferably present in an amount ranging from about 0.1 wt % to about 3.0 wt %. The inventive electrolyte system may be embodied in an electrochemical cell, which may have a configuration such as described herein, including a pouch configuration, a coin configuration, a cylindrical configuration, or a prismatic configuration. Said electrochemical cells may or may not include a distinct structure serving as a current collector.

### Highly Solvating Electrolyte for Lithium-Sulfur Batteries

The present disclosure relates to the field of lithium-sulfur battery technology, specifically focusing on electrolyte formulations designed to achieve high energy density performance in lightweight energy storage applications such as but not limited to drone systems, electric vehicles, and portable electronics.

Current lithium-sulfur battery systems encounter significant obstacles that limit their commercial viability, including the requirement for high electrolyte-to-sulfur ratios that often exceed 5:1, which substantially increases overall battery weight and reduces practical energy density. Existing electrolyte compositions struggle to provide adequate polysulfide solvation while maintaining electrochemical stability, leading to poor cycling performance and capacity fade. Additionally, conventional formulations fail to balance ionic conductivity, polysulfide dissolution kinetics, and electrode passivation effects within a single electrolyte system, forcing manufacturers to choose between performance characteristics rather than achieving both high energy density and long cycle life simultaneously.

The present disclosure addresses these challenges through a highly solvating electrolyte formulation comprising a high volume fraction of dimethoxyethane with moderate to low lithium salt concentrations, enabling operation under lean electrolyte conditions with electrolyte-to-sulfur ratios of 3.5:1 or even potentially lower. This approach maximizes non-coordinated ether groups for enhanced polysulfide solvation while reducing electrolyte weight contribution, thereby achieving both high specific capacity performance and improved energy density in practical battery configurations.

The disclosure further incorporates novel cell architecture features including reduced cathode mass loading below 5 mg/cm2, freestanding lithium anodes with thickness less than 100 microns, and specific additive systems such as dicyandiamide that enable extended cycle life without compromising energy density. The combination of optimized electrolyte composition with precise molar ratios of DME to lithium salts, along with the integration of lithium-magnesium alloy anodes and operation at reduced pressures below 50 PSI, provides a comprehensive solution that overcomes the traditional trade-offs between energy density and cycle life in lithium-sulfur battery systems.

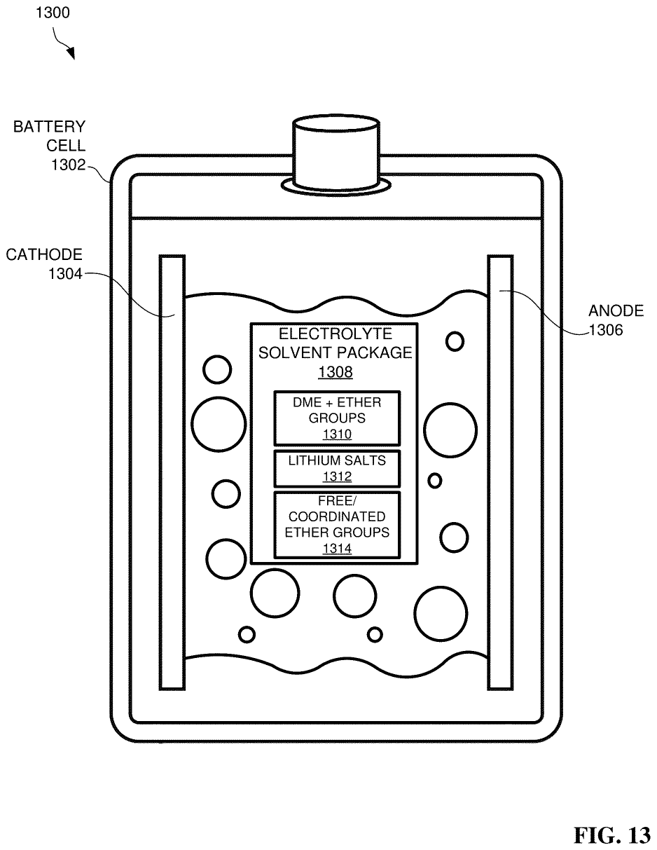

FIG. 13 illustrates a battery system 1300, in accordance with one embodiment. As an option, the battery system 1300 may be implemented in the context of any one or more of the embodiments set forth in any previous and/or subsequent Figures and/or description thereof. Of course, however, the battery system 1300 may be implemented in the context of any desired environment. Further, the aforementioned definitions may equally apply to the description below.

The battery system 1300 comprises a battery cell 1302 configured for lithium-sulfur electrochemical operation. The battery cell 1302 includes a cathode 1304 positioned within the cell structure to facilitate sulfur-based electrochemical reactions during discharge and charge cycles. The cathode 1304 comprises sulfur with a mass loading of less than 5 mg/cm2, which enables reduced lithium stripping per cycle and contributes to extended operational life of the battery cell 1302. In some cases, the reduced mass loading configuration allows the battery system 1300 to achieve enhanced cycle stability while maintaining electrochemical performance characteristics. The cathode 1304 may be configured with various sulfur-containing active materials that participate in the conversion reactions during battery operation.

In various embodiments, the cathode mass loading may be optimized to balance cycle life and energy density performance characteristics. The cathode comprising sulfur may have a mass loading below 5 mg/cm², more preferably below 4 mg/cm², and even more preferably between 2.5-3.5 mg/cm². Lower mass loading may generally correlate with enhanced cycle life performance, as reduced sulfur loading minimizes polysulfide concentration and associated shuttle effects during cycling operations. For balanced cell configurations that optimize both cycle life and energy density characteristics, the cathode mass loading may be approximately 3.5 mg/cm², which may provide one possible configuration and balance between energy density and electrochemical stability. In other embodiments, the optimal mass loading may vary depending on the specific carbon materials used in the cathode formulation, with carbon nanotube-based cathodes potentially achieving optimal performance at mass loadings below 3 mg/cm², while other carbon-based cathode architectures may require different loading ranges to achieve comparable performance characteristics.

The battery cell 1302 further includes an anode 1306 positioned opposite to the cathode 1304 within the cell architecture. The anode 1306 comprises lithium with a thickness of less than 100 microns, providing a compact electrode configuration that reduces overall cell weight and volume. In various embodiments, the anode 1306 may comprise a lithium alloy, such as a lithium-magnesium alloy, which can enhance mechanical stability and electrochemical properties compared to pure lithium configurations. The anode 1306 may be configured as a freestanding structure without a copper foil current collector, eliminating additional weight contributions from current collection infrastructure. This freestanding configuration allows the battery system 1300 to achieve higher gravimetric energy density by reducing inactive material content within the battery cell 1302.

An electrolyte solvent package 1308 is positioned between the cathode 1304 and the anode 1306 to facilitate ionic transport during electrochemical operation. The electrolyte solvent package 1308 comprises a solvent package having at least two solvents, with dimethoxyethane (DME) comprising at least 60% by volume of the solvent package. In some cases, the solvent package may include dioxolane (DOL) as a partial substitute for DME while maintaining overall ether functionality and solvation capability for polysulfide species. The electrolyte solvent package 1308 may also incorporate 1,1,2,2-Tetrafluoroethyl-2,2,3,3-tetrafluoropropyl ether (TTE) as a diluent to reduce viscosity and surface tension characteristics of the electrolyte composition. Additionally, trioxane may be included as a diluent component to reduce viscosity and surface tension while preventing premature cathode passivation during extended cycling operations.

The electrolyte solvent package 1308 contains DME+ether groups 1310 that provide solvation sites for polysulfide species generated during sulfur conversion reactions. The DME+ether groups 1310 interact with dissolved polysulfide intermediates to maintain solubility and prevent precipitation that could otherwise lead to capacity fade or cell failure. In some cases, the concentration and availability of the DME+ether groups 1310 directly influences the electrochemical kinetics and capacity retention characteristics of the battery system 1300.

Lithium salts 1312 may be distributed throughout the electrolyte solvent package 1308. In one embodiment, the lithium salts 1312 may be distributed at a total concentration below 1.2 M to provide ionic conductivity while maintaining adequate availability of non-coordinated ether groups.

In various embodiments, the lithium salts 1312 may include at least one lithium salt that may be lithium nitrate (LiNO3) and at least one additional lithium salt selected from the group consisting of lithium bis(trifluoromethanesulfonyl)imide (LiTFSI), lithium bis(fluorosulfonyl)imide (LiFSI), lithium perchlorate (LiClO4), and/or lithium trifluoromethanesulfonate (LiOTf). The concentration of the lithium salts 1312 may be configured to allow for sufficient ionic transport while avoiding excessive coordination with the DME+ether groups 1310 that could reduce polysulfide solvation capability. In various embodiments, the lithium salts 1312 may be formulated with specific molar ratios to optimize both ionic conductivity and ether group availability for enhanced electrochemical performance.

Free coordinated ether groups 1314 may represent the unoccupied coordination sites within the DME ether groups 1310 that remain available for polysulfide solvation after lithium salt coordination. The free coordinated ether groups 1314 may provide enhanced polysulfide dissolution capability by maintaining excess solvation sites that can accommodate the various polysulfide species formed during sulfur conversion reactions. The concentration of the free coordinated ether groups 1314 may be controlled through the ratio of DME to lithium salt concentrations, with higher DME content and lower salt concentrations resulting in greater availability of solvation sites. In some cases, the free coordinated ether groups 1314 enable the battery system 1300 to operate under lean electrolyte conditions with an electrolyte-to-sulfur mass ratio of less than or equal to 3.5:1 while maintaining electrochemical performance.

The interaction between the DME+ether groups 1310, lithium salts 1312, and free coordinated ether groups 1314 within the electrolyte solvent package 1308 may create a balanced electrochemical environment that supports high energy density operation. The coordinated system allows for efficient polysulfide dissolution and transport while maintaining ionic conductivity through the lithium salts 1312.

The battery system 1300 addresses limitations in conventional lithium-sulfur technology by providing an approach to electrolyte composition and cell architecture optimization. Traditional lithium-sulfur systems often require high electrolyte-to-sulfur ratios exceeding 5:1, which substantially increases battery weight and reduces practical energy density for applications requiring lightweight energy storage solutions. The present disclosure resolves these limitations through the combination of high DME content with moderate lithium salt concentrations, enabling stable operation at reduced electrolyte quantities while maintaining polysulfide solvation capability. The integration of reduced cathode mass loading with thin anode configurations further contributes to weight reduction without compromising electrochemical performance, providing a comprehensive solution to the energy density challenges in lithium-sulfur battery technology.

By way of a practical example, in various embodiments, the battery system 1300 may be implemented in drone applications to achieve high energy density with reduced electrolyte weight for improved flight time and payload capacity. The lightweight configuration enabled by the lean electrolyte conditions and optimized cell architecture allows drone systems to carry larger payloads or operate for extended periods compared to conventional battery technologies. The battery system 1300 may also be utilized in electric vehicle applications to develop lightweight, high-capacity energy storage systems that extend driving range while reducing overall vehicle weight and energy consumption. In automotive implementations, the reduced electrolyte requirements and compact cell design contribute to improved packaging efficiency and thermal management characteristics.

The battery system 1300 may be applied in portable electronics manufacturing for smartphones, laptops, and wearable devices where lean electrolyte conditions enable smaller, lighter batteries with extended operational capacity. The reduced electrolyte volume requirements allow for more compact battery designs that can fit within the space constraints of modern portable electronic devices while providing enhanced energy storage capability. Additionally, the battery system 1300 may be implemented in grid-scale energy storage systems to improve economic viability of renewable energy storage through reduced material costs and enhanced energy density performance. In grid applications, the reduced electrolyte requirements translate to lower material costs and simplified manufacturing processes that can improve the economic competitiveness of large-scale energy storage installations.

The battery system 1300 may be utilized in aerospace applications for satellite and spacecraft power systems where high energy density and reduced electrolyte mass provide advantages for space missions with strict weight constraints. The lean electrolyte configuration reduces launch costs associated with payload weight while providing reliable energy storage for extended mission durations. In aerospace implementations, the freestanding anode configuration eliminates copper foil current collectors that contribute additional weight without providing electrochemical functionality, further enhancing the gravimetric energy density characteristics. The combination of reduced cathode mass loading, thin lithium alloy anodes, and optimized electrolyte composition creates a battery system architecture that addresses the specific requirements of weight-sensitive applications while maintaining electrochemical performance and operational reliability.

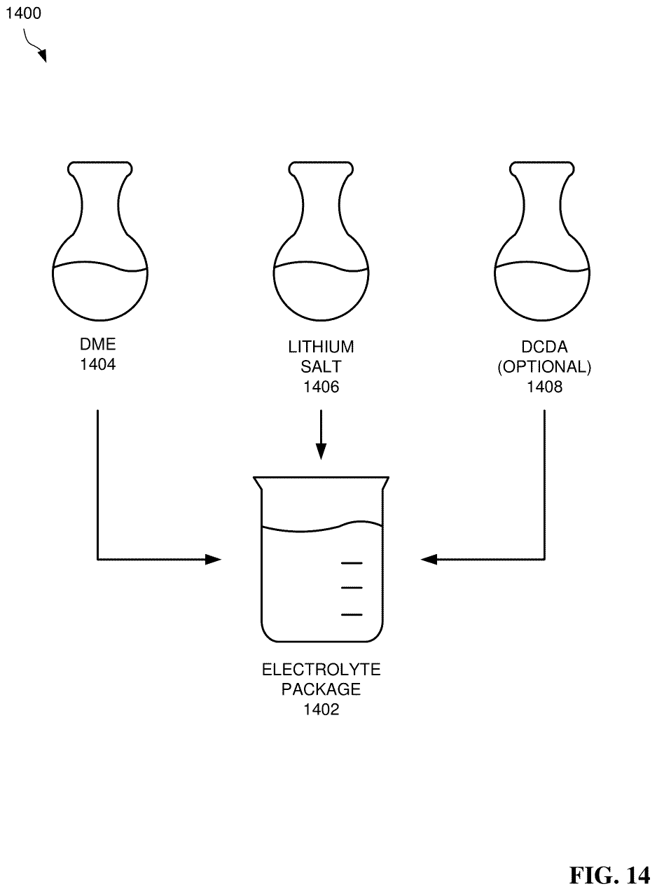

FIG. 14 illustrates an electrolyte system 1400, in accordance with one embodiment. As an option, the electrolyte system 1400 may be implemented in the context of any one or more of the embodiments set forth in any previous and/or subsequent Figures and/or description thereof. Of course, however, the electrolyte system 1400 may be implemented in the context of any desired environment. Further, the aforementioned definitions may equally apply to the description below.

The electrolyte system 1400 comprises a electrolyte package 1402 configured to provide ionic transport and polysulfide solvation capabilities for lithium-sulfur electrochemical operations. The electrolyte package 1402 receives multiple component streams that combine to form the final electrolyte composition with controlled ratios of solvents, salts, and additives. In some cases, the electrolyte package 1402 may be formulated to contain at least two solvents to provide enhanced electrochemical performance characteristics compared to binary solvent systems.

DME 1404 supplies dimethoxyethane to the electrolyte package 1402 at a preconfigured and desired volumetric fraction within the final electrolyte composition. The DME 1404 may be configured to deliver DME at concentrations comprising at least 70% by volume of the electrolyte package 1402 to maximize non-coordinated ether groups available for polysulfide solvation.

Lithium salt 1406 provides lithium salt components to the electrolyte package 1402 with controlled concentration levels that balance ionic conductivity requirements with ether group availability for polysulfide solvation. For example, the lithium salt 1406 may include lithium bis(fluorosulfonyl)imide (LiFSI), LiTFSI, lithium perchlorate (LiClO4), lithium trifluoromethanesulfonate (LiOTf), etc. as an alternative lithium salt component with distinct solvation properties and electrochemical characteristics. The electrolyte system 1400 may be configured to operate with salt concentrations in the higher range of 0.8-1.2 M for improved ionic conductivity when enhanced transport properties are required for specific applications or operating conditions.

DCDA 1408 provides dicyandiamide (DCDA) additive to the electrolyte package 1402 to enhance cycle life and electrochemical stability of the resulting electrolyte composition. The DCDA 1408 may be configured at a concentration of about 0.15 M within the final electrolyte formulation to provide optimal additive effects without compromising ionic conductivity or polysulfide solvation capability.

In some cases, the DCDA 1408 may interact with electrode surfaces to form protective layers that prevent unwanted side reactions and extend operational life of lithium-sulfur cells.

The electrolyte system 1400 may incorporate organodiselenocompounds, particularly diphenyl diselenide (DPhDSe), as additives to enhance cycle life and specific capacity performance beyond what may be achieved with DCDA alone. In various embodiments, the electrolyte system 1400 may incorporate multiple additives simultaneously, such as combining DCDA with organodiselenocompounds for synergistic effects that provide enhanced electrochemical performance compared to individual additive systems. The combination of multiple additives within the electrolyte system 1400 may create complementary mechanisms for electrode protection, polysulfide management, and ionic transport enhancement. The electrolyte system 1400 may also operate with diluent concentrations up to 25% volume fraction of the electrolyte package 1402 to modify viscosity, surface tension, and wetting characteristics of the final electrolyte composition.

The electrolyte system 1400 may be formulated without lithium nitrate using LiTFSI, LiFSI, LiClO4, and/or LiOTf for simplified formulation processes that reduce the number of required salt components while maintaining electrochemical functionality. This simplified approach may reduce manufacturing complexity and material handling requirements while providing adequate ionic conductivity and electrochemical stability for specific applications. In some cases, the elimination of lithium nitrate from the electrolyte system 1400 may allow for higher concentrations of other lithium salts that provide enhanced transport properties or improved compatibility with specific electrode materials.

The electrolyte system 1400 may be formulated using computer program instructions to determine optimal solvent package composition and calculate lithium salt concentrations based on desired electrochemical performance parameters and operating conditions. For example, the computer program instructions may analyze multiple formulation variables simultaneously to identify optimal component ratios that maximize energy density, cycle life, and/or rate capability based on specific application requirements.

In various embodiments, the electrolyte system 1400 may incorporate alternative lithium salt systems beyond LiTFSI and LiNO₃ to provide enhanced electrochemical performance characteristics. The lithium salt 1406 may supply lithium bis(fluorosulfonyl)imide (LiFSI) as an alternative or complementary lithium salt that offers improved ionic conductivity and reduced viscosity compared to conventional LiTFSI formulations. In some cases, the lithium salt 1406 may deliver lithium perchlorate (LiClO₄) which provides different coordination behavior with DME ether groups 1310 and may enable operation at higher concentrations without excessive ether group coordination. The electrolyte system 1400 may also incorporate lithium trifluoromethanesulfonate (LiOTf) as an alternative lithium salt component that offers distinct solvation properties and electrochemical stability characteristics under lean electrolyte operating conditions.

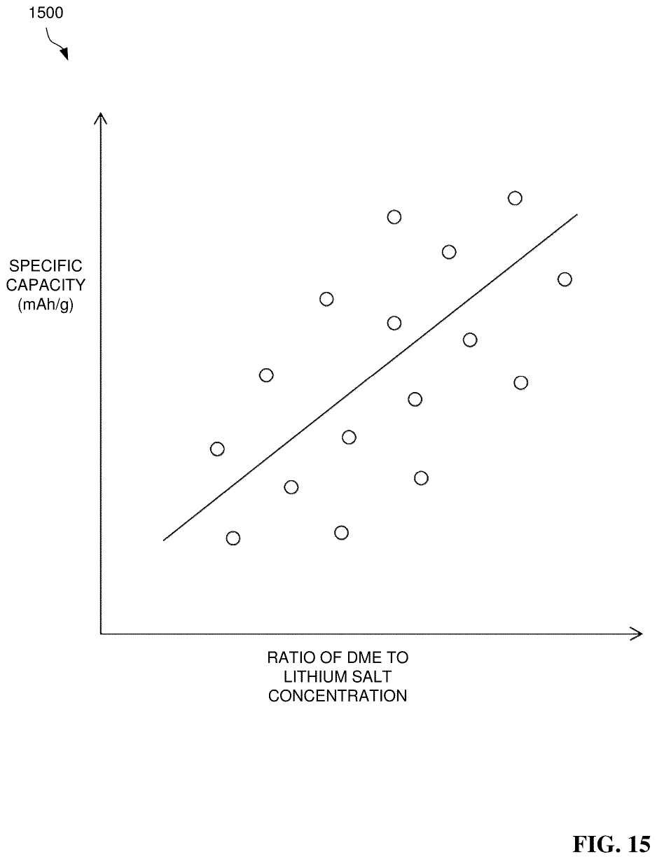

FIG. 15 illustrates a specific capacity graph 1500, in accordance with one embodiment. As an option, the specific capacity graph 1500 may be implemented in the context of any one or more of the embodiments set forth in any previous and/or subsequent Figures and/or description thereof. Of course, however, the specific capacity graph 1500 may be implemented in the context of any desired environment. Further, the aforementioned definitions may equally apply to the description below.

The specific capacity graph 1500 demonstrates the relationship between the ratio of DME to lithium salt concentration and specific capacity performance measured in mAh/g for lithium-sulfur electrochemical systems. The specific capacity graph 1500 displays multiple data points plotted along a trend line that illustrate how varying the molar ratio between DME and lithium salts affects the electrochemical performance characteristics of a battery system (such as the battery system 1300). In some cases, the specific capacity graph 1500 reveals that higher ratios of DME to lithium salt concentrations correspond to enhanced specific capacity values, indicating improved utilization of sulfur active material during discharge processes.

In various embodiments, the specific capacity graph 1500 may demonstrate that molar ratios of DME to LiTFSI of about 10.1:1 provide enhanced specific capacity performance compared to lower ratios where lithium salts occupy a larger fraction of available ether coordination sites. The specific capacity graph 1500 may also illustrate how molar ratios of DME to total lithium salts of about 5.52:1 contribute to optimized electrochemical performance by maintaining adequate ionic conductivity while preserving sufficient non-coordinated ether groups for polysulfide dissolution.

The data points plotted within the specific capacity graph 1500 may represent different electrolyte formulations that incorporate varying ratios of DME to lithium salt concentrations while maintaining other compositional parameters within specified ranges. Each data point in the specific capacity graph 1500 may correspond to electrochemical testing results obtained from battery cells configured with specific electrolyte compositions, providing empirical validation of the relationship between solvent ratios and performance characteristics.

In various embodiments, the electrolyte compositions disclosed herein may be systematically formulated using stoichiometric relationships demonstrated in the specific capacity graph 1500, which may illustrate the relationship between DME to lithium salt ratios and electrochemical performance. The specific capacity graph 1500 reveals that higher ratios of DME to lithium salt concentrations correspond to enhanced specific capacity values, indicating improved utilization of sulfur active material during discharge processes through increased availability of non-coordinated ether groups for polysulfide solvation.

As shown below, Tables 4A and 4B provide comprehensive stoichiometric compositions that enable systematic optimization of electrolyte formulations based on the fundamental principles demonstrated in the specific capacity graph 1500.

Table 4A presents solvent stoichiometric compositions that provide systematic variation of DME volume percentages and co-solvent ratios across multiple solvent systems including DME/DOL/BTFE, DME/DOL/TTE, DME/Trioxane, and quaternary combinations. Further, Table 4B presents solute stoichiometric compositions that provide systematic variation of lithium salt concentrations.

In various embodiments, the salt formulations in Table 4B may be coordinated with the solvent compositions in Table 4A to achieve target DME to lithium salt ratios, for example, that correspond to enhanced performance regions within the specific capacity graph 1500. Additionally, the integration of Tables 4A and 4B enables formulation of electrolyte compositions that achieve the optimal balance between polysulfide solvation capability and ionic transport properties.

TABLE 4A
SOLVENT STOICHIOMETRIC COMPOSITIONS

| | DME | DOL | BTFE | TTE | Trioxane |
|---|---|---|---|---|---|
| Solvent System | (vol %) | (vol %) | (vol %) | (vol %) | (vol %) |
| DME/BTFE/Trioxane | 60 | — | 30 | — | 10 |
| DME/BTFE/Trioxane | 65 | — | 25 | — | 10 |
| DME/BTFE/Trioxane | 70 | — | 20 | — | 10 |
| DME/BTFE/Trioxane | 75 | — | 15 | — | 10 |
| DME/BTFE/Trioxane | 80 | — | 10 | — | 10 |
| DME/BTFE/Trioxane | 70 | — | 25 | — | 5 |
| DME/BTFE/Trioxane | 75 | — | 20 | — | 5 |
| DME/BTFE/Trioxane | 80 | — | 15 | — | 5 |
| DME/BTFE/Trioxane | 85 | — | 10 | — | 5 |
| DME/BTFE/Trioxane | 50 | — | 40 | — | 10 |
| DME/BTFE/Trioxane | 55 | — | 35 | — | 10 |
| DME/BTFE/Trioxane | 85 | — | 5 | — | 10 |
| DME/BTFE/Trioxane | 90 | — | 5 | — | 5 |
| DME/BTFE/Trioxane | 50 | — | 45 | — | 5 |
| DME/BTFE/Trioxane | 55 | — | 40 | — | 5 |
| DME/BTFE/Trioxane | 60 | — | 35 | — | 5 |
| DME/BTFE/Trioxane | 65 | — | 30 | — | 5 |
| DME/BTFE/Trioxane | 50 | — | 35 | — | 15 |
| DME/BTFE/Trioxane | 55 | — | 30 | — | 15 |
| DME/BTFE/Trioxane | 60 | — | 25 | — | 15 |
| DME/BTFE/Trioxane | 65 | — | 20 | — | 15 |
| DME/BTFE/Trioxane | 70 | — | 15 | — | 15 |
| DME/BTFE/Trioxane | 75 | — | 10 | — | 15 |
| DME/BTFE/Trioxane | 80 | — | 5 | — | 15 |
| DME/BTFE/Trioxane | 50 | — | 30 | — | 20 |
| DME/BTFE/Trioxane | 55 | — | 25 | — | 20 |
| DME/BTFE/Trioxane | 60 | — | 20 | — | 20 |
| DME/BTFE/Trioxane | 65 | — | 15 | — | 20 |
| DME/BTFE/Trioxane | 70 | — | 10 | — | 20 |
| DME/BTFE/Trioxane | 75 | — | 5 | — | 20 |
| DME/BTFE/Trioxane | 50 | — | 25 | — | 25 |
| DME/BTFE/Trioxane | 55 | — | 20 | — | 25 |
| DME/BTFE/Trioxane | 60 | — | 15 | — | 25 |
| DME/BTFE/Trioxane | 65 | — | 10 | — | 25 |
| DME/BTFE/Trioxane | 70 | — | 5 | — | 25 |
| DME/BTFE/Trioxane | 50 | — | 20 | — | 30 |
| DME/BTFE/Trioxane | 55 | — | 15 | — | 30 |
| DME/BTFE/Trioxane | 60 | — | 10 | — | 30 |
| DME/BTFE/Trioxane | 65 | — | 5 | — | 30 |
| DME/BTFE/Trioxane | 50 | — | 47.5 | — | 2.5 |
| DME/BTFE/Trioxane | 55 | — | 42.5 | — | 2.5 |
| DME/BTFE/Trioxane | 60 | — | 37.5 | — | 2.5 |
| DME/BTFE/Trioxane | 65 | — | 32.5 | — | 2.5 |
| DME/BTFE/Trioxane | 70 | — | 27.5 | — | 2.5 |
| DME/BTFE/Trioxane | 75 | — | 22.5 | — | 2.5 |
| DME/BTFE/Trioxane | 80 | — | 17.5 | — | 2.5 |
| DME/BTFE/Trioxane | 85 | — | 12.5 | — | 2.5 |
| DME/BTFE/Trioxane | 90 | — | 7.5 | — | 2.5 |
| DME/BTFE/Trioxane | 95 | — | 2.5 | — | 2.5 |
| DME/BTFE/Trioxane | 50 | — | 42.5 | — | 7.5 |
| DME/BTFE/Trioxane | 55 | — | 37.5 | — | 7.5 |
| DME/BTFE/Trioxane | 60 | — | 32.5 | — | 7.5 |
| DME/BTFE/Trioxane | 65 | — | 27.5 | — | 7.5 |
| DME/BTFE/Trioxane | 70 | — | 22.5 | — | 7.5 |
| DME/BTFE/Trioxane | 75 | — | 17.5 | — | 7.5 |
| DME/BTFE/Trioxane | 80 | — | 12.5 | — | 7.5 |
| DME/BTFE/Trioxane | 85 | — | 7.5 | — | 7.5 |
| DME/BTFE/Trioxane | 90 | — | 2.5 | — | 7.5 |
| DME/BTFE/Trioxane | 50 | — | 37.5 | — | 12.5 |
| DME/BTFE/Trioxane | 55 | — | 32.5 | — | 12.5 |
| DME/BTFE/Trioxane | 60 | — | 27.5 | — | 12.5 |
| DME/BTFE/Trioxane | 65 | — | 22.5 | — | 12.5 |
| DME/BTFE/Trioxane | 70 | — | 17.5 | — | 12.5 |
| DME/BTFE/Trioxane | 75 | — | 12.5 | — | 12.5 |
| DME/BTFE/Trioxane | 80 | — | 7.5 | — | 12.5 |
| DME/BTFE/Trioxane | 85 | — | 2.5 | — | 12.5 |
| DME/DOL/BTFE | 58 | 29 | 13 | — | — |
| DME/DOL/BTFE | 60 | 30 | 10 | — | — |
| DME/DOL/BTFE | 65 | 20 | 15 | — | — |
| DME/DOL/BTFE | 50 | 25 | 25 | — | — |
| DME/DOL/BTFE | 50 | 30 | 20 | — | — |
| DME/DOL/BTFE | 50 | 35 | 15 | — | — |
| DME/DOL/BTFE | 50 | 40 | 10 | — | — |
| DME/DOL/BTFE | 60 | 20 | 20 | — | — |
| DME/DOL/BTFE | 60 | 25 | 15 | — | — |
| DME/DOL/BTFE | 60 | 30 | 10 | — | — |
| DME/DOL/BTFE | 60 | 35 | 5 | — | — |
| DME/DOL/BTFE | 70 | 15 | 15 | — | — |
| DME/DOL/BTFE | 70 | 20 | 10 | — | — |
| DME/DOL/BTFE | 70 | 25 | 5 | — | — |
| DME/DOL/BTFE | 75 | 12.5 | 12.5 | — | — |
| DME/DOL/BTFE | 80 | 10 | 10 | — | — |
| DME/DOL/BTFE | 80 | 15 | 5 | — | — |
| DME/DOL/BTFE | 90 | 5 | 5 | — | — |
| DME/DOL/BTFE/TTE | 55 | 20 | 12.5 | 12.5 | — |
| DME/DOL/BTFE/TTE | 50 | 20 | 15 | 15 | — |
| DME/DOL/BTFE/TTE | 55 | 20 | 12.5 | 12.5 | — |
| DME/DOL/BTFE/TTE | 60 | 15 | 12.5 | 12.5 | — |
| DME/DOL/BTFE/TTE | 60 | 20 | 10 | 10 | — |
| DME/DOL/BTFE/TTE | 62 | 18 | 10 | 10 | — |
| DME/DOL/BTFE/TTE | 65 | 15 | 10 | 10 | — |
| DME/DOL/BTFE/TTE | 70 | 10 | 10 | 10 | — |
| DME/DOL/BTFE/TTE | 70 | 15 | 7.5 | 7.5 | — |
| DME/DOL/BTFE/TTE | 75 | 10 | 7.5 | 7.5 | — |
| DME/DOL/BTFE/TTE | 80 | 5 | 7.5 | 7.5 | — |
| DME/DOL/Trioxane | 60 | 30 | — | — | 10 |
| DME/DOL/Trioxane | 65 | 25 | — | — | 10 |
| DME/DOL/Trioxane | 70 | 20 | — | — | 10 |
| DME/DOL/Trioxane | 75 | 15 | — | — | 10 |
| DME/DOL/Trioxane | 80 | 10 | — | — | 10 |
| DME/DOL/Trioxane | 70 | 25 | — | — | 5 |
| DME/DOL/Trioxane | 75 | 20 | — | — | 5 |
| DME/DOL/Trioxane | 80 | 15 | — | — | 5 |
| DME/DOL/Trioxane | 85 | 10 | — | — | 5 |
| DME/DOL/TTE | 50 | 25 | — | 25 | — |
| DME/DOL/TTE | 58 | 29 | — | 13 | — |
| DME/DOL/TTE | 60 | 30 | — | 10 | — |
| DME/DOL/TTE | 65 | 20 | — | 15 | — |
| DME/DOL/TTE | 50 | 25 | — | 25 | — |
| DME/DOL/TTE | 50 | 30 | — | 20 | — |
| DME/DOL/TTE | 50 | 35 | — | 15 | — |
| DME/DOL/TTE | 50 | 40 | — | 10 | — |
| DME/DOL/TTE | 60 | 20 | — | 20 | — |
| DME/DOL/TTE | 60 | 25 | — | 15 | — |
| DME/DOL/TTE | 60 | 30 | — | 10 | — |
| DME/DOL/TTE | 60 | 35 | — | 5 | — |
| DME/DOL/TTE | 70 | 15 | — | 15 | — |
| DME/DOL/TTE | 70 | 20 | — | 10 | — |
| DME/DOL/TTE | 70 | 25 | — | 5 | — |
| DME/DOL/TTE | 75 | 12.5 | — | 12.5 | — |
| DME/DOL/TTE | 80 | 10 | — | 10 | — |
| DME/DOL/TTE | 80 | 15 | — | 5 | — |
| DME/DOL/TTE | 90 | 5 | — | 5 | — |
| DME/Trioxane | 80 | — | — | — | 20 |
| DME/Trioxane | 82.5 | — | — | — | 17.5 |
| DME/Trioxane | 85 | — | — | — | 15 |
| DME/Trioxane | 70 | — | — | — | 30 |
| DME/Trioxane | 75 | — | — | — | 25 |
| DME/Trioxane | 80 | — | — | — | 20 |
| DME/Trioxane | 82.5 | — | — | — | 17.5 |
| DME/Trioxane | 85 | — | — | — | 15 |
| DME/Trioxane | 90 | — | — | — | 10 |
| DME/Trioxane | 95 | — | — | — | 5 |
| DME/TTE/Trioxane | 70 | — | — | 20 | 10 |
| DME/TTE/Trioxane | 60 | — | — | 30 | 10 |
| DME/TTE/Trioxane | 65 | — | — | 25 | 10 |
| DME/TTE/Trioxane | 70 | — | — | 20 | 10 |
| DME/TTE/Trioxane | 75 | — | — | 15 | 10 |
| DME/TTE/Trioxane | 80 | — | — | 10 | 10 |
| DME/TTE/Trioxane | 70 | — | — | 25 | 5 |
| DME/TTE/Trioxane | 75 | — | — | 20 | 5 |
| DME/TTE/Trioxane | 80 | — | — | 15 | 5 |
| DME/TTE/Trioxane | 85 | — | — | 10 | 5 |
| DME/BTFE Binary | 80 | — | 20 | — | — |
| DME/BTFE Binary | 75 | — | 25 | — | — |
| DME/BTFE Binary | 70 | — | 30 | — | — |
| DME/BTFE Binary | 65 | — | 35 | — | — |
| DME/BTFE Binary | 60 | — | 40 | — | — |
| DME/TTE Binary | 80 | — | 20 | — | — |
| DME/TTE Binary | 75 | — | — | 25 | — |
| DME/TTE Binary | 70 | — | — | 30 | — |
| DME/TTE Binary | 65 | — | — | 35 | — |
| DME/TTE Binary | 60 | — | — | 40 | — |

TABLE 4B
SOLUTE (LITHIUM SALTS AND ADDITIVES)
STOICHIOMETRIC COMPOSITIONS

| | LiTFSI | LiFSI | LiNO₃ | DCDA | ISDN | Other |
|---|---|---|---|---|---|---|
| Salt System | (M) | (M) | (M) | (M) | (M) | Nitrates (M) |
| Balanced multi-salt | 0.4 | 0.4 | 0.5 | 0.15 | 0.05 | 0.02 (Amyl) |
| Balanced multi-salt | 0.3 | 0.3 | 0.4 | 0.1 | 0.05 | 0.02 (Amyl) |
| Balanced multi-salt | 0.3 | 0.3 | 0.5 | 0.1 | 0.05 | 0.02 (Amyl) |
| Balanced multi-salt | 0.3 | 0.3 | 0.6 | 0.1 | 0.05 | 0.02 (Amyl) |
| Balanced multi-salt | 0.35 | 0.35 | 0.4 | 0.1 | 0.05 | 0.02 (Amyl) |
| Balanced multi-salt | 0.35 | 0.35 | 0.5 | 0.1 | 0.05 | 0.02 (Amyl) |
| Balanced multi-salt | 0.35 | 0.35 | 0.6 | 0.1 | 0.05 | 0.02 (Amyl) |
| Balanced multi-salt | 0.4 | 0.4 | 0.4 | 0.1 | 0.05 | 0.02 (Amyl) |
| Balanced multi-salt | 0.4 | 0.4 | 0.5 | 0.15 | 0.05 | 0.02 (Amyl) |
| Balanced multi-salt | 0.4 | 0.4 | 0.6 | 0.1 | 0.05 | 0.02 (Amyl) |
| Balanced multi-salt | 0.45 | 0.45 | 0.4 | 0.1 | 0.05 | 0.02 (Amyl) |
| Balanced multi-salt | 0.45 | 0.45 | 0.5 | 0.1 | 0.05 | 0.02 (Amyl) |
| Balanced multi-salt | 0.5 | 0.5 | 0.4 | 0.1 | 0.05 | 0.02 (Amyl) |
| Balanced multi-salt | 0.5 | 0.5 | 0.5 | 0.1 | 0.05 | 0.02 (Amyl) |
| Balanced multi-salt | 0.3 | 0.3 | 0.4 | 0.1 | 0.05 | 0.02 (Ce) |
| Balanced multi-salt | 0.3 | 0.3 | 0.5 | 0.1 | 0.05 | 0.02 (Ce) |
| Balanced multi-salt | 0.35 | 0.35 | 0.4 | 0.1 | 0.05 | 0.02 (Ce) |
| Balanced multi-salt | 0.35 | 0.35 | 0.5 | 0.1 | 0.05 | 0.02 (Ce) |
| Balanced multi-salt | 0.4 | 0.4 | 0.4 | 0.1 | 0.05 | 0.02 (Ce) |
| Balanced multi-salt | 0.4 | 0.4 | 0.5 | 0.15 | 0.05 | 0.02 (Ce) |
| Balanced multi-salt | 0.45 | 0.45 | 0.4 | 0.1 | 0.05 | 0.02 (Ce) |
| Balanced multi-salt | 0.5 | 0.5 | 0.4 | 0.1 | 0.05 | 0.02 (Ce) |
| Balanced multi-salt | 0.3 | 0.3 | 0.4 | 0.1 | 0.05 | 0.03 (Mixed) |
| Balanced multi-salt | 0.3 | 0.3 | 0.5 | 0.1 | 0.05 | 0.03 (Mixed) |
| Balanced multi-salt | 0.35 | 0.35 | 0.4 | 0.1 | 0.05 | 0.03 (Mixed) |
| Balanced multi-salt | 0.35 | 0.35 | 0.5 | 0.1 | 0.05 | 0.03 (Mixed) |
| Balanced multi-salt | 0.4 | 0.4 | 0.4 | 0.1 | 0.05 | 0.03 (Mixed) |
| Balanced multi-salt | 0.4 | 0.4 | 0.5 | 0.15 | 0.05 | 0.03 (Mixed) |
| Balanced multi-salt | 0.45 | 0.45 | 0.4 | 0.1 | 0.05 | 0.03 (Mixed) |
| Balanced multi-salt | 0.5 | 0.5 | 0.4 | 0.1 | 0.05 | 0.03 (Mixed) |
| Balanced multi-salt | 0.4 | 0.4 | 0.5 | 0.12 | 0.05 | 0.02 (Amyl) |
| Balanced multi-salt | 0.4 | 0.4 | 0.5 | 0.18 | 0.05 | 0.02 (Amyl) |
| Balanced multi-salt | 0.4 | 0.4 | 0.5 | 0.2 | 0.05 | 0.02 (Amyl) |
| Balanced multi-salt | 0.35 | 0.35 | 0.5 | 0.12 | 0.05 | 0.02 (Ce) |
| Balanced multi-salt | 0.35 | 0.35 | 0.5 | 0.18 | 0.05 | 0.02 (Ce) |
| Balanced multi-salt | 0.35 | 0.35 | 0.5 | 0.2 | 0.05 | 0.02 (Ce) |
| Balanced multi-salt | 0.4 | 0.4 | 0.5 | 0.15 | 0.08 | 0.02 (Amyl) |
| Balanced multi-salt | 0.4 | 0.4 | 0.5 | 0.15 | 0.1 | 0.02 (Amyl) |
| Balanced multi-salt | 0.35 | 0.35 | 0.5 | 0.15 | 0.08 | 0.02 (Ce) |
| Balanced multi-salt | 0.35 | 0.35 | 0.5 | 0.15 | 0.1 | 0.02 (Ce) |
| Balanced multi-salt | 0.3 | 0.3 | 0.5 | 0.15 | 0.08 | 0.03 (Mixed) |
| Balanced multi-salt | 0.3 | 0.3 | 0.5 | 0.15 | 0.1 | 0.03 (Mixed) |
| High concentration system | 0.9 | — | 0.35 | 0.18 | 0.08 | 0.03 (Mixed) |
| High concentration system | 0.8 | — | 0.4 | 0.15 | 0.05 | 0.02 (Amyl) |
| High concentration system | 0.8 | — | 0.4 | 0.18 | 0.08 | 0.03 (Mixed) |
| High concentration system | 0.8 | — | 0.5 | 0.15 | 0.05 | 0.02 (Ce) |
| High concentration system | 0.8 | — | 0.5 | 0.18 | 0.08 | 0.03 (Mixed) |
| High concentration system | 0.85 | — | 0.3 | 0.15 | 0.05 | 0.02 (Amyl) |
| High concentration system | 0.85 | — | 0.35 | 0.18 | 0.08 | 0.03 (Mixed) |
| High concentration system | 0.9 | — | 0.3 | 0.15 | 0.05 | 0.02 (Ce) |
| High concentration system | 0.9 | — | 0.4 | 0.18 | 0.08 | 0.03 (Mixed) |
| High concentration system | 0.95 | — | 0.3 | 0.15 | 0.05 | 0.02 (Amyl) |
| High concentration system | 0.95 | — | 0.35 | 0.18 | 0.08 | 0.03 (Mixed) |
| High concentration system | 1 | — | 0.3 | 0.15 | 0.05 | 0.02 (Ce) |
| High concentration system | 1 | — | 0.4 | 0.2 | 0.1 | 0.03 (Mixed) |
| High concentration system | — | 0.8 | 0.4 | 0.15 | 0.05 | 0.02 (Amyl) |
| High concentration system | — | 0.8 | 0.45 | 0.18 | 0.08 | 0.03 (Mixed) |
| High concentration system | — | 0.85 | 0.35 | 0.15 | 0.05 | 0.02 (Ce) |
| High concentration system | — | 0.85 | 0.4 | 0.18 | 0.08 | 0.03 (Mixed) |
| High concentration system | — | 0.9 | 0.3 | 0.15 | 0.05 | 0.02 (Amyl) |
| High concentration system | — | 0.9 | 0.35 | 0.18 | 0.08 | 0.03 (Mixed) |
| High concentration system | — | 0.95 | 0.3 | 0.15 | 0.05 | 0.02 (Ce) |
| High concentration system | — | 1 | 0.3 | 0.18 | 0.08 | 0.03 (Mixed) |
| High concentration system | 0.5 | 0.4 | 0.4 | 0.15 | 0.05 | 0.02 (Amyl) |
| High concentration system | 0.5 | 0.4 | 0.45 | 0.18 | 0.08 | 0.03 (Mixed) |
| High concentration system | 0.55 | 0.35 | 0.4 | 0.15 | 0.05 | 0.02 (Ce) |
| High concentration system | 0.55 | 0.35 | 0.45 | 0.18 | 0.08 | 0.03 (Mixed) |
| High concentration system | 0.6 | 0.3 | 0.4 | 0.15 | 0.05 | 0.02 (Amyl) |
| High concentration system | 0.6 | 0.3 | 0.45 | 0.18 | 0.08 | 0.03 (Mixed) |
| High concentration system | 0.65 | 0.25 | 0.4 | 0.15 | 0.05 | 0.02 (Ce) |
| High concentration system | 0.7 | 0.2 | 0.4 | 0.18 | 0.08 | 0.03 (Mixed) |
| High concentration system | 0.9 | — | 0.35 | 0.2 | 0.15 | 0.05 (Amyl) |
| High concentration system | 0.85 | 0.15 | 0.35 | 0.2 | 0.15 | 0.05 (Ce) |
| High concentration system | 0.8 | 0.2 | 0.35 | 0.2 | 0.15 | 0.05 (Mixed) |
| High concentration system | — | 0.9 | 0.4 | 0.2 | 0.15 | 0.05 (Amyl) |
| High concentration system | — | 0.85 | 0.4 | 0.2 | 0.15 | 0.05 (Ce) |
| High concentration system | 0.75 | 0.25 | 0.4 | 0.2 | 0.15 | 0.05 (Mixed) |
| LiFSI/Cerium Nitrate | — | 0.6 | 0.4 | 0.15 | — | 0.02 (Ce) |
| LiFSI/CeriumNitrate | — | 0.5 | 0.3 | 0.1 | — | 0.02 (Ce) |
| LiFSI/CeriumNitrate | — | 0.5 | 0.4 | 0.15 | — | 0.02 (Ce) |
| LiFSI/CeriumNitrate | — | 0.6 | 0.3 | 0.1 | — | 0.02 (Ce) |
| LiFSI/CeriumNitrate | — | 0.6 | 0.4 | 0.15 | — | 0.02 (Ce) |
| LiFSI/CeriumNitrate | — | 0.7 | 0.3 | 0.1 | — | 0.02 (Ce) |
| LiFSI/CeriumNitrate | — | 0.7 | 0.4 | 0.15 | — | 0.02 (Ce) |
| LiFSI/LiNO₃/DCDA | — | 0.5 | 0.75 | 0.15 | — | — |
| LiFSI/LiNO₃/DCDA | — | 0.6 | 0.6 | 0.12 | — | — |
| LiFSI/LiNO₃/DCDA | — | 0.7 | 0.4 | 0.2 | — | — |
| LiFSI/LiNO₃/DCDA | — | 0.4 | 0.3 | 0.1 | — | — |
| LiFSI/LiNO₃/DCDA | — | 0.4 | 0.4 | 0.1 | — | — |
| LiFSI/LiNO₃/DCDA | — | 0.4 | 0.5 | 0.1 | — | — |
| LiFSI/LiNO₃/DCDA | — | 0.4 | 0.6 | 0.1 | — | — |
| LiFSI/LiNO₃/DCDA | — | 0.4 | 0.7 | 0.1 | — | — |
| LiFSI/LiNO₃/DCDA | — | 0.4 | 0.8 | 0.1 | — | — |
| LiFSI/LiNO₃/DCDA | — | 0.5 | 0.3 | 0.1 | — | — |
| LiFSI/LiNO₃/DCDA | — | 0.5 | 0.4 | 0.1 | — | — |
| LiFSI/LiNO₃/DCDA | — | 0.5 | 0.5 | 0.1 | — | — |
| LiFSI/LiNO₃/DCDA | — | 0.5 | 0.6 | 0.1 | — | — |
| LiFSI/LiNO₃/DCDA | — | 0.5 | 0.7 | 0.1 | — | — |
| LiFSI/LiNO₃/DCDA | — | 0.5 | 0.75 | 0.15 | — | — |
| LiFSI/LiNO₃/DCDA | — | 0.5 | 0.8 | 0.1 | — | — |
| LiFSI/LiNO₃/DCDA | — | 0.6 | 0.3 | 0.1 | — | — |
| LiFSI/LiNO₃/DCDA | — | 0.6 | 0.4 | 0.1 | — | — |
| LiFSI/LiNO₃/DCDA | — | 0.6 | 0.4 | 0.15 | — | — |
| LiFSI/LiNO₃/DCDA | — | 0.6 | 0.5 | 0.1 | — | — |
| LiFSI/LiNO₃/DCDA | — | 0.6 | 0.6 | 0.12 | — | — |
| LiFSI/LiNO₃/DCDA | — | 0.6 | 0.7 | 0.1 | — | — |
| LiFSI/LiNO₃/DCDA | — | 0.6 | 0.8 | 0.1 | — | — |
| LiFSI/LiNO₃/DCDA | — | 0.7 | 0.3 | 0.1 | — | — |
| LiFSI/LiNO₃/DCDA | — | 0.7 | 0.4 | 0.15 | — | — |
| LiFSI/LiNO₃/DCDA | — | 0.7 | 0.4 | 0.2 | — | — |
| LiFSI/LiNO₃/DCDA | — | 0.7 | 0.5 | 0.1 | — | — |
| LiFSI/LiNO₃/DCDA | — | 0.7 | 0.6 | 0.1 | — | — |
| LiFSI/LiNO₃/DCDA | — | 0.8 | 0.3 | 0.1 | — | — |
| LiFSI/LiNO₃/DCDA | — | 0.8 | 0.4 | 0.1 | — | — |
| LiFSI/LiNO₃/DCDA | — | 0.8 | 0.5 | 0.1 | — | — |
| LiFSI/LiNO₃/ISDN | — | 0.5 | 0.5 | — | 0.12 | — |
| LiFSI/LiNO₃/ISDN | — | 0.4 | 0.3 | — | 0.1 | — |
| LiFSI/LiNO₃/ISDN | — | 0.4 | 0.4 | — | 0.1 | — |
| LiFSI/LiNO₃/ISDN | — | 0.4 | 0.5 | — | 0.1 | — |
| LiFSI/LiNO₃/ISDN | — | 0.4 | 0.6 | — | 0.1 | — |
| LiFSI/LiNO₃/ISDN | — | 0.5 | 0.3 | — | 0.1 | — |
| LiFSI/LiNO₃/ISDN | — | 0.5 | 0.4 | — | 0.1 | — |
| LiFSI/LiNO₃/ISDN | — | 0.5 | 0.5 | — | 0.12 | — |
| LiFSI/LiNO₃/ISDN | — | 0.5 | 0.6 | — | 0.1 | — |
| LiFSI/LiNO₃/ISDN | — | 0.6 | 0.3 | — | 0.1 | — |
| LiFSI/LiNO₃/ISDN | — | 0.6 | 0.4 | — | 0.1 | — |
| LiFSI/LiNO₃/ISDN | — | 0.6 | 0.5 | — | 0.1 | — |
| LiFSI/LiNO₃/ISDN | — | 0.7 | 0.3 | — | 0.1 | — |
| LiFSI/LiNO₃/ISDN | — | 0.7 | 0.4 | — | 0.1 | — |
| LiFSI/LiNO₃/ISDN | — | 0.8 | 0.3 | — | 0.1 | — |
| LiFSI/Multi-additive | — | 0.55 | 0.45 | 0.12 | 0.06 | 0.02 (Ce) |
| LiTFSI/Amyl Nitrate | 0.7 | — | 0.3 | 0.1 | — | 0.05 (Amyl) |
| LiTFSI/AmylNitrate | 0.5 | — | 0.3 | 0.1 | — | 0.03 (Amyl) |
| LiTFSI/AmylNitrate | 0.6 | — | 0.3 | 0.1 | — | 0.05 (Amyl) |
| LiTFSI/AmylNitrate | 0.7 | — | 0.3 | 0.1 | — | 0.05 (Amyl) |
| LiTFSI/AmylNitrate | 0.8 | — | 0.3 | 0.1 | — | 0.05 (Amyl) |
| LiTFSI/AmylNitrate | 0.6 | — | 0.4 | 0.1 | — | 0.05 (Amyl) |
| LiTFSI/AmylNitrate | 0.7 | — | 0.4 | 0.1 | — | 0.05 (Amyl) |
| LiTFSI/AmylNitrate | 0.8 | — | 0.4 | 0.1 | — | 0.05 (Amyl) |
| LiTFSI/ISDN | 0.7 | — | — | 0.1 | 0.3 | — |
| LiTFSI/ISDN | 0.4 | — | — | 0.1 | 0.2 | — |
| LiTFSI/ISDN | 0.4 | — | — | 0.1 | 0.25 | — |
| LiTFSI/ISDN | 0.4 | — | — | 0.1 | 0.3 | — |
| LiTFSI/ISDN | 0.5 | — | — | 0.1 | 0.2 | — |
| LiTFSI/ISDN | 0.5 | — | — | 0.1 | 0.25 | — |
| LiTFSI/ISDN | 0.5 | — | — | 0.1 | 0.3 | — |
| LiTFSI/ISDN | 0.6 | — | — | 0.1 | 0.2 | — |
| LiTFSI/ISDN | 0.6 | — | — | 0.1 | 0.25 | — |
| LiTFSI/ISDN | 0.6 | — | — | 0.1 | 0.3 | — |
| LiTFSI/ISDN | 0.7 | — | — | 0.1 | 0.2 | — |
| LiTFSI/ISDN | 0.7 | — | — | 0.1 | 0.25 | — |
| LiTFSI/ISDN | 0.7 | — | — | 0.1 | 0.3 | — |
| LiTFSI/ISDN | 0.8 | — | — | 0.1 | 0.2 | — |
| LiTFSI/ISDN | 0.8 | — | — | 0.1 | 0.25 | — |
| LiTFSI/ISDN | 0.8 | — | — | 0.1 | 0.3 | — |
| LiTFSI/LiFSI/LiNO₃ | 0.4 | 0.8 | 0.4 | 0.12 | — | — |
| LiTFSI/LiFSI/LiNO₃ | 0.25 | 0.5 | 0.6 | 0.18 | — | — |
| LiTFSI/LiFSI/LiNO₃ | 0.2 | 0.4 | 0.3 | 0.1 | — | — |
| LiTFSI/LiFSI/LiNO₃ | 0.2 | 0.4 | 0.4 | 0.1 | — | — |
| LiTFSI/LiFSI/LiNO₃ | 0.2 | 0.4 | 0.5 | 0.1 | — | — |
| LiTFSI/LiFSI/LiNO₃ | 0.2 | 0.4 | 0.6 | 0.1 | — | — |
| LiTFSI/LiFSI/LiNO₃ | 0.25 | 0.5 | 0.3 | 0.1 | — | — |
| LiTFSI/LiFSI/LiNO₃ | 0.25 | 0.5 | 0.4 | 0.1 | — | — |
| LiTFSI/LiFSI/LiNO₃ | 0.25 | 0.5 | 0.5 | 0.1 | — | — |
| LiTFSI/LiFSI/LiNO₃ | 0.25 | 0.5 | 0.6 | 0.15 | — | — |
| LiTFSI/LiFSI/LiNO₃ | 0.25 | 0.5 | 0.6 | 0.18 | — | — |
| LiTFSI/LiFSI/LiNO₃ | 0.25 | 0.5 | 0.7 | 0.1 | — | — |
| LiTFSI/LiFSI/LiNO₃ | 0.25 | 0.5 | 0.8 | 0.1 | — | — |
| LiTFSI/LiFSI/LiNO₃ | 0.3 | 0.6 | 0.3 | 0.1 | — | — |
| LiTFSI/LiFSI/LiNO₃ | 0.3 | 0.6 | 0.4 | 0.1 | — | — |
| LiTFSI/LiFSI/LiNO₃ | 0.3 | 0.6 | 0.5 | 0.1 | — | — |
| LiTFSI/LiFSI/LiNO₃ | 0.3 | 0.6 | 0.6 | 0.1 | — | — |
| LiTFSI/LiFSI/LiNO₃ | 0.33 | 0.67 | 0.3 | 0.1 | — | — |
| LiTFSI/LiFSI/LiNO₃ | 0.33 | 0.67 | 0.4 | 0.1 | — | — |
| LiTFSI/LiFSI/LiNO₃ | 0.33 | 0.67 | 0.5 | 0.15 | — | — |
| LiTFSI/LiFSI/LiNO₃ | 0.33 | 0.67 | 0.6 | 0.1 | — | — |
| LiTFSI/LiFSI/LiNO₃ | 0.33 | 0.67 | 0.7 | 0.1 | — | — |
| LiTFSI/LiFSI/LiNO₃ | 0.33 | 0.67 | 0.8 | 0.1 | — | — |
| LiTFSI/LiFSI/LiNO₃ | 0.35 | 0.7 | 0.3 | 0.1 | — | — |
| LiTFSI/LiFSI/LiNO₃ | 0.35 | 0.7 | 0.4 | 0.1 | — | — |
| LiTFSI/LiFSI/LiNO₃ | 0.35 | 0.7 | 0.5 | 0.1 | — | — |
| LiTFSI/LiFSI/LiNO₃ | 0.35 | 0.7 | 0.6 | 0.1 | — | — |
| LiTFSI/LiFSI/LiNO₃ | 0.4 | 0.8 | 0.3 | 0.1 | — | — |
| LiTFSI/LiFSI/LiNO₃ | 0.4 | 0.8 | 0.4 | 0.12 | — | — |
| LiTFSI/LiFSI/LiNO₃ | 0.4 | 0.8 | 0.5 | 0.1 | — | — |
| LiTFSI/LiFSI/LiNO₃ | 0.4 | 0.8 | 0.6 | 0.1 | — | — |
| LiTFSI/LiFSI/Multi-nitrate | 0.3 | 0.6 | 0.4 | 0.1 | 0.05 | 0.03 (Mixed) |
| LiTFSI/LiNO₃/DCDA | 0.6 | — | 0.5 | 0.1 | — | — |
| LiTFSI/LiNO₃/DCDA | 0.8 | — | 0.4 | 0.15 | — | — |
| LiTFSI/LiNO₃/DCDA | 1 | — | 0.3 | 0.2 | — | — |
| LiTFSI/LiNO₃/DCDA | 0.7 | — | 0.6 | 0.12 | — | — |
| LiTFSI/LiNO₃/DCDA | 0.5 | — | 0.8 | 0.18 | — | — |
| LiTFSI/LiNO₃/DCDA | 0.4 | — | 0.3 | 0.1 | — | — |
| LiTFSI/LiNO₃/DCDA | 0.4 | — | 0.4 | 0.1 | — | — |
| LiTFSI/LiNO₃/DCDA | 0.4 | — | 0.5 | 0.1 | — | — |
| LiTFSI/LiNO₃/DCDA | 0.4 | — | 0.6 | 0.1 | — | — |
| LiTFSI/LiNO₃/DCDA | 0.4 | — | 0.7 | 0.1 | — | — |
| LiTFSI/LiNO₃/DCDA | 0.4 | — | 0.8 | 0.1 | — | — |
| LiTFSI/LiNO₃/DCDA | 0.5 | — | 0.3 | 0.1 | — | — |
| LiTFSI/LiNO₃/DCDA | 0.5 | — | 0.4 | 0.1 | — | — |
| LiTFSI/LiNO₃/DCDA | 0.5 | — | 0.5 | 0.1 | — | — |
| LiTFSI/LiNO₃/DCDA | 0.5 | — | 0.6 | 0.1 | — | — |
| LiTFSI/LiNO₃/DCDA | 0.5 | — | 0.7 | 0.1 | — | — |
| LiTFSI/LiNO₃/DCDA | 0.5 | — | 0.8 | 0.1 | — | — |
| LiTFSI/LiNO₃/DCDA | 0.6 | — | 0.3 | 0.1 | — | — |
| LiTFSI/LiNO₃/DCDA | 0.6 | — | 0.4 | 0.1 | — | — |
| LiTFSI/LiNO₃/DCDA | 0.6 | — | 0.5 | 0.1 | — | — |
| LiTFSI/LiNO₃/DCDA | 0.6 | — | 0.6 | 0.1 | — | — |
| LiTFSI/LiNO₃/DCDA | 0.6 | — | 0.7 | 0.1 | — | — |
| LiTFSI/LiNO₃/DCDA | 0.6 | — | 0.8 | 0.1 | — | — |
| LiTFSI/LiNO₃/DCDA | 0.7 | — | 0.3 | 0.1 | — | — |
| LiTFSI/LiNO₃/DCDA | 0.7 | — | 0.4 | 0.1 | — | — |
| LiTFSI/LiNO₃/DCDA | 0.7 | — | 0.5 | 0.1 | — | — |
| LiTFSI/LiNO₃/DCDA | 0.7 | — | 0.6 | 0.1 | — | — |
| LiTFSI/LiNO₃/DCDA | 0.7 | — | 0.7 | 0.1 | — | — |
| LiTFSI/LiNO₃/DCDA | 0.7 | — | 0.8 | 0.1 | — | — |
| LiTFSI/LiNO₃/DCDA | 0.8 | — | 0.3 | 0.1 | — | — |
| LiTFSI/LiNO₃/DCDA | 0.8 | — | 0.4 | 0.1 | — | — |
| LiTFSI/LiNO₃/DCDA | 0.8 | — | 0.5 | 0.1 | — | — |
| LiTFSI/LiNO₃/DCDA | 0.8 | — | 0.6 | 0.1 | — | — |
| LiTFSI/LiNO₃/DCDA | 0.8 | — | 0.7 | 0.1 | — | — |
| LiTFSI/LiNO₃/DCDA | 0.8 | — | 0.8 | 0.1 | — | — |
| LiTFSI/LiNO₃/DCDA | 0.9 | — | 0.3 | 0.1 | — | — |
| LiTFSI/LiNO₃/DCDA | 0.9 | — | 0.4 | 0.1 | — | — |
| LiTFSI/LiNO₃/DCDA | 0.9 | — | 0.5 | 0.1 | — | — |
| LiTFSI/LiNO₃/DCDA | 0.9 | — | 0.6 | 0.1 | — | — |
| LiTFSI/LiNO₃/DCDA | 1 | — | 0.3 | 0.1 | — | — |
| LiTFSI/LiNO₃/DCDA | 1 | — | 0.4 | 0.1 | — | — |
| LiTFSI/LiNO₃/DCDA | 1 | — | 0.5 | 0.1 | — | — |
| LiTFSI/LiNO₃/DCDA | 0.6 | — | 0.5 | 0.12 | — | — |
| LiTFSI/LiNO₃/DCDA | 0.6 | — | 0.5 | 0.15 | — | — |
| LiTFSI/LiNO₃/DCDA | 0.6 | — | 0.5 | 0.18 | — | — |
| LiTFSI/LiNO₃/DCDA | 0.6 | — | 0.5 | 0.2 | — | — |
| LiTFSI/LiNO₃/DCDA | 0.8 | — | 0.4 | 0.12 | — | — |
| LiTFSI/LiNO₃/DCDA | 0.8 | — | 0.4 | 0.15 | — | — |
| LiTFSI/LiNO₃/DCDA | 0.8 | — | 0.4 | 0.18 | — | — |
| LiTFSI/LiNO₃/DCDA | 0.8 | — | 0.4 | 0.2 | — | — |
| LiTFSI/LiNO₃/DCDA | 1 | — | 0.3 | 0.15 | — | — |
| LiTFSI/LiNO₃/DCDA | 1 | — | 0.3 | 0.18 | — | — |
| LiTFSI/LiNO₃/DCDA | 1 | — | 0.3 | 0.2 | — | — |
| LiTFSI/LiNO₃/DCDA/ISDN | 0.5 | — | 0.4 | 0.1 | 0.08 | — |
| LiTFSI/LiNO₃/DCDA/ISDN | 0.4 | — | 0.3 | 0.1 | 0.05 | — |
| LiTFSI/LiNO₃/DCDA/ISDN | 0.4 | — | 0.4 | 0.1 | 0.08 | — |
| LiTFSI/LiNO₃/DCDA/ISDN | 0.5 | — | 0.3 | 0.1 | 0.05 | — |
| LiTFSI/LiNO₃/DCDA/ISDN | 0.5 | — | 0.4 | 0.1 | 0.08 | — |
| LiTFSI/LiNO₃/DCDA/ISDN | 0.6 | — | 0.3 | 0.1 | 0.05 | — |
| LiTFSI/LiNO₃/DCDA/ISDN | 0.6 | — | 0.4 | 0.1 | 0.08 | — |
| LiTFSI/LiNO₃/DCDA/ISDN | 0.7 | — | 0.3 | 0.1 | 0.05 | — |
| LiTFSI/LiNO₃/DCDA/ISDN | 0.7 | — | 0.4 | 0.1 | 0.08 | — |
| LiTFSI/LiNO₃/ISDN | 0.6 | — | 0.4 | — | 0.1 | — |
| LiTFSI/LiNO₃/ISDN | 0.8 | — | 0.3 | — | 0.15 | — |
| LiTFSI/LiNO₃/ISDN | 0.4 | — | 0.3 | — | 0.1 | — |
| LiTFSI/LiNO₃/ISDN | 0.4 | — | 0.4 | — | 0.1 | — |
| LiTFSI/LiNO₃/ISDN | 0.4 | — | 0.5 | — | 0.1 | — |
| LiTFSI/LiNO₃/ISDN | 0.5 | — | 0.3 | — | 0.1 | — |
| LiTFSI/LiNO₃/ISDN | 0.5 | — | 0.4 | — | 0.1 | — |
| LiTFSI/LiNO₃/ISDN | 0.5 | — | 0.5 | — | 0.1 | — |
| LiTFSI/LiNO₃/ISDN | 0.6 | — | 0.3 | — | 0.1 | — |
| LiTFSI/LiNO₃/ISDN | 0.6 | — | 0.4 | — | 0.1 | — |
| LiTFSI/LiNO₃/ISDN | 0.6 | — | 0.5 | — | 0.1 | — |
| LiTFSI/LiNO₃/ISDN | 0.7 | — | 0.3 | — | 0.1 | — |
| LiTFSI/LiNO₃/ISDN | 0.7 | — | 0.4 | — | 0.1 | — |
| LiTFSI/LiNO₃/ISDN | 0.7 | — | 0.5 | — | 0.1 | — |
| LiTFSI/LiNO₃/ISDN | 0.8 | — | 0.3 | — | 0.1 | — |
| LiTFSI/LiNO₃/ISDN | 0.8 | — | 0.3 | — | 0.15 | — |
| LiTFSI/LiNO₃/ISDN | 0.8 | — | 0.4 | — | 0.1 | — |
| LiTFSI/LiNO₃/ISDN | 0.8 | — | 0.4 | — | 0.15 | — |
| LiTFSI/LiNO₃/ISDN | 0.8 | — | 0.5 | — | 0.1 | — |
| LiTFSI/LiNO₃/ISDN | 0.9 | — | 0.3 | — | 0.1 | — |
| LiTFSI/LiNO₃/ISDN | 0.9 | — | 0.4 | — | 0.1 | — |
| LiTFSI/LiNO₃/ISDN | 1 | — | 0.3 | — | 0.1 | — |
| Ultra-high concentration | 1.1 | — | 0.3 | 0.2 | 0.1 | 0.03 (Mixed) |
| Ultra-high concentration | 1.2 | — | 0.25 | 0.2 | 0.1 | 0.03 (Mixed) |
| Ultra-high concentration | — | 1.1 | 0.3 | 0.2 | 0.1 | 0.03 (Mixed) |
| Ultra-high concentration | — | 1.2 | 0.25 | 0.2 | 0.1 | 0.03 (Mixed) |
| Ultra-high concentration | 0.6 | 0.6 | 0.3 | 0.2 | 0.1 | 0.03 (Mixed) |
| Ultra-high concentration | 0.7 | 0.5 | 0.3 | 0.2 | 0.1 | 0.03 (Mixed) |
| Ultra-high concentration | 0.8 | 0.4 | 0.3 | 0.2 | 0.1 | 0.03 (Mixed) |

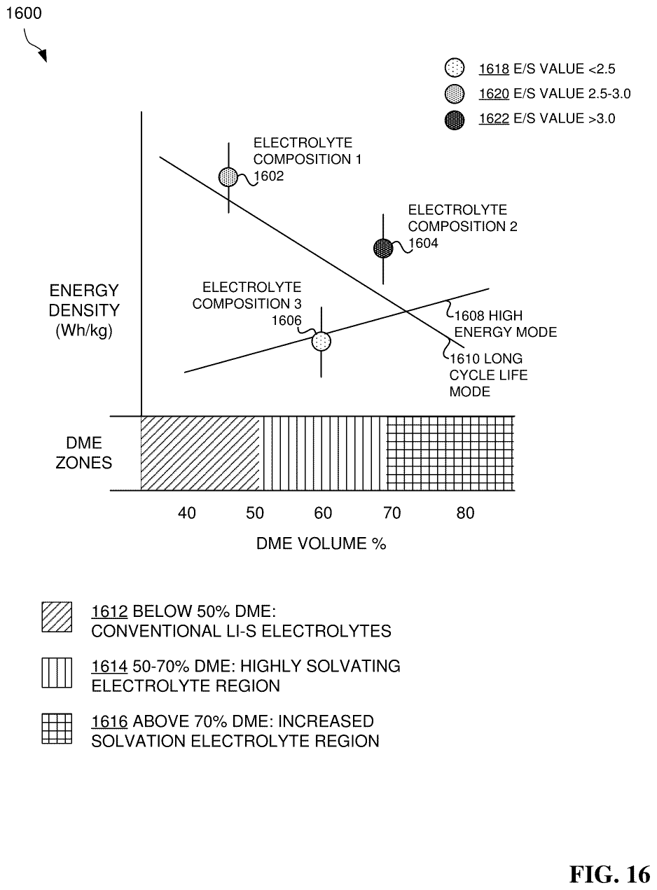

FIG. 16 illustrates an energy density graph 1600, in accordance with one embodiment. As an option, the energy density graph 1600 may be implemented in the context of any one or more of the embodiments set forth in any previous and/or subsequent Figures and/or description thereof. Of course, however, the energy density graph 1600 may be implemented in the context of any desired environment. Further, the aforementioned definitions may equally apply to the description below.

The energy density graph 1600 demonstrates the relationship between energy density measured in Wh/kg and DME volume percentage within, for example, the electrolyte solvent package 1308 for lithium-sulfur electrochemical systems. The energy density graph 1600 displays multiple data points and operating zones that illustrate how varying the volumetric concentration of DME affects the overall energy density performance characteristics of the battery system. In some cases, the energy density graph 1600 reveals that higher volume percentages of DME correspond to enhanced energy density values when combined with specific electrolyte formulations including lithium salt concentrations.

An electrolyte composition point (1) 1602 represents a specific formulation within the energy density graph 1600 that demonstrates the energy density performance achievable with a particular combination of DME volume percentage and lithium salt concentrations. The electrolyte composition point (1) 1602 may correspond to an electrolyte formulation consistent with Table 4A, provided hereinabove, as it relates to the solvent package.

The positioning of the electrolyte composition point (1) 1602 within the energy density graph 1600 may indicate the energy density performance achievable with this specific combination of solvent ratios and salt concentrations under lean electrolyte conditions. The electrolyte composition point (1) 1602 may demonstrate how the integration of multiple solvents with controlled additive concentrations contributes to enhanced energy density performance compared to binary solvent systems or formulations without additive components.

An electrolyte composition point (2) 1604 represents an alternative formulation within the energy density graph 1600 that provides different energy density characteristics through modified solvent ratios and/or salt concentrations compared to the electrolyte composition point (1) 1602. For example, in one embodiment, the electrolyte composition point (2) 1604 may correspond to an electrolyte configuration where the DME volume percentage may be adjusted to achieve different performance characteristics while maintaining the fundamental relationship between solvent composition and energy density. In some cases, the electrolyte composition point (2) 1604 may represent a formulation optimized for specific operating conditions or application requirements that differ from those represented by the electrolyte composition point (1) 1602. The electrolyte composition point (2) 1604 may incorporate alternative lithium salt concentrations or additive systems that provide enhanced performance characteristics. The comparison between the electrolyte composition point (1) 1602 and the electrolyte composition point (2) 1604 within the energy density graph 1600 may demonstrate how different formulation strategies can achieve varying energy density performance while maintaining compatibility with lean electrolyte operating conditions.

An electrolyte composition point (3) 1606 represents a third formulation alternative within the energy density graph 1600 that provides additional data points for understanding the relationship between electrolyte composition and energy density performance characteristics. The electrolyte composition point (3) 1606 may correspond to an electrolyte formulation that incorporates different DME volume percentages and/or lithium salt concentrations to achieve specific performance targets for particular applications or operating conditions.

In various embodiments, the electrolyte composition point (3) 1606 may represent a formulation where the electrolyte solution further comprises dicyandiamide (DCDA) at a concentration of about 0.15 M to enhance cycle life and electrochemical stability while maintaining energy density performance. The electrolyte composition point (3) 1606 may demonstrate how additive systems such as DCDA can influence the relationship between DME content and energy density by providing enhanced electrode stability and reduced capacity fade during extended cycling operations. Additionally, the positioning of electrolyte composition point (3) 1606 at lower energy density values reflects a potential trade-off between enhanced cycle life through increased additive concentration and slight energy density reduction due to solvation effects or formation of thicker, more resistive solid electrolyte interphase layers.

A high energy mode 1608 represents an operating condition within the energy density graph 1600 that demonstrates maximum energy density performance achievable with the disclosed electrolyte formulations and cell architecture configurations. The high energy mode 1608 may correspond to operating conditions where the battery cell may be configured to prioritize energy density performance over cycle life characteristics, enabling applications that require maximum energy storage capability within weight-constrained systems. In some cases, the high energy mode 1608 may represent operating conditions where the electrolyte-to-sulfur mass ratio may be minimized to reduce electrolyte weight contribution while maintaining adequate polysulfide solvation through high DME concentrations and optimized free coordinated ether groups availability.

As such, the high energy mode 1608 may demonstrate energy density performance achievable when the cathode mass loading and anode thickness are optimized in conjunction with the electrolyte composition to minimize inactive material weight while maximizing active material utilization. Further, the operating conditions represented by the high energy mode 1608 may incorporate pressure settings where the lithium-sulfur cell may be configured to operate at a pressure of about 40 PSI, below 50 PSI, and/or between 50-100 PSI to minimize mechanical stress while maintaining adequate electrode contact and ionic transport characteristics.

A long cycle life mode 1610 represents an alternative operating condition within the energy density graph 1600 that demonstrates energy density performance achievable when the battery cell 1302 may be configured to prioritize extended operational life over maximum energy density characteristics. The long cycle life mode 1610 may correspond to operating conditions where electrolyte composition and cell architecture parameters are optimized to minimize capacity fade and extend operational life while maintaining acceptable energy density performance for practical applications.

In various embodiments, the long cycle life mode 1610 may represent operating conditions where the cell may be configured to cycle between 1.8 V and 2.5 V to minimize electrode stress and reduce unwanted side reactions that could otherwise contribute to capacity fade during extended cycling operations. Additionally, the long cycle life mode 1610 may demonstrate how the integration of DCDA additives with optimized DME concentrations can provide enhanced cycle stability while maintaining energy density performance within acceptable ranges for commercial applications. The operating conditions represented by the long cycle life mode 1610 may incorporate modified cathode mass loading and anode thickness parameters that reduce electrochemical stress while maintaining adequate energy storage capability for applications requiring extended operational life.

A conventional electrolyte zone 1612 represents a region within the energy density graph 1600 that corresponds to electrolyte formulations with DME volume percentages below 50% that provide conventional energy density performance characteristics. The conventional electrolyte zone 1612 may encompass electrolyte formulations that rely on traditional solvent ratios and lithium salt concentrations that require higher electrolyte-to-sulfur ratios to maintain adequate polysulfide solvation and electrochemical performance. In some cases, the conventional electrolyte zone 1612 may represent formulations that provide limited energy density performance due to higher electrolyte weight contributions and reduced efficiency of polysulfide dissolution processes compared to higher DME content formulations.

In some embodiments, the conventional electrolyte zone 1612 may demonstrate energy density limitations associated with traditional lithium-sulfur electrolyte approaches that rely on balanced solvent systems without optimization for lean electrolyte operating conditions. The boundary between the conventional electrolyte zone 1612 and higher performance zones within the energy density graph 1600 may indicate threshold DME concentration where enhanced polysulfide solvation begins to provide measurable improvements in energy density performance under lean electrolyte conditions.

A highly solvating electrolyte zone 1614 represents a region within the energy density graph 1600 that corresponds to electrolyte formulations with DME volume percentages between 50-70% that provide enhanced energy density performance through improved polysulfide solvation capability. The highly solvating electrolyte zone 1614 may encompass electrolyte formulations that achieve enhanced energy density performance by increasing, e.g., the concentration of free coordinated ether groups 1314 available for polysulfide dissolution while maintaining adequate ionic conductivity through controlled lithium salt concentrations.

In various embodiments, the highly solvating electrolyte zone 1614 may represent formulations that enable operation under lean electrolyte conditions with electrolyte-to-sulfur ratios below 3:1, and/or below 5:1, while maintaining electrochemical performance characteristics comparable to or enhanced compared to conventional formulations. The highly solvating electrolyte zone 1614 may demonstrate how increased DME concentrations within this range provide enhanced polysulfide dissolution kinetics that enable more complete sulfur utilization during discharge processes, contributing to improved gravimetric energy density characteristics. The electrolyte formulations within the highly solvating electrolyte zone 1614 may incorporate optimized ratios of DME to lithium salts 1312 that maximize non-coordinated ether group availability while maintaining sufficient ionic transport capability for practical battery applications.

An increased solvation electrolyte zone 1616 represents a region within the energy density graph 1600 that corresponds to electrolyte formulations with DME volume percentages above 70% that provide maximum polysulfide solvation capability and energy density performance under lean electrolyte conditions. The increased solvation electrolyte zone 1616 may encompass electrolyte formulations that achieve maximum energy density performance by maximizing the concentration of, e.g., DME ether groups 1310 available for polysulfide solvation while maintaining electrochemical stability through controlled additive systems and optimized cell architecture parameters.

In some cases, the increased solvation electrolyte zone 1616 may represent formulations that enable operation at the lowest practical electrolyte-to-sulfur ratios while maintaining adequate polysulfide dissolution and transport characteristics throughout the discharge process. The increased solvation electrolyte zone 1616 may demonstrate how DME concentrations above 70% by volume provide enhanced polysulfide solvation capability that enables maximum sulfur utilization efficiency and gravimetric energy density performance in weight-constrained applications. The electrolyte formulations within the increased solvation electrolyte zone 1616 may incorporate temperature stability optimization that enables performance at operating temperatures where thermal management and weight constraints may require enhanced energy density characteristics.

Additionally, an electrolyte-sulfur value indicator provides visual representation within the energy density graph 1600 of different electrolyte-to-sulfur mass ratios that correspond to various operating conditions and performance characteristics. The electrolyte-sulfur value indicator may display three different shading patterns or symbols that correspond to 1618 E/S values of less than 2.5, 1620 E/S values between 2.5-3.0, and 1622 E/S values greater than 3.0 to illustrate how different electrolyte quantities affect energy density performance within each operating zone.

In various embodiments, the electrolyte-sulfur values may demonstrate how formulations within the increased solvation electrolyte zone 1616 enable operation at E/S ratios below 2.5 while maintaining enhanced energy density performance compared to conventional formulations that require higher electrolyte quantities. Further, the electrolyte-sulfur values may illustrate how the relationship between DME volume percentage and energy density performance varies depending on the electrolyte-to-sulfur ratio employed in the battery cell configuration. The different categories represented by the electrolyte-sulfur values may provide guidance for selecting appropriate electrolyte compositions based on target E/S ratios and desired energy density performance characteristics for specific applications or operating requirements.

The interaction between the electrolyte composition points 1602, 1604, 1606 and the operating zones within the energy density graph 1600 demonstrates how different formulation strategies can achieve varying energy density performance characteristics while maintaining compatibility with lean electrolyte operating conditions. The positioning of these composition points within the highly solvating electrolyte zone 1614 and increased solvation electrolyte zone 1616 may indicate the enhanced performance achievable through optimized DME concentrations and controlled lithium salt ratios compared to formulations within the conventional electrolyte zone 1612.

In some cases, the relationship between the high energy mode 1608 and long cycle life mode 1610 within the energy density graph 1600 may demonstrate how operating condition optimization can achieve different performance characteristics using similar electrolyte compositions through modified cell architecture and cycling parameters. The electrolyte-sulfur values (1618, 1620, 1622) may provide additional context for understanding how different E/S ratios affect the energy density performance achievable within each operating zone, enabling selection of appropriate formulation and operating strategies based on specific application requirements. The comprehensive representation within the energy density graph 1600 may enable predictive optimization of electrolyte formulations and operating conditions to achieve target energy density performance while maintaining electrochemical stability and cycle life characteristics.

The energy density graph 1600 addresses limitations in conventional lithium-sulfur electrolyte optimization by providing systematic analysis of the relationship between DME volume percentage and energy density performance across different operating zones and electrolyte-to-sulfur ratios. Traditional lithium-sulfur development often relies on discrete formulation testing without comprehensive understanding of how solvent composition affects energy density performance under different operating conditions, leading to suboptimal formulations and limited performance optimization. The present disclosure resolves these limitations through the systematic analysis represented in the energy density graph 1600, which demonstrates how specific DME volume percentages within different operating zones directly influence energy density performance through their effect on polysulfide solvation capability and electrolyte weight contribution. The quantitative relationship illustrated across the conventional electrolyte zone 1612, highly solvating electrolyte zone 1614, and increased solvation electrolyte zone 1616 enables predictive optimization of electrolyte formulations based on target energy density characteristics while maintaining practical manufacturability and electrochemical stability considerations.

In various embodiments, the energy density graph 1600 may be expanded to incorporate temperature-dependent performance data that demonstrates how the relationship between DME volume percentage and energy density varies under different thermal conditions where operating temperature ranges may affect electrolyte viscosity, ionic conductivity, and polysulfide dissolution kinetics. The energy density graph 1600 may be modified to include pressure-dependent performance data that illustrates how different operating pressures affect the relationship between electrolyte composition and energy density performance, enabling optimization of mechanical constraints for applications requiring operation at pressures of about 40 PSI, below 50 PSI, and/or between 50-100 PSI. In some cases, the energy density graph 1600 may be altered to incorporate voltage window analysis that demonstrates how cycling between 1.8 V and 2.5 V affects energy density performance within different operating zones, providing guidance for optimizing voltage limits based on electrolyte composition and target performance characteristics.

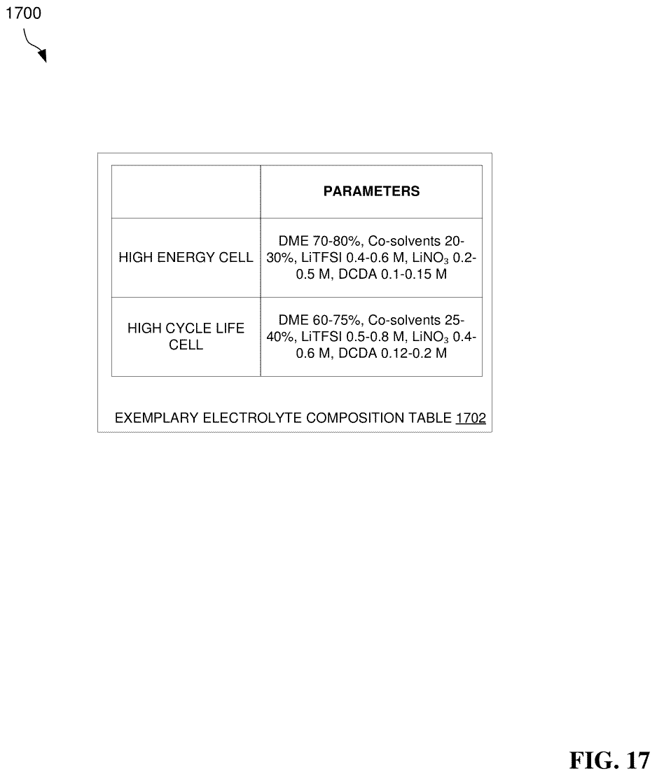

FIG. 17 illustrates an electrolyte composition 1700, in accordance with one embodiment. As an option, the electrolyte composition 1700 may be implemented in the context of any one or more of the embodiments set forth in any previous and/or subsequent Figures and/or description thereof. Of course, however, the electrolyte composition 1700 may be implemented in the context of any desired environment. Further, the aforementioned definitions may equally apply to the description below.

An exemplary electrolyte composition table 1702 provides detailed parameter values that demonstrate the relationship between different electrolyte formulations and their respective performance characteristics for high energy and high cycle life cell configurations. The exemplary electrolyte composition table 1702 displays quantitative data ranges for multiple electrolyte parameters including DME volume percentage, co-solvent volume percentage, LiTFSI molarity, LiNO3 molarity, DCDA molarity, and density measurements that collectively define the electrochemical properties of each formulation. In various embodiments, the exemplary electrolyte composition table 1702 may demonstrate how the electrolyte composition 1700 can be modified to achieve different performance targets through systematic adjustment of individual component concentrations while maintaining compatibility with the battery cell 1302 architecture.

The exemplary electrolyte composition table 1702 may illustrate how formulations configured for high energy applications incorporate reduced electrolyte quantities and optimized solvent ratios that minimize weight contribution while maximizing active material utilization efficiency. The parametric data within the exemplary electrolyte composition table 1702 enables direct comparison between different formulation strategies and their respective effects on energy density, cycle life, and electrochemical stability characteristics under controlled operating conditions.

The exemplary electrolyte composition table 1702 may display parameter values for high energy cell configurations that demonstrate how the electrolyte composition 1700 can be optimized to achieve maximum gravimetric energy density through reduced electrolyte-to-sulfur ratios and enhanced polysulfide solvation capability. High energy formulations within the exemplary electrolyte composition table 1702 may incorporate DME volume percentages of 70-80% combined with LiTFSI concentrations of 0.4-0.6M and LiNO3 concentrations of 0.2-0.5M to maximize the availability of free coordinated ether groups 1314 for polysulfide dissolution during discharge processes. In some cases, the high energy configurations shown in the exemplary electrolyte composition table 1702 may demonstrate how the molar ratio of DME to LiTFSI within these concentration ranges provides excess non-coordinated ether groups for polysulfide solvation that enables enhanced sulfur utilization efficiency. The high energy parameter ranges within the exemplary electrolyte composition table 1702 may correspond to operating conditions where the battery cell 1302 may be configured to prioritize energy density performance through minimized electrolyte weight contribution and optimized active material accessibility. The exemplary electrolyte composition table 1702 may illustrate how high energy formulations enable operation at electrolyte-to-sulfur ratios approaching the theoretical minimum while maintaining adequate electrochemical performance through enhanced polysulfide dissolution kinetics provided by the optimized electrolyte composition 1700.

The exemplary electrolyte composition table 1702 may also display parameter ranges for high cycle life cell configurations that demonstrate how the electrolyte composition 1700 can be modified to achieve extended operational life through enhanced electrode stability and reduced capacity fade during extended cycling operations. High cycle life formulations within the exemplary electrolyte composition table 1702 may incorporate DME volume percentages of 60-75%, co-solvents comprising 25-40% by volume, LiTFSI concentrations of 0.5-0.8M, LiNO3 concentrations of 0.4-0.6M, and DCDA additive concentrations of 0.12-0.2M that provide enhanced electrode passivation and reduced unwanted side reactions that could otherwise contribute to performance degradation over time.

In various embodiments, the high cycle life configurations shown in the exemplary electrolyte composition table 1702 may demonstrate how the combination of reduced cathode 1304 mass loading of less than 5 mg/cm2, anode 1306 thickness of less than 1000 microns, electrolyte-to-sulfur mass ratio of less than or equal to 3.5:1, and at least 60-75% by volume of DME in the electrolyte package 1402 may be configured for extended cell cycle life. The high cycle life parameter values within the exemplary electrolyte composition table 1702 may correspond to operating conditions where the battery cell 1302 may be configured with reduced cathode mass loading, freestanding anode architecture, and DCDA additive concentrations of 0.12-0.2M for extended cycle life while maintaining energy density performance within acceptable ranges for commercial applications. The exemplary electrolyte composition table 1702 may illustrate how high cycle life formulations balance electrochemical performance with stability considerations through controlled adjustment of solvent ratios, salt concentrations, and additive systems that minimize electrode stress during extended cycling operations.

The comparative analysis enabled by the exemplary electrolyte composition table 1702 may demonstrate how different parameter combinations within the electrolyte composition 1700 achieve varying performance characteristics through systematic modification of individual component concentrations while maintaining overall compositional balance. The parameter relationships shown within the exemplary electrolyte composition table 1702 may illustrate how high energy configurations prioritize reduced electrolyte weight and enhanced polysulfide solvation through high DME concentrations of 70-80% and low salt concentrations, while high cycle life configurations incorporate additive systems and modified solvent ratios that enhance electrode stability and reduce capacity fade.

In various embodiments, the exemplary electrolyte composition table 1702 may demonstrate how the electrolyte composition 1700 can be systematically modified to achieve intermediate performance characteristics that balance energy density and cycle life requirements for specific applications or operating conditions. As such, the parametric data within the exemplary electrolyte composition table 1702 may enable predictive modeling of electrolyte performance based on component concentrations, allowing for rapid optimization of formulations without extensive experimental validation for each composition variant. The exemplary electrolyte composition table 1702 may provide a framework for understanding how individual parameter modifications affect overall electrochemical performance, enabling rational design of electrolyte systems that achieve target performance characteristics while maintaining practical manufacturability and cost considerations.

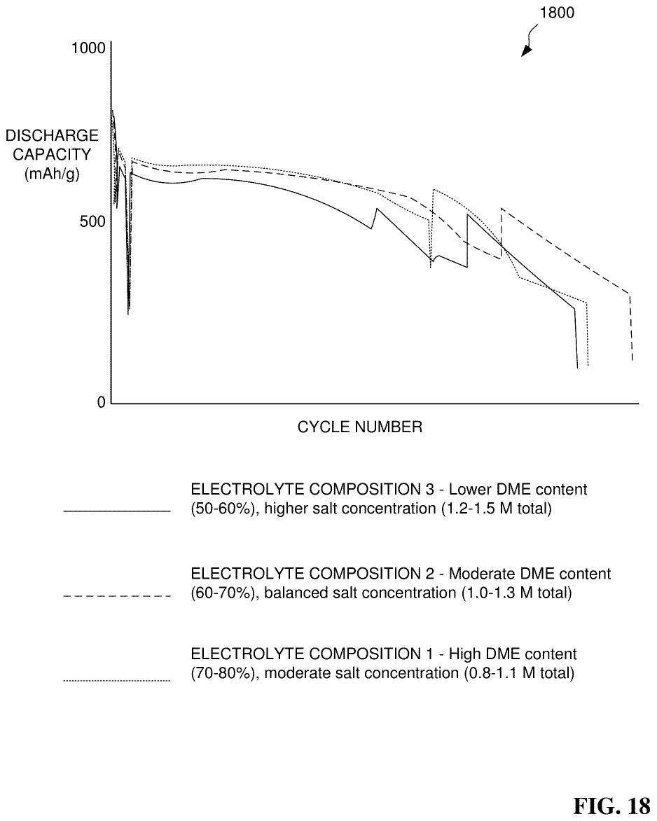

FIG. 18 illustrates discharge capacity versus cycle number curves for different electrolyte compositions, in accordance with one embodiment. As an option, the discharge capacity versus cycle number curves for different electrolyte compositions may be implemented in the context of any one or more of the embodiments set forth in any previous and/or subsequent Figures and/or description thereof. Of course, however, the discharge capacity versus cycle number curves for different electrolyte compositions may be implemented in the context of any desired environment. Further, the aforementioned definitions may equally apply to the description below.

A cycle number 1800 represents the horizontal axis parameter that quantifies the progression of charge-discharge cycles during extended electrochemical testing of the battery cell 1302 configurations with different electrolyte formulations. The progression along the cycle number 1800 axis allows for direct comparison of capacity fade rates between different electrolyte formulations, providing quantitative data for evaluating the effectiveness of various compositional strategies in maintaining electrochemical performance over extended operational periods.

The discharge capacity curves plotted against the cycle number 1800 demonstrate how different electrolyte compositions affect long-term cycling performance through their influence on polysulfide management, electrode stability, and ionic transport characteristics during extended operational periods. Each discharge capacity curve represents a specific electrolyte formulation range with systematic variations in DME volume percentage ranges (50-60%, 60-70%, 70-80%) and corresponding lithium salt concentration ranges (1.2-1.5 M, 1.0-1.3 M, 0.8-1.1 M total), and additive systems that provide different electrochemical stability and performance characteristics.

In various embodiments, the discharge capacity curves may demonstrate how electrolyte formulations within the increased solvation electrolyte zone 1616 maintain enhanced capacity retention compared to formulations within the conventional electrolyte zone 1612 throughout the progression of the cycle number 1800. The slope and curvature of individual discharge capacity curves may indicate the rate of capacity fade and the mechanisms responsible for performance degradation in each electrolyte formulation. The discharge capacity data plotted against the cycle number 1800 may reveal how specific electrolyte compositions enable extended operational life through enhanced electrode passivation, reduced unwanted side reactions, and improved polysulfide dissolution kinetics that minimize capacity loss during extended cycling operations.

The tabular data displayed below the discharge capacity curves provides detailed compositional parameter ranges for the three electrolyte formulations tested, including DME volume percentage, co-solvent percentage, and total lithium salt concentration ranges that collectively define the electrochemical properties of each composition. The parametric data enables direct correlation between specific electrolyte compositions and their respective discharge capacity performance characteristics throughout the progression of the cycle number 1800.

In some cases, the tabular data may demonstrate how Electrolyte Composition 1 with high DME content (70-80%) and moderate salt concentration (0.8-1.1 M total) provides enhanced capacity retention compared to alternative solvent ratios when combined with appropriate lithium salt concentrations and additive systems compared to Electrolyte Composition 2 with moderate DME content (60-70%) and Electrolyte Composition 3 with lower DME content (50-60%). In some instances, the capacity retention data may exhibit temporary discontinuities or variations that reflect testing equipment interruptions rather than inherent electrochemical performance limitations.

The interaction between the different electrolyte compositions and their respective discharge capacity performance throughout the cycle number 1800 demonstrates how compositional optimization directly influences long-term electrochemical stability and capacity retention characteristics in lithium-sulfur battery systems. The comparative performance data may reveal how the three electrolyte composition ranges with their respective DME content and salt concentration combinations, and additive systems contribute to enhanced cycle life through their effects on polysulfide dissolution, electrode passivation, and ionic transport mechanisms.

In various embodiments, the discharge capacity and energy density performance curves presented in the figures (including FIG. 18 and others herein) may exhibit characteristic features that reflect standardized electrochemical testing protocols and statistical analysis methods employed in lithium-sulfur battery evaluation. For example, the performance curves may display initial capacity variations during early cycling periods that correspond to rate capability testing phases where cells are evaluated at elevated C-rates (such as up to 1C) before returning to nominal C/3 cycling conditions, which may temporarily reduce apparent capacity due to kinetic limitations at higher discharge rates. Additionally, the performance curves may exhibit periodic capacity fluctuations during extended cycling operations that reflect median capacity calculations of surviving cells within test populations, where capacity may appear to decrease and subsequently recover as underperforming cells are removed from the statistical analysis, resulting in median values that more accurately represent the performance of stable, well-functioning cells. These testing artifacts and statistical analysis methods are commonly observed in lithium-sulfur battery evaluation and do not reflect fundamental limitations of the disclosed electrolyte compositions, but rather represent standard practices for comprehensive electrochemical characterization that enable accurate assessment of both initial performance capabilities and long-term stability characteristics under controlled testing conditions.

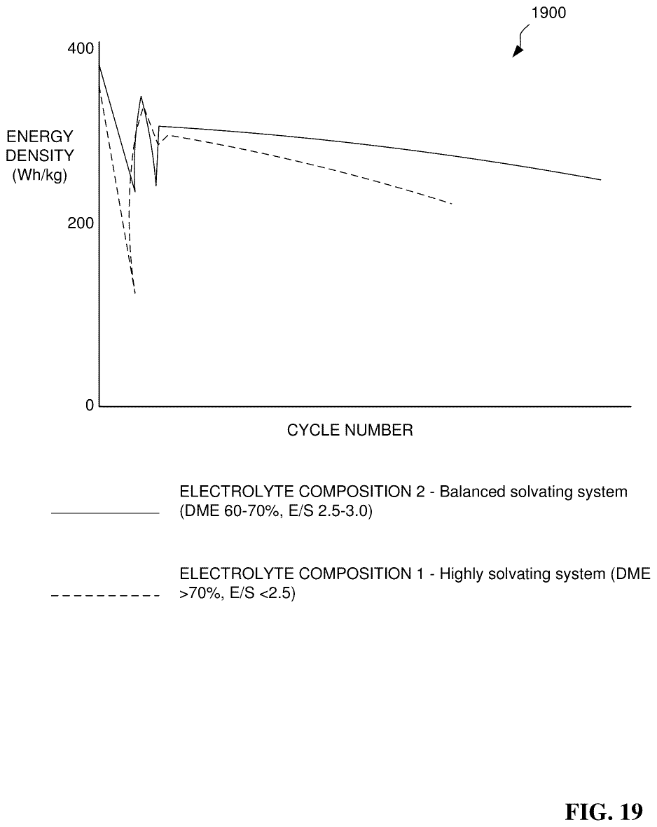

FIG. 19 illustrates a cycle number graph 1900, in accordance with one embodiment. As an option, the cycle number graph 1900 may be implemented in the context of any one or more of the embodiments set forth in any previous and/or subsequent Figures and/or description thereof. Of course, however, the cycle number graph 1900 may be implemented in the context of any desired environment. Further, the aforementioned definitions may equally apply to the description below.

The cycle number graph 1900 demonstrates the relationship between energy density performance measured in Wh/kg and cycle progression for different electrolyte compositions within the battery system 1300 configurations. The cycle number graph 1900 displays two distinct performance curves representing Electrolyte Composition 1 (highly solvating system with DME>70%, E/S<2.5) and Electrolyte Composition 2 (balanced solvating system with DME 60-70%, E/S 2.5-3.0) that illustrate how different electrolyte formulations affect energy density retention throughout extended cycling operations, providing comparative analysis of electrochemical stability and performance degradation characteristics. In some cases, the cycle number graph 1900 may reveal how optimized electrolyte compositions maintain enhanced energy density performance compared to conventional formulations throughout extended operational periods that may exceed several hundred charge-discharge cycles.

Electrolyte Composition 1 within the cycle number graph 1900 represents a highly solvating system optimized for enhanced energy density retention through DME content greater than 70% and electrolyte-to-sulfur ratios below 2.5 combined with controlled lithium salt concentrations that maintain adequate polysulfide solvation capability throughout extended cycling operations. The energy density performance of this second curve throughout the cycle progression may illustrate how optimized ratios of DME to the lithium salts 1312 contribute to sustained electrochemical performance by maintaining the availability of the free coordinated ether groups 1314 for polysulfide dissolution processes.

In various embodiments, Electrolyte Composition 1 may incorporate DME content greater than 70% by volume with co-solvents and electrolyte-to-sulfur ratios below 3.5 (and even potentially below 2.5) to provide enhanced polysulfide solvation capability while maintaining electrochemical stability during extended cycling operations. The interaction between the optimized electrolyte composition and the battery cell 1302 architecture may contribute to sustained energy density performance throughout the cycle progression by reducing electrode stress and minimizing unwanted side reactions that could otherwise lead to capacity fade and energy density degradation.

Electrolyte Composition 2 within the cycle number graph 1900 represents a balanced solvating system with DME content of 60-70% and electrolyte-to-sulfur ratios of 2.5-3.0 that incorporates different compositional parameters to achieve different energy density retention characteristics through modified polysulfide management and electrode passivation mechanisms. The energy density retention profile of the first curve throughout the cycle progression may demonstrate how alternative formulation approaches can achieve different performance characteristics while maintaining compatibility with the electrolyte solvent package 1308 and moderate electrolyte-to-sulfur ratios in the 2.5-3.0 range.

### Additional Embodiments

In various embodiments, the electrolyte composition 1700 may incorporate organodiselenide compounds as performance-enhancing additives beyond the DCDA 1408 system. The electrolyte system 1400 may include diphenyl diselenide (DPhDSe) as an additive that provides enhanced cycle life and specific capacity performance through mechanisms that complement the polysulfide solvation capability of the high DME content formulations. These organodiselenide compounds may interact with polysulfide species to reduce unwanted side reactions while maintaining the enhanced solvation capability provided by the optimized DME to lithium salt ratios. The combination of organodiselenide additives with the highly solvating electrolyte system enables synergistic performance improvements that exceed what may be achieved through individual optimization of solvent composition or additive systems alone.

In various embodiments, the electrolyte system 1400 may incorporate diluent components to modify viscosity, surface tension, and wetting characteristics of the final electrolyte composition without compromising the fundamental polysulfide solvation capability. For example, the electrolyte package 1402 may include 1,1,2,2-Tetrafluoroethyl-2,2,3,3-tetrafluoropropyl ether (TTE) as a diluent component that reduces electrolyte viscosity while maintaining compatibility with the high DME concentrations and optimized lithium salt ratios. In some cases, the electrolyte system 1400 may incorporate trioxane as a diluent that prevents premature cathode passivation during extended cycling operations while reducing surface tension to improve electrolyte wetting characteristics. The diluent concentration within the electrolyte package 1402 may be maintained below 25% by volume to preserve the enhanced polysulfide solvation capability while achieving the desired viscosity and wetting property modifications.

In various embodiments, the battery system 1300 may be configured for operation under specific pressure conditions that optimize electrochemical performance while maintaining mechanical integrity of the cell architecture. The battery cell 1302 may be designed to operate at pressures of approximately 40 PSI, which provides adequate electrode contact and ionic transport while minimizing mechanical stress on the freestanding anode 1306 configuration. In some cases, the operating pressure may be maintained below 50 PSI to enable simplified battery pack design and manufacturing processes that do not require high-pressure containment systems. The reduced pressure operation enabled by the optimized electrolyte composition and cell architecture provides advantages for practical battery applications where mechanical constraints and packaging requirements limit the acceptable pressure ranges for safe and reliable operation. It is recognized that other systems may operate between 50-100 PSI under higher-pressure environments.

In various embodiments, the battery cell 1302 may be configured to operate within specific voltage windows that optimize both energy density and cycle life characteristics while maintaining electrochemical stability of the highly solvating electrolyte system. The cell may be designed to cycle between 1.8 V and 2.5 V to minimize electrode stress and reduce unwanted side reactions that could otherwise contribute to capacity fade during extended cycling operations. This voltage window optimization works synergistically with the high DME content electrolyte formulation to maintain polysulfide dissolution capability while preventing excessive polysulfide shuttling that could occur at higher voltage limits. The controlled voltage cycling combined with the optimized electrolyte composition enables extended operational life while maintaining the enhanced energy density characteristics provided by the lean electrolyte operating conditions.

### Use Case Scenario

By way of a use-case scenario, and in various embodiments, a drone manufacturer implements the highly solvating electrolyte system in commercial unmanned aerial vehicles designed for extended surveillance missions. The manufacturer configures the battery system 1300 with a cathode 1304 comprising sulfur at a mass loading of 3.5 mg/cm2 and an anode 1306 comprising a lithium-magnesium alloy with a thickness of 65 microns in a freestanding configuration without copper foil current collectors. The electrolyte solvent package 1308 contains DME at 70% by volume, DOL at 15% by volume, and BTFE at 15% by volume, with lithium salts 1312 comprising LiTFSI at 0.6 M and LiNO3 at 0.5 M, achieving an electrolyte-to-sulfur mass ratio of 2.6:1. The DCDA additive at 0.15 M concentration enhances cycle life while the molar ratio of DME to LiTFSI of 10.1:1 provides excess non-coordinated ether groups for enhanced polysulfide solvation. During operation, the drone achieves 336 Wh/kg energy density while cycling between 1.8 V and 2.5 V at 40 PSI pressure, enabling flight times exceeding many hours with a 2 kg payload. The lean electrolyte conditions reduce overall battery weight by 25% compared to conventional lithium-sulfur systems, allowing the drone to carry additional sensors or extend mission duration.

### Improvements Over Existing Systems

The present disclosure addresses significant challenges in lithium-sulfur battery technology that have long limited the commercial viability of these high-energy-density systems. Prior art lithium-sulfur batteries have struggled with fundamental limitations including the requirement for excessive electrolyte quantities, often exceeding electrolyte-to-sulfur ratios of 5:1, which substantially increases overall battery weight and negates the theoretical energy density advantages that make lithium-sulfur technology attractive. Conventional electrolyte formulations fail to provide adequate polysulfide solvation while maintaining electrochemical stability, resulting in poor cycling performance, rapid capacity fade, and the inability to balance ionic conductivity with polysulfide dissolution kinetics within a single electrolyte system. These deficiencies force manufacturers to choose between high energy density and long cycle life rather than achieving both characteristics simultaneously, severely limiting practical applications in weight-sensitive systems such as drones, electric vehicles, and aerospace applications where both performance parameters are critical for commercial success.

The disclosed highly solvating electrolyte system overcomes these deficiencies through a coordinated approach that maximizes non-coordinated ether groups for enhanced polysulfide solvation while enabling operation under lean electrolyte conditions with electrolyte-to-sulfur ratios of 3.5:1 or lower. By incorporating a high volume fraction of DME (at least 70%) with moderate to low lithium salt concentrations (below 1.2 M), the system maintains a molar ratio of DME to LiTFSI of about 10.1:1, providing excess ether groups available for polysulfide dissolution that enables complete sulfur utilization during discharge processes. The integration of reduced cathode mass loading below 5 mg/cm2, freestanding lithium-magnesium alloy anodes with thickness less than 100 microns, and specific additive systems such as DCDA at 0.15 M concentration creates a comprehensive solution that achieves both high energy density (336 Wh/kg) and extended cycle life (80+% capacity retention after hundreds of cycles) while reducing overall battery weight by 25% compared to conventional systems. This breakthrough enables practical implementation of lithium-sulfur technology in commercial applications by resolving the traditional trade-offs between energy density and operational life that have prevented widespread adoption of these theoretically superior energy storage systems.

Further, it is noted that the availability of free DME molecules enables dissolution of greater quantities of lithium polysulfide species before electrolyte viscosity increases significantly, thereby maintaining ionic conductivity and preventing high resistance buildup that could otherwise lead to IR drops and premature cycle termination under lean electrolyte conditions. This enhanced polysulfide dissolution capability directly addresses the fundamental challenge of maintaining electrochemical performance while minimizing electrolyte loading requirements.

### Fluoroether Electrolyte Additives for Lithium-Sulfur Batteries

The present disclosure relates to the field of electrochemical energy storage systems, specifically focusing on advanced electrolyte compositions for lithium-sulfur battery technologies. Lithium-sulfur batteries represent a promising next-generation energy storage solution due to their exceptionally high theoretical energy density (such as approximately 2600 Wh/kg), which substantially exceeds conventional lithium-ion systems. This enhanced energy density makes lithium-sulfur batteries particularly attractive for applications including electric vehicles, aerospace systems, and grid-scale energy storage where weight and volume constraints are critical considerations.

Current lithium-sulfur battery systems encounter several fundamental obstacles that significantly hinder their electrochemical performance and long-term stability. These challenges include the polysulfide shuttle effect, where soluble lithium polysulfide intermediates migrate between electrodes causing capacity loss and reduced coulombic efficiency. Additionally, electrolyte degradation and dryout occur during cycling, while lithium dendrite formation at the anode surface leads to safety concerns and further performance deterioration. Existing electrolyte solutions often fail to provide adequate performance across multiple metrics simultaneously, typically focusing on addressing individual problems in isolation rather than providing comprehensive solutions that optimize overall battery performance.

The present disclosure addresses these challenges through the development of specialized fluoroether electrolyte additives that provide synergistic improvements across multiple performance parameters. The disclosed fluoroether compounds, including those with CF3CH2O—R structures and CF3CHFCF2O—R configurations, form enhanced solid electrolyte interphase layers on the lithium anode that significantly improve coulombic efficiency while maintaining low electrolyte viscosity for optimal rate performance. The combination of electron withdrawing fluoroether compounds with performance enhancing additives creates unexpected synergistic effects that simultaneously address polysulfide management, dendrite suppression, and cycle life extension.

Furthermore, the present disclosure incorporates systematic fluorination patterns and dual-oxygen ether structures that enable precise tuning of electrochemical properties for specific application requirements. The disclosed compounds demonstrate superior performance characteristics compared to conventional electrolyte systems, including enhanced coulombic efficiency retention, reduced resistance buildup during cycling, and improved compatibility with both lithium metal anodes and sulfur cathodes. Additionally, the modular nature of the fluoroether structures allows for customizable electrolyte formulations that can be optimized for different operating conditions while maintaining the fundamental advantages of improved solid electrolyte interphase formation and enhanced electrochemical stability.

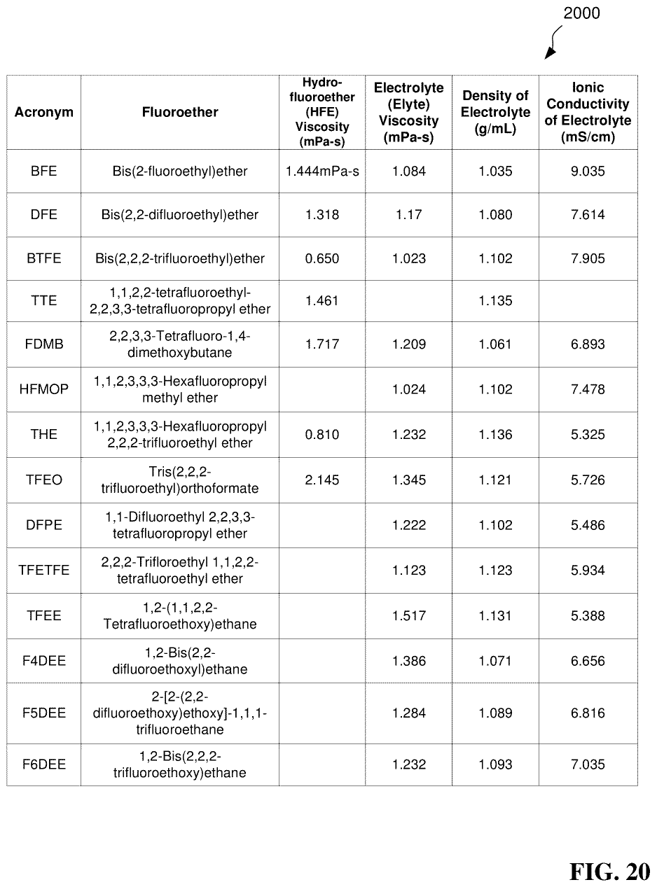

FIG. 20 illustrates a fluoroether property table 2000, in accordance with one embodiment. As an option, the fluoroether property table 2000 may be implemented in the context of any one or more of the embodiments set forth in any previous and/or subsequent Figures and/or description thereof. Of course, however, the fluoroether property table 2000 may be implemented in the context of any desired environment. Further, the aforementioned definitions may equally apply to the description below.

The fluoroether property table 2000 presents comprehensive physical and electrochemical characteristics for various fluoroether compounds utilized in lithium-sulfur battery electrolyte systems. The fluoroether property table 2000 includes columns displaying acronym designations, fluoroether chemical names, hydrofluroether (HFE) viscosity measurements, electrolyte (Elyte) viscosity values, density of electrolyte compositions, and ionic conductivity of the electrolyte measurements for fourteen distinct fluoroether compounds. These compounds include BFE, DFE, BTFE, TTE, FDMB, HFMOP, THE, TFEO, DFPE, TFETFE, TFEE, F4DEE, F5DEE, and F6DEE, each representing different fluorination patterns and molecular structures (shown in, for example, FIGS. 21-1 through 21-14) that contribute to enhanced electrochemical performance.

Viscosity measurements presented in the fluoroether property table 2000 reveal substantial differences between individual fluoroether compounds and their corresponding electrolyte formulations. The HFE viscosity column displays intrinsic viscosity values for pure fluoroether compounds, while the electrolyte viscosity column shows viscosity measurements for complete electrolyte formulations containing the respective fluoroether additives. Lower viscosity values generally correlate with improved ion transport properties and enhanced rate performance in lithium-sulfur electrochemical cells, as reduced viscosity facilitates lithium ion mobility through the electrolyte medium.

The fluoroether compounds demonstrate improved electrode wetting properties and reduced lithium polysulfide solubility compared to conventional electrolyte systems, contributing to enhanced electrochemical stability and reduced polysulfide shuttle effects. Compounds such as DFE and BTFE exhibit particularly favorable viscosity characteristics that enable efficient ion transport while maintaining the beneficial properties associated with fluorinated ether structures.

Density measurements within the fluoroether property table 2000 indicate the mass per unit volume for electrolyte compositions containing different fluoroether compounds. These density values influence energy density calculations for complete battery systems, as higher electrolyte density may reduce overall gravimetric energy density while potentially improving volumetric energy density. Generally, it has been found that the density values increase with higher fluorine content in the fluoroether compounds, as fluorine atoms contribute significantly more mass per atom compared to hydrogen atoms they replace.

Ionic conductivity measurements displayed in the fluoroether property table 2000 quantify the ability of electrolyte compositions to transport lithium ions between electrodes during battery operation. Higher ionic conductivity values generally correlate with improved rate capability and reduced internal resistance in lithium-sulfur electrochemical cells. The fluoroether compounds listed in the fluoroether property table 2000 demonstrate varying ionic conductivity values that reflect differences in molecular structure, fluorination patterns, and interactions with lithium salts in the electrolyte medium. Compounds such as BTFE and THE exhibit ionic conductivity values that support efficient electrochemical operation while providing the additional benefits of enhanced solid electrolyte interphase formation and reduced polysulfide solubility.

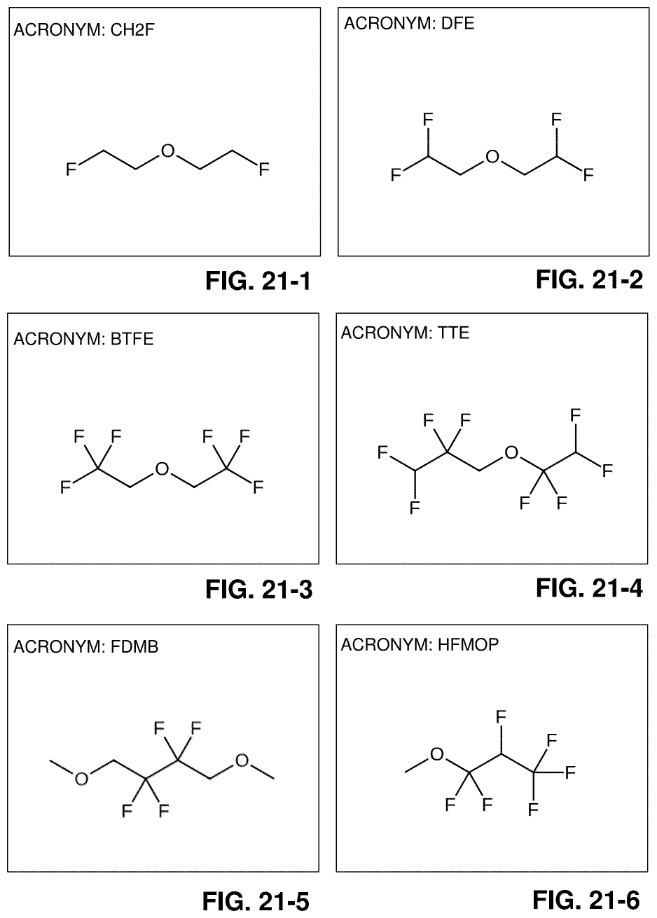

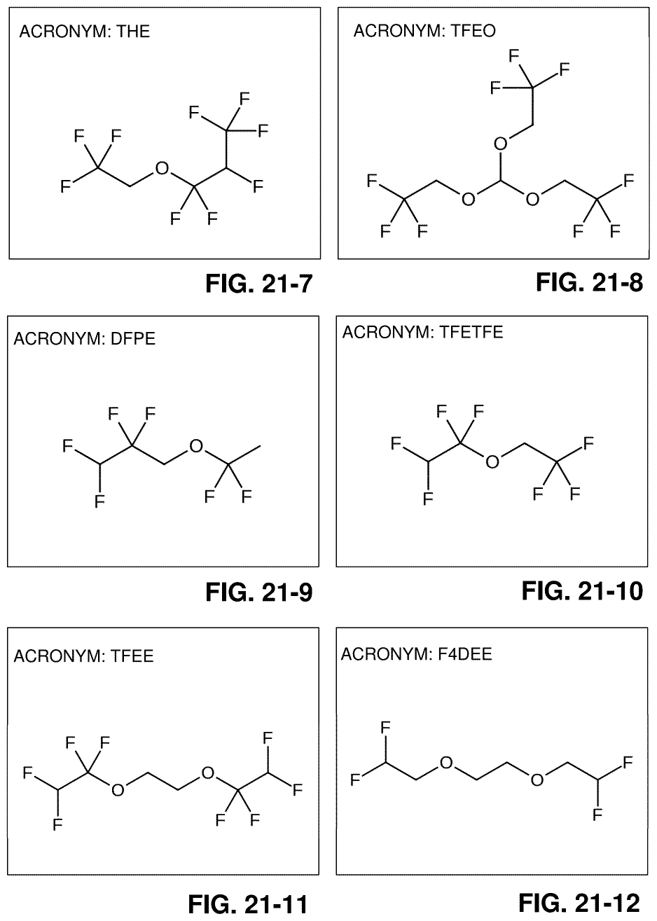

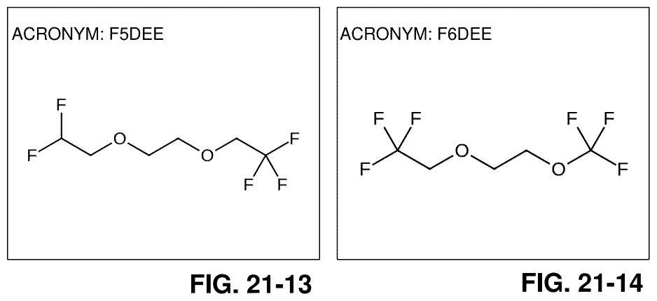

FIG. 21-1, FIG. 21-2, FIG. 21-3, FIG. 21-4, FIG. 21-5, FIG. 21-6, FIG. 21-7, FIG. 21-8, FIG. 21-9, FIG. 21-10, FIG. 21-11, FIG. 21-12, FIG. 21-13, and FIG. 21-14 illustrate chemical structures of fluoroether compounds, in accordance with one embodiment. As an option, the chemical structures of the fluoroether compounds may be implemented in the context of any one or more of the embodiments set forth in any previous and/or subsequent Figures and/or description thereof. Of course, however, the chemical structures of the fluoroether compounds may be implemented in the context of any desired environment. Further, the aforementioned definitions may equally apply to the description below.

The structure labeled BFE shows a linear fluoroether with terminal fluorine atoms connected by an oxygen bridge. The BFE compound exhibits a symmetric molecular arrangement where two difluoromethyl groups (CHF2) are linked through a central oxygen atom, creating a structure with the formula CH2FCH2OCH2CH2F. This particular fluorination pattern positions fluorine atoms at specific carbon locations that influence the electrochemical behavior of the compound within lithium-sulfur battery systems. The degree of fluorination in BFE contributes to enhanced cycling performance in electrochemical cells, as the fluorinated carbons provide electron-withdrawing effects that stabilize the electrolyte composition during battery operation.

The structure labeled DFE illustrates a fluoroether with two difluoromethyl groups linked by an oxygen atom. The DFE compound represents a partially fluorinated ether where hydrogen atoms remain present on the alpha carbons adjacent to the oxygen bridge, creating a structure with enhanced electrochemical properties compared to fully hydrogenated ethers. The molecular arrangement of DFE demonstrates how alpha-hydrogenated fluoroethers may perform in lithium-sulfur battery applications, as the combination of fluorine and hydrogen atoms on the carbon framework provides balanced chemical reactivity. The degree of fluorination in DFE enables beneficial cycling characteristics in electrochemical cells while maintaining structural stability under operating conditions. The presence of hydrogen atoms on the alpha carbons allows for controlled reactivity that may contribute to solid electrolyte interphase formation without excessive electrolyte consumption during battery cycling.

The structure labeled BTFE displays a fluoroether containing two trifluoromethyl groups connected by an oxygen bridge. The BTFE compound, also known as bis(2,2,2-trifluoroethyl) ether, represents a symmetric fluoroether containing CF3CH2O—R groups where R corresponds to CH2CF3. This molecular structure exemplifies how symmetric fluoroethers may provide enhanced performance characteristics despite manufacturing challenges associated with producing highly fluorinated compounds. The BTFE structure demonstrates the CF3CH2O—R motif that may contribute to improved electrochemical stability and coulombic efficiency in lithium-sulfur battery systems. The symmetric arrangement of trifluoromethyl groups in BTFE creates a balanced molecular structure that may facilitate uniform interactions with lithium ions and polysulfide species during battery operation. Further, the high degree of fluorination in BTFE enables enhanced chemical stability and reduced reactivity with lithium metal anodes, contributing to improved cycle life performance.

The structure labeled TTE shows a fluoroether with multiple fluorine substitutions and a central oxygen atom. The TTE compound exhibits an asymmetric molecular arrangement where different fluorinated groups are connected through the oxygen bridge, creating a structure that combines various fluorination patterns within a single molecule. The molecular structure of TTE demonstrates how fluorine atoms may be positioned at different carbon locations (Cα or Cβ) within the fluoroether structure. The degree of fluorination in TTE provides beneficial effects for cycling electrochemical cells while maintaining structural diversity that may contribute to enhanced electrolyte properties. The asymmetric nature of TTE allows for tunable electrochemical characteristics that may be optimized for specific lithium-sulfur battery applications through controlled synthesis approaches.

The structure labeled FDMB illustrates a fluoroether with two methoxy groups and a central tetrafluorobutane unit. The FDMB compound represents a unique molecular arrangement where fluorinated and non-fluorinated ether groups are combined within a single structure, creating a compound with intermediate fluorination characteristics. The molecular structure of FDMB demonstrates how partial fluorination may be achieved while maintaining ether functionality that contributes to electrolyte solvation properties. The degree of fluorination in FDMB enables beneficial cycling performance in electrochemical cells while providing structural features that may enhance compatibility with lithium salts and other electrolyte components. The presence of methoxy groups in FDMB allows for hydrogen bonding interactions that may contribute to improved electrolyte stability and reduced volatility during battery operation.

The structure labeled HFMOP shows a fluoroether containing multiple fluorine substitutions and a methoxy group. The HFMOP compound exhibits a complex molecular arrangement that combines highly fluorinated segments with partially fluorinated regions, creating a structure with diverse chemical properties. The molecular structure of HFMOP demonstrates how fluorine atoms positioned at different carbon locations within the fluoroether structure may be achieved through custom synthesis approaches that enable precise control over fluorination patterns. The degree of fluorination in HFMOP contributes to enhanced electrochemical performance while maintaining structural features that may facilitate interactions with lithium-sulfur battery components. The combination of fluorinated and methoxy groups in HFMOP creates a molecular structure that may provide balanced solvation properties and chemical stability under battery operating conditions.

The structure labeled THE exhibits a linear molecular structure containing a central oxygen atom connecting two different fluorinated carbon chains. The molecular arrangement demonstrates an asymmetric fluoroether configuration where a trifluoromethyl group (CF3) is positioned at one end and a hexafluoropropyl group (CF3CHFCF3) is positioned at the other end, creating a structurally diverse framework that provides varied electrochemical interactions. The trifluoroethyl portion connects through a methylene carbon bearing two fluorine atoms (CF2), while the hexafluoropropyl portion incorporates a central carbon bearing one hydrogen and one fluorine atom (CHF) flanked by two trifluoromethyl groups, establishing a highly fluorinated molecular environment that contributes to enhanced chemical stability and reduced reactivity with lithium metal surfaces. The overall structure represents an asymmetric fluoroether molecule with extensive fluorine substitutions arranged around the central oxygen atom, creating a strong electron-withdrawing environment that stabilizes the electrolyte composition during battery cycling operations. The THE compound incorporates the CF3CHFCF2O—R structural motif that demonstrates enhanced coulombic efficiency through solid electrolyte interphase formation on lithium anodes.

The structure labeled TFEO represents an advanced fluoroether structure where three CF3CH2O groups merge with a single carbon atom, creating enhanced coverage and improved electrochemical performance compared to conventional fluoroether designs. The convergence of multiple fluorinated ether segments at a central carbon creates a molecular environment with high local concentration of electron-withdrawing groups that facilitates controlled interactions with lithium metal surfaces while maintaining electrolyte stability. The triple CF3CH2O group arrangement in TFEO provides extensive fluorinated coverage that may contribute to enhanced solid electrolyte interphase formation and improved chemical stability during battery cycling operations. The molecular structure demonstrates how multiple fluorinated ether segments may be integrated within a single framework to achieve synergistic electrochemical effects that address multiple performance limitations simultaneously. The enhanced coverage provided by the convergent CF3CH2O groups enables improved electrode wetting characteristics and more uniform electrolyte distribution across battery electrode surfaces.

The structure labeled DFPE exhibits a fluoroether structure that incorporates strategic fluorination patterns designed to optimize electrochemical performance through controlled electron-withdrawing effects and enhanced chemical stability. The molecular arrangement demonstrates how fluorine atoms may be positioned at specific carbon locations to create a balanced chemical environment that facilitates beneficial interactions with lithium-sulfur battery components while minimizing unwanted side reactions. The degree of fluorination in DFPE provides enhanced anodic stability compared to conventional ether-based electrolytes, enabling stable operation under demanding electrochemical conditions without significant electrolyte decomposition. The structural features of DFPE enable controlled solid electrolyte interphase formation processes that contribute to improved coulombic efficiency and extended cycle life performance.

The structure labeled TFETFE represents a complex fluoroether structure that combines multiple fluorinated segments within an extended molecular framework, creating enhanced electrochemical properties through synergistic interactions between different fluorinated regions. The molecular arrangement demonstrates how fluorine atoms positioned at various carbon locations throughout the structure contribute to comprehensive electron-withdrawing effects that stabilize the electrolyte composition during battery cycling operations. The extended chain configuration in TFETFE enables improved electrode wetting properties and enhanced electrolyte penetration into porous battery electrode structures, potentially leading to more uniform electrochemical reactions and improved capacity utilization. The degree of fluorination in TFETFE provides enhanced chemical stability while maintaining controlled reactivity that contributes to beneficial solid electrolyte interphase formation processes.

The structure labeled TFEE exhibits a fluoroether structure that demonstrates how strategic molecular design may optimize the balance between chemical stability and electrochemical activity through controlled fluorination patterns and ether functionality. The molecular arrangement shows how fluorine atoms positioned at specific carbon locations create electron-withdrawing environments that reduce reactivity with lithium metal surfaces while maintaining beneficial electrolyte properties for ion transport and electrode interactions. The structural features of TFEE enable enhanced solid electrolyte interphase formation characteristics that provide protective effects on battery electrodes while preserving adequate ionic conductivity for efficient electrochemical operation. The degree of fluorination in TFEE contributes to improved anodic stability and reduced electrolyte consumption during battery cycling, potentially extending operational lifetime and improving overall performance characteristics.

The structure labeled F4DEE incorporates a fluoroether structure that demonstrates multiple fluorine substitutions arranged along the carbon framework, creating electron-withdrawing regions that contribute to enhanced chemical stability and controlled reactivity during electrochemical processes. The structural design of F4DEE enables improved electrode wetting characteristics and reduced electrolyte viscosity that facilitate efficient ion transport while maintaining the chemical stability provided by fluorinated ether functionality. The degree of fluorination in F4DEE provides enhanced anodic stability compared to conventional electrolyte systems, enabling stable operation under demanding conditions without significant performance degradation.

The structure labeled F5DEE comprises a central portion with two oxygen molecules connected by an ethane bridge, creating a dual-oxygen ether structure that enables longer chain configurations with enhanced polarization characteristics. One end of the F5DEE molecule contains a terminal carbon, while the other end contains a terminal carbon, establishing an asymmetric molecular arrangement that provides diverse chemical environments within a single compound. The molecule includes multiple fluorine atoms arranged along the carbon chain, creating electron-withdrawing regions that contribute to enhanced chemical stability and controlled reactivity during electrochemical processes. The dual-oxygen structure of F5DEE enables extended molecular chains that maintain similar polarization characteristics compared to shorter fluoroether compounds while providing additional flexibility in molecular conformation. The fluoroethers with two oxygen molecules in the ether structure, exemplified by F5DEE, enable longer chains with similar polarization effects that may contribute to enhanced electrolyte solvation properties and improved compatibility with lithium-sulfur battery components.

The structure labeled F6DEE comprises a central portion with two oxygen molecules connected by an ethylene bridge, similar to F5DEE but with a symmetric arrangement of trifluoromethyl groups at both ends of the molecule. The symmetric molecular structure of F6DEE creates a balanced distribution of electron-withdrawing effects that may facilitate uniform electrochemical interactions across the entire molecular framework. The dual-oxygen ether structure in F6DEE enables extended chain length while maintaining the beneficial polarization characteristics associated with fluorinated ether compounds, potentially providing enhanced solvation properties for lithium salts and improved electrolyte conductivity. The presence of two oxygen atoms within the ether structure creates multiple coordination sites that may facilitate interactions with lithium ions, potentially contributing to enhanced ion transport properties and improved electrochemical performance. The symmetric arrangement of trifluoromethyl groups in F6DEE creates a molecular environment where fluorination effects are distributed uniformly, potentially providing consistent electrochemical behavior during battery cycling operations.

The comprehensive analysis of fluoroether structures from FIG. 21-1 through FIG. 21-14 reveals a systematic progression in molecular complexity that enables targeted optimization of electrochemical properties for specific lithium-sulfur battery applications. The evolution from simple symmetric structures like BFE and DFE to advanced multi-functional compounds such as TFEO and the dual-oxygen ethers F5DEE and F6DEE demonstrates how strategic molecular engineering may address multiple performance limitations through integrated structural approaches. The spectrum of fluorination patterns across these fourteen compounds creates a toolkit of electron-withdrawing strengths, ranging from partially fluorinated structures that maintain controlled reactivity to highly fluorinated compounds that provide maximum chemical stability. The structural diversity encompasses linear symmetric designs like BTFE and THE that facilitate uniform electrochemical interactions, asymmetric arrangements like TTE and F5DEE that provide diverse chemical environments within single molecules, and complex multi-segment structures like TFEO that achieve enhanced coverage through convergent fluorinated ether groups.

The collective molecular architectures represented across these fluoroether compounds establish fundamental design principles for next-generation electrolyte additives that systematically address the interconnected challenges of lithium-sulfur battery systems. The progression from single-oxygen ether structures to dual-oxygen configurations demonstrates how extended molecular chains may maintain beneficial polarization characteristics while providing enhanced electrode wetting and improved electrolyte penetration capabilities. The systematic variation in fluorination degrees and patterns enables precise tuning of solid electrolyte interphase formation processes, with compounds like THE and TFEO providing enhanced coverage through multiple CF₃CH₂O—R groups, while structures like F4DEE and F6DEE offer extended chain flexibility for accommodating volume changes during cycling. The molecular diversity across these fourteen compounds enables the development of customized electrolyte formulations that may combine multiple fluoroether structures to achieve synergistic effects, addressing polysulfide shuttle management, dendrite suppression, and cycle life extension through complementary mechanisms that optimize overall battery performance beyond what individual compounds can provide.

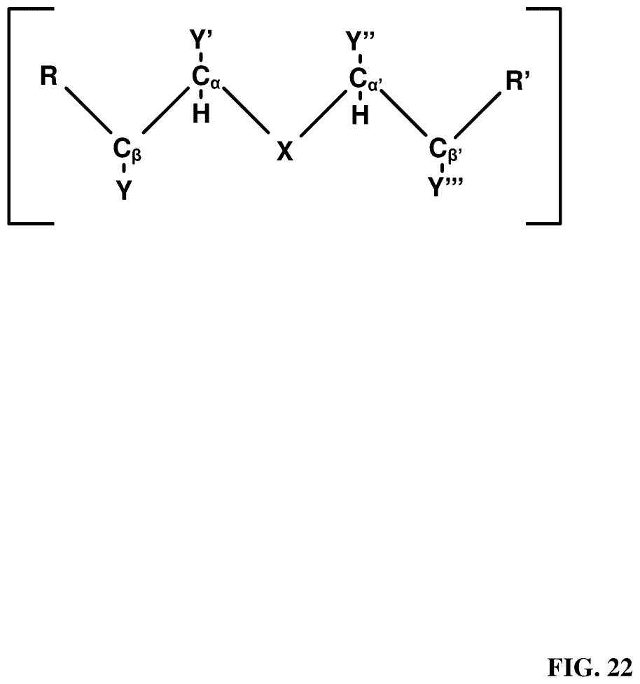

FIG. 22 illustrates a general chemical structure formula for a fluoroether compound, in accordance with one embodiment. As an option, the general chemical structure formula for a fluoroether compound may be implemented in the context of any one or more of the embodiments set forth in any previous and/or subsequent Figures and/or description thereof. Of course, however, the general chemical structure formula for a fluoroether compound may be implemented in the context of any desired environment. Further, the aforementioned definitions may equally apply to the description below.

The general chemical structure formula depicts a repeating unit containing two carbon atoms (Cβ and Cα) connected by single bonds, where each carbon atom bears multiple substituent groups that may be systematically varied to achieve enhanced electrochemical performance characteristics. The carbon atoms labeled Cβ and Cα represent the beta and alpha positions relative to the central heteroatom X, with the alpha carbon positioned adjacent to the central atom and the beta carbon positioned one bond further away from the central connection point. Each carbon atom within the general structure bears substituent groups labeled as R, Y, Y′, Y″, Y′″, and R′, where these substituents may be independently selected from hydrogen atoms, fluorine atoms, alkyl groups, fluoroalkyl groups, or other functional groups that contribute to enhanced cell performance in lithium-sulfur battery applications. The hydrogen atoms (H) attached to the Cα carbons represent positions where fluorine substitution may occur through controlled synthesis approaches, enabling systematic modification of the molecular structure to optimize electrochemical properties. The central atom or group X connects the carbon-containing segments and may comprise oxygen, nitrogen, sulfur, or other heteroatoms that provide the core functionality of the fluoroether compound while maintaining structural integrity during battery cycling operations.

The general structure formula encompasses various fluoroether configurations through systematic variation of the substituent groups and central connecting atom, enabling the design of compounds with tailored electrochemical properties for specific lithium-sulfur battery applications. The substituent groups R and R′ may comprise alkyl chains, fluoroalkyl segments, or aromatic groups that influence the molecular weight, viscosity, and solvation characteristics of the resulting fluoroether compound. The Y-type substituents (Y, Y′, Y″, Y′″) may be independently selected as hydrogen or fluorine atoms, enabling precise control over the degree of fluorination and the resulting electron-withdrawing effects that contribute to enhanced chemical stability and reduced reactivity with lithium metal anodes. The flexibility in substituent selection allows for the creation of symmetric or asymmetric molecular structures that may provide balanced electrochemical properties or specialized functionality for particular battery operating conditions. The general formula demonstrates how fluorine positioning may be systematically varied across different carbon positions to achieve optimal combinations of ionic conductivity, viscosity, and chemical stability that enhance overall cell performance.

The general chemical structure formula depicted in FIG. 22 represents an expanded version of the fluoroether molecular framework compared to the structure shown in FIG. 1B, with the key difference being the substitution pattern at the alpha carbon positions that enables enhanced molecular connectivity and structural diversity. While FIG. 1B shows a fluoroether structure where the two alpha carbons (Cα) are attached only to hydrogen atoms, the general formula in FIG. 22 demonstrates how these same alpha carbon positions may bear various substituent groups (Y, Y′, Y″, Y′″) that can be independently selected from hydrogen atoms, fluorine atoms, alkyl groups, fluoroalkyl groups, or other functional groups. This structural modification enables the fluoroethers to be connected to additional locations within larger molecular frameworks, creating opportunities for extended chain configurations, branched architectures, or incorporation into polymer structures that were not possible with the hydrogen-limited alpha carbons in FIG. 1B.

Taking a step back, the flexibility in fluorine positioning demonstrated by the general formula enables the creation of fluoroether compounds with customized electrochemical properties that address specific performance limitations in lithium-sulfur battery systems. The systematic placement of fluorine atoms at Cα or Cβ positions allows for precise control over the electron-withdrawing strength and chemical reactivity of the resulting compounds, enabling optimization of solid electrolyte interphase formation processes while maintaining adequate electrolyte stability. The general structure accommodates partial fluorination approaches where selected hydrogen atoms may be retained at specific positions to provide controlled reactivity that contributes to beneficial electrochemical processes without excessive electrolyte consumption. The structural modifications enabled by the general formula may include the incorporation of multiple oxygen atoms or alternative heteroatoms that provide enhanced solvation properties and improved compatibility with lithium salts and other electrolyte components. The modular nature of the general structure allows for the systematic exploration of structure-property relationships that enable rational design of next-generation fluoroether compounds with enhanced performance characteristics for advanced lithium-sulfur battery applications.

FIG. 23A, FIG. 23B illustrate performance characteristics of different electrolyte compositions in a lithium-sulfur electrochemical cell, in accordance with one embodiment. As an option, the performance characteristics of different electrolyte compositions in a lithium-sulfur electrochemical cell may be implemented in the context of any one or more of the embodiments set forth in any previous and/or subsequent Figures and/or description thereof. Of course, however, the performance characteristics of different electrolyte compositions in a lithium-sulfur electrochemical cell may be implemented in the context of any desired environment. Further, the aforementioned definitions may equally apply to the description below.

The upper graph depicted in FIG. 23A shows discharge capacity measured in mAh/g versus cycle number for two distinct electrolyte compositions, where Composition 1 Baseline appears as a solid line and Composition 2 THE Electrolyte appears as a dashed line. The discharge capacity measurements demonstrate how different fluoroether compounds influence the electrochemical behavior and capacity retention characteristics during extended cycling operations in lithium-sulfur battery systems. Composition 1 Baseline exhibits discharge capacity values that remain relatively stable throughout the cycling period, indicating enhanced capacity retention compared to alternative fluoroether formulations.

The discharge capacity measurements for Composition 2 THE Electrolyte reveal different electrochemical behavior patterns compared to the Baseline formulation, with capacity values showing distinct cycling characteristics that reflect the influence of molecular structure on electrochemical performance. The THE compound incorporates a linear molecular structure with terminal trifluoromethyl groups connected through a central oxygen atom, creating a highly fluorinated environment that influences ion transport and electrode interactions during battery operation. The capacity retention characteristics of Composition 2 demonstrate how the degree of fluorination and molecular arrangement in THE affect the electrochemical processes occurring at both the lithium anode and sulfur cathode during cycling operations. The structural differences between THE and the Baseline formulation create distinct chemical environments that influence polysulfide solubility, electrode wetting characteristics, and solid electrolyte interphase formation processes that collectively determine the observed discharge capacity behavior.

The lower graph depicted in FIG. 23B shows coulombic efficiency versus cycle number for the same two electrolyte compositions, with Composition 1 shown as a solid line and Composition 2 shown as a dashed line, where coulombic efficiency values range from 0.70 to 1.0 on the vertical axis. The coulombic efficiency measurements quantify the charge-discharge efficiency ratio for each electrolyte composition, providing insight into the extent of side reactions and electrochemical reversibility during battery cycling operations. Composition 1 Baseline demonstrates coulombic efficiency values that approach unity throughout the cycling period, indicating minimal side reactions and enhanced electrochemical reversibility compared to alternative fluoroether formulations. The coulombic efficiency exhibited by the baseline composition reflects the electrochemical characteristics of the reference formulation, which creates protective layers that minimize parasitic reactions while maintaining efficient lithium ion transport.

The coulombic efficiency measurements for Composition 2 THE Electrolyte reveal distinct electrochemical behavior compared to the Baseline formulation, with efficiency values showing variations that reflect the influence of molecular structure on electrochemical reversibility and side reaction occurrence. The THE compound incorporates multiple fluorine substitutions arranged around a central oxygen atom, creating an electron-withdrawing environment that influences the chemical reactivity and electrochemical behavior during battery operation. The coulombic efficiency characteristics of Composition 2 demonstrate how the linear molecular structure and high degree of fluorination in THE affect the solid electrolyte interphase formation processes and electrochemical stability during cycling operations. The structural arrangement of fluorinated carbon segments in THE creates a molecular environment that may influence lithium ion interactions and polysulfide species behavior, contributing to the observed coulombic efficiency patterns during battery cycling. The comparative coulombic efficiency data illustrates how different fluoroether molecular architectures may provide varying degrees of electrochemical reversibility and side reaction suppression in lithium-sulfur battery systems.

The fluoroether compounds include CF₂HCF2CH2O—R compounds that show higher coulombic efficiency due to solid electrolyte interphase formation and improved rate performance due to relatively low electrolyte viscosity. The molecular structure of CF2HCF2CH2O—R compounds incorporates partially fluorinated carbon segments that provide controlled electron-withdrawing effects while maintaining hydrogen atoms that contribute to balanced chemical reactivity during electrochemical processes. The presence of both fluorine and hydrogen atoms within the molecular framework creates chemical environments that facilitate solid electrolyte interphase formation through controlled reactions with lithium metal surfaces while avoiding excessive electrolyte consumption that may occur with fully fluorinated compounds. The CF2HCF2CH2O—R structure demonstrates how partial fluorination may achieve enhanced coulombic efficiency through optimized solid electrolyte interphase characteristics that provide protective effects while maintaining adequate ionic conductivity for efficient battery operation. The relatively low electrolyte viscosity provided by CF2HCF2CH2O—R compounds facilitates improved rate performance through enhanced ion transport characteristics that enable efficient electrochemical reactions at higher current densities and improved power delivery capabilities.

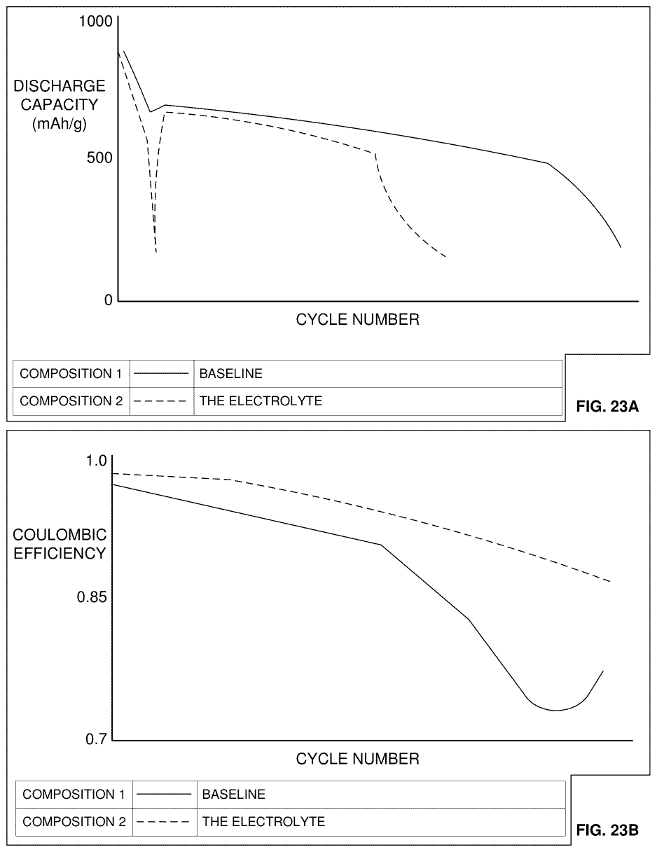

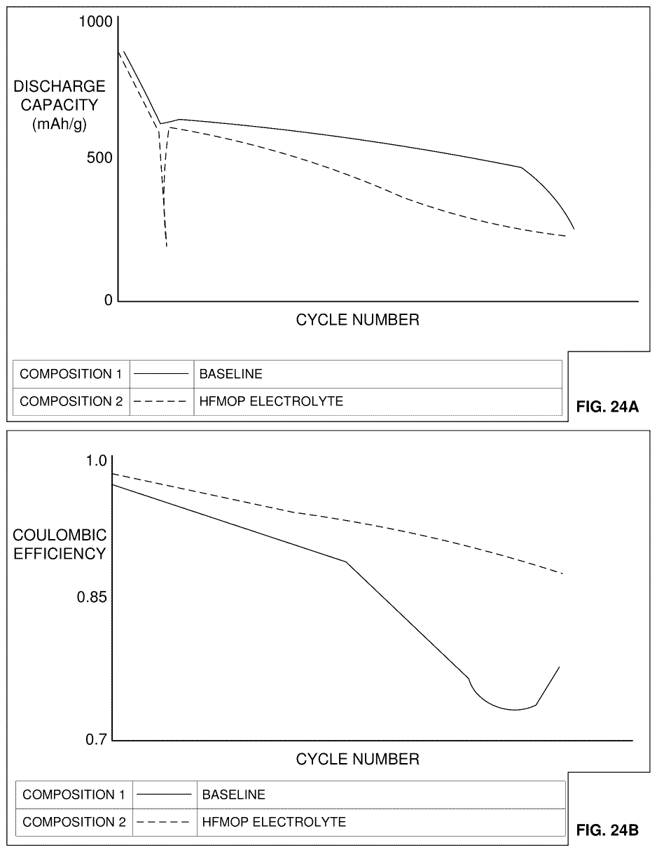

FIG. 24A, FIG. 24B illustrate performance characteristics of different electrolyte compositions in lithium-sulfur electrochemical cells, in accordance with one embodiment. As an option, the performance characteristics of different electrolyte compositions in lithium-sulfur electrochemical cells may be implemented in the context of any one or more of the embodiments set forth in any previous and/or subsequent Figures and/or description thereof. Of course, however, the performance characteristics of different electrolyte compositions in lithium-sulfur electrochemical cells may be implemented in the context of any desired environment. Further, the aforementioned definitions may equally apply to the description below.

The upper graph depicted in FIG. 24A shows discharge capacity in mAh/g versus cycle number for two distinct electrolyte compositions, where Composition 1 Baseline (solid line) and Composition 2 HFMOP Electrolyte (dashed line). The discharge capacity measurements demonstrate how different fluoroether compounds influence the electrochemical behavior and capacity retention characteristics during extended cycling operations in lithium-sulfur battery systems. Composition 1 Baseline exhibits discharge capacity values that demonstrate specific cycling characteristics throughout the testing period.

The discharge capacity measurements for Composition 2 HFMOP Electrolyte reveal distinct electrochemical behavior patterns compared to the baseline formulation, with capacity values showing cycling characteristics that reflect the influence of the HFMOP molecular structure on battery performance. The HFMOP compound incorporates multiple fluorine substitutions and a methoxy group within its molecular framework, creating a complex chemical environment that influences ion transport and electrode interactions during cycling operations. The molecular structure of HFMOP demonstrates how fluorine atoms positioned at different carbon locations within the fluoroether structure may affect electrochemical processes through varying degrees of electron-withdrawing effects and chemical reactivity. The presence of both highly fluorinated segments and methoxy functionality in HFMOP creates a molecular environment that may provide different solvation characteristics compared to the baseline structure. The structural complexity of HFMOP enables diverse chemical interactions that may influence polysulfide solubility, electrode wetting properties, and solid electrolyte interphase formation processes during battery cycling operations.

The lower graph depicted in FIG. 24B shows coulombic efficiency versus cycle number for the same two compositions, with Composition 1 Baseline shown as a solid line and Composition 2 HFMOP Electrolyte shown as a dashed line, where coulombic efficiency values range from 0.70 to 1.0 on the vertical axis. The coulombic efficiency measurements quantify the charge-discharge efficiency ratio for each electrolyte composition, providing insight into the extent of side reactions and electrochemical reversibility during battery cycling operations.

The coulombic efficiency measurements for Composition 2 HFMOP Electrolyte reveal electrochemical behavior characteristics that differ from the baseline formulation, with efficiency values showing patterns that reflect the influence of the complex HFMOP molecular structure on electrochemical processes. The HFMOP compound incorporates multiple fluorinated segments and methoxy functionality that create a diverse chemical environment for lithium ion interactions and electrochemical reactions during battery operation. The molecular complexity of HFMOP may influence coulombic efficiency through multiple pathways, including effects on solid electrolyte interphase formation, polysulfide species interactions, and electrode surface chemistry during cycling operations. The presence of both highly fluorinated regions and methoxy groups in HFMOP creates molecular environments that may affect electrochemical reversibility through different mechanisms compared to the baseline structure. The coulombic efficiency characteristics of Composition 2 HFMOP Electrolyte demonstrate how asymmetric fluoroether molecular architectures may provide alternative approaches to managing electrochemical processes in lithium-sulfur battery systems.

The HFMOP compound exhibits a different molecular architecture that influences electrochemical behavior through alternative mechanisms compared to the baseline structure, creating opportunities for different performance characteristics in lithium-sulfur battery applications. The asymmetric arrangement of fluorinated segments and methoxy functionality in HFMOP creates a molecular environment with diverse chemical properties that may affect electrochemical processes through multiple pathways. The structural complexity of HFMOP enables varied interactions with lithium ions, polysulfide species, and electrode surfaces that may contribute to different electrochemical behavior patterns compared to baseline fluoroether compounds. The molecular design of HFMOP demonstrates how asymmetric fluoroether architectures may provide alternative approaches to achieving electrochemical performance through diverse chemical environments within single molecular frameworks. The fluorination patterns and methoxy functionality in HFMOP create molecular regions with different electron-withdrawing characteristics that may influence electrochemical processes through spatially varied chemical reactivity.

The electrochemical performance data presented in FIG. 24A and FIG. 24B demonstrate how systematic variations in fluoroether molecular structure may be utilized to achieve different battery performance characteristics for specific applications and operating conditions. The discharge capacity measurements reveal how different molecular architectures influence capacity retention mechanisms and electrochemical stability during extended cycling operations in lithium-sulfur battery systems. The coulombic efficiency data illustrate how fluoroether structural features affect electrochemical reversibility and side reaction occurrence, providing guidance for selecting electrolyte compositions based on performance requirements and application specifications.

In one embodiment, the HFMOP compound may contribute to reduced lithium polysulfide solubility through its complex molecular structure that incorporates multiple fluorinated segments and methoxy functionality, creating chemical environments that may influence polysulfide species interactions and migration behavior.

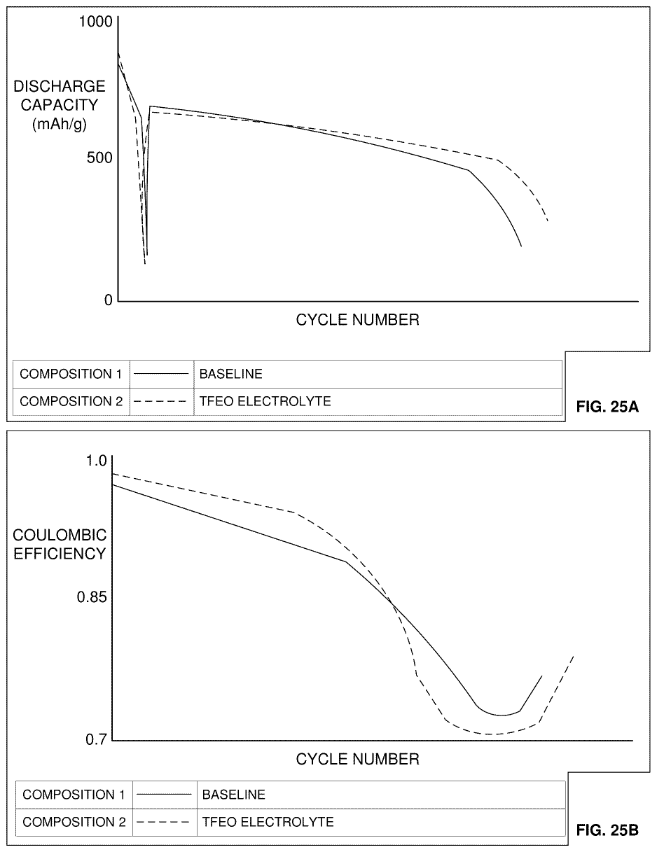

FIG. 25A, FIG. 25B illustrate discharge capacity and coulombic efficiency measurements for lithium-sulfur electrochemical cells using different electrolyte compositions, in accordance with one embodiment. As an option, the discharge capacity and coulombic efficiency measurements for lithium-sulfur electrochemical cells using different electrolyte compositions may be implemented in the context of any one or more of the embodiments set forth in any previous and/or subsequent Figures and/or description thereof. Of course, however, the discharge capacity and coulombic efficiency measurements for lithium-sulfur electrochemical cells using different electrolyte compositions may be implemented in the context of any desired environment. Further, the aforementioned definitions may equally apply to the description below.

The upper graph shows discharge capacity versus cycle number comparing two compositions, where Composition 1 Baseline shown as a solid line and Composition 2 TFEO Electrolyte shown as a dashed line. The discharge capacity measurements demonstrate how different fluoroether molecular architectures influence electrochemical behavior and capacity retention characteristics during extended cycling operations in lithium-sulfur battery systems. Composition 1 Baseline exhibits discharge capacity values that reflect electrochemical characteristics associated with ether structures during battery cycling operations.

The discharge capacity measurements for Composition 2 TFEO Electrolyte reveal distinct electrochemical behavior patterns compared to the baseline formulation, with capacity values showing cycling characteristics that reflect the influence of the advanced TFEO molecular structure on battery performance. The TFEO compound contains three CF3CH2O groups merged with a single carbon atom, creating enhanced coverage and improved electrochemical performance compared to conventional fluoroether structures. The triple CF3CH2O group arrangement in TFEO provides extensive fluorinated coverage that may contribute to enhanced solid electrolyte interphase formation and improved chemical stability during battery cycling operations. The convergence of three fluorinated ether segments at a single carbon center creates a molecular environment with high local concentration of electron-withdrawing groups that may facilitate controlled interactions with lithium metal surfaces while maintaining electrolyte stability. The enhanced coverage provided by the multiple CF3CH2O groups in TFEO may contribute to improved electrode wetting characteristics and more uniform electrolyte distribution across battery electrode surfaces, potentially leading to enhanced capacity utilization and improved electrochemical reaction consistency.

The lower graph shows coulombic efficiency versus cycle number for the same two compositions, with Composition 1 Baseline shown as a solid line and Composition 2 TFEO Electrolyte shown as a dashed line, where coulombic efficiency values range from 0.70 to 1.0 on the vertical axis. The coulombic efficiency measurements quantify the charge-discharge efficiency ratio for each electrolyte composition, providing insight into the extent of side reactions and electrochemical reversibility during battery cycling operations.

The coulombic efficiency measurements for Composition 2 TFEO Electrolyte reveal electrochemical behavior characteristics that demonstrate the influence of the triple CF3CH2O group structure on electrochemical processes and side reaction management during battery operation. The TFEO compound incorporates three CF3CH2O groups merged with a single carbon atom, creating a molecular environment with enhanced fluorinated coverage that may influence coulombic efficiency through multiple pathways. The convergence of three fluorinated ether segments in TFEO creates a high local concentration of electron-withdrawing groups that may contribute to enhanced solid electrolyte interphase formation characteristics compared to conventional fluoroether structures. The enhanced coverage provided by the triple CF3CH2O group arrangement may facilitate improved electrochemical reversibility through more effective management of side reactions and enhanced protection of lithium anode surfaces during cycling operations. The advanced molecular design of TFEO demonstrates how multiple fluorinated ether segments may work synergistically to provide enhanced coulombic efficiency characteristics through improved electrochemical stability and controlled reactivity during battery cycling processes.

In one embodiment, the TFEO compound exhibits a more advanced molecular architecture that influences electrochemical behavior through enhanced fluorinated coverage and improved chemical stability mechanisms compared to conventional fluoroether structures. The triple CF3CH2O group arrangement in TFEO creates a molecular environment with extensive electron-withdrawing character that may provide enhanced chemical stability while maintaining controlled electrochemical activity during battery operation. The convergence of three fluorinated ether segments at a central carbon atom enables enhanced molecular coverage that may facilitate improved interactions with battery components and enhanced electrochemical performance characteristics. The structural design of TFEO demonstrates how multiple fluorinated ether segments may be integrated within single molecular frameworks to achieve enhanced electrochemical properties through synergistic effects that address multiple performance limitations simultaneously. The enhanced coverage provided by the triple CF3CH2O group structure enables improved electrode wetting characteristics and more uniform electrolyte distribution that may contribute to enhanced capacity utilization and improved electrochemical reaction consistency during battery cycling operations.

### Additional Embodiments

In various embodiments, the fluoroether compounds may be synthesized through custom synthesis approaches that enable precise placement of fluorine atoms at any carbon position within the molecular structure. The systematic positioning of fluorine atoms at different carbon locations (Cα or Cβ) allows for fine-tuning of electrochemical properties and optimization of solid electrolyte interphase formation characteristics. The custom synthesis techniques may incorporate controlled fluorination reactions that target specific carbon positions while preserving other structural elements, enabling the creation of fluoroether compounds with tailored electron-withdrawing effects and chemical reactivity profiles.

In various embodiments, the fluoroether compounds may exhibit varying degrees of fluorination that directly influence their electrochemical performance in lithium-sulfur battery systems. Experimental results demonstrate that the degree of fluorination in compounds such as BFE, DFE, and BTFE affects cycling performance, with higher fluorination levels generally providing enhanced chemical stability and improved coulombic efficiency. However, partially hydrogenated fluoroethers such as DFE may provide reduced resistance characteristics toward the end of cycling operations, potentially enabling longer cycle life compared to fully fluorinated analogs. The balance between fluorination level and electrochemical performance may be optimized through systematic variation of hydrogen and fluorine substitution patterns.

In various embodiments, the fluoroether compounds may be selected based on their physical parameters including viscosity, density, and ionic conductivity measurements that directly impact cell performance characteristics. The HFE viscosity of individual fluoroether compounds ranges from approximately 0.650 to 2.145 mPa s, while complete electrolyte formulations containing these compounds exhibit viscosity values that influence ion transport properties and rate capability. The density of electrolyte compositions containing fluoroether additives may affect both gravimetric and volumetric energy density calculations for complete battery systems. Ionic conductivity measurements for fluoroether-containing electrolytes range from approximately 5 to 9 mS/cm, with higher values generally correlating with improved electrochemical performance.

In various embodiments, the fluoroether compounds may be detected and analyzed through various analytical techniques including gas chromatography mass spectrometry (GC-MS), gas chromatography with flame ionization detection (GC-FID), gas chromatography with thermal conductivity detection (GC-TCD), liquid chromatography mass spectrometry (LC-MS), and high-performance liquid chromatography (HPLC). These analytical methods enable identification and quantification of fluoroether compounds in electrolyte samples extracted from lithium-sulfur battery systems. Post-mortem analysis of battery cells may reveal the presence and concentration of specific fluoroether additives, providing insight into their stability and consumption during cycling operations.

In various embodiments, the fluoroether compounds may be formulated at specific concentration ranges within the electrolyte composition to optimize electrochemical performance while maintaining chemical stability. Initial formulations may incorporate fluoroether additives at concentrations of approximately 25% by volume, though optimization studies may reveal that lower concentrations such as 10% or other ratios provide enhanced performance characteristics. The optimal concentration of fluoroether additives may depend on the specific molecular structure, the base electrolyte composition, and the intended application requirements for the lithium-sulfur battery system.

In various embodiments, the fluoroether compounds may form solid electrolyte interphase layers with varying thickness and composition characteristics depending on their molecular structure and concentration in the electrolyte. The SEI layer formation process may be influenced by the degree of fluorination, the presence of specific functional groups, and the interaction with other electrolyte components. Quantitative analysis of SEI layer properties may include thickness measurements, compositional analysis, and mechanical property characterization to understand the relationship between fluoroether structure and protective layer formation.

In various embodiments, the fluoroether compounds may exhibit specific temperature stability ranges that determine their suitability for different operating conditions and applications. Temperature stability assessments may reveal the thermal decomposition characteristics, volatility behavior, and electrochemical performance variations across different temperature ranges. The temperature stability data may guide the selection of appropriate fluoroether compounds for applications requiring operation under extreme temperature conditions or extended temperature cycling.

In various embodiments, the fluoroether compounds may demonstrate varying effects on lithium polysulfide solubility compared to baseline electrolyte formulations. The influence on polysulfide dissolution and migration may be quantified through solubility measurements, spectroscopic analysis, and electrochemical characterization techniques. Reduced polysulfide solubility may contribute to decreased shuttle effects and improved capacity retention during battery cycling operations, with different fluoroether structures providing varying degrees of polysulfide management effectiveness.

### Use Case Scenario

By way of a use-case scenario, and in various embodiments, an electric vehicle manufacturer seeks to develop next-generation lithium-sulfur battery packs that provide enhanced driving range while maintaining safety and durability requirements for commercial automotive applications. The manufacturer formulates an electrolyte composition comprising DME/DOL solvents with BTFE fluoroether additive in a 50:25:25 ratio, combined with 0.4M LiTFSI lithium salt and 0.32M LiNO3 performance enhancing additive to create a synergistic electrolyte system that addresses multiple electrochemical challenges simultaneously. During battery assembly, the fluoroether electrolyte composition facilitates enhanced solid electrolyte interphase formation on lithium metal anodes through the CF3CH2O—R structural motif present in BTFE, which creates controlled electron-withdrawing effects that stabilize the electrolyte while reducing polysulfide shuttle effects at the sulfur cathode. The symmetric molecular structure of BTFE enables uniform electrode wetting properties and maintains low electrolyte viscosity that supports efficient ion transport during high-rate charging and discharging operations required for automotive applications. Throughout extended cycling operations, the combination of fluorinated ether and performance enhancing additive works synergistically to maintain coulombic efficiency values approaching unity while preserving discharge capacity retention, enabling the electric vehicle to achieve target driving ranges of over many hundreds of miles per charge while maintaining battery performance over thousands of charge-discharge cycles. The manufacturer validates the electrolyte performance through systematic testing protocols that demonstrate enhanced electrochemical stability, reduced capacity fade, and improved safety characteristics compared to conventional lithium-ion battery systems, ultimately enabling commercial deployment of lithium-sulfur battery technology that provides superior energy density and extended vehicle range for consumer electric vehicle applications.

### Improvements Over Existing Systems

The present disclosure addresses significant challenges in lithium-sulfur battery technology that have long plagued existing electrolyte systems. Prior art solutions have struggled to effectively manage the complex electrochemical processes occurring in lithium-sulfur batteries, including the polysulfide shuttle effect where soluble lithium polysulfide intermediates migrate between electrodes causing capacity loss and reduced coulombic efficiency. These conventional electrolyte systems often face limitations such as excessive reactivity with lithium metal anodes leading to rapid electrolyte consumption, poor electrochemical stability that results in dendrite formation and safety concerns, and inadequate chemical stability that causes electrolyte degradation and dryout during cycling operations. As a result, they frequently fail to provide adequate performance across multiple metrics simultaneously, typically focusing on addressing individual problems in isolation rather than providing comprehensive solutions that optimize overall battery performance, particularly in scenarios requiring high energy density applications such as electric vehicles where consistent performance over thousands of charge-discharge cycles is critical.

The disclosed fluoroether electrolyte system overcomes these deficiencies through a novel approach that incorporates specialized fluoroether compounds with strategic molecular architectures that provide synergistic improvements across multiple performance parameters. By incorporating advanced fluoroether structures such as CF3CH2O—R compounds and CF3CHFCF2O—R configurations that form enhanced solid electrolyte interphase layers on lithium anodes, the system achieves enhanced coulombic efficiency while maintaining low electrolyte viscosity for optimal rate performance. Furthermore, the combination of electron withdrawing fluoroether compounds with performance enhancing additives creates unexpected synergistic effects that simultaneously address polysulfide management, dendrite suppression, and cycle life extension, addressing critical limitations in existing solutions. This innovative approach not only provides superior chemical stability through strategic fluorination patterns that reduce reactivity while maintaining beneficial solvation properties, but also enables systematic fluorination patterns and dual-oxygen ether structures that allow precise tuning of electrochemical properties for specific application requirements, effectively resolving the longstanding issues of capacity fade, poor coulombic efficiency, and limited cycle life that have plagued prior art lithium-sulfur battery systems.

The strategic implementation of fluoroether compounds in the disclosed system provides dual functionality as both viscosity-modifying diluents and electron-withdrawing agents that influence lithium polysulfide speciation, distinguishing this approach from conventional fluoroether applications that primarily serve as inert diluents or simple SEI enhancers. Unlike traditional fluoroether implementations that exhibit very limited polysulfide solubility and function mainly as viscosity modifiers, the disclosed fluoroether compounds with specific CF3CH2O—R and CF3CHFCF2O—R motifs actively participate in electrochemical processes by modulating polysulfide species distribution while simultaneously providing the viscosity reduction and SEI formation benefits, creating a multifunctional additive system that addresses multiple battery performance limitations through coordinated chemical mechanisms rather than isolated effects.

### Guanidine-Based Electrolyte Additives for Lithium-Sulfur Batteries

The present disclosure relates to the field of electrochemical energy storage systems, specifically focusing on lithium-sulfur battery technologies that offer high theoretical energy density for applications ranging from electric vehicles to grid-scale energy storage systems.

Current lithium-sulfur battery systems encounter significant technical challenges that limit their practical implementation and commercial viability. These systems suffer from poor coulombic efficiency, rapid capacity fade during cycling, and limited cycle life due to fundamental electrochemical processes including polysulfide dissolution and shuttling effects. Existing electrolyte formulations struggle to simultaneously address polysulfide dissolution, maintain electrochemical stability, and provide adequate ionic conductivity, while traditional electrolyte additives often provide limited improvement in one performance metric while compromising others.

The present disclosure addresses these challenges through the development of guanidine-containing electrolyte additives that enhance both coulombic efficiency and cycle life in lithium-sulfur battery systems. The disclosed electrolyte compositions incorporate specific guanidine-containing compounds, including guanidine nitrate, guanidine thiocyanate, guanine, guanidine bromide, guanidine iodide, guanidine hydrochloride, 1,3-diphenylguanidine, biguanide, and metformin hydrochloride, which demonstrate synergistic effects when combined with nitrogen-containing additives such as dicyandiamide, sildenafil citrate, taurine, (S)-2-amino-5-ureidopentanoic acid, 2-(1-methylguanidino) acetic acid, 1,3,7-trimethyl-2,3,6,7-tetrahydro-1H-purine-2,6-dione, and 2-phenylethylamine, providing comprehensive enhancement of battery performance across multiple metrics.

Furthermore, the present disclosure provides electrolyte systems that exhibit optimized concentration ranges for the guanidine-containing additives, typically between 0.05M to 0.15M, which maintain stable performance over extended cycling periods while addressing multiple lithium-sulfur battery challenges simultaneously, including polysulfide shuttle suppression and anode protection, without compromising kinetic performance or rate capability.

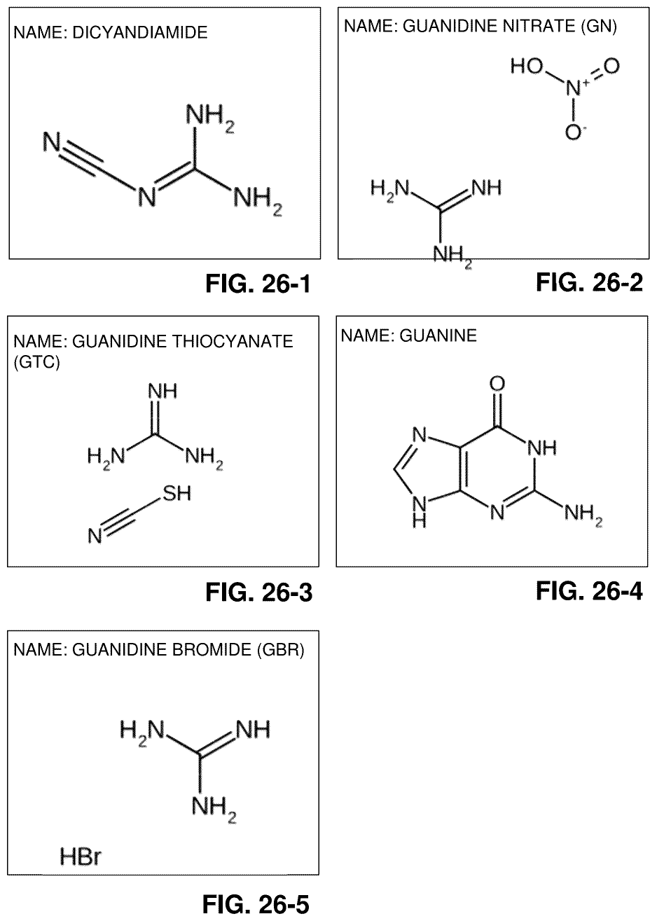

FIG. 26-1 illustrates a chemical structure diagram of dicyandiamide, in accordance with one embodiment. As an option, the chemical structure diagram of dicyandiamide may be implemented in the context of any one or more of the embodiments set forth in any previous and/or subsequent Figures and/or description thereof. Of course, however, the chemical structure diagram of dicyandiamide may be implemented in the context of any desired environment. Further, the aforementioned definitions may equally apply to the description below.

The dicyandiamide structure demonstrates a nitrogen-containing additive that comprises an NH group double-bonded to a carbon atom, which connects to an NH2 group and an NH group that bonds to a cyano (CN) group. The dicyandiamide structure exhibits specific bonding patterns that contribute to electrochemical performance enhancement through interactions with polysulfide species and electrode surfaces. In some cases, the dicyandiamide may serve as a baseline reference compound for comparing the performance characteristics of guanidine-containing additives within lithium-sulfur battery systems.

The structural features of dicyandiamide include multiple nitrogen atoms positioned at strategic locations within the molecular framework, enabling diverse chemical interactions during battery operation. The presence of both primary amine groups and nitrile functionalities provides multiple sites for electrochemical activity and surface adsorption phenomena. In various embodiments, the dicyandiamide structure may undergo decomposition or transformation reactions that contribute to solid electrolyte interphase formation and polysulfide shuttle suppression mechanisms. The molecular geometry of dicyandiamide allows for hydrogen bonding interactions and coordination with lithium ions, which may influence ionic conductivity and electrochemical stability within the electrolyte matrix.

FIG. 26-2 illustrates a chemical structure diagram of guanidine nitrate, in accordance with one embodiment. As an option, the chemical structure diagram of guanidine nitrate may be implemented in the context of any one or more of the embodiments set forth in any previous and/or subsequent Figures and/or description thereof. Of course, however, the chemical structure diagram of guanidine nitrate may be implemented in the context of any desired environment. Further, the aforementioned definitions may equally apply to the description below.

The guanidine nitrate structure comprises a central carbon atom double-bonded to an NH group and single-bonded to two NH2 groups, forming a positively charged guanidinium cation paired with a nitrate (NO3-) counterion. This ionic compound represents a performance-enhancing additive that incorporates both the characteristic guanidine structural motif and an electron-withdrawing nitrate component. The guanidine nitrate demonstrates how guanidine-containing compounds may be combined with specific anions to achieve targeted electrochemical properties. In some cases, the nitrate counterion in guanidine nitrate may contribute to anode protection mechanisms through the formation of protective surface layers on lithium metal electrodes.

The molecular architecture of guanidine nitrate exhibits the NH2-CNH—NH—R structural motif where R represents the association with the nitrate counterion through ionic interactions. The guanidinium cation portion provides multiple nitrogen-containing sites for hydrogen bonding and coordination chemistry, while the nitrate anion offers additional electrochemical functionality. In various embodiments, guanidine nitrate may dissociate in electrolyte solutions to provide both guanidinium cations and nitrate anions, each contributing distinct performance enhancement mechanisms. The combination of these ionic species within guanidine nitrate enables simultaneous polysulfide shuttle suppression and anode protection through complementary chemical pathways.

FIG. 26-3 illustrates a chemical structure diagram of guanidine thiocyanate, in accordance with one embodiment. As an option, the chemical structure diagram of guanidine thiocyanate may be implemented in the context of any one or more of the embodiments set forth in any previous and/or subsequent Figures and/or description thereof. Of course, however, the chemical structure diagram of guanidine thiocyanate may be implemented in the context of any desired environment. Further, the aforementioned definitions may equally apply to the description below.

The guanidine thiocyanate structure features a central carbon atom double-bonded to an NH2+ group and single-bonded to two NH2 groups, paired with a thiocyanate (SCN−) counterion. This compound represents another embodiment of guanidine-containing performance-enhancing additives that combines the guanidine structural framework with a sulfur-containing anion. The thiocyanate counterion in guanidine thiocyanate provides additional chemical functionality through its sulfur and nitrogen components, which may interact favorably with sulfur-based cathode materials and polysulfide intermediates. In some cases, the thiocyanate anion may participate in redox reactions or surface adsorption processes that enhance electrochemical performance.

The structural characteristics of guanidine thiocyanate demonstrate how different counterions may be incorporated with guanidinium cations to achieve specific performance objectives. The thiocyanate anion contains both sulfur and nitrogen atoms, providing multiple coordination sites and potential reaction pathways within the electrolyte environment. In various embodiments, guanidine thiocyanate may exhibit enhanced solubility characteristics compared to other guanidine salts, enabling higher concentration formulations. The molecular structure of guanidine thiocyanate allows for diverse intermolecular interactions, including hydrogen bonding through the guanidinium portion and coordination chemistry through the thiocyanate component.

FIG. 26-4 illustrates a chemical structure diagram of guanine, in accordance with one embodiment. As an option, the chemical structure diagram of guanine may be implemented in the context of any one or more of the embodiments set forth in any previous and/or subsequent Figures and/or description thereof. Of course, however, the chemical structure diagram of guanine may be implemented in the context of any desired environment. Further, the aforementioned definitions may equally apply to the description below.

The guanine structure contains a fused imidazole and pyrimidine ring system with an NH2 group, NH group, and carbonyl group, representing a cyclic ring structure containing nitrogen. This purine ring system demonstrates how guanidine-containing compounds may incorporate complex heterocyclic frameworks that provide multiple nitrogen-containing functional groups. The guanine structure exhibits both the characteristic guanidine-like functionality and additional aromatic character through its bicyclic purine framework. In some cases, the cyclic ring structure of guanine may provide enhanced stability and specific binding interactions with electrode surfaces or dissolved species.

The molecular architecture of guanine incorporates multiple nitrogen atoms positioned throughout the purine ring system, creating numerous sites for hydrogen bonding, coordination chemistry, and π-π stacking interactions. The presence of both amine and carbonyl functionalities within the same molecule enables diverse chemical interactions during battery operation. In various embodiments, guanine may exhibit limited solubility in certain electrolyte formulations, appearing milky or slightly suspended in solution while still providing performance enhancement benefits. The aromatic character of the purine ring system in guanine may contribute to electronic conductivity or facilitate electron transfer processes within the electrolyte matrix.

FIG. 26-5 illustrates a chemical structure diagram of guanidine bromide, in accordance with one embodiment. As an option, the chemical structure diagram of guanidine bromide may be implemented in the context of any one or more of the embodiments set forth in any previous and/or subsequent Figures and/or description thereof. Of course, however, the chemical structure diagram of guanidine bromide may be implemented in the context of any desired environment. Further, the aforementioned definitions may equally apply to the description below.

The guanidine bromide structure comprises a central carbon atom double-bonded to an NH group and single-bonded to two NH2 groups, paired with a bromide (Br—) counterion. This compound exemplifies how guanidine-containing compounds may comprise a halogen component, specifically bromine, which provides distinct electrochemical properties compared to other counterions. The halogen component in guanidine bromide may contribute to enhanced kinetic performance and improved rate capability through facilitated ion transport mechanisms. In some cases, the bromide anion may participate in redox shuttle suppression or contribute to the formation of conductive surface films on electrode materials.

The structural features of guanidine bromide demonstrate the incorporation of halogen elements within guanidine-containing performance-enhancing additives. The bromide counterion provides a relatively large, polarizable anion that may influence electrolyte conductivity and electrochemical kinetics. In various embodiments, the halogen component may be selected from bromine and iodine, with each halogen offering distinct size, polarizability, and electrochemical characteristics. The guanidine bromide structure maintains the characteristic NH2-CNH—NH—R structural motif while incorporating the specific benefits associated with halogen-containing anions.

The chemical structures illustrated in FIGS. 26-1 through 26-5 collectively demonstrate how various guanidine-containing compounds and nitrogen-containing additives may be designed to address polysulfide shuttle suppression and anode protection simultaneously. Each structural variant provides distinct molecular features that contribute to different aspects of electrochemical performance enhancement. The diversity of counterions and structural frameworks enables the formulation of electrolyte systems with tailored properties for specific battery applications and operating conditions.

In various embodiments, alternative nitrogen-containing compounds such as melamine, urea, and/or trimethyl urea (TMU), etc. may serve as potential substitutes for the illustrated structures, providing similar nitrogen-rich frameworks with different molecular geometries and chemical properties. These alternative compounds may offer comparable performance enhancement mechanisms while potentially providing cost advantages or improved solubility characteristics.

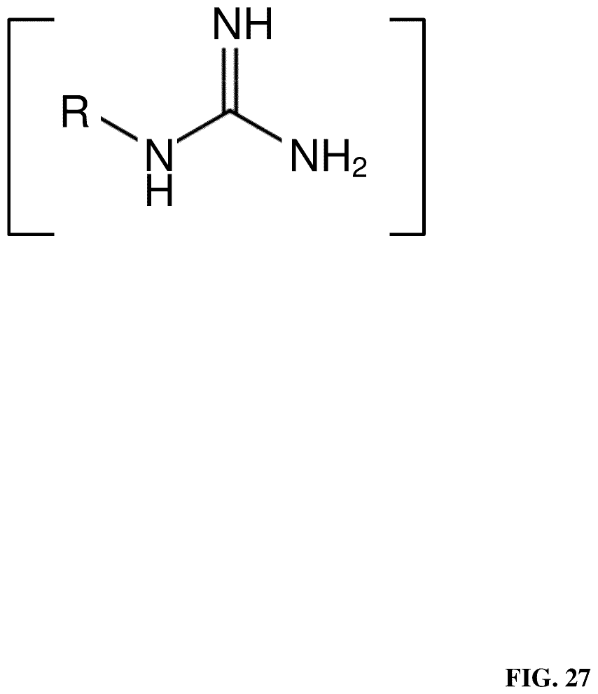

FIG. 27 illustrates a chemical structure diagram showing the general NH2-CNH—NH—R structural motif, in accordance with one embodiment. As an option, the chemical structure diagram showing the general NH2-CNH—NH—R structural motif may be implemented in the context of any one or more of the embodiments set forth in any previous and/or subsequent Figures and/or description thereof. Of course, however, the chemical structure diagram showing the general NH2-CNH—NH—R structural motif may be implemented in the context of any desired environment. Further, the aforementioned definitions may equally apply to the description below.

The NH2-CNH—NH—R structural motif demonstrates the fundamental molecular framework that characterizes guanidine-containing compounds within electrolyte systems. The structural motif comprises a central carbon atom that forms a double bond with a nitrogen atom bearing a hydrogen substituent (NH), while simultaneously forming single bonds with two additional nitrogen-containing groups. The first nitrogen-containing group consists of a primary amine functionality (NH2), while the second nitrogen-containing group features a secondary amine structure (NH) that connects to a variable substituent represented by R. This molecular architecture provides the foundational framework for understanding how guanidine-containing compounds achieve performance enhancement within lithium-sulfur battery applications. The variable substituent R within the structural motif may represent diverse chemical groups, counterions, or molecular fragments that modify the overall properties and behavior of the guanidine-containing compound.

The molecular framework of the NH2-CNH—NH—R structural motif enables multiple sites for chemical interaction and coordination chemistry within electrolyte environments. The presence of multiple nitrogen atoms positioned at strategic locations throughout the structural motif provides numerous opportunities for hydrogen bonding interactions with dissolved species, electrode surfaces, and other electrolyte components. The central carbon atom within the structural motif exhibits partial positive character due to the electron-withdrawing effects of the surrounding nitrogen atoms, creating a reactive center that may participate in various chemical processes during battery operation. The delocalized electron density across the nitrogen-carbon framework of the structural motif contributes to the stability and reactivity characteristics that enable performance enhancement mechanisms. In some cases, the structural motif may undergo protonation or deprotonation reactions that influence the overall charge distribution and chemical behavior of the guanidine-containing compound.

The variable substituent R within the NH2-CNH—NH—R structural motif provides a mechanism for tailoring the specific properties and performance characteristics of guanidine-containing compounds. When R represents an ionic counterion such as nitrate, thiocyanate, or bromide, the resulting compound exhibits distinct solubility, conductivity, and electrochemical properties compared to other substituent variations. The nature of the R group within the structural motif influences the overall molecular geometry, intermolecular interactions, and chemical reactivity of the guanidine-containing compound. In various embodiments, the R substituent may comprise electron-withdrawing groups that enhance the electrophilic character of the central carbon atom, or electron-donating groups that modify the basicity of the nitrogen-containing functionalities. The selection of appropriate R groups within the structural motif enables the design of guanidine-containing compounds with optimized performance characteristics for specific battery applications and operating conditions.

The performance-enhancing properties of compounds containing the NH2-CNH—NH—R structural motif arise from the unique combination of electronic and steric characteristics provided by this molecular framework. The multiple nitrogen atoms within the structural motif create a highly polar and hydrogen-bonding capable molecular environment that facilitates interactions with polysulfide species, lithium ions, and electrode surfaces. The planar or near-planar geometry of the structural motif enables effective 7E-7E stacking interactions and surface adsorption phenomena that contribute to polysulfide shuttle suppression mechanisms. The basic character of the nitrogen-containing functionalities within the structural motif allows for proton transfer reactions and acid-base chemistry that may influence electrolyte pH and chemical stability. In some cases, the structural motif may participate in coordination chemistry with lithium ions, creating temporary or permanent complexes that affect ionic conductivity and transport properties within the electrolyte matrix.

The electrolyte preparation process involves simple addition of guanidine compounds containing the NH2-CNH—NH—R structural motif to base electrolyte formulations without requiring complex synthesis or modification procedures. The straightforward incorporation method enables practical implementation of these performance-enhancing additives within existing battery manufacturing processes and quality control protocols. Some guanidine compounds containing the structural motif exhibit limited solubility characteristics in certain electrolyte formulations, appearing milky or slightly suspended in solution while maintaining their performance enhancement capabilities. The limited solubility behavior may result from strong intermolecular interactions between molecules containing the structural motif, including hydrogen bonding networks and electrostatic attractions that reduce dissolution rates. In various embodiments, the solubility characteristics of compounds containing the structural motif may be modified through selection of appropriate R substituents, adjustment of electrolyte composition, or optimization of preparation conditions such as temperature and mixing procedures.

The NH2-CNH—NH—R structural motif represents a targeted molecular framework that provides more focused performance enhancement compared to broader categories of nitrogen-containing compounds. The specific arrangement of nitrogen and carbon atoms within the structural motif creates a unique electronic environment that enables selective interactions with lithium-sulfur battery components while maintaining chemical stability under operating conditions. The protection and preservation of the structural motif within guanidine-containing compounds ensures consistent performance enhancement across different battery configurations and cycling conditions. In some cases, compounds containing the structural motif may undergo partial decomposition or transformation reactions that generate beneficial products while maintaining the core performance-enhancing characteristics. The molecular design principles embodied by the structural motif provide guidance for developing additional guanidine-containing compounds with tailored properties for specific battery applications and performance requirements.

The following Table 5 presents comprehensive electrolyte additive combinations and concentrations for systematic battery performance testing of compounds. In one embodiment, at least some of the electrolyte additives contain the NH2-CNH—NH—R structural motif and/or related nitrogen-containing additives.

TABLE 5
Electrolyte Additive Combinations and Concentrations for Battery Performance Testing

| Additive 1 | Conc. 1 (M) | Additive 2 | Conc. 2 (M) | Additive 3 | Conc. 3 (M) |
|---|---|---|---|---|---|
| Dicyandiamide | 0.025 | none | 0 | none | 0 |
| Dicyandiamide | 0.050 | none | 0 | none | 0 |
| Dicyandiamide | 0.075 | none | 0 | none | 0 |
| Dicyandiamide | 0.100 | none | 0 | none | 0 |
| Dicyandiamide | 0.125 | none | 0 | none | 0 |
| Dicyandiamide | 0.150 | none | 0 | none | 0 |
| Dicyandiamide | 0.175 | none | 0 | none | 0 |
| Dicyandiamide | 0.200 | none | 0 | none | 0 |
| Dicyandiamide | 0.225 | none | 0 | none | 0 |
| Dicyandiamide | 0.250 | none | 0 | none | 0 |
| Guanidine Nitrate | 0.025 | none | 0 | none | 0 |
| Guanidine Nitrate | 0.050 | none | 0 | none | 0 |
| Guanidine Nitrate | 0.075 | none | 0 | none | 0 |
| Guanidine Nitrate | 0.100 | none | 0 | none | 0 |
| Guanidine Nitrate | 0.125 | none | 0 | none | 0 |
| Guanidine Nitrate | 0.150 | none | 0 | none | 0 |
| Guanidine Nitrate | 0.175 | none | 0 | none | 0 |
| Guanidine Nitrate | 0.200 | none | 0 | none | 0 |
| Guanidine Nitrate | 0.225 | none | 0 | none | 0 |
| Guanidine Nitrate | 0.250 | none | 0 | none | 0 |
| Guanidine Thiocyanate | 0.025 | none | 0 | none | 0 |
| Guanidine Thiocyanate | 0.050 | none | 0 | none | 0 |
| Guanidine Thiocyanate | 0.075 | none | 0 | none | 0 |
| Guanidine Thiocyanate | 0.100 | none | 0 | none | 0 |
| Guanidine Thiocyanate | 0.125 | none | 0 | none | 0 |
| Guanidine Thiocyanate | 0.150 | none | 0 | none | 0 |
| Guanidine Thiocyanate | 0.175 | none | 0 | none | 0 |
| Guanidine Thiocyanate | 0.200 | none | 0 | none | 0 |
| Guanidine Thiocyanate | 0.225 | none | 0 | none | 0 |
| Guanidine Thiocyanate | 0.250 | none | 0 | none | 0 |
| Guanine | 0.025 | none | 0 | none | 0 |
| Guanine | 0.050 | none | 0 | none | 0 |
| Guanine | 0.075 | none | 0 | none | 0 |
| Guanine | 0.100 | none | 0 | none | 0 |
| Guanine | 0.125 | none | 0 | none | 0 |
| Guanine | 0.150 | none | 0 | none | 0 |
| Guanine | 0.175 | none | 0 | none | 0 |
| Guanine | 0.200 | none | 0 | none | 0 |
| Guanine | 0.225 | none | 0 | none | 0 |
| Guanine | 0.250 | none | 0 | none | 0 |
| Guanidine Bromide | 0.025 | none | 0 | none | 0 |
| Guanidine Bromide | 0.050 | none | 0 | none | 0 |
| Guanidine Bromide | 0.075 | none | 0 | none | 0 |
| Guanidine Bromide | 0.100 | none | 0 | none | 0 |
| Guanidine Bromide | 0.125 | none | 0 | none | 0 |
| Guanidine Bromide | 0.150 | none | 0 | none | 0 |
| Guanidine Bromide | 0.175 | none | 0 | none | 0 |
| Guanidine Bromide | 0.200 | none | 0 | none | 0 |
| Guanidine Bromide | 0.225 | none | 0 | none | 0 |
| Guanidine Bromide | 0.250 | none | 0 | none | 0 |
| Guanidine Iodide | 0.025 | none | 0 | none | 0 |
| Guanidine Iodide | 0.050 | none | 0 | none | 0 |
| Guanidine Iodide | 0.075 | none | 0 | none | 0 |
| Guanidine Iodide | 0.100 | none | 0 | none | 0 |
| Guanidine Iodide | 0.125 | none | 0 | none | 0 |
| Guanidine Iodide | 0.150 | none | 0 | none | 0 |
| Guanidine Iodide | 0.175 | none | 0 | none | 0 |
| Guanidine Iodide | 0.200 | none | 0 | none | 0 |
| Guanidine Iodide | 0.225 | none | 0 | none | 0 |
| Guanidine Iodide | 0.250 | none | 0 | none | 0 |
| Sildenafil Citrate | 0.025 | none | 0 | none | 0 |
| Sildenafil Citrate | 0.050 | none | 0 | none | 0 |
| Sildenafil Citrate | 0.075 | none | 0 | none | 0 |
| Sildenafil Citrate | 0.100 | none | 0 | none | 0 |
| Sildenafil Citrate | 0.125 | none | 0 | none | 0 |
| Sildenafil Citrate | 0.150 | none | 0 | none | 0 |
| Sildenafil Citrate | 0.175 | none | 0 | none | 0 |
| Sildenafil Citrate | 0.200 | none | 0 | none | 0 |
| Sildenafil Citrate | 0.225 | none | 0 | none | 0 |
| Sildenafil Citrate | 0.250 | none | 0 | none | 0 |
| Taurine | 0.025 | none | 0 | none | 0 |
| Taurine | 0.050 | none | 0 | none | 0 |
| Taurine | 0.075 | none | 0 | none | 0 |
| Taurine | 0.100 | none | 0 | none | 0 |
| Taurine | 0.125 | none | 0 | none | 0 |
| Taurine | 0.150 | none | 0 | none | 0 |
| Taurine | 0.175 | none | 0 | none | 0 |
| Taurine | 0.200 | none | 0 | none | 0 |
| Taurine | 0.225 | none | 0 | none | 0 |
| Taurine | 0.250 | none | 0 | none | 0 |
| (S)2Amino5- | 0.025 | none | 0 | none | 0 |
| ureidopentanoic acid | | | | | |
| (S)2Amino5- | 0.050 | none | 0 | none | 0 |
| ureidopentanoic acid | | | | | |
| (S)2Amino5- | 0.075 | none | 0 | none | 0 |
| ureidopentanoic acid | | | | | |
| (S)2Amino5- | 0.100 | none | 0 | none | 0 |
| ureidopentanoic acid | | | | | |
| (S)2Amino5- | 0.125 | none | 0 | none | 0 |
| ureidopentanoic acid | | | | | |
| (S)2Amino5- | 0.150 | none | 0 | none | 0 |
| ureidopentanoic acid | | | | | |
| (S)2Amino5- | 0.175 | none | 0 | none | 0 |
| ureidopentanoic acid | | | | | |
| (S)2Amino5- | 0.200 | none | 0 | none | 0 |
| ureidopentanoic acid | | | | | |
| (S)2Amino5- | 0.225 | none | 0 | none | 0 |
| ureidopentanoic acid | | | | | |
| (S)2Amino5- | 0.250 | none | 0 | none | 0 |
| ureidopentanoic acid | | | | | |
| 2-(1-Methylguanidino) | 0.025 | none | 0 | none | 0 |
| acetic acid | | | | | |
| 2-(1-Methylguanidino) | 0.050 | none | 0 | none | 0 |
| acetic acid | | | | | |
| 2-(1-Methylguanidino) | 0.075 | none | 0 | none | 0 |
| acetic acid | | | | | |
| 2-(1-Methylguanidino) | 0.100 | none | 0 | none | 0 |
| acetic acid | | | | | |
| 2-(1-Methylguanidino) | 0.125 | none | 0 | none | 0 |
| acetic acid | | | | | |
| 2-(1-Methylguanidino) | 0.150 | none | 0 | none | 0 |
| acetic acid | | | | | |
| 2-(1-Methylguanidino) | 0.175 | none | 0 | none | 0 |
| acetic acid | | | | | |
| 2-(1-Methylguanidino) | 0.200 | none | 0 | none | 0 |
| acetic acid | | | | | |
| 2-(1-Methylguanidino) | 0.225 | none | 0 | none | 0 |
| acetic acid | | | | | |
| 2-(1-Methylguanidino) | 0.250 | none | 0 | none | 0 |
| acetic acid | | | | | |
| 1,3,7-Trimethyl-2,3,6,7- | 0.025 | none | 0 | none | 0 |
| tetrahydro-1H-purine- | | | | | |
| 2,6-dione | | | | | |
| 1,3,7-Trimethyl-2,3,6,7- | 0.050 | none | 0 | none | 0 |
| tetrahydro-1H-purine- | | | | | |
| 2,6-dione | | | | | |
| 1,3,7-Trimethyl-2,3,6,7- | 0.075 | none | 0 | none | 0 |
| tetrahydro-1H-purine- | | | | | |
| 2,6-dione | | | | | |
| 1,3,7-Trimethyl-2,3,6,7- | 0.100 | none | 0 | none | 0 |
| tetrahydro-1H-purine- | | | | | |
| 2,6-dione | | | | | |
| 1,3,7-Trimethyl-2,3,6,7- | 0.125 | none | 0 | none | 0 |
| tetrahydro-1H-purine- | | | | | |
| 2,6-dione | | | | | |
| 1,3,7-Trimethyl-2,3,6,7- | 0.150 | none | 0 | none | 0 |
| tetrahydro-1H-purine- | | | | | |
| 2,6-dione | | | | | |
| 1,3,7-Trimethyl-2,3,6,7- | 0.175 | none | 0 | none | 0 |
| tetrahydro-1H-purine- | | | | | |
| 2,6-dione | | | | | |
| 1,3,7-Trimethyl-2,3,6,7- | 0.200 | none | 0 | none | 0 |
| tetrahydro-1H-purine- | | | | | |
| 2,6-dione | | | | | |
| 1,3,7-Trimethyl-2,3,6,7- | 0.225 | none | 0 | none | 0 |
| tetrahydro-1H-purine- | | | | | |
| 2,6-dione | | | | | |
| 1,3,7-Trimethyl-2,3,6,7- | 0.250 | none | 0 | none | 0 |
| tetrahydro-1H-purine- | | | | | |
| 2,6-dione | | | | | |
| 2-phenylethylamine | 0.025 | none | 0 | none | 0 |
| 2-phenylethylamine | 0.050 | none | 0 | none | 0 |
| 2-phenylethylamine | 0.075 | none | 0 | none | 0 |
| 2-phenylethylamine | 0.100 | none | 0 | none | 0 |
| 2-phenylethylamine | 0.125 | none | 0 | none | 0 |
| 2-phenylethylamine | 0.150 | none | 0 | none | 0 |
| 2-phenylethylamine | 0.175 | none | 0 | none | 0 |
| 2-phenylethylamine | 0.200 | none | 0 | none | 0 |
| 2-phenylethylamine | 0.225 | none | 0 | none | 0 |
| 2-phenylethylamine | 0.250 | none | 0 | none | 0 |
| Guanidine hydrochloride | 0.025 | none | 0 | none | 0 |
| Guanidine hydrochloride | 0.050 | none | 0 | none | 0 |
| Guanidine hydrochloride | 0.075 | none | 0 | none | 0 |
| Guanidine hydrochloride | 0.100 | none | 0 | none | 0 |
| Guanidine hydrochloride | 0.125 | none | 0 | none | 0 |
| Guanidine hydrochloride | 0.150 | none | 0 | none | 0 |
| Guanidine hydrochloride | 0.175 | none | 0 | none | 0 |
| Guanidine hydrochloride | 0.200 | none | 0 | none | 0 |
| Guanidine hydrochloride | 0.225 | none | 0 | none | 0 |
| Guanidine hydrochloride | 0.250 | none | 0 | none | 0 |
| 1,3-Diphenylguanidine | 0.025 | none | 0 | none | 0 |
| 1,3-Diphenylguanidine | 0.050 | none | 0 | none | 0 |
| 1,3-Diphenylguanidine | 0.075 | none | 0 | none | 0 |
| 1,3-Diphenylguanidine | 0.100 | none | 0 | none | 0 |
| 1,3-Diphenylguanidine | 0.125 | none | 0 | none | 0 |
| 1,3-Diphenylguanidine | 0.150 | none | 0 | none | 0 |
| 1,3-Diphenylguanidine | 0.175 | none | 0 | none | 0 |
| 1,3-Diphenylguanidine | 0.200 | none | 0 | none | 0 |
| 1,3-Diphenylguanidine | 0.225 | none | 0 | none | 0 |
| 1,3-Diphenylguanidine | 0.250 | none | 0 | none | 0 |
| Biguanide | 0.025 | none | 0 | none | 0 |
| Biguanide | 0.050 | none | 0 | none | 0 |
| Biguanide | 0.075 | none | 0 | none | 0 |
| Biguanide | 0.100 | none | 0 | none | 0 |
| Biguanide | 0.125 | none | 0 | none | 0 |
| Biguanide | 0.150 | none | 0 | none | 0 |
| Biguanide | 0.175 | none | 0 | none | 0 |
| Biguanide | 0.200 | none | 0 | none | 0 |
| Biguanide | 0.225 | none | 0 | none | 0 |
| Biguanide | 0.250 | none | 0 | none | 0 |
| Metformin hydrochloride | 0.025 | none | 0 | none | 0 |
| Metformin hydrochloride | 0.050 | none | 0 | none | 0 |
| Metformin hydrochloride | 0.075 | none | 0 | none | 0 |
| Metformin hydrochloride | 0.100 | none | 0 | none | 0 |
| Metformin hydrochloride | 0.125 | none | 0 | none | 0 |
| Metformin hydrochloride | 0.150 | none | 0 | none | 0 |
| Metformin hydrochloride | 0.175 | none | 0 | none | 0 |
| Metformin hydrochloride | 0.200 | none | 0 | none | 0 |
| Metformin hydrochloride | 0.225 | none | 0 | none | 0 |
| Metformin hydrochloride | 0.250 | none | 0 | none | 0 |
| Dicyandiamide | 0.025 | Guanidine Nitrate | 0.025 | none | 0 |
| Dicyandiamide | 0.050 | Guanidine Nitrate | 0.050 | none | 0 |
| Dicyandiamide | 0.075 | Guanidine Nitrate | 0.075 | none | 0 |
| Dicyandiamide | 0.100 | Guanidine Nitrate | 0.100 | none | 0 |
| Dicyandiamide | 0.125 | Guanidine Nitrate | 0.125 | none | 0 |
| Dicyandiamide | 0.150 | Guanidine Nitrate | 0.150 | none | 0 |
| Dicyandiamide | 0.175 | Guanidine Nitrate | 0.175 | none | 0 |
| Dicyandiamide | 0.200 | Guanidine Nitrate | 0.200 | none | 0 |
| Dicyandiamide | 0.225 | Guanidine Nitrate | 0.225 | none | 0 |
| Dicyandiamide | 0.250 | Guanidine Nitrate | 0.250 | none | 0 |
| Dicyandiamide | 0.025 | Guanidine Thiocyanate | 0.025 | none | 0 |
| Dicyandiamide | 0.050 | Guanidine Thiocyanate | 0.050 | none | 0 |
| Dicyandiamide | 0.075 | Guanidine Thiocyanate | 0.075 | none | 0 |
| Dicyandiamide | 0.100 | Guanidine Thiocyanate | 0.100 | none | 0 |
| Dicyandiamide | 0.125 | Guanidine Thiocyanate | 0.125 | none | 0 |
| Dicyandiamide | 0.150 | Guanidine Thiocyanate | 0.150 | none | 0 |
| Dicyandiamide | 0.175 | Guanidine Thiocyanate | 0.175 | none | 0 |
| Dicyandiamide | 0.200 | Guanidine Thiocyanate | 0.200 | none | 0 |
| Dicyandiamide | 0.225 | Guanidine Thiocyanate | 0.225 | none | 0 |
| Dicyandiamide | 0.250 | Guanidine Thiocyanate | 0.250 | none | 0 |
| Dicyandiamide | 0.025 | Guanine | 0.025 | none | 0 |
| Dicyandiamide | 0.050 | Guanine | 0.050 | none | 0 |
| Dicyandiamide | 0.075 | Guanine | 0.075 | none | 0 |
| Dicyandiamide | 0.100 | Guanine | 0.100 | none | 0 |
| Dicyandiamide | 0.125 | Guanine | 0.125 | none | 0 |
| Dicyandiamide | 0.150 | Guanine | 0.150 | none | 0 |
| Dicyandiamide | 0.175 | Guanine | 0.175 | none | 0 |
| Dicyandiamide | 0.200 | Guanine | 0.200 | none | 0 |
| Dicyandiamide | 0.225 | Guanine | 0.225 | none | 0 |
| Dicyandiamide | 0.250 | Guanine | 0.250 | none | 0 |
| Dicyandiamide | 0.025 | Guanidine Bromide | 0.025 | none | 0 |
| Dicyandiamide | 0.050 | Guanidine Bromide | 0.050 | none | 0 |
| Dicyandiamide | 0.075 | Guanidine Bromide | 0.075 | none | 0 |
| Dicyandiamide | 0.100 | Guanidine Bromide | 0.100 | none | 0 |
| Dicyandiamide | 0.125 | Guanidine Bromide | 0.125 | none | 0 |
| Dicyandiamide | 0.150 | Guanidine Bromide | 0.150 | none | 0 |
| Dicyandiamide | 0.175 | Guanidine Bromide | 0.175 | none | 0 |
| Dicyandiamide | 0.200 | Guanidine Bromide | 0.200 | none | 0 |
| Dicyandiamide | 0.225 | Guanidine Bromide | 0.225 | none | 0 |
| Dicyandiamide | 0.250 | Guanidine Bromide | 0.250 | none | 0 |
| Guanidine Nitrate | 0.025 | Guanidine Thiocyanate | 0.025 | none | 0 |
| Guanidine Nitrate | 0.050 | Guanidine Thiocyanate | 0.050 | none | 0 |
| Guanidine Nitrate | 0.075 | Guanidine Thiocyanate | 0.075 | none | 0 |
| Guanidine Nitrate | 0.100 | Guanidine Thiocyanate | 0.100 | none | 0 |
| Guanidine Nitrate | 0.125 | Guanidine Thiocyanate | 0.125 | none | 0 |
| Guanidine Nitrate | 0.150 | Guanidine Thiocyanate | 0.150 | none | 0 |
| Guanidine Nitrate | 0.175 | Guanidine Thiocyanate | 0.175 | none | 0 |
| Guanidine Nitrate | 0.200 | Guanidine Thiocyanate | 0.200 | none | 0 |
| Guanidine Nitrate | 0.225 | Guanidine Thiocyanate | 0.225 | none | 0 |
| Guanidine Nitrate | 0.250 | Guanidine Thiocyanate | 0.250 | none | 0 |
| Guanidine Nitrate | 0.025 | Guanine | 0.025 | none | 0 |
| Guanidine Nitrate | 0.050 | Guanine | 0.050 | none | 0 |
| Guanidine Nitrate | 0.075 | Guanine | 0.075 | none | 0 |
| Guanidine Nitrate | 0.100 | Guanine | 0.100 | none | 0 |
| Guanidine Nitrate | 0.125 | Guanine | 0.125 | none | 0 |
| Guanidine Nitrate | 0.150 | Guanine | 0.150 | none | 0 |
| Guanidine Nitrate | 0.175 | Guanine | 0.175 | none | 0 |
| Guanidine Nitrate | 0.200 | Guanine | 0.200 | none | 0 |
| Guanidine Nitrate | 0.225 | Guanine | 0.225 | none | 0 |
| Guanidine Nitrate | 0.250 | Guanine | 0.250 | none | 0 |
| Guanidine Nitrate | 0.025 | Guanidine Bromide | 0.025 | none | 0 |
| Guanidine Nitrate | 0.050 | Guanidine Bromide | 0.050 | none | 0 |
| Guanidine Nitrate | 0.075 | Guanidine Bromide | 0.075 | none | 0 |
| Guanidine Nitrate | 0.100 | Guanidine Bromide | 0.100 | none | 0 |
| Guanidine Nitrate | 0.125 | Guanidine Bromide | 0.125 | none | 0 |
| Guanidine Nitrate | 0.150 | Guanidine Bromide | 0.150 | none | 0 |
| Guanidine Nitrate | 0.175 | Guanidine Bromide | 0.175 | none | 0 |
| Guanidine Nitrate | 0.200 | Guanidine Bromide | 0.200 | none | 0 |
| Guanidine Nitrate | 0.225 | Guanidine Bromide | 0.225 | none | 0 |
| Guanidine Nitrate | 0.250 | Guanidine Bromide | 0.250 | none | 0 |
| Guanidine Thiocyanate | 0.025 | Guanine | 0.025 | none | 0 |
| Guanidine Thiocyanate | 0.050 | Guanine | 0.050 | none | 0 |
| Guanidine Thiocyanate | 0.075 | Guanine | 0.075 | none | 0 |
| Guanidine Thiocyanate | 0.100 | Guanine | 0.100 | none | 0 |
| Guanidine Thiocyanate | 0.125 | Guanine | 0.125 | none | 0 |
| Guanidine Thiocyanate | 0.150 | Guanine | 0.150 | none | 0 |
| Guanidine Thiocyanate | 0.175 | Guanine | 0.175 | none | 0 |
| Guanidine Thiocyanate | 0.200 | Guanine | 0.200 | none | 0 |
| Guanidine Thiocyanate | 0.225 | Guanine | 0.225 | none | 0 |
| Guanidine Thiocyanate | 0.250 | Guanine | 0.250 | none | 0 |
| Guanidine Thiocyanate | 0.025 | Guanidine Bromide | 0.025 | none | 0 |
| Guanidine Thiocyanate | 0.050 | Guanidine Bromide | 0.050 | none | 0 |
| Guanidine Thiocyanate | 0.075 | Guanidine Bromide | 0.075 | none | 0 |
| Guanidine Thiocyanate | 0.100 | Guanidine Bromide | 0.100 | none | 0 |
| Guanidine Thiocyanate | 0.125 | Guanidine Bromide | 0.125 | none | 0 |
| Guanidine Thiocyanate | 0.150 | Guanidine Bromide | 0.150 | none | 0 |
| Guanidine Thiocyanate | 0.175 | Guanidine Bromide | 0.175 | none | 0 |
| Guanidine Thiocyanate | 0.200 | Guanidine Bromide | 0.200 | none | 0 |
| Guanidine Thiocyanate | 0.225 | Guanidine Bromide | 0.225 | none | 0 |
| Guanidine Thiocyanate | 0.250 | Guanidine Bromide | 0.250 | none | 0 |
| Guanine | 0.025 | Guanidine Bromide | 0.025 | none | 0 |
| Guanine | 0.050 | Guanidine Bromide | 0.050 | none | 0 |
| Guanine | 0.075 | Guanidine Bromide | 0.075 | none | 0 |
| Guanine | 0.100 | Guanidine Bromide | 0.100 | none | 0 |
| Guanine | 0.125 | Guanidine Bromide | 0.125 | none | 0 |
| Guanine | 0.150 | Guanidine Bromide | 0.150 | none | 0 |
| Guanine | 0.175 | Guanidine Bromide | 0.175 | none | 0 |
| Guanine | 0.200 | Guanidine Bromide | 0.200 | none | 0 |
| Guanine | 0.225 | Guanidine Bromide | 0.225 | none | 0 |
| Guanine | 0.250 | Guanidine Bromide | 0.250 | none | 0 |
| Dicyandiamide | 0.025 | Guanidine Iodide | 0.025 | none | 0 |
| Dicyandiamide | 0.050 | Guanidine Iodide | 0.050 | none | 0 |
| Dicyandiamide | 0.075 | Guanidine Iodide | 0.075 | none | 0 |
| Dicyandiamide | 0.100 | Guanidine Iodide | 0.100 | none | 0 |
| Dicyandiamide | 0.125 | Guanidine Iodide | 0.125 | none | 0 |
| Dicyandiamide | 0.150 | Guanidine Iodide | 0.150 | none | 0 |
| Dicyandiamide | 0.175 | Guanidine Iodide | 0.175 | none | 0 |
| Dicyandiamide | 0.200 | Guanidine Iodide | 0.200 | none | 0 |
| Dicyandiamide | 0.225 | Guanidine Iodide | 0.225 | none | 0 |
| Dicyandiamide | 0.250 | Guanidine Iodide | 0.250 | none | 0 |
| Dicyandiamide | 0.025 | Sildenafil Citrate | 0.025 | none | 0 |
| Dicyandiamide | 0.050 | Sildenafil Citrate | 0.050 | none | 0 |
| Dicyandiamide | 0.075 | Sildenafil Citrate | 0.075 | none | 0 |
| Dicyandiamide | 0.100 | Sildenafil Citrate | 0.100 | none | 0 |
| Dicyandiamide | 0.125 | Sildenafil Citrate | 0.125 | none | 0 |
| Dicyandiamide | 0.150 | Sildenafil Citrate | 0.150 | none | 0 |
| Dicyandiamide | 0.175 | Sildenafil Citrate | 0.175 | none | 0 |
| Dicyandiamide | 0.200 | Sildenafil Citrate | 0.200 | none | 0 |
| Dicyandiamide | 0.225 | Sildenafil Citrate | 0.225 | none | 0 |
| Dicyandiamide | 0.250 | Sildenafil Citrate | 0.250 | none | 0 |
| Guanidine Nitrate | 0.025 | Guanidine Iodide | 0.025 | none | 0 |
| Guanidine Nitrate | 0.050 | Guanidine Iodide | 0.050 | none | 0 |
| Guanidine Nitrate | 0.075 | Guanidine Iodide | 0.075 | none | 0 |
| Guanidine Nitrate | 0.100 | Guanidine Iodide | 0.100 | none | 0 |
| Guanidine Nitrate | 0.125 | Guanidine Iodide | 0.125 | none | 0 |
| Guanidine Nitrate | 0.150 | Guanidine Iodide | 0.150 | none | 0 |
| Guanidine Nitrate | 0.175 | Guanidine Iodide | 0.175 | none | 0 |
| Guanidine Nitrate | 0.200 | Guanidine Iodide | 0.200 | none | 0 |
| Guanidine Nitrate | 0.225 | Guanidine Iodide | 0.225 | none | 0 |
| Guanidine Nitrate | 0.250 | Guanidine Iodide | 0.250 | none | 0 |
| Guanidine Thiocyanate | 0.025 | Guanidine Iodide | 0.025 | none | 0 |
| Guanidine Thiocyanate | 0.050 | Guanidine Iodide | 0.050 | none | 0 |
| Guanidine Thiocyanate | 0.075 | Guanidine Iodide | 0.075 | none | 0 |
| Guanidine Thiocyanate | 0.100 | Guanidine Iodide | 0.100 | none | 0 |
| Guanidine Thiocyanate | 0.125 | Guanidine Iodide | 0.125 | none | 0 |
| Guanidine Thiocyanate | 0.150 | Guanidine Iodide | 0.150 | none | 0 |
| Guanidine Thiocyanate | 0.175 | Guanidine Iodide | 0.175 | none | 0 |
| Guanidine Thiocyanate | 0.200 | Guanidine Iodide | 0.200 | none | 0 |
| Guanidine Thiocyanate | 0.225 | Guanidine Iodide | 0.225 | none | 0 |
| Guanidine Thiocyanate | 0.250 | Guanidine Iodide | 0.250 | none | 0 |
| Guanidine Iodide | 0.025 | Sildenafil Citrate | 0.025 | none | 0 |
| Guanidine Iodide | 0.050 | Sildenafil Citrate | 0.050 | none | 0 |
| Guanidine Iodide | 0.075 | Sildenafil Citrate | 0.075 | none | 0 |
| Guanidine Iodide | 0.100 | Sildenafil Citrate | 0.100 | none | 0 |
| Guanidine Iodide | 0.125 | Sildenafil Citrate | 0.125 | none | 0 |
| Guanidine Iodide | 0.150 | Sildenafil Citrate | 0.150 | none | 0 |
| Guanidine Iodide | 0.175 | Sildenafil Citrate | 0.175 | none | 0 |
| Guanidine Iodide | 0.200 | Sildenafil Citrate | 0.200 | none | 0 |
| Guanidine Iodide | 0.225 | Sildenafil Citrate | 0.225 | none | 0 |
| Guanidine Iodide | 0.250 | Sildenafil Citrate | 0.250 | none | 0 |
| Taurine | 0.025 | Guanidine hydrochloride | 0.025 | none | 0 |
| Taurine | 0.050 | Guanidine hydrochloride | 0.050 | none | 0 |
| Taurine | 0.075 | Guanidine hydrochloride | 0.075 | none | 0 |
| Taurine | 0.100 | Guanidine hydrochloride | 0.100 | none | 0 |
| Taurine | 0.125 | Guanidine hydrochloride | 0.125 | none | 0 |
| Taurine | 0.150 | Guanidine hydrochloride | 0.150 | none | 0 |
| Taurine | 0.175 | Guanidine hydrochloride | 0.175 | none | 0 |
| Taurine | 0.200 | Guanidine hydrochloride | 0.200 | none | 0 |
| Taurine | 0.225 | Guanidine hydrochloride | 0.225 | none | 0 |
| Taurine | 0.250 | Guanidine hydrochloride | 0.250 | none | 0 |
| Biguanide | 0.025 | Metformin hydrochloride | 0.025 | none | 0 |
| Biguanide | 0.050 | Metformin hydrochloride | 0.050 | none | 0 |
| Biguanide | 0.075 | Metformin hydrochloride | 0.075 | none | 0 |
| Biguanide | 0.100 | Metformin hydrochloride | 0.100 | none | 0 |
| Biguanide | 0.125 | Metformin hydrochloride | 0.125 | none | 0 |
| Biguanide | 0.150 | Metformin hydrochloride | 0.150 | none | 0 |
| Biguanide | 0.175 | Metformin hydrochloride | 0.175 | none | 0 |
| Biguanide | 0.200 | Metformin hydrochloride | 0.200 | none | 0 |
| Biguanide | 0.225 | Metformin hydrochloride | 0.225 | none | 0 |
| Biguanide | 0.250 | Metformin hydrochloride | 0.250 | none | 0 |
| 1,3-Diphenylguanidine | 0.025 | 2-phenylethylamine | 0.025 | none | 0 |
| 1,3-Diphenylguanidine | 0.050 | 2-phenylethylamine | 0.050 | none | 0 |
| 1,3-Diphenylguanidine | 0.075 | 2-phenylethylamine | 0.075 | none | 0 |
| 1,3-Diphenylguanidine | 0.100 | 2-phenylethylamine | 0.100 | none | 0 |
| 1,3-Diphenylguanidine | 0.125 | 2-phenylethylamine | 0.125 | none | 0 |
| 1,3-Diphenylguanidine | 0.150 | 2-phenylethylamine | 0.150 | none | 0 |
| 1,3-Diphenylguanidine | 0.175 | 2-phenylethylamine | 0.175 | none | 0 |
| 1,3-Diphenylguanidine | 0.200 | 2-phenylethylamine | 0.200 | none | 0 |
| 1,3-Diphenylguanidine | 0.225 | 2-phenylethylamine | 0.225 | none | 0 |
| 1,3-Diphenylguanidine | 0.250 | 2-phenylethylamine | 0.250 | none | 0 |
| Dicyandiamide | 0.025 | Guanidine Iodide | 0.025 | none | 0 |
| Dicyandiamide | 0.050 | Guanidine Iodide | 0.050 | none | 0 |
| Dicyandiamide | 0.075 | Guanidine Iodide | 0.075 | none | 0 |
| Dicyandiamide | 0.100 | Guanidine Iodide | 0.100 | none | 0 |
| Dicyandiamide | 0.125 | Guanidine Iodide | 0.125 | none | 0 |
| Dicyandiamide | 0.150 | Guanidine Iodide | 0.150 | none | 0 |
| Dicyandiamide | 0.175 | Guanidine Iodide | 0.175 | none | 0 |
| Dicyandiamide | 0.200 | Guanidine Iodide | 0.200 | none | 0 |
| Dicyandiamide | 0.225 | Guanidine Iodide | 0.225 | none | 0 |
| Dicyandiamide | 0.250 | Guanidine Iodide | 0.250 | none | 0 |
| Guanidine Thiocyanate | 0.025 | Biguanide | 0.025 | none | 0 |
| Guanidine Thiocyanate | 0.050 | Biguanide | 0.050 | none | 0 |
| Guanidine Thiocyanate | 0.075 | Biguanide | 0.075 | none | 0 |
| Guanidine Thiocyanate | 0.100 | Biguanide | 0.100 | none | 0 |
| Guanidine Thiocyanate | 0.125 | Biguanide | 0.125 | none | 0 |
| Guanidine Thiocyanate | 0.150 | Biguanide | 0.150 | none | 0 |
| Guanidine Thiocyanate | 0.175 | Biguanide | 0.175 | none | 0 |
| Guanidine Thiocyanate | 0.200 | Biguanide | 0.200 | none | 0 |
| Guanidine Thiocyanate | 0.225 | Biguanide | 0.225 | none | 0 |
| Guanidine Thiocyanate | 0.250 | Biguanide | 0.250 | none | 0 |
| Dicyandiamide | 0.025 | Guanidine Iodide | 0.025 | Sildenafil Citrate | 0.025 |
| Dicyandiamide | 0.050 | Guanidine Iodide | 0.050 | Sildenafil Citrate | 0.050 |
| Dicyandiamide | 0.075 | Guanidine Iodide | 0.075 | Sildenafil Citrate | 0.075 |
| Dicyandiamide | 0.100 | Guanidine Iodide | 0.100 | Sildenafil Citrate | 0.100 |
| Dicyandiamide | 0.125 | Guanidine Iodide | 0.125 | Sildenafil Citrate | 0.125 |
| Dicyandiamide | 0.150 | Guanidine Iodide | 0.150 | Sildenafil Citrate | 0.150 |
| Dicyandiamide | 0.175 | Guanidine Iodide | 0.175 | Sildenafil Citrate | 0.175 |
| Dicyandiamide | 0.200 | Guanidine Iodide | 0.200 | Sildenafil Citrate | 0.200 |
| Dicyandiamide | 0.225 | Guanidine Iodide | 0.225 | Sildenafil Citrate | 0.225 |
| Dicyandiamide | 0.250 | Guanidine Iodide | 0.250 | Sildenafil Citrate | 0.250 |
| Guanidine Nitrate | 0.025 | Taurine | 0.025 | Guanidine hydrochloride | 0.025 |
| Guanidine Nitrate | 0.050 | Taurine | 0.050 | Guanidine hydrochloride | 0.050 |
| Guanidine Nitrate | 0.075 | Taurine | 0.075 | Guanidine hydrochloride | 0.075 |
| Guanidine Nitrate | 0.100 | Taurine | 0.100 | Guanidine hydrochloride | 0.100 |
| Guanidine Nitrate | 0.125 | Taurine | 0.125 | Guanidine hydrochloride | 0.125 |
| Guanidine Nitrate | 0.150 | Taurine | 0.150 | Guanidine hydrochloride | 0.150 |
| Guanidine Nitrate | 0.175 | Taurine | 0.175 | Guanidine hydrochloride | 0.175 |
| Guanidine Nitrate | 0.200 | Taurine | 0.200 | Guanidine hydrochloride | 0.200 |
| Guanidine Nitrate | 0.225 | Taurine | 0.225 | Guanidine hydrochloride | 0.225 |
| Guanidine Nitrate | 0.250 | Taurine | 0.250 | Guanidine hydrochloride | 0.250 |
| Biguanide | 0.025 | Metformin hydrochloride | 0.025 | 1,3-Diphenylguanidine | 0.025 |
| Biguanide | 0.050 | Metformin hydrochloride | 0.050 | 1,3-Diphenylguanidine | 0.050 |
| Biguanide | 0.075 | Metformin hydrochloride | 0.075 | 1,3-Diphenylguanidine | 0.075 |
| Biguanide | 0.100 | Metformin hydrochloride | 0.100 | 1,3-Diphenylguanidine | 0.100 |
| Biguanide | 0.125 | Metformin hydrochloride | 0.125 | 1,3-Diphenylguanidine | 0.125 |
| Biguanide | 0.150 | Metformin hydrochloride | 0.150 | 1,3-Diphenylguanidine | 0.150 |
| Biguanide | 0.175 | Metformin hydrochloride | 0.175 | 1,3-Diphenylguanidine | 0.175 |
| Biguanide | 0.200 | Metformin hydrochloride | 0.200 | 1,3-Diphenylguanidine | 0.200 |
| Biguanide | 0.225 | Metformin hydrochloride | 0.225 | 1,3-Diphenylguanidine | 0.225 |
| Biguanide | 0.250 | Metformin hydrochloride | 0.250 | 1,3-Diphenylguanidine | 0.250 |
| (S)2Amino5- | 0.025 | 2-(1-Methylguanidino) | 0.025 | 1,3,7-Trimethyl-2,3,6,7- | 0.025 |
| ureidopentanoic acid | | acetic acid | | tetrahydro-1H-purine- | |
| | | | | 2,6-dione | |
| (S)2Amino5- | 0.050 | 2-(1-Methylguanidino) | 0.050 | 1,3,7-Trimethyl-2,3,6,7- | 0.050 |
| ureidopentanoic acid | | acetic acid | | tetrahydro-1H-purine- | |
| | | | | 2,6-dione | |
| (S)2Amino5- | 0.075 | 2-(1-Methylguanidino) | 0.075 | 1,3,7-Trimethyl-2,3,6,7- | 0.075 |
| ureidopentanoic acid | | acetic acid | | tetrahydro-1H-purine- | |
| | | | | 2,6-dione | |
| (S)2Amino5- | 0.100 | 2-(1-Methylguanidino) | 0.100 | 1,3,7-Trimethyl-2,3,6,7- | 0.100 |
| ureidopentanoic acid | | acetic acid | | tetrahydro-1H-purine- | |
| | | | | 2,6-dione | |
| (S)2Amino5- | 0.125 | 2-(1-Methylguanidino) | 0.125 | 1,3,7-Trimethyl-2,3,6,7- | 0.125 |
| ureidopentanoic acid | | acetic acid | | tetrahydro-1H-purine- | |
| | | | | 2,6-dione | |
| (S)2Amino5- | 0.150 | 2-(1-Methylguanidino) | 0.150 | 1,3,7-Trimethyl-2,3,6,7- | 0.150 |
| ureidopentanoic acid | | acetic acid | | tetrahydro-1H-purine- | |
| | | | | 2,6-dione | |
| (S)2Amino5- | 0.175 | 2-(1-Methylguanidino) | 0.175 | 1,3,7-Trimethyl-2,3,6,7- | 0.175 |
| ureidopentanoic acid | | acetic acid | | tetrahydro-1H-purine- | |
| | | | | 2,6-dione | |
| (S)2Amino5- | 0.200 | 2-(1-Methylguanidino) | 0.200 | 1,3,7-Trimethyl-2,3,6,7- | 0.200 |
| ureidopentanoic acid | | acetic acid | | tetrahydro-1H-purine- | |
| | | | | 2,6-dione | |
| (S)2Amino5- | 0.225 | 2-(1-Methylguanidino) | 0.225 | 1,3,7-Trimethyl-2,3,6,7- | 0.225 |
| ureidopentanoic acid | | acetic acid | | tetrahydro-1H-purine- | |
| | | | | 2,6-dione | |
| (S)2Amino5- | 0.250 | 2-(1-Methylguanidino) | 0.250 | 1,3,7-Trimethyl-2,3,6,7- | 0.250 |
| ureidopentanoic acid | | acetic acid | | tetrahydro-1H-purine- | |
| | | | | 2,6-dione | |
| Dicyandiamide | 0.025 | Guanidine Nitrate | 0.025 | Guanidine Thiocyanate | 0.025 |

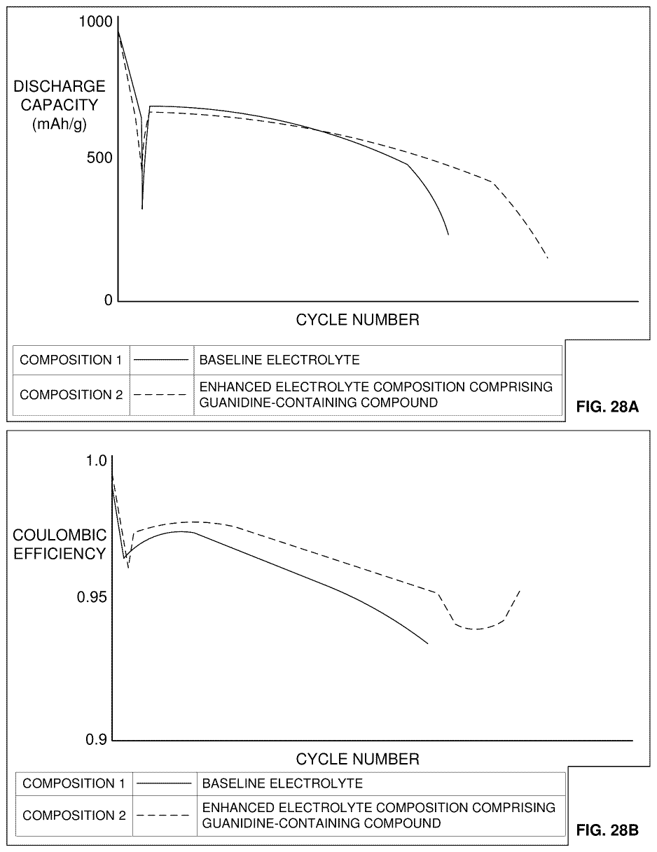

FIG. 28A illustrates discharge capacity versus cycle number performance graphs comparing electrolyte formulations, in accordance with one embodiment. As an option, the discharge capacity versus cycle number performance graphs comparing electrolyte formulations may be implemented in the context of any one or more of the embodiments set forth in any previous and/or subsequent Figures and/or description thereof. Of course, however, the discharge capacity versus cycle number performance graphs comparing electrolyte formulations may be implemented in the context of any desired environment. Further, the aforementioned definitions may equally apply to the description below.

The discharge capacity performance graphs demonstrate the electrochemical behavior of lithium-sulfur battery systems incorporating guanidine-containing compounds as performance-enhancing additives. The solid line within the performance graphs represents Composition 1 Baseline Electrolyte, while the dashed line illustrates the performance characteristics of Composition 2 Enhanced Electrolyte Composition Comprising Guanidine-Containing Compound. The discharge capacity measurements within the performance graphs range from 0 to 1000 mAh/g on the vertical axis, providing comprehensive coverage of the capacity retention behavior across extended cycling periods. The horizontal axis of the performance graphs tracks cycle number progression, enabling evaluation of long-term stability and capacity fade characteristics.

Composition 1 Baseline Electrolyte represented by the solid line in the performance graphs establishes the reference performance characteristics for baseline electrolyte systems. The discharge capacity behavior of the baseline formulation demonstrates the electrochemical limitations encountered in baseline electrolyte systems in lithium-sulfur battery applications. The capacity retention profile of the baseline system within the performance graphs exhibits gradual decline over extended cycling periods, reflecting the inherent challenges associated with polysulfide shuttle effects and electrode degradation mechanisms.

Composition 2 Enhanced Electrolyte Composition represented by the dashed line in the performance graphs demonstrates the synergistic electrochemical performance achieved through the incorporation of guanidine-containing compounds. The discharge capacity behavior of the enhanced formulation exhibits improved capacity retention and extended cycle life compared to the baseline system. The performance enhancement illustrated by the dashed line within the performance graphs reflects the complementary mechanisms provided by guanidine-containing compounds, including polysulfide shuttle suppression and anode protection functionalities.

FIG. 28B illustrates coulombic efficiency versus cycle number performance graphs comparing electrolyte formulations, in accordance with one embodiment. As an option, the coulombic efficiency versus cycle number performance graphs comparing electrolyte formulations may be implemented in the context of any one or more of the embodiments set forth in any previous and/or subsequent Figures and/or description thereof. Of course, however, the coulombic efficiency versus cycle number performance graphs comparing electrolyte formulations may be implemented in the context of any desired environment. Further, the aforementioned definitions may equally apply to the description below.

The solid line within the performance graphs represents the coulombic efficiency behavior of Composition 1 Baseline Electrolyte, while the dashed line illustrates the efficiency characteristics of Composition 2 Enhanced Electrolyte Composition Comprising Guanidine-Containing Compound. The coulombic efficiency measurements within the performance graphs range from 0.90 to 1.0 on the vertical axis, encompassing the practical operating range for lithium-sulfur battery systems. The horizontal axis of the performance graphs tracks cycle number progression, enabling assessment of efficiency stability and degradation patterns over extended operation periods.

The baseline coulombic efficiency behavior represented by the solid line in the performance graphs establishes the reference efficiency characteristics for baseline electrolyte systems. The efficiency profile of the baseline formulation demonstrates the electrochemical limitations associated with incomplete charge recovery and parasitic side reactions that occur during battery operation. The coulombic efficiency trajectory of the baseline system within the performance graphs exhibits variability and potential decline over extended cycling periods, reflecting the ongoing challenges associated with polysulfide shuttle effects and electrolyte decomposition mechanisms.

The enhanced coulombic efficiency behavior represented by the dashed line in the performance graphs demonstrates the substantial improvements achieved through the incorporation of guanidine-containing compounds within the electrolyte system. The efficiency characteristics of the enhanced formulation exhibit improved stability and higher average efficiency values compared to the baseline system. The coulombic efficiency performance illustrated by the dashed line within the performance graphs reflects the effectiveness of guanidine-containing compounds in suppressing parasitic reactions and improving charge recovery during battery cycling. The sustained high efficiency values of the enhanced formulation across extended cycling periods demonstrate the long-term stability benefits provided by the inclusion of guanidine-containing compounds. The superior efficiency characteristics of the enhanced formulation support the practical implementation of guanidine-containing compounds in commercial lithium-sulfur battery applications.

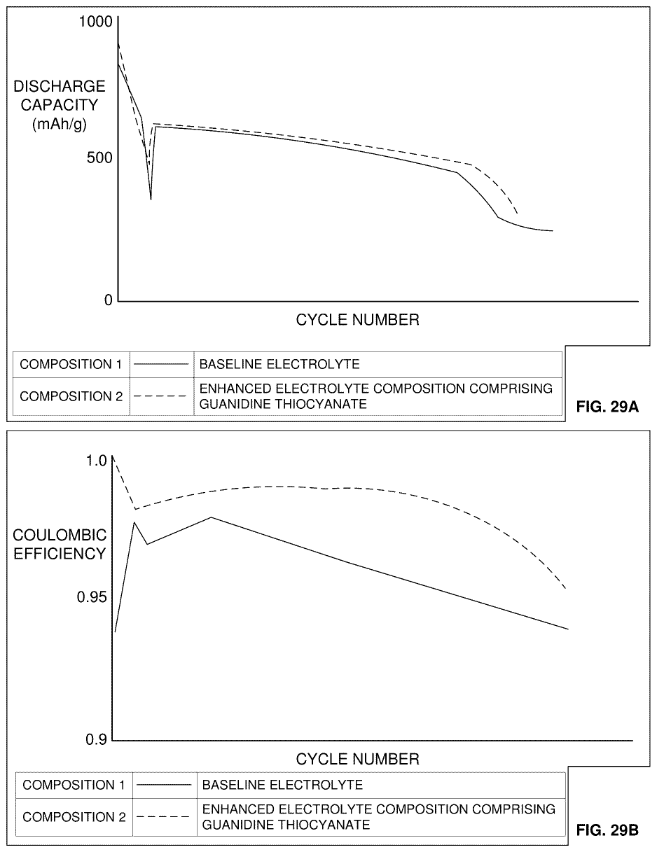

FIG. 29A illustrates discharge capacity versus cycle number performance graphs comparing electrolyte formulations incorporating guanidine thiocyanate additives, in accordance with one embodiment. As an option, the discharge capacity versus cycle number performance graphs comparing electrolyte formulations incorporating guanidine thiocyanate additives may be implemented in the context of any one or more of the embodiments set forth in any previous and/or subsequent Figures and/or description thereof. Of course, however, the discharge capacity versus cycle number performance graphs comparing electrolyte formulations incorporating guanidine thiocyanate additives may be implemented in the context of any desired environment. Further, the aforementioned definitions may equally apply to the description below.

The discharge capacity performance graphs demonstrate the electrochemical behavior of lithium-sulfur battery systems incorporating guanidine thiocyanate as a performance-enhancing additive. The solid line within the performance graphs represents Composition 1 Baseline Electrolyte, while the dashed line illustrates the performance characteristics of Composition 2 Enhanced Electrolyte Composition Comprising Guanidine Thiocyanate.

The capacity retention profile of the baseline system within the performance graphs exhibits gradual decline over extended cycling periods, reflecting the inherent challenges associated with polysulfide shuttle effects and electrode degradation mechanisms.

The enhanced electrolyte formulation represented by the dashed line in the performance graphs demonstrates the synergistic electrochemical performance achieved through the incorporation of guanidine thiocyanate. The discharge capacity behavior of the enhanced formulation exhibits improved capacity retention and extended cycle life compared to the baseline system. The performance enhancement illustrated by the dashed line within the performance graphs reflects the complementary mechanisms provided by guanidine thiocyanate, including polysulfide shuttle suppression and enhanced electrochemical kinetics through the thiocyanate anion functionality. The superior performance characteristics of the enhanced formulation validate the approach of incorporating guanidine thiocyanate to achieve optimized concentration ratios within the range of 0.05M to 0.15M for enhanced electrochemical performance.

FIG. 29B illustrates coulombic efficiency versus cycle number performance graphs comparing electrolyte formulations incorporating guanidine thiocyanate additives, in accordance with one embodiment. As an option, the coulombic efficiency versus cycle number performance graphs comparing electrolyte formulations incorporating guanidine thiocyanate additives may be implemented in the context of any one or more of the embodiments set forth in any previous and/or subsequent Figures and/or description thereof. Of course, however, the coulombic efficiency versus cycle number performance graphs comparing electrolyte formulations incorporating guanidine thiocyanate additives may be implemented in the context of any desired environment. Further, the aforementioned definitions may equally apply to the description below.

The coulombic efficiency performance graphs provide detailed analysis of charge-discharge efficiency characteristics for electrolyte systems incorporating guanidine thiocyanate additives. The solid line represents Composition 1 Baseline Electrolyte, while the dashed line illustrates Composition 2 Enhanced Electrolyte Composition Comprising Guanidine Thiocyanate.

The efficiency profile of the baseline formulation demonstrates the electrochemical limitations associated with incomplete charge recovery and parasitic side reactions that occur during battery operation at electrolyte-to-sulfur ratios of 3:1 and 5:1. The coulombic efficiency trajectory of the baseline system within the performance graphs exhibits variability and potential decline over extended cycling periods, reflecting the ongoing challenges associated with polysulfide shuttle effects and electrolyte decomposition mechanisms.

The enhanced coulombic efficiency behavior represented by the dashed line in the performance graphs demonstrates the substantial improvements achieved through the incorporation of guanidine thiocyanate within the electrolyte system. The efficiency characteristics of the enhanced formulation exhibit improved stability and higher average efficiency values compared to the baseline system, reflecting the enhanced coulombic efficiency achieved. The coulombic efficiency performance illustrated by the dashed line within the performance graphs reflects the effectiveness of guanidine thiocyanate in suppressing parasitic reactions and improving charge recovery during battery cycling through complementary mechanisms that address both polysulfide shuttle effects and electrode surface protection. The sustained high efficiency values of the enhanced formulation across extended cycling periods demonstrate the long-term stability benefits. The superior efficiency characteristics of the enhanced formulation support the practical implementation of guanidine thiocyanate additives in commercial lithium-sulfur battery applications where consistent charge recovery and minimal parasitic losses are required for reliable operation.

Taking a step back, the thiocyanate anion component within guanidine thiocyanate may provide particularly effective parasitic reaction suppression through its dual nitrogen-sulfur functionality that enables multiple interaction pathways with polysulfide species and electrode surfaces.

The performance characteristics demonstrated in both FIG. 29A and FIG. 29B validate the effectiveness of guanidine thiocyanate as a performance-enhancing additive when present in concentrations ranging from 0.05M to 0.15M within electrolyte systems (as an example and not limited thereto). The concentration range evaluation reveals that guanidine thiocyanate exhibits optimal performance characteristics that provide balanced enhancement of both discharge capacity and coulombic efficiency metrics through complementary chemical mechanisms.

In various embodiments, the testing procedures may incorporate electrolyte-to-sulfur ratios of 3:1 and 5:1, providing comprehensive evaluation across different electrolyte loading conditions that may be encountered in practical battery applications. In some cases, the enhanced electrolyte formulations demonstrate variable C/2 performance and kinetic improvements that reflect the enhanced electrochemical kinetics provided by the thiocyanate anion component within the guanidine thiocyanate additive structure.

The synergistic electrochemical performance exhibited by incorporation of guanidine thiocyanate additives demonstrates enhanced coulombic efficiency compared to either baseline formulations or guanidine thiocyanate alone, validating the effectiveness of multi-additive electrolyte systems in addressing diverse degradation mechanisms within lithium-sulfur battery applications. The performance enhancement mechanisms may arise from the complementary chemical functionalities provided by each additive component, where guanidine thiocyanate provides both guanidine-based polysulfide interactions and thiocyanate-mediated electrochemical kinetics enhancement.

Additionally, the optimized concentration ratios within the range of 0.05M to 0.15M for guanidine thiocyanate enable balanced performance enhancement without introducing excessive electrolyte viscosity or solubility limitations that could compromise practical battery operation. The concentration optimization process involves systematic evaluation of intermediate concentration values to identify precise formulations that maximize the synergistic benefits while maintaining electrolyte stability and processability characteristics. The performance data presented in the graphs supports the implementation of guanidine thiocyanate additives as performance-enhancing components within commercial lithium-sulfur battery electrolyte formulations that require extended cycle life and reliable efficiency characteristics.

The electrochemical performance characteristics illustrated in the performance graphs demonstrate how the incorporation of guanidine thiocyanate additives addresses multiple degradation pathways within lithium-sulfur battery systems through complementary chemical mechanisms that provide comprehensive performance enhancement.

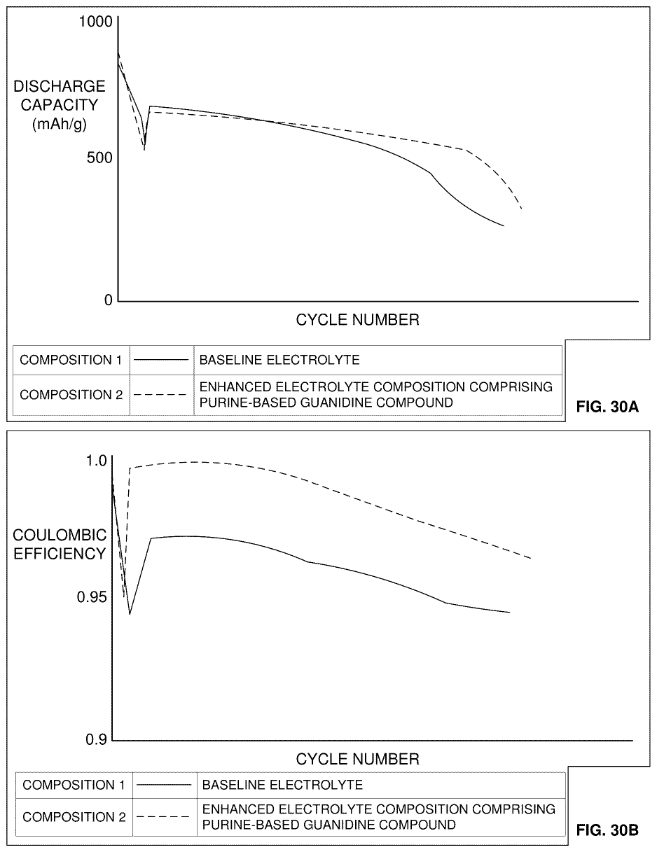

FIG. 30A illustrates discharge capacity versus cycle number performance graphs comparing electrolyte formulations incorporating guanine additives, in accordance with one embodiment. As an option, the discharge capacity versus cycle number performance graphs comparing electrolyte formulations incorporating guanine additives may be implemented in the context of any one or more of the embodiments set forth in any previous and/or subsequent Figures and/or description thereof. Of course, however, the discharge capacity versus cycle number performance graphs comparing electrolyte formulations incorporating guanine additives may be implemented in the context of any desired environment. Further, the aforementioned definitions may equally apply to the description below.

The discharge capacity performance graphs demonstrate the electrochemical behavior of lithium-sulfur battery systems incorporating purine-based guanidine compounds within electrolyte formulations that comprise dimethoxyethane (DME), 1,3-dioxolane (DOL), and BTFE or TTE in a volume ratio of 70:15:15. The solid line represents Composition 1 Baseline Electrolyte, while the dashed line illustrates Composition 2 Enhanced Electrolyte Composition Comprising Purine-Based Guanidine Compound.

The baseline electrolyte formulation represented by the solid line in the performance graphs establishes the reference performance characteristics for baseline electrolyte systems within the base electrolyte matrix. The capacity retention profile of the baseline system within the performance graphs exhibits gradual decline over extended cycling periods, reflecting the inherent challenges associated with polysulfide shuttle effects and electrode degradation mechanisms that occur.

The enhanced electrolyte formulation represented by the dashed line in the performance graphs demonstrates the enhanced electrochemical stability achieved through the incorporation of purine-based guanidine compounds within electrolyte systems. The discharge capacity behavior of the enhanced formulation exhibits improved capacity retention and extended cycle life compared to the baseline system. The performance enhancement illustrated by the dashed line within the performance graphs reflects the complementary mechanisms provided by guanine, which incorporates a cyclic ring structure containing nitrogen that provides multiple sites for chemical interaction with polysulfide species and electrode surfaces. The sustained capacity delivery of the enhanced formulation across extended cycling periods demonstrates how the incorporation of purine-based compound enhancements provides enhanced electrochemical stability compared to the baseline formulation. The superior performance characteristics of the enhanced formulation validate the approach of selecting guanidine-containing compounds based on protection of the NH2-CNH—NH—R structural motif, where the purine ring system of guanine provides additional stability and binding interactions that complement the performance enhancement mechanisms provided by the baseline formulation.

In various embodiments, the guanine additive may exhibit limited solubility characteristics at 0.1M concentration, appearing as a slight suspension in the electrolyte solution without forming solid precipitate deposits at the bottom of the container. Despite this limited solubility behavior, the guanine additive maintains its performance enhancement capabilities through the suspended particles that remain available for electrochemical interactions during battery operation.

FIG. 30B illustrates coulombic efficiency versus cycle number performance graphs comparing electrolyte formulations incorporating guanine additives, in accordance with one embodiment. As an option, the coulombic efficiency versus cycle number performance graphs comparing electrolyte formulations incorporating guanine additives may be implemented in the context of any one or more of the embodiments set forth in any previous and/or subsequent Figures and/or description thereof. Of course, however, the coulombic efficiency versus cycle number performance graphs comparing electrolyte formulations incorporating guanine additives may be implemented in the context of any desired environment. Further, the aforementioned definitions may equally apply to the description below.

The coulombic efficiency performance graphs provide detailed analysis of charge-discharge efficiency characteristics for electrolyte systems incorporating purine-based guanidine compounds within base electrolyte formulations that comprise at least one solvent, at least one electron withdrawing compound, and at least one lithium ion-transporting compound. The solid line within the performance graphs represents the coulombic efficiency behavior of the baseline electrolyte composition, while the dashed line illustrates the efficiency characteristics of the enhanced electrolyte system comprising purine-based guanidine compound.

The enhanced coulombic efficiency behavior represented by the dashed line in the performance graphs demonstrates the substantial improvements achieved through the incorporation of purine-based guanidine compounds within electrolyte systems that exhibit enhanced electrochemical stability compared to the baseline system. The efficiency characteristics of the enhanced formulation exhibit improved stability and higher average efficiency values compared to the baseline system. The coulombic efficiency performance illustrated by the dashed line within the performance graphs reflects the effectiveness of guanine in suppressing parasitic reactions and improving charge recovery during battery cycling through complementary mechanisms that address both polysulfide shuttle effects and electrode surface protection.

The performance characteristics demonstrated in both FIG. 30A and FIG. 30B validate the effectiveness of purine-based guanidine compounds when selected based on protection of the NH2-CNH—NH—R structural motif. The purine ring system of guanine provides a cyclic ring structure containing nitrogen that enables multiple sites for chemical interaction with polysulfide species, lithium ions, and electrode surfaces through hydrogen bonding, coordination chemistry, and π-π stacking interactions.

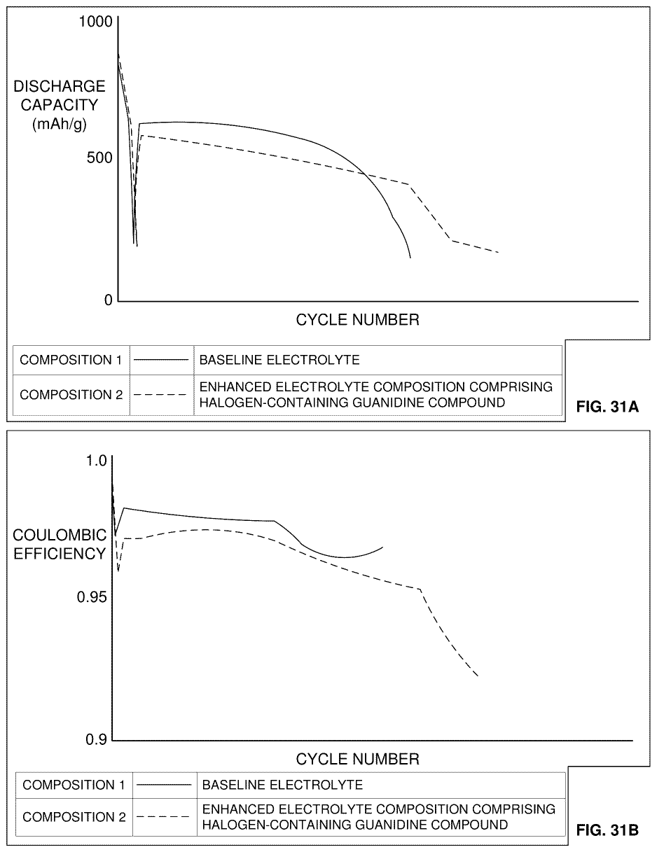

FIG. 31A illustrates discharge capacity versus cycle number performance graphs comparing electrolyte formulations incorporating guanidine bromide additives, in accordance with one embodiment. As an option, the discharge capacity versus cycle number performance graphs comparing electrolyte formulations incorporating guanidine bromide additives may be implemented in the context of any one or more of the embodiments set forth in any previous and/or subsequent Figures and/or description thereof. Of course, however, the discharge capacity versus cycle number performance graphs comparing electrolyte formulations incorporating guanidine bromide additives may be implemented in the context of any desired environment. Further, the aforementioned definitions may equally apply to the description below.

The discharge capacity performance graphs demonstrate the electrochemical behavior of lithium-sulfur battery systems incorporating halogen-containing guanidine compounds within electrolyte formulations that comprise at least one solvent selected from the group consisting of dimethoxyethane, diethylene glycol dimethyl ether, tetraethylene glycol dimethyl ether, and combinations thereof. The solid line represents Composition 1 Baseline Electrolyte, while the dashed line illustrates Composition 2 Enhanced Electrolyte Composition Comprising Halogen-Containing Guanidine Compound.

The enhanced electrolyte formulation represented by the dashed line in the performance graphs demonstrates the performance enhancement achieved through the incorporation of halogen-containing guanidine compounds within electrolyte systems. The discharge capacity behavior of the enhanced formulation exhibits modified capacity retention patterns compared to the baseline system, reflecting the distinct electrochemical effects provided, in one particular embodiment, by the bromide anion component within the halogen-containing guanidine compounds such as guanidine bromide. The performance characteristics illustrated by the dashed line within the performance graphs reflect the complementary mechanisms provided by halogen-containing guanidine compounds, which combines the polysulfide interaction capabilities of the guanidine structural motif with the enhanced kinetic properties associated with halogen-containing anions. The capacity delivery characteristics of the enhanced formulation across extended cycling periods demonstrate how halogen-containing guanidine compounds may provide different performance enhancement mechanisms compared to other guanidine-containing additives through the specific electrochemical properties that influence ionic conductivity and charge transfer kinetics.

FIG. 31B illustrates coulombic efficiency versus cycle number performance graphs comparing electrolyte formulations incorporating halogen-containing guanidine compounds, in accordance with one embodiment. As an option, the coulombic efficiency versus cycle number performance graphs comparing electrolyte formulations incorporating halogen-containing guanidine compounds may be implemented in the context of any one or more of the embodiments set forth in any previous and/or subsequent Figures and/or description thereof. Of course, however, the coulombic efficiency versus cycle number performance graphs comparing electrolyte formulations incorporating halogen-containing guanidine compounds may be implemented in the context of any desired environment. Further, the aforementioned definitions may equally apply to the description below.

The coulombic efficiency performance graphs provide detailed analysis of charge-discharge efficiency characteristics for electrolyte systems incorporating halogen-containing guanidine compounds. The solid line within the performance graphs represents the coulombic efficiency behavior of Composition 1 Baseline Electrolyte, while the dashed line illustrates the efficiency characteristics of Composition 2 Enhanced Electrolyte Composition Comprising Halogen-Containing Guanidine Compound. The coulombic efficiency measurements within the performance graphs encompass the practical operating range for lithium-sulfur battery systems, providing comprehensive evaluation of charge recovery and parasitic reaction suppression capabilities across extended cycling periods.

The baseline coulombic efficiency behavior represented by the solid line in the performance graphs establishes the baseline reference efficiency characteristics for electrolyte systems.

The enhanced coulombic efficiency behavior represented by the dashed line in the performance graphs demonstrates the efficiency characteristics achieved through the incorporation of halogen-containing guanidine compounds. The efficiency profile of the enhanced formulation exhibits distinct characteristics compared to the baseline system, reflecting the specific electrochemical effects provided by the halogen anion components within the halogen-containing guanidine compounds. The efficiency characteristics of the enhanced formulation across extended cycling periods demonstrate how halogen-containing guanidine compounds combine guanidine structural motifs with halogen functionality to influence parasitic reaction suppression and charge recovery processes within electrolyte systems.

The performance characteristics demonstrated in both FIG. 31A and FIG. 31B validate the electrochemical behavior of halogen-containing guanidine compounds within electrolyte systems, which may incorporate multiple performance-enhancing additives alongside at least one solvent selected from the group consisting of dimethoxyethane, diethylene glycol dimethyl ether, tetraethylene glycol dimethyl ether, and combinations thereof. The bromide anion component within guanidine bromide provides distinct electrochemical properties compared to other counterions, potentially influencing ionic conductivity, electrochemical kinetics, and interfacial phenomena through the specific characteristics of halogen anions.

### Additional Embodiments

In various embodiments, the guanidine-containing compounds may include guanidine iodide at concentrations of approximately 0.1M within the electrolyte system (or other combinations as shown in Table 5). The iodide anion component may provide enhanced electrochemical kinetics through facilitated charge transfer processes while maintaining the polysulfide interaction capabilities associated with the guanidine structural motif. The combination of guanidine functionality with iodide anions may offer distinct advantages in terms of ionic conductivity and electrochemical stability compared to other halogen-containing guanidine compounds.

In various embodiments, the electrolyte systems may incorporate sildenafil citrate as a performance-enhancing additive. The sildenafil citrate additive may provide unique molecular interactions that complement the performance enhancement mechanisms of guanidine-containing compounds through its complex heterocyclic structure and multiple nitrogen-containing functional groups. The citrate component may contribute additional electrochemical functionality through coordination chemistry and surface interactions that enhance overall battery performance.

In various embodiments, the nitrogen-containing additives may include taurine, which provides sulfonic acid functionality that may interact with lithium ions and electrode surfaces. The taurine additive may contribute to electrolyte stability and ionic conductivity through its zwitterionic character and ability to form hydrogen bonding networks within the electrolyte matrix. The combination of amino and sulfonic acid functionalities within taurine may provide complementary performance enhancement mechanisms when used alongside guanidine-containing compounds.

In various embodiments, the electrolyte systems may incorporate (S)-2-amino-5-ureidopentanoic acid as a performance-enhancing additive that combines amino acid functionality with urea-like structural features. This compound may provide enhanced polysulfide interactions through its multiple nitrogen-containing functional groups while contributing to electrolyte stability through its carboxylic acid functionality. The chiral nature of this additive may influence molecular interactions and surface adsorption phenomena in ways that enhance overall electrochemical performance.

In various embodiments, the performance-enhancing additives may include 2-(1-methylguanidino) acetic acid, which combines the guanidine structural motif with carboxylic acid functionality. This compound may provide enhanced solubility characteristics compared to other guanidine-containing additives while maintaining the polysulfide interaction capabilities associated with the NH₂—CNH—NH—R structural motif. The acetic acid component may contribute to pH buffering and electrochemical stability within the electrolyte system.

In various embodiments, the electrolyte systems may incorporate 1,3,7-trimethyl-2,3,6,7-tetrahydro-1H-purine-2,6-dione (caffeine) as a performance-enhancing additive that provides a purine ring system similar to guanine but with different substitution patterns. The methylated purine structure may offer distinct solubility and electrochemical properties compared to guanine while maintaining nitrogen-rich functionality that contributes to performance enhancement. The carbonyl groups within this compound may provide additional sites for coordination chemistry and molecular interactions.

In various embodiments, the nitrogen-containing additives may include 2-phenylethylamine, which provides aromatic functionality combined with primary amine groups. This compound may contribute to π-π stacking interactions with electrode materials while providing basic nitrogen functionality that can interact with polysulfide species. The phenylethylamine structure may offer unique molecular geometry that complements the performance enhancement mechanisms of guanidine-containing compounds.

In various embodiments, the guanidine-containing compounds may include guanidine hydrochloride, which provides the basic guanidine structural motif with chloride as the counterion. The chloride anion may contribute to ionic conductivity and electrochemical kinetics while the guanidine cation provides polysulfide interaction capabilities. The combination of guanidine functionality with chloride anions may offer balanced performance characteristics in terms of solubility, stability, and electrochemical activity.

In various embodiments, the electrolyte systems may incorporate 1,3-diphenylguanidine as a performance-enhancing additive that combines the guanidine structural motif with aromatic phenyl substituents. The phenyl groups may provide enhanced π-π stacking interactions with carbon-based electrode materials while the guanidine functionality maintains polysulfide interaction capabilities. The bulky aromatic substituents may influence molecular packing and surface adsorption phenomena in ways that enhance electrochemical performance.

In various embodiments, the nitrogen-containing additives may include biguanide, which contains two guanidine units connected through a nitrogen bridge. This compound may provide enhanced polysulfide interaction capabilities through multiple guanidine functionalities while offering unique molecular geometry that enables diverse chemical interactions. The biguanide structure may form extensive hydrogen bonding networks that contribute to electrolyte stability and performance enhancement.

In various embodiments, the electrolyte systems may incorporate metformin hydrochloride as a performance-enhancing additive that combines biguanide functionality with dimethyl substitution and chloride counterion. The methylated biguanide structure may provide enhanced solubility characteristics compared to unsubstituted biguanide while maintaining multiple nitrogen-containing sites for chemical interactions. The metformin structure may offer unique steric and electronic properties that complement other performance-enhancing additives.

In various embodiments, the electrolyte preparation involves simple addition procedures where the guanidine-containing compounds and nitrogen-containing additives are directly incorporated into base electrolyte formulations without requiring complex synthesis or modification steps. The straightforward mixing process enables practical implementation within existing battery manufacturing protocols while maintaining consistent additive distribution throughout the electrolyte matrix. Some additives may exhibit limited solubility characteristics, appearing milky or slightly suspended in solution while retaining their performance enhancement capabilities.

### Use Case Scenario

By way of a use-case scenario, and in various embodiments, a battery manufacturer developing lithium-sulfur cells for electric vehicle applications implements the guanidine-based electrolyte additive system to address persistent challenges with coulombic efficiency and cycle life degradation. The manufacturer begins by preparing a base electrolyte formulation comprising dimethoxyethane (DME), 1,3-dioxolane (DOL), and bis(trifluoromethane)sulfonimide lithium salt (LiTFSI) in a volume ratio ranging from about 60-80:10-20:10-20, incorporating lithium nitrate at concentrations ranging from about 0.25M to about 0.75M as an electron withdrawing compound. To this base formulation, the manufacturer adds dicyandiamide (DCDA) at concentrations ranging from about 0.075M to about 0.225M as the primary nitrogen-containing additive, followed by guanidine thiocyanate as the guanidine-containing compound to achieve synergistic electrochemical performance. The manufacturer further optimizes the electrolyte formulation by adjusting the LiTFSI concentration within the range of about 0.3M to about 0.9M and the guanidine thiocyanate concentration within the range of 0.05M to 0.15M to achieve targeted performance characteristics for specific vehicle platforms, while maintaining the synergistic benefits provided by the combination of multiple nitrogen-containing additives that address polysulfide shuttle suppression and anode protection simultaneously through complementary chemical mechanisms.

### Improvements Over Existing Systems

The present disclosure addresses significant challenges in lithium-sulfur battery technology that have long hindered the commercial viability of these high-energy-density systems. Prior art electrolyte formulations have struggled to simultaneously address multiple degradation mechanisms, including polysulfide dissolution and shuttling effects, rapid capacity fade during cycling, and poor coulombic efficiency that results from parasitic side reactions and incomplete charge recovery. Traditional electrolyte additives often provide limited improvement in one performance metric while compromising others, such as enhancing cycle life at the expense of rate capability, or improving coulombic efficiency while reducing discharge capacity. Existing nitrogen-containing additives frequently fail to maintain stable performance over extended cycling periods, particularly under demanding operating conditions, and lack the structural features necessary to provide comprehensive enhancement of both coulombic efficiency and cycle life simultaneously. Furthermore, conventional single-additive approaches have proven inadequate for addressing the complex interplay between electrolyte composition, electrode materials, and operating conditions that determines overall battery performance.

The disclosed guanidine-based electrolyte additive system overcomes these deficiencies through a novel multi-additive approach that combines guanidine-containing compounds with nitrogen-containing additives to achieve synergistic electrochemical performance that exceeds the capabilities of either component alone. By incorporating specific guanidine-containing compounds such as guanidine nitrate, guanidine thiocyanate, guanine, and guanidine bromide at optimized concentrations ranging from 0.05M to 0.15M, the disclosed system addresses multiple lithium-sulfur battery challenges simultaneously, including polysulfide shuttle suppression and anode protection, while maintaining kinetic performance and rate capability. The strategic selection of guanidine-containing compounds based on protection of the NH2-CNH—NH—R structural motif enables comprehensive performance enhancement across multiple electrochemical metrics. This innovative approach not only resolves the traditional trade-offs between different performance characteristics but also provides enhanced electrochemical stability compared to either component alone, effectively addressing the longstanding issues of capacity fade, efficiency degradation, and limited cycle life that have plagued prior art lithium-sulfur battery systems.

### System Implementation Embodiments

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. An electrochemical lithium-sulfur cell, comprising:
a cathode comprising sulfur with a mass loading of less than 5 mg/cm²;
an anode comprising lithium with a thickness of less than 100 microns;
an electrolyte solution comprising a solvent package having at least two solvents, wherein dimethoxyethane (DME) comprises at least 50% by volume of the solvent package, and lithium salts at a total concentration below 1.2 M, wherein at least one lithium salt is lithium nitrate (LiNO₃) and at least one additional lithium salt is selected from the group consisting of lithium bis(trifluoromethanesulfonyl)imide (LiTFSI), lithium bis(fluorosulfonyl)imide (LiFSI), lithium perchlorate (LiClO₄), and lithium trifluoromethanesulfonate (LiOTf);
wherein the electrolyte-to-sulfur mass ratio is less than or equal to 3.5:1.

2. The electrochemical lithium-sulfur cell of claim 1, wherein the dimethoxyethane (DME) comprises at least 50% by volume of the solvent package, preferably at least 60% by volume, more preferably at least 70% by volume.

3. The electrochemical lithium-sulfur cell of claim 1, wherein the solvent package comprises at least three solvents.

4. The electrochemical lithium-sulfur cell of claim 1, wherein the anode is freestanding without a copper foil current collector.

5. The electrochemical lithium-sulfur cell of claim 1, wherein the anode comprises a lithium alloy.

6. The electrochemical lithium-sulfur cell of claim 1, wherein the molar ratio of DME to LiTFSI is about 10.1:1.

7. The electrochemical lithium-sulfur cell of claim 1, wherein the molar ratio of DME to total lithium salts is about 5.52:1.

8. The electrochemical lithium-sulfur cell of claim 1, wherein the electrolyte solution further comprises dicyandiamide (DCDA).

9. The electrochemical lithium-sulfur cell of claim 8, wherein the DCDA is present at a concentration of about 0.15 M.

10. The electrochemical lithium-sulfur cell of claim 1, wherein the lithium-sulfur cell is configured to operate at at least one of:
a pressure of about 40 PSI;
a pressure below 50 PSI; or
a pressure between 50-100 PSI.

11. The electrochemical lithium-sulfur cell of claim 1, wherein the cell is configured to cycle between 1.8 V and 2.5 V.

12. The electrochemical lithium-sulfur cell of claim 1, wherein the solvent package comprises DME, dioxolane (DOL), and bis(2,2,2-trifluoroethyl) ether (BTFE) in a volume ratio ranging from about 60-80:10-20:10-20.

13. The electrochemical lithium-sulfur cell of claim 1, wherein at least one of:
the lithium salts comprise LiTFSI at a concentration ranging from about 0.3 M to about 0.9 M and LiNO₃ at a concentration ranging from about 0.25 M to about 0.75 M;
the lithium salts comprise LiTFSI or LiFSI at a concentration ranging from about 0.3 M to about 0.7 M; or
the lithium salts comprise at least one salt selected from the group consisting of LiTFSI, LiFSI, and LiNO₃ at a concentration ranging from about 0.3 M to about 0.9 M.

14. The electrochemical lithium-sulfur cell of claim 1, wherein the lithium salts comprise LiTFSI at a concentration ranging from about 0.4 M to about 0.9 M, LiNO₃ at a concentration ranging from about 0.25 M to about 0.75 M, and DCDA at a concentration ranging from about 0.075 M to about 0.2255 M.

15. The electrochemical lithium-sulfur cell of claim 1, wherein the solvent package comprises at least three solvents including DME, dioxolane (DOL), and bis(2,2,2-trifluoroethyl) ether (BTFE), and wherein the electrolyte solution further comprises dicyandiamide (DCDA) at a concentration of about 0.15 M.

16. The electrochemical lithium-sulfur cell of claim 4, wherein the anode comprises a lithium-magnesium alloy and has a thickness of less than 100 microns, and wherein the molar ratio of DME to LiTFSI is about 10.1:1 providing excess non-coordinated ether groups for polysulfide solvation.

17. The electrochemical lithium-sulfur cell of claim 8, wherein the anode is freestanding without copper foil and the DCDA additive concentration is about 0.15 M, wherein the cell is configured with this combination of reduced cathode mass loading, freestanding anode architecture, and DCDA additive for extended cycle life while maintaining energy density.

18. The electrochemical lithium-sulfur cell of claim 12, wherein the lithium salts comprise LiTFSI at about 0.6 M and LiNO₃ at about 0.5 M, and the electrolyte-to-sulfur mass ratio is less than 3.5:1, wherein the cell is configured with the high DME volume fraction relative to low salt concentration for enhanced polysulfide kinetics through free DME availability.

19. The electrochemical lithium-sulfur cell of claim 1, wherein the DME comprises at least 70% by volume of the solvent package, wherein a combination of the cathode mass loading of less than 5 mg/cm², the anode thickness of less than 100 microns, the electrolyte-to-sulfur mass ratio of less than or equal to 3.5:1, and the at least 70% by volume of DME in the solvent package is configured for extended cell cycle life.

20. The electrochemical lithium-sulfur cell of claim 14, wherein the solvent package comprises DME at 70% by volume, DOL at 15% by volume, and BTFE at 15% by volume, and the anode is freestanding lithium-magnesium alloy, wherein the cell is configured with the optimized electrolyte composition and cell architecture for both high energy density and extended cycle life.
